(19) United States
(12) Patent Application Publication
(10) Pub. No.: US 2013/0290234 A1
(43) Pub. Date: Oct. 31, 2013

(54) Intelligent Consumer Service Terminal Apparatuses, Methods and Systems

(71) Applicant: Visa International Service Association, San Francisco, CA (US)

(72) Inventors: Theodore Harris, San Francisco, CA (US); Patrick L. Faith, Pleasanton, CA (US)

(21) Appl. No.: 13/923,149

(22) Filed: Jun. 20, 2013

Related U.S. Application Data
(63) Continuation-in-part of application No. 13/758,900, filed on Feb. 4, 2013.
Application No. 13/758,900 is a continuation-in-part of application No. 13/520,481.
Application No. 13/520,481 is a continuation-in-part of application No. PCT/US13/24538, filed on Feb. 2, 2013.
(60) Provisional application No. 61/661,899, filed on Jun. 20, 2012.
(60) Provisional application No. 61/774,571, filed on Mar. 7, 2013.
(60) Provisional application No. 61/594,063, filed on Feb. 2, 2012.

(51) Int. Cl. G06N 5/02

(52) U.S. Cl. CPC G06N 5/022; Y10S 901/50
USPC 706/46; 901/50

(57) ABSTRACT

The INTELLIGENT CONSUMER SERVICE TERMINAL APPARATUSES, METHODS AND SYSTEMS (hereinafter “ICST”) The ICST transforms user service request inputs via ICST components into a service solution executable by an intelligent terminal. In one embodiment, a method is disclosed, comprising: receiving a service request inquiry from a remote terminal; parsing the service request inquiry to obtain service identifying information; querying in a solution cloud based on the obtained service identifying information; retrieving a solution from the solution cloud from the query; generating a downloadable instruction package including the retrieved solution based on source information of the remote terminal; and providing the downloadable instruction package to the remote terminal.

### PRIORITY

The instant application is a non-provisional of and claims priority under 35 USC §119 to U.S. provisional patent application Ser. No. 61/661,899, filed Jun. 20, 2012, entitled “INTELLIGENT CONSUMER SERVICE TERMINAL APPARATUSES, METHODS AND SYSTEMS”; and U.S. provisional patent application Ser. No. 61/774,571, filed Mar. 7, 2013, entitled “PREDICTIVE SHOPPING LIST MANAGER APPARATUSES, METHODS AND SYSTEMS.”

This application further claims priority under 35 USC §120 to United States application Ser. No. 13/758,900, filed Feb. 4, 2013, entitled “Multi-Source, Multi-Dimensional, Cross-Entity, Multimedia Encryptmatics Database Platform Apparatuses, Methods and Systems,” which in turn is a non-provisional of and claims priority under 35 USC §§119, 120 to: U.S. provisional patent application Ser. No. 61/594,063 filed Feb. 2, 2012, entitled “CENTRALIZED PERSONAL INFORMATION PLATFORM APPARATUSES, METHODS AND SYSTEMS,” attorney docket no. P-42185PRV|VISA-122/01US, and U.S. patent application Ser. No. 13/520,481 filed Jul. 3, 2012, entitled “Universal Electronic Payment Apparatuses, Methods and Systems,” attorney docket no. P-42051US02|20270-136US.

This application hereby claims priority under 35 U.S.C. §365, 371 to PCT application no. PCT/US13/24538 filed Feb. 2, 2013, entitled “MULTI-SOURCE, MULTI-DIMENSIONAL, CROSS-ENTITY, MULTIMEDIA DATABASE PLATFORM APPARATUSES, METHODS AND SYSTEMS,” attorney docket no. P-42185WO01|VISA-122/01WO.

The entire contents of the aforementioned application(s) are expressly incorporated by reference herein.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to financial service terminal apparatuses, and more particularly, to INTELLIGENT CONSUMER SERVICE TERMINAL APPARATUSES, METHODS AND SYSTEMS.

### BACKGROUND

Autonomous technology has been developed to assist humans in a variety of task operations. For example, autonomous robots may be designed to perform tasks in dangerous environments, such as space probes and roadside bombs diffusion. For another example, robots are also designed for home use to perform vacuum cleaning, floor washing and lawn mowing.

### BRIEF DESCRIPTION OF THE DRAWINGS

The accompanying appendices and/or drawings illustrate various non-limiting, example, innovative aspects in accordance with the present descriptions:

FIGS. 1A-1G show block diagrams illustrating example applications of ICST robots within various embodiments of the ICST;

FIGS. 2A-2B provide data flow diagrams illustrating data flows between ICST entities within various embodiments of the ICST;

FIG. 2C provides a block diagram illustrating infrastructure of the ICST within various embodiments of the ICST;

FIGS. 3A-3C show logic flow diagrams illustrating various embodiments of the ICST;

FIGS. 4A-4C provide exemplary user interface diagrams illustrating providing solutions to a consumer via the ICST within embodiments of the ICST;

FIGS. 5A-5B provide example block diagrams illustrating example component structure of ICST components in the form of ICST wearable jewelry within embodiments of the ICST;

FIGS. 6A-6B provide example block diagrams illustrating example component structure and use cases of ICST quadrocopter examples within embodiments of the ICST;

FIGS. 6C-6D provide example block diagrams illustrating example component structure of ICST robot cleaners within embodiments of the ICST;

FIG. 7 shows a block diagram illustrating example aspects of a centralized personal information platform in some embodiments of the ICST;

FIGS. 8A-F show block diagrams illustrating example aspects of data models within a centralized personal information platform in some embodiments of the ICST;

FIG. 9 shows a block diagram illustrating example ICST component configurations in some embodiments of the ICST;

FIG. 10 shows a data flow diagram illustrating an example search result aggregation procedure in some embodiments of the ICST;

FIG. 11 shows a logic flow diagram illustrating example aspects of aggregating search results in some embodiments of the ICST, e.g., a Search Results Aggregation (“SRA”) component 500;

FIGS. 12A-D show data flow diagrams illustrating an example card-based transaction execution procedure in some embodiments of the ICST;

FIGS. 13A-E show logic flow diagrams illustrating example aspects of card-based transaction execution, resulting in generation of card-based transaction data and service usage data, in some embodiments of the ICST, e.g., a Card-Based Transaction Execution (“CTE”) component 1300;

FIG. 14 shows a data flow diagram illustrating an example procedure to aggregate card-based transaction data in some embodiments of the ICST;

FIG. 15 shows a logic flow diagram illustrating example aspects of aggregating card-based transaction data in some embodiments of the ICST, e.g., a Transaction Data Aggregation (“TDA”) component 1500;

FIG. 16 shows a data flow diagram illustrating an example social data aggregation procedure in some embodiments of the ICST;

FIG. 17 shows a logic flow diagram illustrating example aspects of aggregating social data in some embodiments of the ICST, e.g., a Social Data Aggregation (“SDA”) component 1700;

FIG. 18 shows a data flow diagram illustrating an example procedure for enrollment in value-add services in some embodiments of the ICST;

FIG. 19 shows a logic flow diagram illustrating example aspects of social network payment authentication enrollment in some embodiments of the ICST, e.g., a Value-Add Service Enrollment (“VASE”) component 1900;

FIGS. 20A-B show flow diagrams illustrating example aspects of normalizing aggregated search, enrolled, service usage, transaction and/or other aggregated data into a standardized data format in some embodiments of the ICST, e.g., a Aggregated Data Record Normalization (“ADRN”) component 2000;

FIG. 21 shows a logic flow diagram illustrating example aspects of recognizing data fields in normalized aggregated data records in some embodiments of the ICST, e.g., a Data Field Recognition (“DFR”) component 2100;

FIG. 22 shows a logic flow diagram illustrating example aspects of classifying entity types in some embodiments of the ICST, e.g., an Entity Type Classification (“ETC”) component 2200;

FIG. 23 shows a logic flow diagram illustrating example aspects of identifying cross-entity correlation in some embodiments of the ICST, e.g., a Cross-Entity Correlation (“CEC”) component 2300;

FIG. 24 shows a logic flow diagram illustrating example aspects of associating attributes to entities in some embodiments of the ICST, e.g., an Entity Attribute Association (“EAA”) component 2400;

FIG. 25 shows a logic flow diagram illustrating example aspects of updating entity profile-graphs in some embodiments of the ICST, e.g., an Entity Profile-Graph Updating (“EPGU”) component 2500;

FIG. 26 shows a logic flow diagram illustrating example aspects of generating search terms for profile-graph updating in some embodiments of the ICST, e.g., a Search Term Generation (“STG”) component 2600;

FIGS. 27A-E show user interface diagrams illustrating example features of user interfaces for an electronic virtual wallet in some embodiments of the ICST;

FIG. 28 shows a block diagram illustrating example aspects of a merchant analytics platform in some embodiments of the ICST;

FIGS. 29A-B show data flow diagrams illustrating an example procedure to provide a user and/or merchant offers for products, services and/or the like, using user behavior patterns derived from card-based transaction data in some embodiments of the ICST;

FIG. 30 shows a logic flow diagram illustrating example aspects of providing a user and/or merchant offers for products, services and/or the like, using user behavior patterns derived from card-based transaction data in some embodiments of the ICST, e.g., a Merchant Analytics (“MA”) component;

FIG. 31 shows a logic flow diagram illustrating example aspects of generating a user behavior pattern analysis in some embodiments of the ICST, e.g., a User Behavioral Pattern Analytics (“UBPA”) component;

FIG. 32 shows a logic flow diagram illustrating example aspects of identifying user behavioral patterns from aggregated card-based transaction data in some embodiments of the ICST, e.g., a User Patten Identification (“UPI”) component;

FIGS. 33A-B show block diagrams illustrating example aspects of merchant analytics in a second set of embodiments of the ICST;

FIGS. 34A-C show data flow diagrams illustrating an example procedure for econometrical analysis of a proposed investment strategy based on card-based transaction data in some embodiments of the ICST;

FIG. 35 shows a logic flow diagram illustrating example aspects of normalizing raw card-based transaction data into a standardized data format in some embodiments of the ICST, e.g., a Transaction Data Normalization (“TDN”) component;

FIG. 36 shows a logic flow diagram illustrating example aspects of generating classification labels for card-based transactions in some embodiments of the ICST, e.g., a Card-Based Transaction Classification (“CTC”) component;

FIG. 37 shows a logic flow diagram illustrating example aspects of filtering card-based transaction data for econometrical investment strategy analysis in some embodiments of the ICST, e.g., a Transaction Data Filtering (“TDF”) component;

FIG. 38 shows a logic flow diagram illustrating example aspects of anonymizing consumer data from card-based transactions for econometrical investment strategy analysis in some embodiments of the ICST, e.g., a Consumer Data Anonymization (“CDA”) component;

FIGS. 39A-B show logic flow diagrams illustrating example aspects of econometrically analyzing a proposed investment strategy based on card-based transaction data in some embodiments of the ICST, e.g., an Econometrical Strategy Analysis (“ESA”) component;

FIG. 40 shows a logic flow diagram illustrating example aspects of reporting business analytics derived from an econometrical analysis based on card-based transaction data in some embodiments of the ICST, e.g., a Business Analytics Reporting (“BAR”) component;

FIG. 41 shows a logic flow diagram illustrating example aspects of sharing an analytical model generated using data acquired using the centralized personal information platform in some embodiments of the ICST, e.g., an Analytical Model Sharing (“AMS”) component;

FIG. 42 shows a logic flow diagram illustrating example aspects of a metadata based interpretation engine of the ICST that generates standardized encryptmatics XML from structured data obtained from various sources via the centralized personal information platform, e.g., an Encryptmatics XML Converter (“EXC”) component;

FIG. 43 shows a data flow diagram illustrating an example email data aggregation procedure, in one embodiment of the ICST;

FIG. 44 shows a block diagram illustrating an example distributed linking node mesh, in one embodiment of the ICST;

FIGS. 45A-F show a block diagram illustrating an example distributed linking node mesh search, in one embodiment of the ICST;

FIGS. 46A-C show a block diagram illustrating an example distributed linking node mesh index creation, in one embodiment of the ICST;

FIG. 47 shows a logic flow illustrating an example Encryptmatics XML Converter component, in one embodiment of the ICST;

FIG. 48 shows a logic flow illustrating input language loading by an Encryptmatics XML Converter component, in one embodiment of the ICST;

FIGS. 49A-B show a logic flow illustrating input model conversion by an Encryptmatics XML Converter component, in one embodiment of the ICST;

FIG. 50 shows a block diagram illustrating aspects of a tumblar data source manipulation/anonymization component, e.g., a TDS component, in one embodiment of the ICST;

FIG. 51 shows a logic flow diagram illustrating an example tumblar data source manipulation/anonymization component, in one embodiment of the ICST;

FIG. 52 shows an example data flow illustrating mesh aggregation and cluster querying, in one embodiment of a ICST;

FIG. 53 shows an example logic flow illustrating cluster response analysis and transaction triggering, in one embodiment of a ICST;

FIG. 54A-C illustrate an example ICST application embodiment, in one embodiment of the ICST;

FIG. 55 shows a block diagram illustrating example embodiments of the ICST;

FIG. 56 shows a data flow diagram illustrating collecting information for predictive shopping lists in some embodiments of the ICST;

FIG. 57 shows a data flow diagram illustrating collecting receipt information for predictive shopping lists in some embodiments of the ICST;

FIGS. 58a-c show logic flow diagrams illustrating parsing receipts and generating predictive shopping lists in some embodiments of the ICST;

FIG. 59 shows a logic flow diagram illustrating obtaining electronic receipts in some embodiments of the ICST;

FIG. 60 shows a data flow diagram illustrating collecting code information for predictive shopping lists in some embodiments of the ICST;

FIG. 61 shows a logic flow diagram illustrating collecting code information for predictive shopping lists in some embodiments of the ICST;

FIG. 62 shows a data flow diagram illustrating collecting snap purchase information for predictive shopping lists in some embodiments of the ICST;

FIG. 63 shows a logic flow diagram illustrating collecting snap purchase information for predictive shopping lists in some embodiments of the ICST;

FIG. 64 shows a block diagram illustrating using predictive shopping lists with a smart shopping cart in some embodiments of the ICST;

FIGS. 65a-b show data flow diagrams illustrating using predictive shopping lists with a smart shopping cart in some embodiments of the ICST;

FIGS. 66a-b show logic flow diagrams illustrating using predictive shopping lusts with a smart shopping cart in some embodiments of the ICST;

FIG. 67 shows a data flow diagram illustrating providing predictive shopping list feedback in some embodiments of the ICST;

FIG. 68 shows a data flow diagram illustrating receiving predictive shopping list feedback from other users in some embodiments of the ICST;

FIG. 69 shows a logic flow diagram illustrating receiving feedback for predictive shopping list in some embodiments of the ICST;

FIG. 70 shows a block diagram illustrating notifying users of nearby merchants with items on predictive shopping list in some embodiments of the ICST;

FIG. 71 shows a data flow diagram illustrating notifying users of nearby merchants with items on predictive shopping list in some embodiments of the ICST;

FIGS. 72a-b show logic flow diagrams illustrating notifying users of nearby merchants with items on predictive shopping list in some embodiments of the ICST;

FIG. 73 shows a block diagram illustrating a PoS checkout code in some embodiments of the ICST; and

FIG. 74 shows a block diagram illustrating embodiments of a ICST controller;

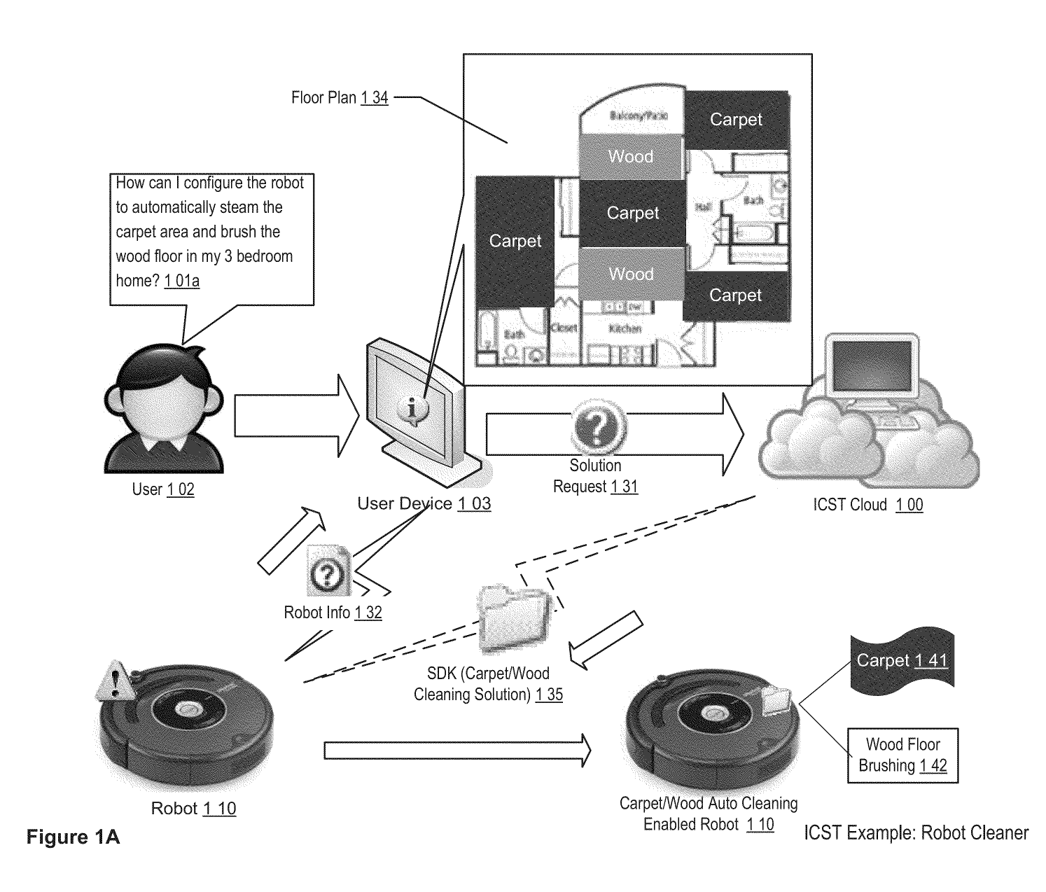

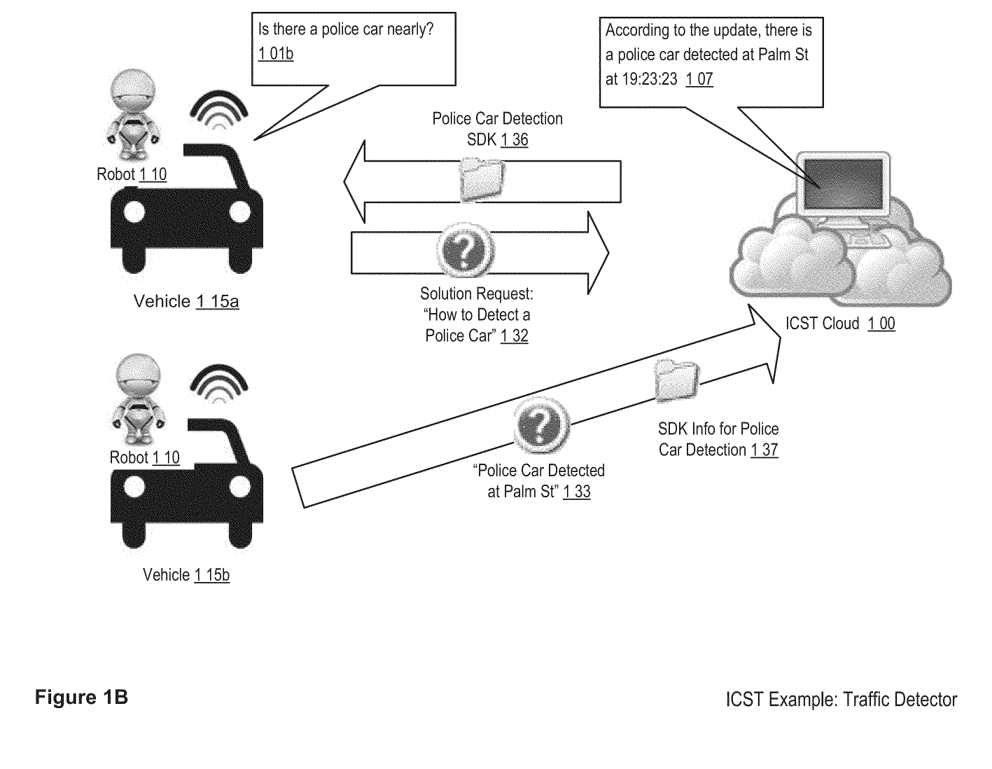

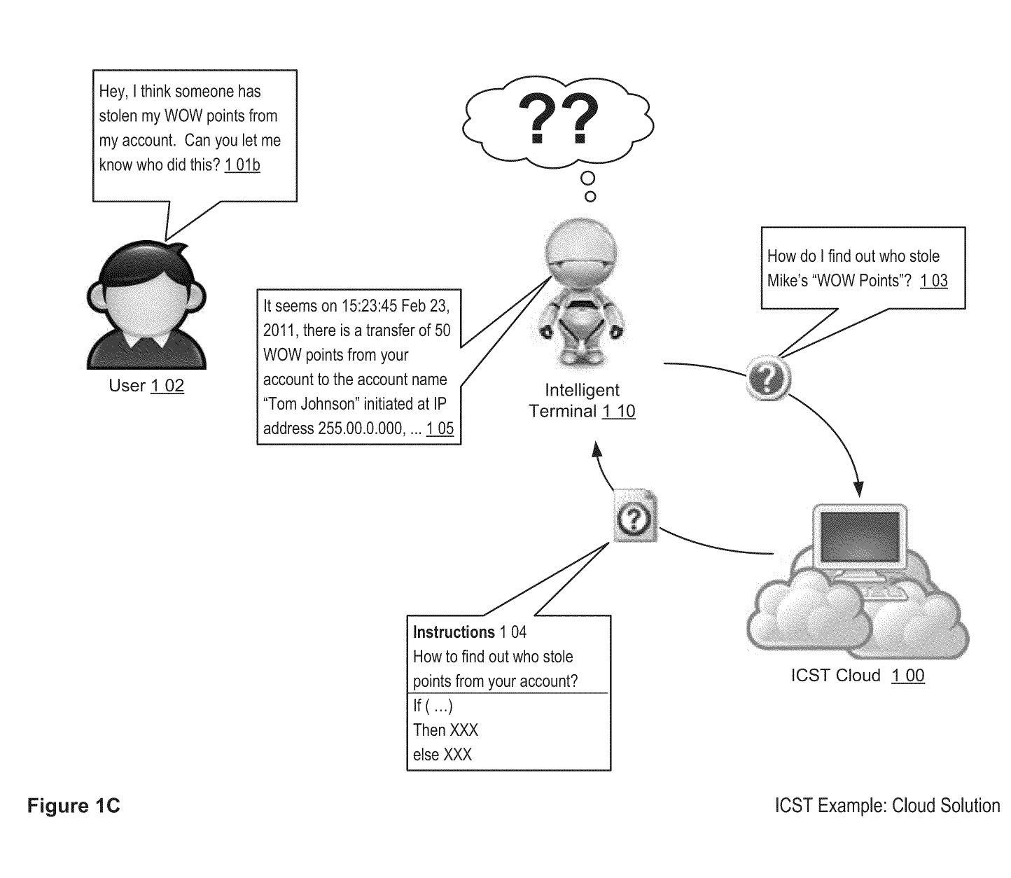

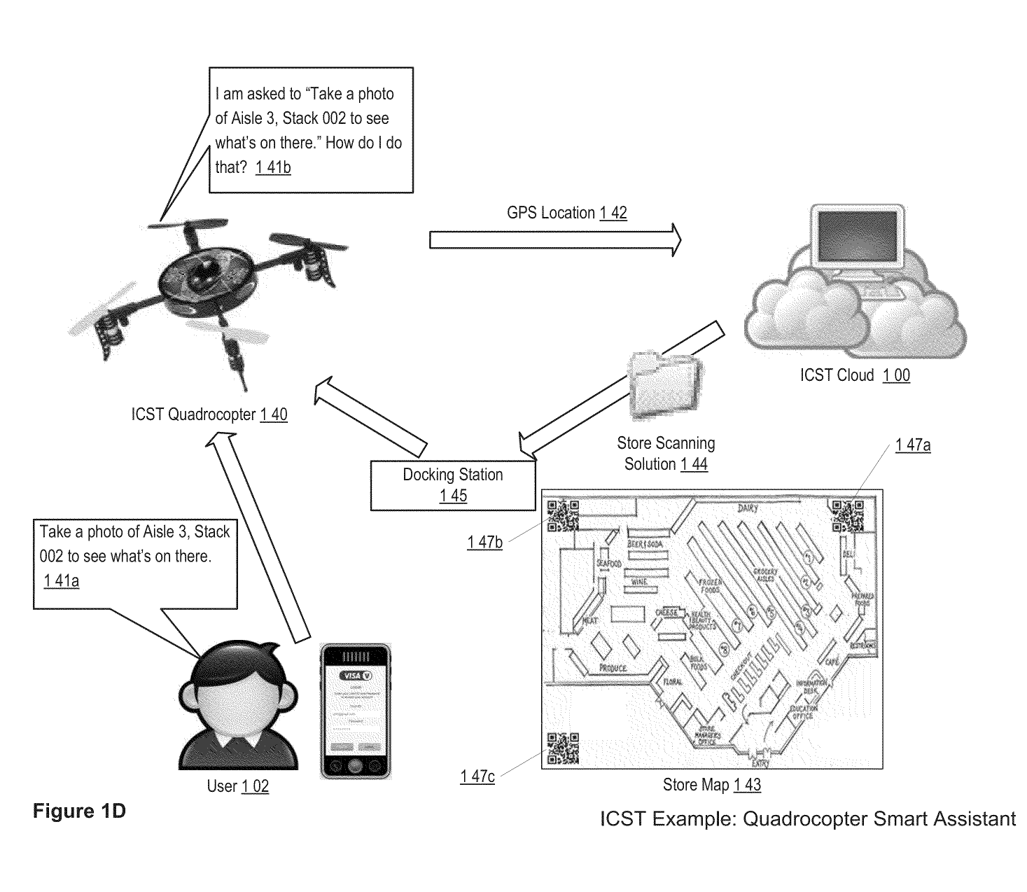

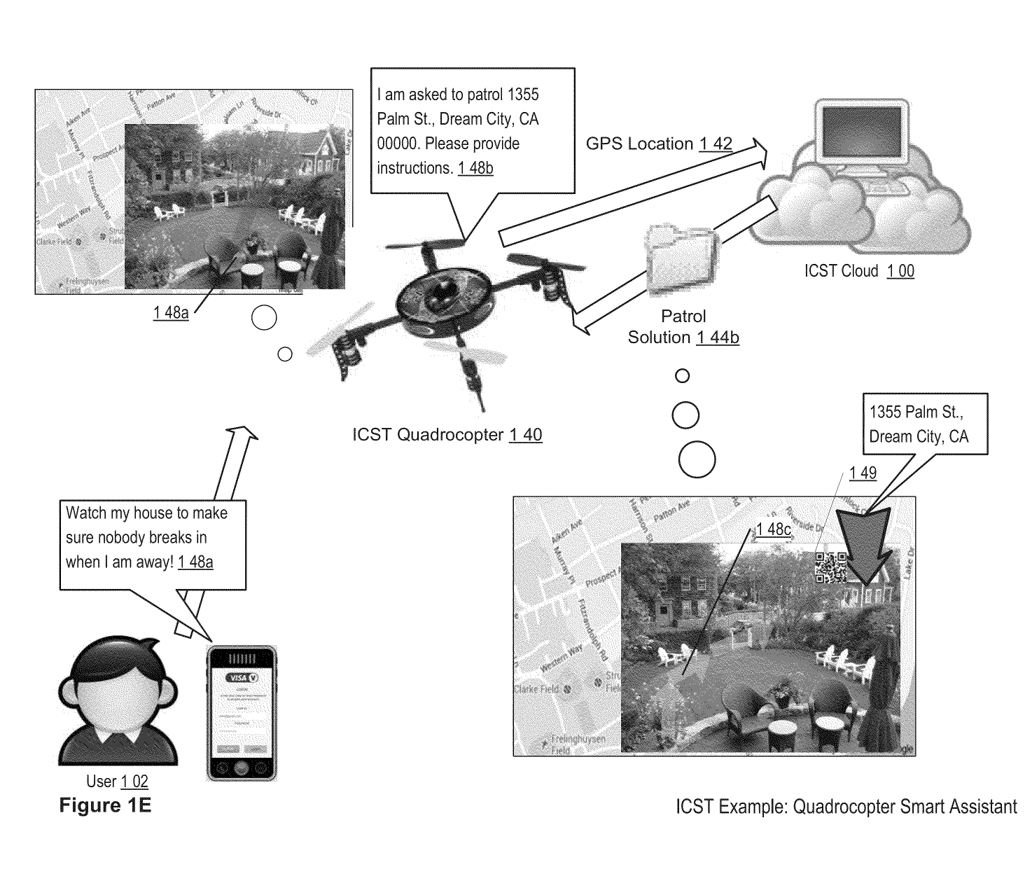

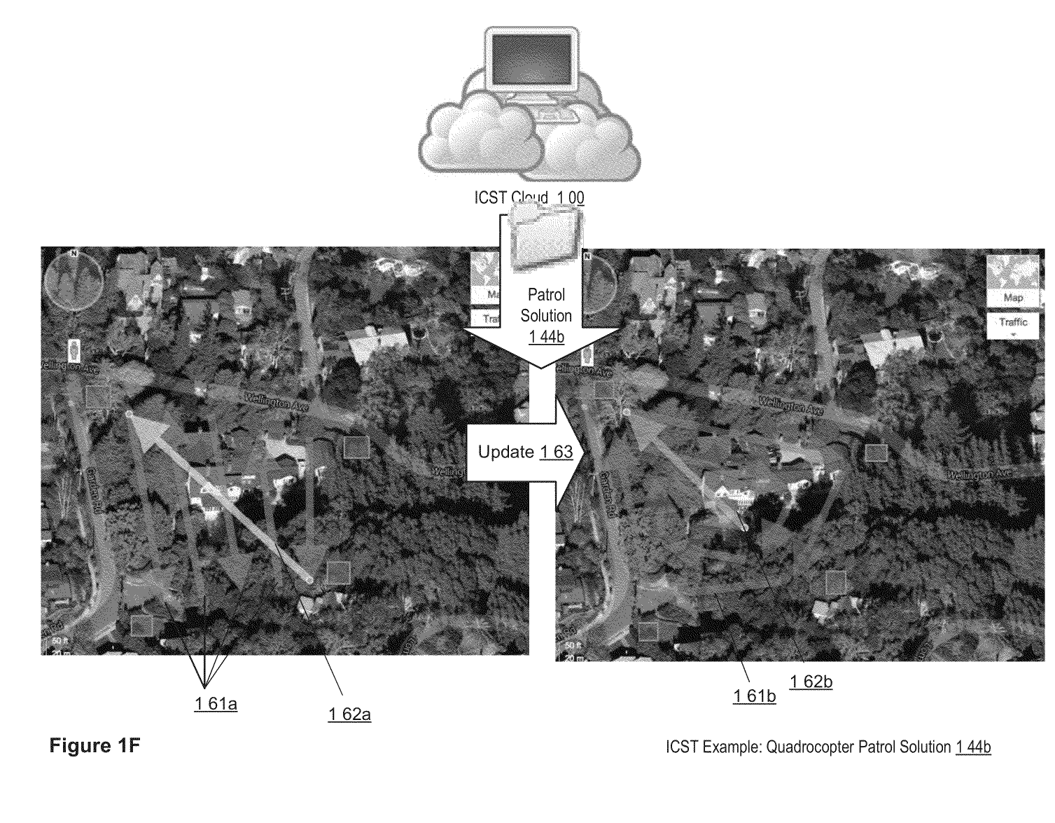

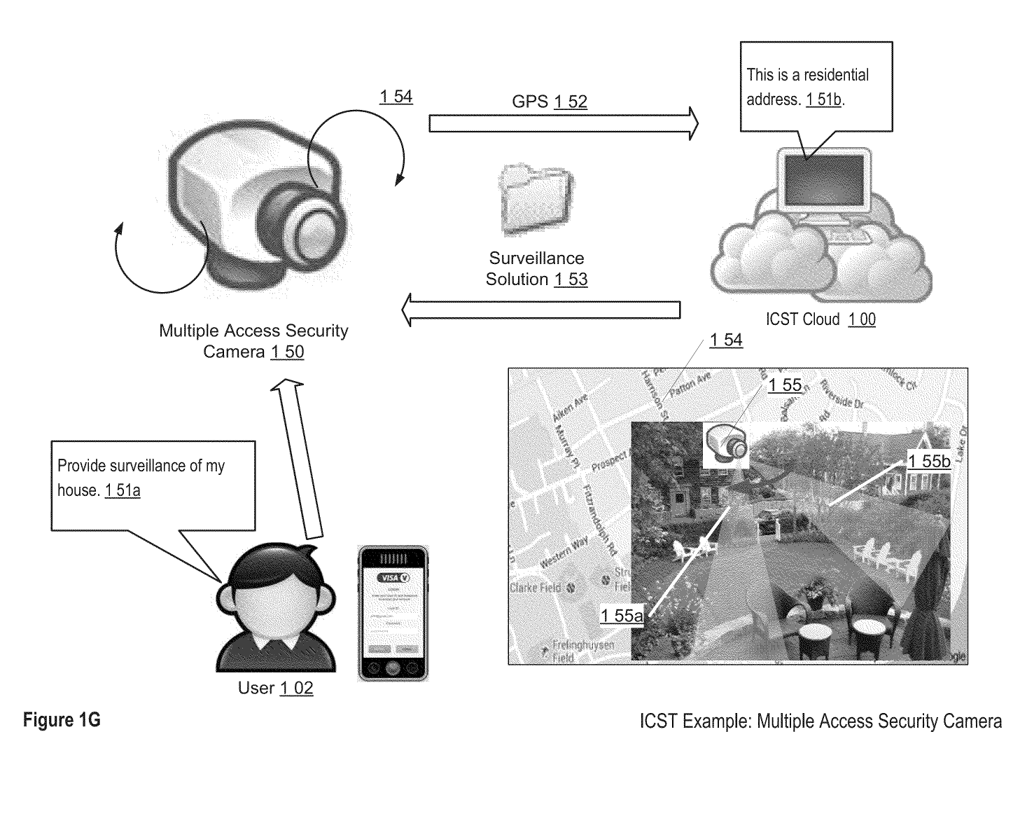

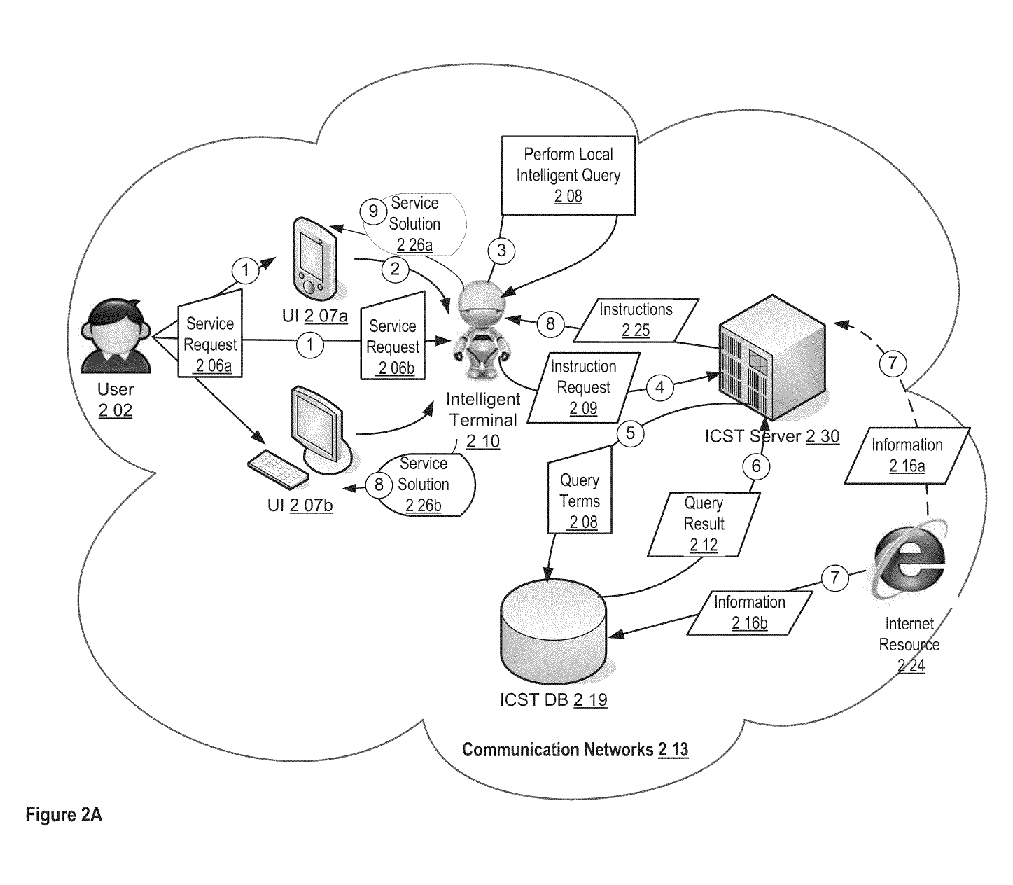

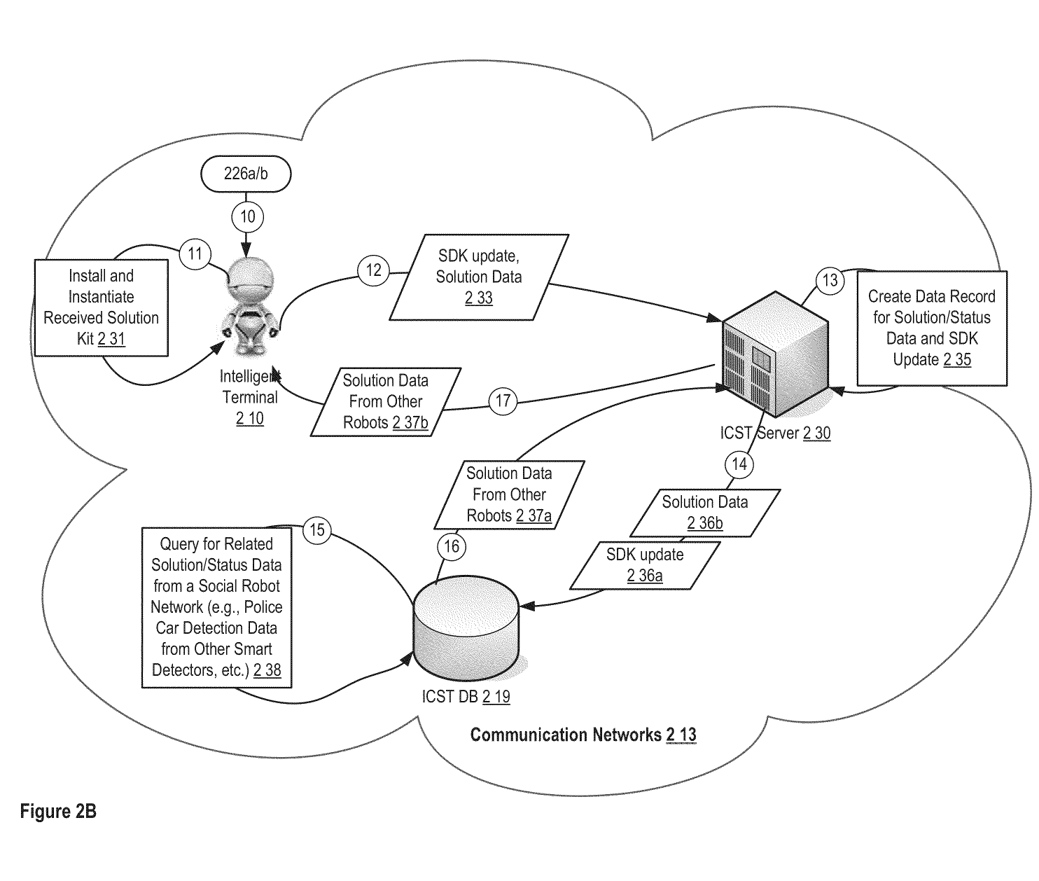

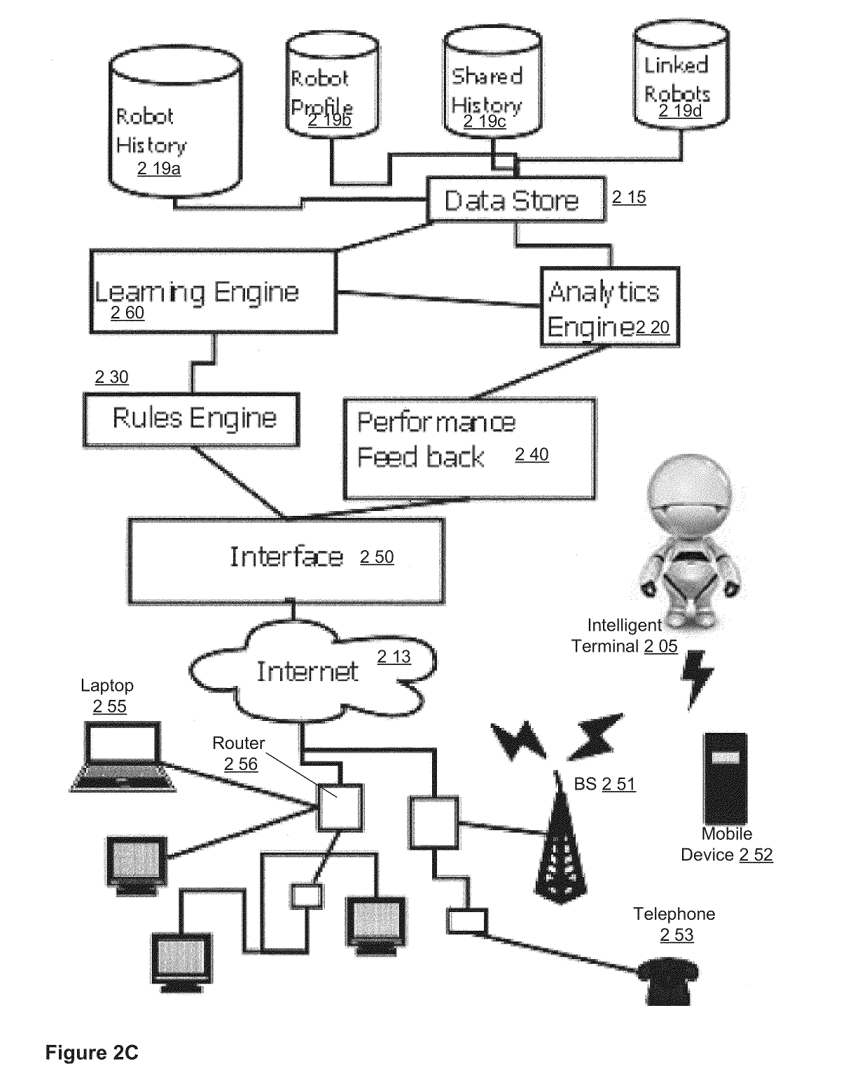

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The INTELLIGENT CONSUMER SERVICE TERMINAL APPARATUSES, METHODS AND SYSTEMS (hereinafter “ICST”) provides a learning mechanism for intelligent consumer service terminals to automatically download knowledge from a cloud database to build new solutions.

For example, robots and other autonomous systems may have confined memory and processing unit tied to their physical unit, wherein the processing systems, memory and software kit of such robot systems are pre-configured and static. In such cases, the power and memory of the control unit may be restricted by the size, weight and power limitations; when a robot malfunctions or becomes obsolete, a new robots may be required to replace the old one. Alternatively, the ICST may provide cloud services to provide shared memory, processing and control system to robots and other autonomous systems (e.g., intelligent service terminals, etc.). The ICST may enable autonomous learning systems to access a far more powerful computation engine, share knowledge and solution with other terminals and access a larger amount of data then they could store locally. In addition, the ICST may be customizable so that each user may define what services are consumed and how they are consumed.

Within implementations, the ICST may expose shared data storage, learning algorithms and other systems as cloud services that can be accessed remotely by distributed devices and/or intelligent consumer service terminals, such as robots, ATM terminals, POS terminals, Kiosks, and/or the like. In one implementation, the ICST may include a configurable rules engine (e.g., including a graph based learning engine, a graph database and links to other data sources). It may provide solutions (sets of commands) to problems generate by a robot or autonomous system. An example problem would be how to open a door that the robot has not seen before. The solution would be the optimal configuration and movement of the robot's hand to open the door.

### ICST

FIG. 1A shows a diagram illustrating an example of robot obtaining and installing SDK solution packages from an ICST cloud within implementations of the ICST. Within embodiments, a robot 110 may comprise a programmable component and a vacuum cleaning component, such as but not limited to a iRobot Create® Roomba®, Scooba®, and/or the like. In one implementation, a user 102 may desire to configure the robot 110 to perform different tasks 101a that the robot 110 may not be pre-programmed to accomplish. For example, the user 102 may want the robot 110 to perform customized tasks such as automatically steaming all the carpet area and brushing all the wood floor areas in a particular three bedroom home, e.g., 101a. In one implementation, the user 102 may enter such task requests via a user device 103, e.g., a user laptop, a desktop, a personal digital assistant (PDA), a smart phone (e.g., an Apple® iPhone, a BlackBerry®, a Google Android®, etc.), a table computer, and/or the like. For example, in one implementation, the user may upload a picture of his floor plan 134 along with his requests, indentifying carpet area and wood area in the floor plan. In another example, the user may or may not provide floor plan 134 or specifying carpet/wood areas but seeking for a solution so that the robot 110 could automatically identify the carpet or wood area.

In an alternative implementation, the robot 110 may comprise a user input/output interface such as a touch screen, a key board, a LCD screen, and/or the like, so that a user 102 may directly submit a service request to the robot 110 via the user interface.

In one implementation, the user device 103 may communicate with the robot 110 via a wireless network such as but not limited to WiFi, Bluetooth, and/or the like, and obtain robot information 132, e.g., robot type, robot manufacturer, robot physical address, robot OS version, robot SDK version, robot hardware identifier, and/or the like. In one implementation, the user 102 may submit a solution request 131 via the user device 103, e.g., by accessing a web-based portal, etc., and upload the request 131 to an ICST cloud 100. In another implementation, the robot 110 which may be equipped with an intelligent component may directly upload such request 131 to the ICST cloud 100.

In one implementation, the ICST cloud 100 may query for a SDK package 135 for the robot 110 based on the submitted robot information 132, e.g., based on compatibility of OS, hardware, and/or the like. The robot 110 may then download and install the SDK for carpet/wood cleaning solutions 135, which may enable the robot 110 to determine a carpet 141 area or a wood floor area 142, and perform cleaning tasks accordingly.

FIG. 1B provides a diagram illustrating another example of intelligent robots uploading and sharing traffic information with the ICST cloud within implementations of the ICST. Within implementations, an intelligent robot no may be installed with a vehicle 115a-b to collect road information. For example, in one implementation, the robot 110 may comprise an Escort smart detector, and/or the like. In one implementation, a user, e.g., the driver of a vehicle 115a, may request the robot, e.g., the smart detector, to detect whether there is a police car 101b. In one implementation, if the robot is not pre-programmed to detect a police car, the robot 110 may submit a solution request 132 to the ICST cloud 100.

In one implementation, if another vehicle 115b, who has installed a robot 110 capable of detecting a police car, may submit smart detection data 133 and SDK information for police car detection 137 to the ICST cloud 100. The ICST cloud 100 may then provide a police car SDK 136 for download, and provide a synchronized update 107 indicating the police car detection information to a social network of robots 110.

FIG. 1C shows a diagram illustrating another example of intelligent terminal learning mechanism within implementations of the ICST. For example, as shown in FIG. 1B, a user 102 may submit a request for service 101 to an intelligent terminal 110. For example, the intelligent terminal 110 may be a smart wallet assistant robot, an ATM machine, a smart wallet mobile robot application (e.g., an Apple Siri-like smart mobile application, etc.), and/or the like.

In one implementation, the user 102 may demand service from the intelligent terminal 110, wherein the service content may not be already pre-programmed with the terminal 110. For example, the user may ask the terminal to determine who has stolen his gaming points from his mobile wallet account 101. In one implementation, the intelligent terminal 110 may form a query in the local instruction pool to determine whether such service request has been submitted before and whether there exists a solution. If not, the intelligent terminal no may submit a request to a ICST cloud 100, seeking for advice on how to find out who stole the user's gaming points 103. In one implementation, the ICST cloud 100 may in turn query for a set of rules, e.g., via a rule engine, and return a set of instructions/rules 104 to the intelligent terminal no, who may receive and load the instructions 104 for execution. For example, in one implementation, the instructions/rules 104 may comprise a software update kit, patches, such as

For example, the instructions 104 may comprise a set of rules for the intelligent terminal no to investigate the user's 102 smart wallet transaction history and find out the time, date, source of IP, transferee account, etc. of the suspicious gaming points transfer, e.g., at 105. As such, the intelligent terminal 110 may install and save the instructions 104, and build a new service type responding to the request 101. In this way, the intelligent terminal 110 may progressively build new solutions and expand its skill set in response to user's new service requests.

FIG. 1D provides an exemplary diagram illustrating aspects of an ICST terminal in the form of a camera equipped quadrocopter within embodiments of the ICST, e.g., for example the Parrot AR.Drone 2.0 and accompanying ADRONE open API (see projects.adrone.org) may be employed for remote access and control. Within implementations, a user 102 may employ a device as a smart ICST assistant to perform a plurality of tasks, e.g., via smartphone API, such as, but not limited to scanning bar code during purchase, performing price check, and/or the like. In one implementation, the ICST smart assistant may take a form to a wearable device, such as glasses, a hat, a headband, a watch, a pin, a button, and/or the like. Further discussion of a wearable device assisting shopping transactions may be found in U.S. provisional application Ser. No. 61/834,968, filed Jun. 14, 2013, titled “WEARABLE INTELLIGENT VISION DEVICE APPARATUSES, METHODS AND SYSTEMS,” which is herein expressly incorporated by reference.

In one implementation, as shown in FIG. 1D, the ICST smart assistant may take a form to a quadrocopter 140, which may be configured to move from one destination to another in the air. In one implementation, a user 102 may remotely control the ICST quadrocopter via a remote control component installed at a mobile device (e.g., a Smartphone, etc.). In one implementation, the ICST quadrocopter 140 may be installed with multiple cameras on facing different directions so that the quadrocopter may take photos from different angles while moving around.

For example, in one implementation, a user 102 may utilize the ICST quadrocopter as a shopping assistant at a physical store. The user may operate a remote control mobile device to request the ICST quadrocopter 140 to take a photo of “Aisle 3, Stack 002” 141a. In one implementation, the ICST quadrocopter 140 may not be pre-programmed with the specific direction and floormap of the storefront to execute the user instructions. The ICST quadrocopter 140 may submit an instruction query 141b to the ICST cloud 100, with its GPS location 142. The ICST cloud 100 may query the database and find a store scanning solution firmware package 144 for the quadrocopter. In one implementation, the ICST could 100 may retrieve a store floor layout map 143 based on the GPS location 142, and provide the movement instructions within the store to the ICST quadrocopter 140. In another implementation, the ICST cloud 100 may provide a store scanning solution 144 to a docking station 145, wherein the docking station 145 may provide the store map 143. In one implementation, the ICST quadrocopter 140 may move to the docking station 145 to receive a store scanning solution package 144 including instructions with regard to the store layout information 143.

In further implementations, the store scanning solution 144 may indicate the locations in the physical store where a, e.g., 4×4 inch, QR code may be found in store, e.g., 147a-c. In one implementation, the ICST quadrocopter 140 may locate the QR codes 147a-c while roaming in store, and obtain information with regard to inventory, store map and/or direction by scanning the QR codes 147a-c.

FIG. 1E provides an alternative embodiment of the ICST quadrocopter providing patrol service of a residential place within embodiments for the ICST. In one implementation, the ICST quadrocopter may be used for security surveillance, e.g., by taking video/photos of a residential area, etc. For example, in one implementation, a user 102 may request an ICST quadrocopter to “patrol” a residential house 148a. In one implementation, the ICST quadrocopter 140 may obtain the user command 148a, and implement the command by obtaining the GPS location of the place, and taking video/photos of the place, e.g., via an initial path (by flying over the lawn of the residential area, see red arrow at 149a) around the street address. This initial path may be supplied by an individual providing an initial flight path by remote control via control pad, e.g., the AR.FREEFLIGHT controls via a smartphone. This path may be saved and repeated in a cycle and the video maybe streamed for analysis.

For example, in one implementation, the user may turn on the quadrocopter at the user's residential address, which may automatically put the quadrocopter to the “patrol” mode; and the quadrocopter may upload a GPS location to the ICST cloud indicating a query for instructions as to how to patrol the place related to the GPS coordinates. As another example, the quadropcopter may upload video and/or photos captured at the residential place to the ICST while performing the “patrol,” wherein the uploaded visual content may serve as a request to update patrol instructions based on the conditions of the place in real-time. As another example, the user 102 may manually input a request to the ICST cloud to provide and/or update “patrol” solutions for the quadrocopter, e.g., via textual input at a user interface (e.g., a Smartphone, etc.), audio command (e.g., a Siri like Smartphone app., etc.), uploading an image/video, and/or the like.

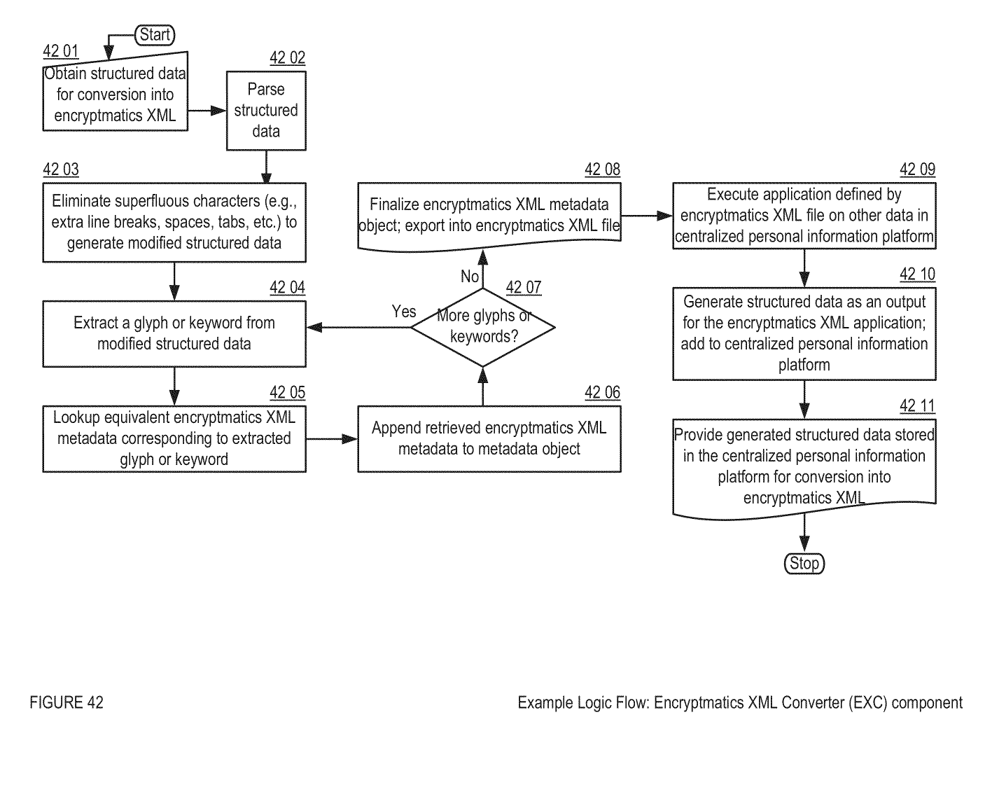

In one implementation, the quadropcopter may already have installed a solution to perform the user requested task, e.g., to “patrol” a residential address, etc. In one implementation, the quadrocopter may submit identifying information of the existing solution (e.g., an application number, a version number, etc.) to the ICST cloud as supplemental identifying information of the user requested solution query. In one implementation, the ICST solution may parse the obtained existing solution information to query for any updates on related solution. In further implementation, the quadrocopter provided information as to the existing solution may be stored at the ICST cloud as part of the data aggregation. Such data aggregation may be performed with an encryptimatic XML converter, e.g., see FIG. 42.

In another implementation, the quadrocopter 140 may upload a query 148b for surveillance/patrol solutions to the ICST cloud 100, which may indicate the GPS location of the place to be patrolled. In one implementation, the ICST patrol solution 144b may obtain a street view photo of the residential area, and a roaming path 149c for the quadrocopter to patrol. For example, as shown at FIG. 1E, the patrol solution 144b may indicate that at the street address “1355 palm St, Dream City, Calif.,” the quadrocopter may roll on the lane across the lawn (e.g., yellow arrows 149c) and fly over the bush (e.g., red arrow 149b).

FIG. 1F provides alternative examples of ICST quadrcopter patrol solutions 144b within embodiments of the ICST. As discussed in FIG. 1E, the ICST cloud 100 may query for instructions to patrol a residential place based on the GPS location of the residential house. In one implementation, as shown at FIG. 1E, the quadrocopter may obtain instructions to patrol the residential house, e.g., by a “zigzag” type movement above the house 161a (e.g., see the red arrows, etc.). Such moving/patrolling pattern may be repeated and requires the quadrocopter to return to its starting point (e.g., see the white arrow 162a) when a “zigzag” routine (e.g., see the red arrows 161a) is finished.

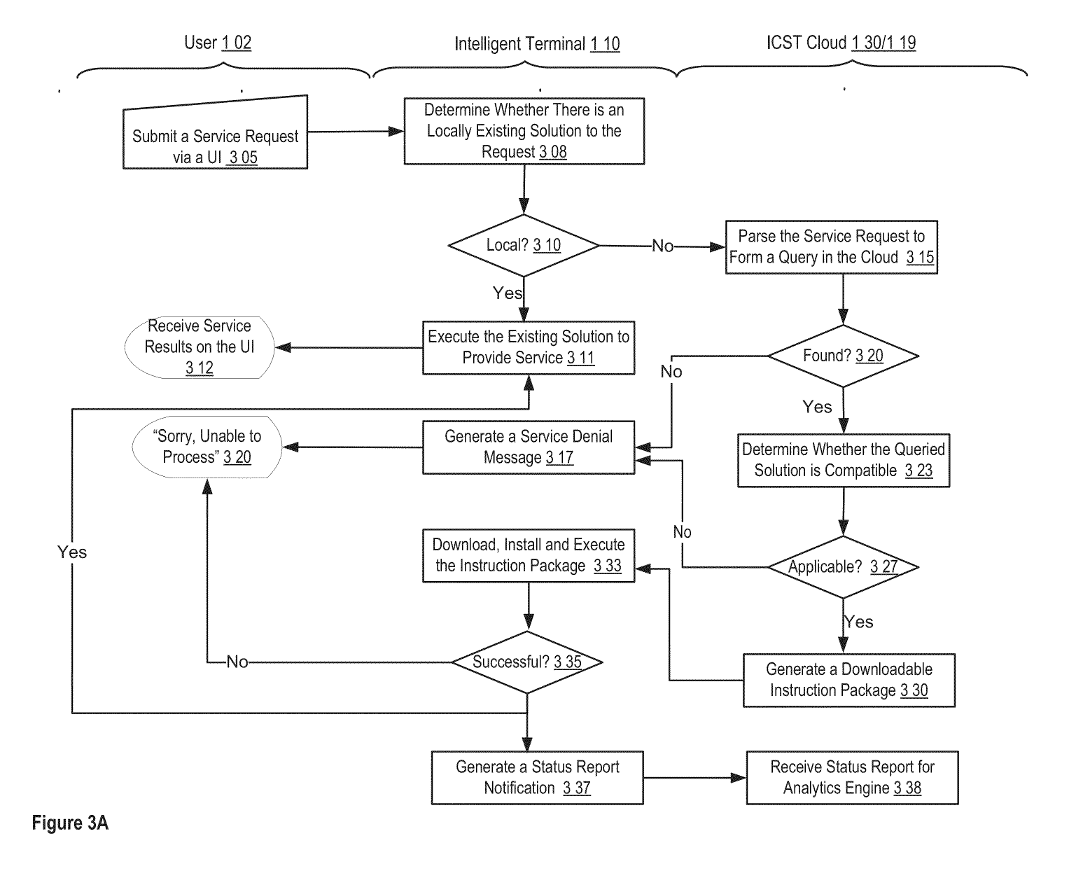

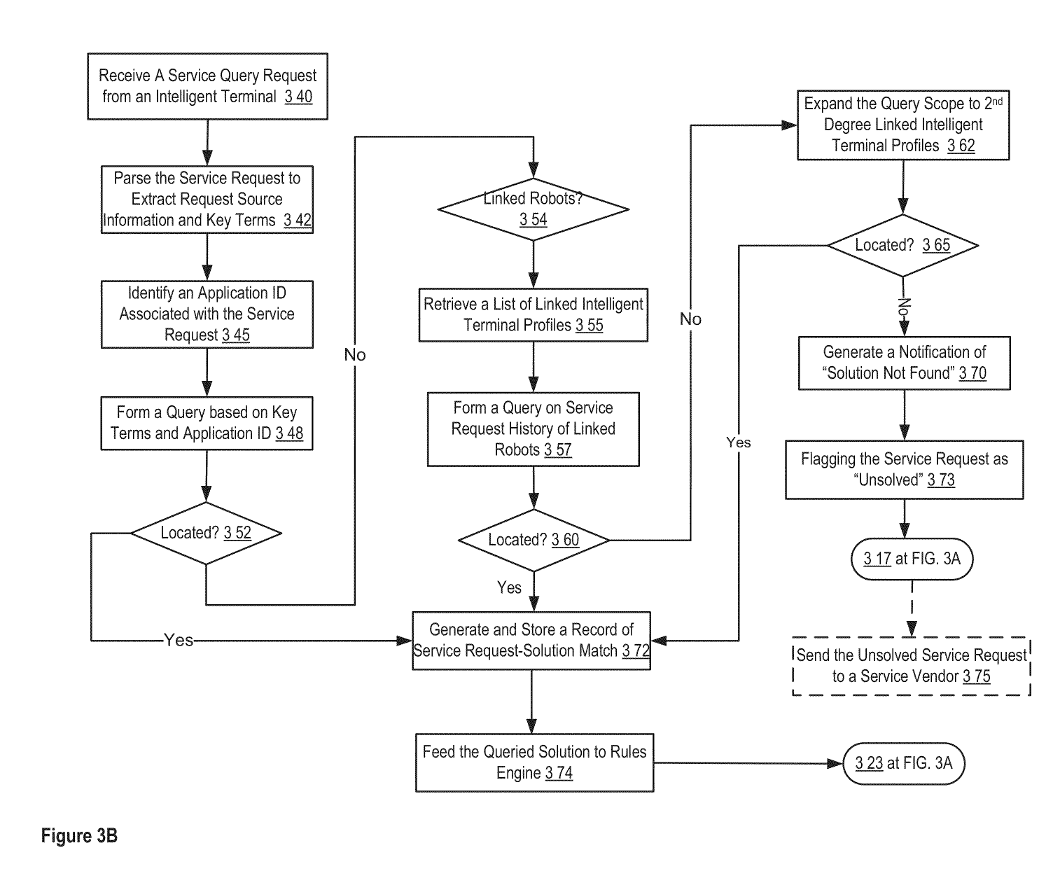

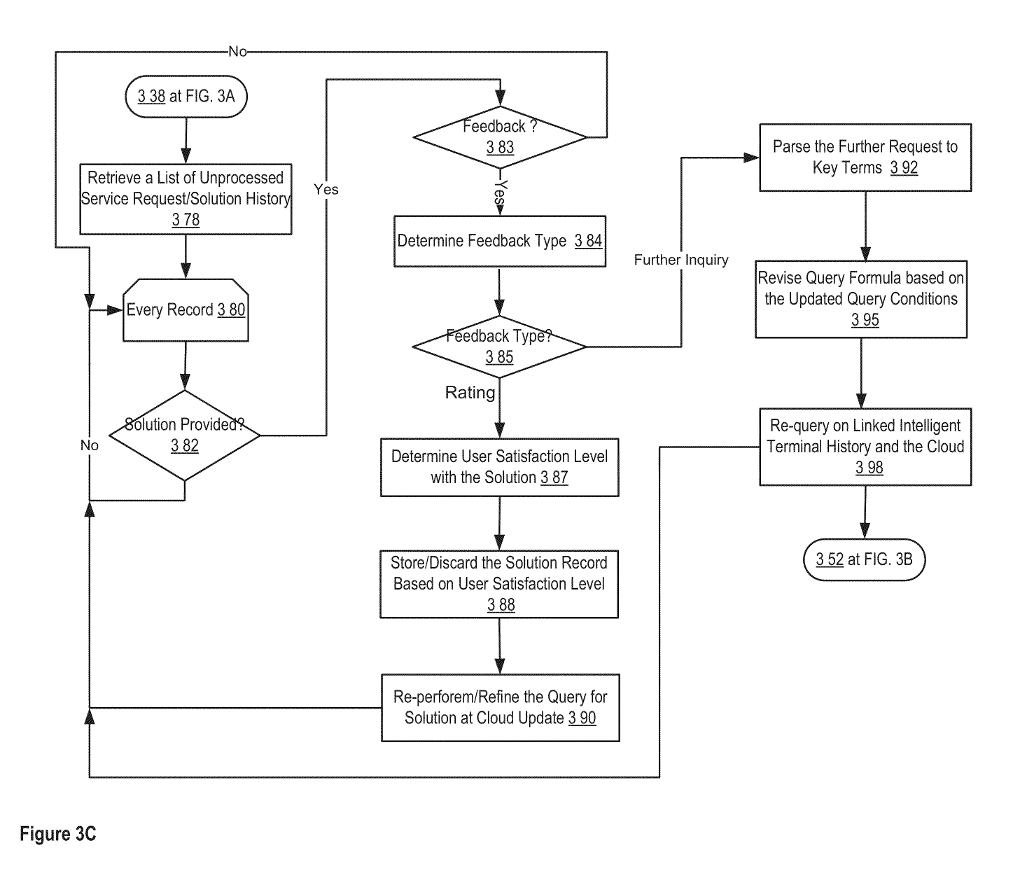

In another implementation, the quadrocopter may obtain updated patrol solution 163 from the ICST cloud. For example, such an update may be generated by the ICST cloud by patrol patterns adopted and uploaded by other patrolling terminals. Flight paths ranked and assessed to be superior may then be integrated and provided as updates to all participating devices. As another example, such update 163 may be generated and/or modified by the ICST cloud 100 based on user feedback, e.g., the user 102 may comment the patrol routine 161a may not be able to scan the entire region of the lawn/yard, and the returning/restarting path 162a is long and thus inefficient. In one implementation, such user feedback may be reflected as a user rating (e.g., see 387 in FIG. 3C) score, and/or another query request from the user (e.g., see 392 in FIG. 3C). For example, the user and/or the quadrocopter may query for “swirling+patrol+path” and indicate a user desired solution.

In one implementation, the ICST cloud 100 may provide an update 163 for the quadrocopter's patrol solution 144b. As shown at 161b, the updated patrol solution may determine a path in a swirling manner, which may allow the quadrocopter to cover more area of the residential area, and the returning/restarting path 162b is shorter.

FIG. 1G provides another example illustrating aspects of an ICST terminal in the form of a multiple access security camera within embodiments of the ICST. Within embodiments, the ICST terminals may comprise multiple access cameras 150, e.g., cameras with a flexible turnable support so that the camera 150 may be turned to face different directions 154.

For example, in one implementation, a user 102 may request the security camera 150 to provide surveillance of a residential house 151a, e.g., via a mobile phone turned remote control, similar to that described in FIG. 1C. In one implementation, the multiple access security camera 150 may provide its GPS information 152 to the ICST cloud 100, which may determine that it is a residential address 151b, and determine that the solution requested is surveillance instructions. For example, if it is a residential address, the ICST cloud 100 may search for surveillance instructions related to a residential place, including the frequency of multi-angle scanning (e.g., every 30 minutes, etc.). In one implementation, the camera 150 may download the surveillance solution package 153 from the cloud.

For example, as shown at 154, the surveillance solution 153 may comprise a street map of the residential area, and provide the vision scope of the multiple access camera 150 based on the position of the camera 155a-155b. Such vision scopes may indicate a series of motion instructions for the camera to turn and move.

FIG. 2A shows a block diagram illustrating data flows between ICST server and affiliated entities within various embodiments of the ICST. Within various embodiments, one or more consumers user(s) 202, intelligent terminal(s) 210, ICST server 230, ICST database(s) 219, Internet resource(s) 224 and/or the like are shown to interact via various communication network 213. The ICST facilitates connections through the communication network 213 based on a broad range of protocols that include WiFi, Bluetooth, 3G cellular, Ethernet, physical tethers (e.g., iPhone Video AV to Dock Connector Cable, which allows for connection to a monitor or TV), and/or the like. In one embodiment, the communication network 213 may be the Internet, a Wide Area Network (WAN), a telephony network, a Local Area Network (LAN), a Peer-to-Peer (P2P) connection, and/or the like.

In one embodiment, the user 202 may operate with a user device having a user interface 207a/107b to communicate with an intelligent terminal 210. For example, the user interface may comprise a mobile application UI 207a, a web based UI 207b, an ATM based UI, and/or the like. For another example, the intelligent terminal 210 may comprise an ATM terminal, a POS terminal, a mobile wallet application, and/or the like, which facilitates financial transaction. For another example, the intelligent terminal 210 may comprise home use robots such as autonomous vacuum cleaner, floor washer, and/or the like. For another example, the intelligent terminal 210 may comprise security surveillance systems such as cameras, detectors, sensors, and/or the like. The intelligent terminals 200 may further comprise a variety of robots, autonomous systems, and/or the like.

In one implementation, the intelligent terminal 210 and the UI 207a/b may be integrated. For example, the user 202 may directly interact with an intelligent terminal 210, which may comprise a smart wallet manager application instantiated on a user's mobile phone. For another example, the intelligent terminal 210 may be remotely accessed by the user 202 via the UI 207a/b.

Within implementations, the user 202 may submit service request 206a via the UI 207a/b, which may in turn forward the user service request 206b to an intelligent terminal 210. In one implementation, the user 202 may enter a textual request, e.g., by typing “what is the weather now?” etc. In another implementation, the user 202 may “speak” to a UI 207a asking “what is the weather now,” wherein the UI 207a/b may adopt a verbal conversation tool to convert the submitted verbal request into text. For example, in one implementation, upon obtaining a textual user service request, the intelligent terminal 210 may analyze the request by extracting key terms and determine whether a solution is available in the local database.

In another example, a service request may be automatically detected or generated by the intelligent terminal 210. For example, a cleaning robot (e.g., see 110 in FIG. 1A) is placed in a new environment with both carpet and wood floor area, and/or a vehicle smart detector (e.g., see 110 in FIG. 1B) is requested to detect local police car distribution within a distance, and/or the like.

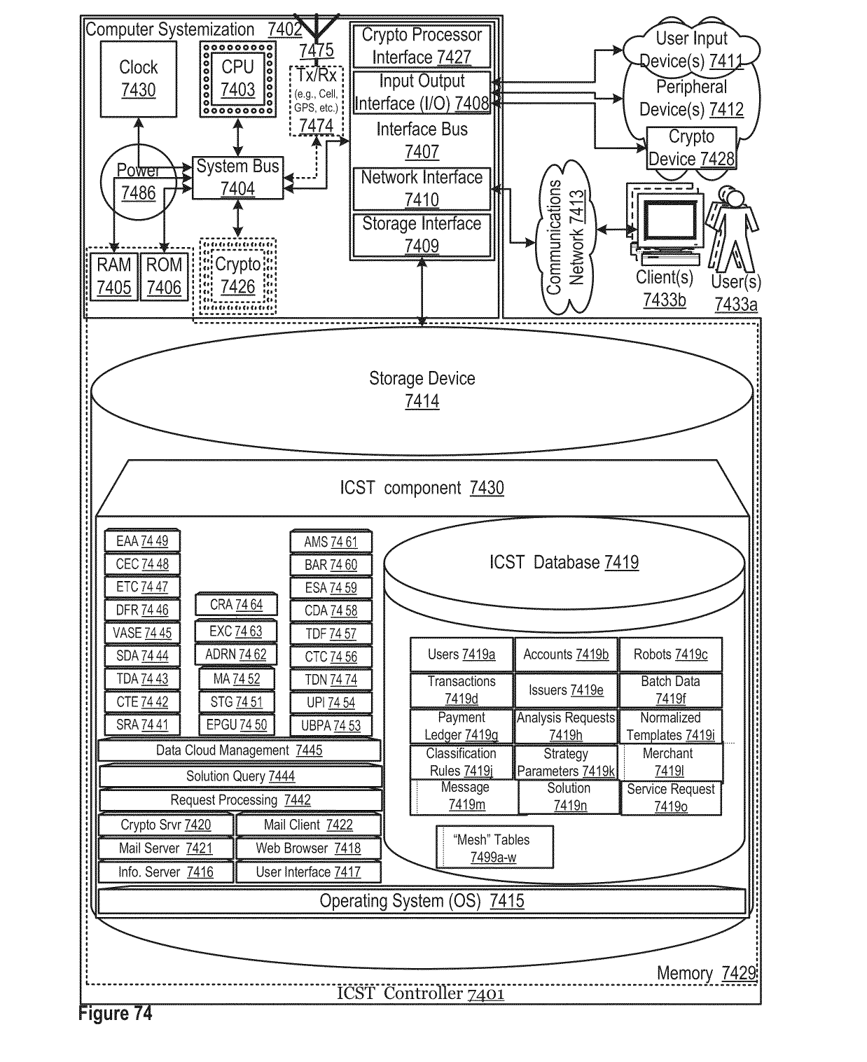

In one implementation, receiving the service request 206b, the intelligent terminal 210 may perform local intelligent query 208 in its local software stack to determine whether a solution to such service request has been previously stored. For example, the intelligent terminal 210 may issue PHP/SQL commands to query a database table (such as FIG. 74, Solution table 7419n) for a solution. An example service solution query 208, substantially in the form of PHP/SQL commands, is provided below:

<?PHP
header(‘Content-Type: text/plain’);
mysql_connect(“254.93.179.112”,$DBserver,$password); // access
database server
mysql_select_db(“ICST_DB.SQL”); // select database table to
search
//create query
$query = “SELECT solution_id solution_code solution_version
solution_term FROM Solution Table WHERE solution_term LIKE ‘%’
weather”;
$result = mysql_query($query); // perform the search query
mysql_close(“ICST_DB.SQL”); // close database access
?>

In another implementation, if the intelligent terminal 210 can not identify the service request, it may provide a (Secure) Hypertext Transfer Protocol (“HTTP(S)”) POST message including a service instruction request 207 in the form of data formatted according to the eXtensible Markup Language (“XML”). Below is an example HTTP(S) POST message including an XML-formatted user service request 206a/b and/or 209 for solution in the cloud:

```
POST /request.php HTTP/1.1
Host: 255.00.222.1
Content-Type: Application/XML
Content-Length: 718
<?XML version = “1.0” encoding = “UTF-8”?>
<ServiceRequest>
      <User> John Smith </User>
      <UserID> JS999 </UserID>
      <Application>
              <Name> V-Wallet Smart Manager </Name>
              <Version> 5.0 </Version>
              ...
      </Application>
      <Date> 09-09-2011 </Date>
      <Time> 29:00:00 </Time>
      <Request> ″what is the weather now″ </Request>
      <KeyTerms> ″weather″ </KeyTerms>
      <Status> Not Found </Status>
      <Route-to-Server> www.visa-smart.com </Route-to-server>
      ...
</ServieRequest>
```

Upon receiving the service request 209, the ICST server 230 may dissect the received request to extract query terms 208, and submit the query terms to the ICST database 219. For example, the ICST server 230 may provide a HTTPS POST message including a query request 208 in the form of data formatted according to XML. Below is an example HTTP(S) POST message including an XML-formatted user service request 206a/b and/or 207 for solution in the cloud:

```
POST /query.php HTTP/1.1
Host: 255.00.000.8
Content-Type: Application/XML
Content-Length: 718
<?XML version = “1.0” encoding = “UTF-8”?>
<Query>
      <SourceIP> 255.00.222.1 </SourceIP>
      <TerminalID> 0000000dasfdsgf </TerminalID
        ...
      <Application>
            <Name> V-Wallet Smart Manager </Name>
            <Version> 5.0 </Version>
            ...
      </Application>
      <Date> 9-09-2011 </Date>
      <Time> 29:00:05 </Time>
      <KeyTerms> ″weather″ ″now″ ″V-Wallet″ ″Version 5.0″
</KeyTerms>
      ...
</Query>
```

In one implementation, the ICST database 219 may send query result 212 to the ICST server 230, which may in turn return the queried results 225 to the intelligent terminal. For example, the ICST server 230 may provide a HTTPS POST message including the query result 212 and/or the downloadable instructions 225 in a similar form in the form of data formatted according to XML. Below is an example HTTP(S) POST message including an XML-formatted query result 212 or instructions 225:

```
POST /request.php HTTP/1.1
Host: 255.00.222.1
Content-Type: Application/XML
Content-Length: 718
<?XML version = “1.0” encoding = “UTF-8”?>
<int
  Model_id =″1″
  environment_type=″RT″
  meta_data=″./fModels/robotExample.meta″
  tumblar_location=″./fModels/robotExample.tumblar.location″
  input_format=″JSON″
  pmmls=″AUTONOMOUS_AGENTS.PMML″
  Model_type =″AUTONOMOUS_AGENTS″ >
<vault>
<door:LOCATION>
      <lock name=″DETERMINE LOCATION″
        inkey=″INPUT″ inkeyname=″lat″
        inkey2=″INPUT″ inkeyname2=″long″
        function=″ROUND″
        fnc-prec=″−2″
        function-1=″JOIN″
        fnc1-delim=″:″
        tumblar=‘LAT_LONG.key’
        outkey=″TEMP″ outkeyname=″location″
        type=″STRING″
      />
      <lock name=″DETERMINE WEATHER″
        inkey=″TEMP″ inkeyname=″location″
        mesh=‘MESHRT.RECENTWEATHER’
        mesh-query=‘HASH’
        outkey=″TEMP″ outkeyname=″WEATHERDATA″
        type=″ARRAY″
      />
      <lock name=″EXPLODE DATA″
        inkey=″TEMP″ inkeyname=″WEATHERDATA″
        function=″EXPLODE″
        fnct-delim=″:″
        outkey=″MODELDATA″ outkeystartindex=1
      />
      <lock name=″USER SETTINGS″
        inkey=″INPUT″ inkeyname=″USERID″
        mesh=‘MESHRT.AUTONOMOUSAGENT.SETTINGS’
        mesh-query=‘HASH’
        outkey=″TEMP″ outkeyname=″USERSETTINGS″
        type=″ARRAY″
      />
      <lock name=″EXPLODE USER″
        inkey=″TEMP″ inkeyname=″USERSETTINGS″
        function=″EXPLODE″
        fnct-delim=″:″
        outkey=″USERDATA″ outkeystartindex=1
      />
      <lock name=″RUN MODELE″
        inkey=″MODELDATA″
        inkey1=″USERDATA″
        function=‘TREE″
        fnc-pmml=″AUTONOMOUS_AGENTS.PMML″
        outkey=″OUTPUT″ outkeyname=″WEATHER″
        type=″NUMERIC″
      />
</door>
</vault>
```

For example, the above exemplary XML-formatted query results 212 include instructions to determine the current weather, comprising steps to “determine location,” “determine weather,” load “weather data,” load “user settings,” and/or the like. Upon receiving such instructions 225, the intelligent terminal 210 may execute the instructions, e.g., to determine the current weather at the user's location, and provide the service solution (e.g., the current weather) 226a/b to the user via UIs 207a/b. For example, the user 202 may receive response at a screen after submitting his weather inquiry, showing “Weather 56° F. DC 20036.”

Within implementations, the ICST server 230 and database 219 may comprise distributed databases which may be integrated in-house with the ICST server 230. In other embodiments, the ICST entities may access a remote ICST database 219 via the communication network 213. In one embodiment, the IPDT entities may send data to the database 219 for storage, such as, but not limited to user account information, application data, protocol data, application history, query instructions, service requests, and/or the like.

In a further embodiment, the ICST server 230 and the ICST database 219 may comprise a cloud platform, infrastructure, servers, and/or the like. The cloud platform may comprise one or more online database connected to a variety of data vendors, such as hardware vendors (e.g. Apple Inc., Intel, Sony, etc.), service vendors (e.g. Visa Network, Google, Apple Inc., etc.) and/or the like. For example, the ICST cloud (e.g., the ICST database 219 and the ICST server 230) may obtain information updates 216a/b from the internet resource 224, wherein the information updates 216a/b may comprise updated hardware driver information, new application packages, services, and/or the like. In one implementation, the information updates may be performed upon request from the ICST cloud, e.g., when a user service request could not be identified within the ICST database 219. In another implementation, the information updates may be performed on a periodic basis (e.g., daily, weekly, etc.).

In further embodiments, the ICST server 230 and/or the ICST database 219 may constantly, intermittently, and/or periodically download updates, such as updated software programs, updated command instructions, and/or the like, from the Internet resources via a variety of connection protocols, such as Telnet FTP, HTTP transfer, P2P transmission and/or the like. For example, an Internet cloud may provide a HTTPS PUT message including information updates 216a/b in the form of data formatted according to XML. Below is an example HTTP(S) PUT message including an XML-formatted information updates:

```
PUT /newinsturctions.php HTTP/1.1
Host: 255.00.222.9
Content-Type: Application/XML
Content-Length: 718
<?XML version = “1.0” encoding = “UTF-8”?>
<Update>
<Date> 09-09-2011 </Date>
<Time> 29:23:23 </Time>
<Source> www.visa.com </Source>
<AppID> VisaV0001 </AppID>
<Application>
      <App1> VisaV Wallet v.1.0 </App1>
      <App2> VisaV Wallet v. 2.0 </App2>
      <App3> VisaV Smart </App3>
      ...
</Application>
<InstructionName> Auto-Weather </InstructionName>
<Instruction>
<door:LOCATION>
      <lock name=″DETERMINE LOCATION″
        inkey=″INPUT″ inkeyname=″lat″
        inkey2=″INPUT″ inkeyname2=″long″
        function=″ROUND″
        fnc-prec=″−2″
        function-1=″JOIN″
        fnc1-delim=″:″
        tumblar=‘LAT_LONG.key’
        outkey=″TEMP″ outkeyname=″location″
        type=″STRING″
      />
      <lock name=″DETERMINE WEATHER″
        inkey=″TEMP″ inkeyname=″location″
        mesh=‘MESHRT.RECENTWEATHER’
        mesh-query=‘HASH’
        outkey=″TEMP″ outkeyname=″WEATHERDATA″
        type=″ARRAY″
      />
      <lock name=″EXPLODE DATA″
        inkey=″TEMP″ inkeyname=″WEATHERDATA″
        function=″EXPLODE″
        fnct-delim=″:″
        outkey=″MODELDATA″ outkeystartindex=1
      />
      <lock name=″USER SETTINGS″
        inkey=″INPUT″ inkeyname=″USERID″
        mesh=‘MESHRT.AUTONOMOUSAGENT.SETTINGS’
        mesh-query=‘HASH’
        outkey=″TEMP″ outkeyname=″USERSETTINGS″
        type=″ARRAY″
      />
      <lock name=″EXPLODE USER″
        inkey=″TEMP″ inkeyname=″USERSETTINGS″
        function=″EXPLODE″
        fnct-delim=″:″
        outkey=″USERDATA″ outkeystartindex=1
      />
      <lock name=″RUN MODELE″
        inkey=″MODELDATA″
        inkey1=″USERDATA″
        function=″TREE″
        fnc-pmml=″AUTONOMOUS_AGENTS.PMML″
        outkey=″OUTPUT″ outkeyname=″WEATHER″
        type=″NUMERIC″
      />
</door>
</vault>
...
</Update>
```

FIG. 2B provides a data flow diagram illustrating data flows for cloud sharing among the ICST server and affiliated entities within alternative embodiments of the ICST. In one embodiment, upon installing and instantiating a SDK package 231 on the intelligent terminal 210, the intelligent terminal 210a may generate solution data and/or SDK updates 233 to the ICST cloud. For example, the SDK update may include current versions of the SDK package, user configuration of the SDK package, and/or the like. The solution data may include robot generated responses to a service request, e.g., a detected police car location with a timestamp as shown at 133 in FIG. 1B.

For example, in one implementation, the robot/intelligent terminal 210 may generate a HTTPS POST message including the solution data and SDK updates 233 in a similar form in the form of data formatted according to XML. Below is an example HTTP(S) POST message including an XML-formatted SDK updates and solution data 233:

```
POST /robot_update.php HTTP/1.1
Host: 255.00.222.1
Content-Type: Application/XML
Content-Length: 718
<?XML version = “1.0” encoding = “UTF-8”?>
<robot_update>
        <robot_id> RB_990 </robot_id>
        <user_id> jS220 </user_id>
        <user_name> John Smith </user_name>
        <robot_name> Smart Detector 2.0 </robot_name>
        <robot_OS> SmartDetect 3.1 </robot_OS>
        <Update>
              <SDK_name> PoliceCar Smart </SDK_name>
              <Status> good </Status>
              <provider> Smart Car, Inc. </provider>
              <version> 3.2 </version>
              <Dev> C++ </Dev>
              <Compatible> Smart Detector 2.0 above </Compatible>
              ...
        </Update>
        <Detector_result>
              <timestamp> 10:23:34 9-9-2014 </timestamp>
              <Location> 232 Palm Street </Location>
              <GPS> 38°53′22.08377″N 77°2′6.86378″W </GPS>
              ...
        </Detector_result>
...
</robot_update>
```

Within implementation, the ICST server 230 may create data records for solution/status data and SDK update 235, e.g., by generating separate data record 236a/b for storage in an ICST database 219. In one implementation, the ICST database 219 may query for related solution/status data from a social robot network (e.g., police car detection data from other smart detectors, etc.) 238. For example, in one implementation, the ICST database 219 may generate a query in the form of PHP/SQL commands, an example of which is provided below:

<?PHP
header(‘Content-Type: text/plain’);
mysql_connect(“254.93.179.112”,$DBserver,$password); // access
database server
mysql_select_db(“ICST_DB.SQL”); // select database table to
search
//create query
$query = “SELECT robot_id robot_type solution_term solution_data
FROM Solution Table WHERE robot_type LIKE ‘%’ smart detector”;
$result = mysql_query($query); // perform the search query
mysql_close(“ICST_DB.SQL”); // close database access
?>

In one implementation, the ICST database 219 may provide a solution data updates from other robots 237a (which may take a similar form to that of 233) to the ICST server 230, which may provide such data 237b to the intelligent terminal 210. In such manners, the robots, e.g., vehicle detectors as discussed in FIG. 1B, may build a real time knowledge cloud of police car location information shared among a social network of smart detectors.

FIG. 2C provides a block diagram illustrating an example infrastructure of the ICST within embodiments of the ICST. In one embodiment, the ICST may comprise and/or be coupled to one or more interface components and/or modules. In one implementation, various user terminals, including end user laptops 255, telephones 253, mobile devices 252, intelligent terminals/robots 205 and other autonomous systems 205 may be connected to Internet 213 resources via routers, gateways, base stations 251, and/or the like. ICST may be coupled to a user interface (UI) (e.g., 252, 253, 255, etc.), which may be configured to receive user inputs (e.g., service request 106a in FIG. 1B, etc.) and display application states and/or other outputs. The UI may, for example, allow a user to adjust ICST system settings, select communication methods and/or protocols, submit service requests, engage mobile device application features, and/or the like. In one implementation, the user interface may include, but not limited to devices such as, keyboard(s), mouse, stylus(es), touch screen(s), digital display(s), and/or the like.

In one implementation, the ICST user terminals may access a cloud data interface 250 via the Internet 213. The interface 250 may comprise components facilitating transmission of electronic communications via a variety of different communication protocols and/or formats as coordinated with and/or by the communications interface 250. Communication interface 250 may, for example, contain ports, slots, antennas, amplifiers, and/or the like to facilitate transmission of display instructions, such as may instruct a remote display what and/or how to display aspects of a mobile device application state, via any of the aforementioned methods. Communication protocols and/or formats for which the communications interface 250, and varies databases/engines may be compatible may include, but are not limited to, GSM, GPRS, W-CDMA, CDMA, CDMA2000, HSDPA, Ethernet, WiFi, Bluetooth, USB, and/or the like. In various implementations, the communication interface 250 may, for example, serve to configure data into application, transport, network, media access control, and/or physical layer formats in accordance with a network transmission protocol, such as, but not limited to FTP, TCP/IP, SMTP, Short Message Peer-to-Peer (SMPP) and/or the like. The communications interface 250 may further be configurable to implement and/or translate Wireless Application Protocol (WAP), VoIP and/or the like data formats and/or protocols. The communications interface 250 may further house one or more ports, jacks, antennas, and/or the like to facilitate wired and/or wireless communications with and/or within the IPDT system. For example, the interface 250 may receive data from Internet 213 and load it to a variety of components, such as the rules engine 230, performance feedback engine 240, analytics engine 220, learning engine 210, and/or the like.

Numerous data transfer protocols may also be employed as ICST connections, for example, TCP/IP and/or higher protocols such as HTTP post, FTP put commands, and/or the like. In one implementation, the communications interface 250 may comprise web server software equipped to configure application state data for publication on the World Wide Web. Published application state data may, in one implementation, be represented as an integrated video, animation, rich internet application, and/or the like configured in accordance with a multimedia plug-in such as Adobe Flash. In another implementation, the communications interface 250 may comprise remote access software, such as Citrix, Virtual Network Computing (VNC), and/or the like equipped to configure application state data for viewing on a remote client (e.g., an intelligent terminal, etc.).

Within implementations, the rule engine 230 may control how a machine can learn, what it can learn and what actions it is allowed to undertake. This rule engine may be configurable by end users to meet the needs of their robot or autonomous system. For example, an intelligent terminal, robot or autonomous system may have a dedicated learning procedure and may also have access to a centralized learning rule engine that may pool the knowledge gained from the local learners. For example, for a service request initiated from an iPhone app, the ICST may query for rules associated with iPhone app based on the application ID, wherein the rules may restrict solution query to specific vendors, programming modules, development types, and/or the like. For another example, the rules may specify system requirements, hardware requirements, security requirements, and/or the like for solutions to a service request. The rules engine may further specify rules per user devices, Email servers, user telephony devices, CPEs, gateways, routers, user terminals, transmission protocols, data formats, and/or the like suitable for communicating with a type of intelligent terminals 205 and/or any ICST affiliated entities.

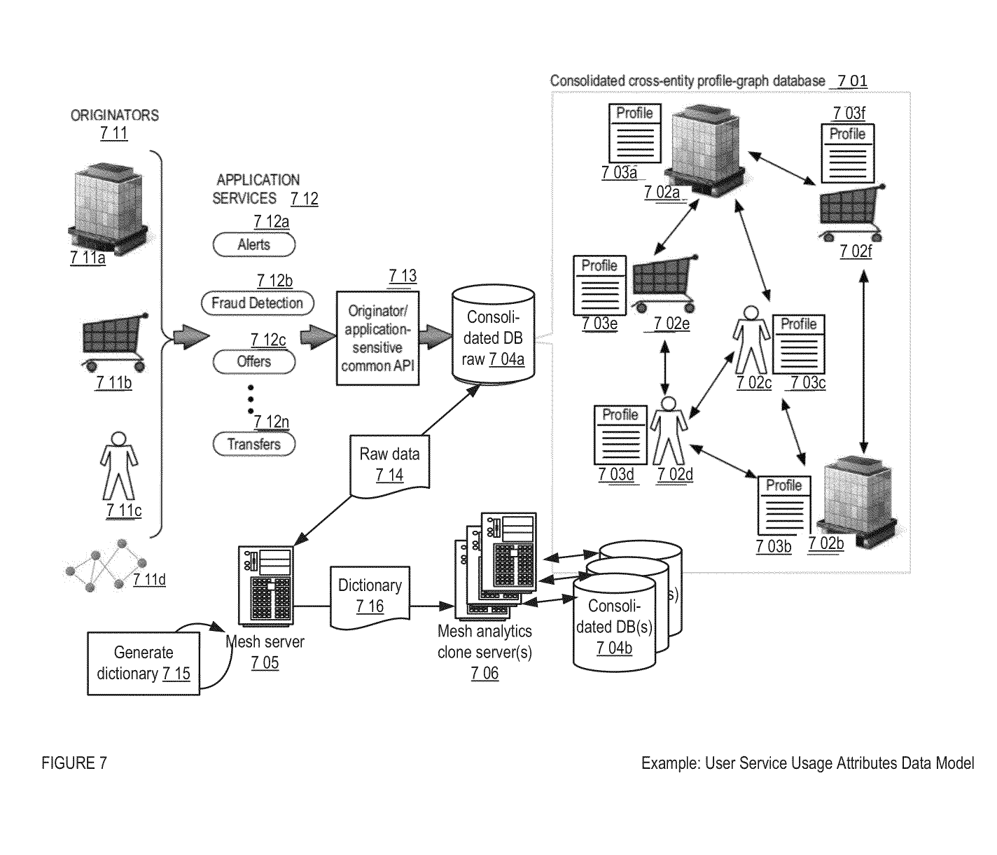

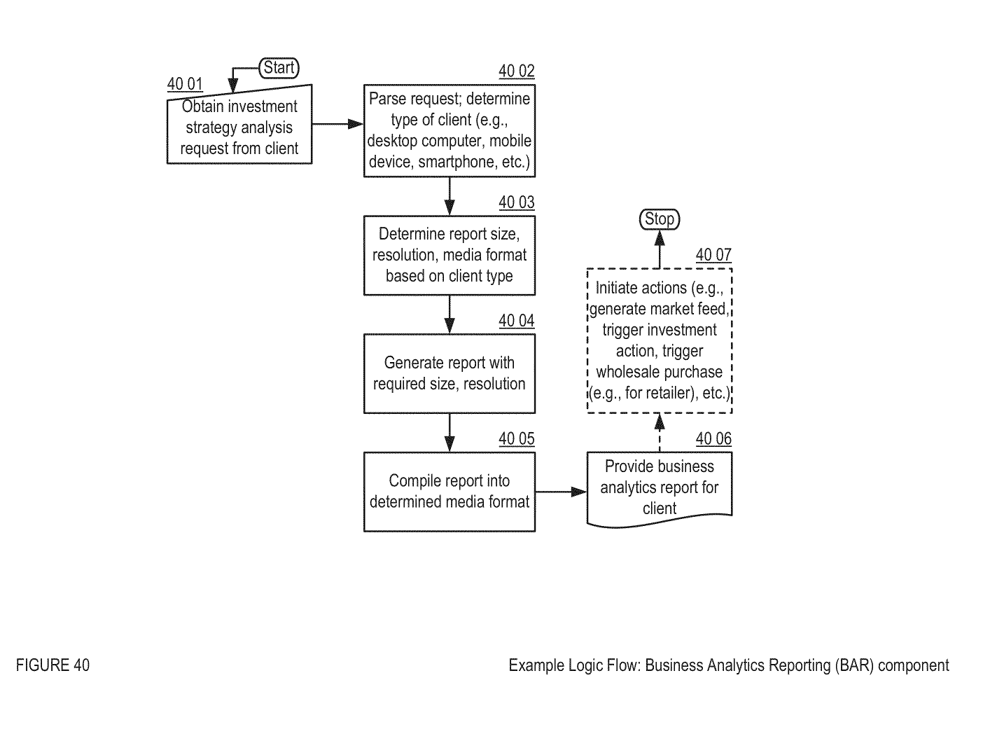

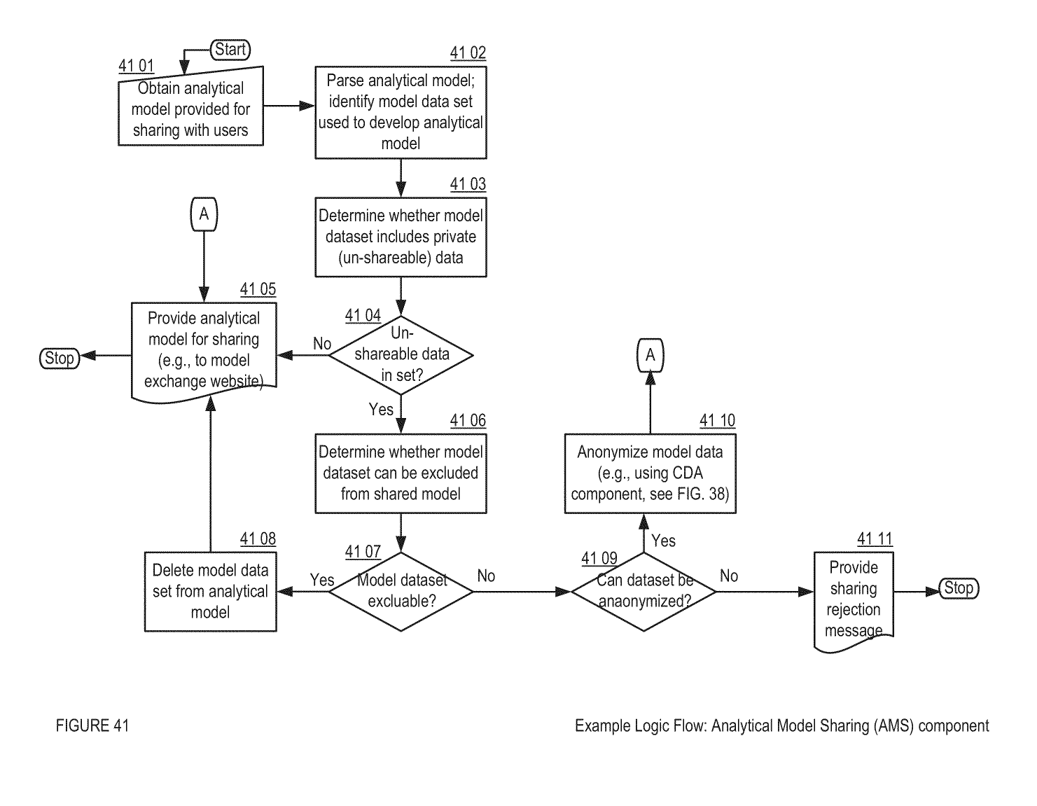

In one implementation, the performance feedback engine may provide feedbacks on the success or failure of the provided solutions. For example, an intelligent terminal 205 may receive instructions from the cloud to perform a new task, and may provide task status as “accomplished,” “in progress,” “failed,” “aborted,” and/or the like to the performance feedback engine 240. The knowledge gained from all participating robots may be pooled in a shared memory and all robots may access. Such feedbacks may be analyzed to improve learning at a centralized personal information platform, as further illustrated in FIGS. 7-54C. In addition, outside data may be used to enhance decision making processes, e.g., user rating, etc.

In one implementation, the ICST may build solutions in response to a service request at a learning engine 210. The learning engine 210 may receive a service request (e.g., 107 in FIG. 1B) via the interface 250, and apply rules from the rules engine 230 to query for solutions to the service request in a shared data store 215. In one implementation, the shared data store 215 may comprise robot history 219a, robot profiles 219b, shared history 219c, linked robots 219d and/or the like.

The robot history 219a may comprise service request that have been received by an intelligent terminal, solutions provided, status of the solution implementations, and/or the like. An exemplary XML-formatted robot history data record may take a form similar to the following:

```
<?XML version = “1.0” encoding = “UTF-8”?>
<robot_history>
        <robot_id> RB_990 </robot_id>
        <user_id> jS220 </user_id>
        <user_name> John Smith </user_name>
        <robot_name> Smart Detector 2.0 </robot_name>
        <robot_OS> SmartDetect 3.1 </robot_OS>
        <history_event_1>
              <timestamp> 10:23:34 9-9-2014 </timestamp>
              <Location> 232 Palm Street </Location>
              <GPS> 38°53′22.08377″N 77°2′6.86378″W </GPS>
              ...
              <query> “Smart Car Update” </query>
              <Update>
                    <SDK_name> PoliceCar Smart </SDK_name>
                    <Status> good </Status>
                    <provider> Smart Car, Inc. </provider>
                        <version> 3.2 </version>
              <Dev> C++ </Dev>
                    <Compatible> Smart Detector 2.0 above
        </Compatible>
              ...
        </Update>
        <feedback> rating 4/5 </feedback>
        ...
        </history_event_1>
        </history_event_2> ... </history_event_2>
        ...
</robot_history>
```

The robot profile 219b may comprise information to each intelligent terminal, robot and/or other autonomous systems. An exemplary XML-formatted robot history data record may take a form similar to the following:

```
<?XML version = “1.0” encoding = “UTF-8”?>
<robot_profile>
        <robot_id> RB_990 </robot_id>
        <user_id> jS220 </user_id>
        <user_name> John Smith </user_name>
        <robot_name> Smart Detector 2.0 </robot_name>
        <robot_OS> SmartDetect 3.1 </robot_OS>
        <robot_manufacturer> XXX Inc. </robot_manufacturer>
        <version_no> 3.1 </version_no>
        <year> 2014 </year>
        ...
</robot_profile>
```

The shared history 219c may comprise records of shared solutions between intelligent terminals; and the linked robots 219d records may comprise robots that are tagged as “similar” or “sharable” by the analytics engine 220. For example, linked robots 219d may comprise a graph linking intelligent terminals so that a query for solutions may be performed along the graph of “similar” or “sharable” robot history to improve search efficiency. Within implementations, the analytics engine 220 may provide analytics report to the service request-query match history, robot history, and/or the like. For example, analytics engine 220 may perform statistical analysis to identify popular inquiries, popular applications, popular intelligent terminal types, and/or the like. The analytics engine 220 may link intelligent terminals that frequently receive similar service requests, compatible to similar solutions, and/or the like. The analytics engine 220 may further categorize intelligent terminals that receive similar service requests to facilitate correlated search for solutions. In further implementations, the analytics engine 220 may receive performance feedbacks from 240 to provide quality of service (QoS) reports, and/or the like.

Within implementations, the ICST may enable intelligent terminals, robots and other autonomous system to find solutions to problems not encountered before or better solutions to existing problems; access a vast amount of structured data to process in the cloud or locally; communicate with other robots to enhance solution generation and cooperation; use the dedicated cloud based learner to optimize its own solution set, and/or the like. In other implementations, the ICST may enable users to create configurable learning machines in a cloud setting; monitor and control robots and autonomous systems remotely; upgrade or switch robots without losing gained knowledge, and/or the like.

FIGS. 3A-3C provide logic flows illustrating intelligent solution matching within embodiments of the ICST. Within embodiments, a user may submit a service request (e.g., 106a/b in FIG. 1B) via a user interface 305. For example, in one implementation, the user may send a textual request describing the desired service, e.g., via email, text messages, instant online messages, dedicated user interface of an intelligent terminal (e.g., ATM, mobile wallet application, etc.) and/or the like. In another implementation, the user may engage in an artificial intelligent conversational tool (e.g., Apple Siri, MSN Robot, etc.) and “speak” to the intelligent terminal about a service request.

Within implementations, upon receiving the service request (e.g., 106b in FIG. 1B), the intelligent terminal may determine whether there exists a solution in the local database 308. For example, in one implementation, the user may have clicked an option button via a user interface, which may in turn trigger an existing solution to the option. When there exists a local solution to the service request 310, the intelligent terminal may execute the existing solution to provide service 311 to the user, who may in turn receive service results via the user interface 312. Alternatively, if there is no local solution 310, the intelligent terminal may send the service request (e.g., 107 in FIG. 1A) to an ICST cloud (e.g., an ICST server 130 and/or ICST database 119 in FIG. 1A).

Within implementations, the ICST cloud may parse the service request to form a query in the cloud 315, as further illustrated in FIG. 3B. If a solution is not found from the query 320, the ICST cloud may notify the intelligent terminal that the solution is not available, and the intelligent terminal may generate a service denial message via the user interface 317, e.g., by displaying a message “Sorry, unable to process” 320 to the user. If a solution is found from the query 320, the ICST cloud may proceed to determine whether the queried solution is compatible with solution rules and requirements 323. For example, in one implementation, requirement parameters may be included in the received service request, such as version requirements, development environment requirement, compatibility requirements, and/or the like. For another example, the application ID from the service request may indicate compatibility requirement, e.g., a service request originated from an Apple iPhone app may inherently exclude solutions that must be executed under a Windows OS. In further implementations, the ICST cloud may incorporate the requirement parameters into search logics at 315.

In one implementation, if the queried solution is not applicable 327, the ICST may send service denial messages, e.g., at 317. In another implementation, if the queried solution is applicable 327, the ICST may generate a downloadable instruction package 330 for the intelligent terminal to download, install and execute the instruction package 333 (e.g., an “.exe” file, a “.dmg” file, etc.). If the intelligent terminal successfully installs and runs the downloaded instructions 335, the intelligent terminal may generate a status report 337 to the ICST cloud to indicate the solution is executable, wherein the ICST cloud may generate a record of the service request and solution match for analytics engine 338, as further illustrated in FIG. 3C. In another implementation, if the downloaded instructions can not be installed or executed 335, the ICST may proceed with 320 to notify the user of failure.

FIG. 3B provides a logic flow illustrating a solution query in the cloud within embodiments of the ICST. Within implementations, the ICST may receive a service query request (e.g., 107 in FIG. 3A) from an intelligent terminal 340, and then may parse the servicer request to extract request source information and key terms 342. For example, the request source information may comprise a device type, an application ID 345, application type, application version information associated with the requested service, and/or the like; and the key terms may be extracted from the user description of the service request, e.g., “Weather,” “Current” as the key terms from a user request of the current local weather.

In one implementation, the ICST may form a query based on the key terms and the application information 348. The query may be performed in a progressive manner. For example, if the application ID indicates the request is originated from an iPhone App, the ICST may query on a database of iPhone compatible solutions. In one implementation, if a solution is located 352, the ICST may generate and store a record of service request—solution match 372. In another implementation, if no solution is found 352, the ICST may expand the query progressively in the database when relaxed query restrictions. For example, if a query on “Weather+current+iPhone OS+Visa wallet” does not return a solution, the ICST may form a second round search on “weather+current+iPhone OS.”

In another implementation, the ICST may progressively search solution history of linked intelligent terminals/robots 354. For example, in one implementation, the linked intelligent terminals may be defined by the analytics engine (e.g., 220 in FIG. 2). For example, a Visa electronic wallet running on an iPhone may be linked with other Visa electronic wallet engaged iPhones as related intelligent terminals.

In one implementation, the linked intelligent terminals may form a social network of the robots. For example, ICST robots/terminals may be linked and/or categorized based on their types, e.g., robot cleaners, robot detectors, robot jewelry, robot surveillance camera, wallets, and/or the like. In one implementation, the ICST robots/terminals may be linked and/or grouped based on the service request (e.g., key terms, instruction type, etc.), e.g., robots that have searched for “auto weather update” may be grouped and linked, etc. In another implementation, the ICST robots/terminals may be linked and/or grouped based on the application type, application identifier, e.g., mobile devices that have a wallet application instantiated thereon may be linked, etc.

In one implementation, the ICST robots social network may facilitate solution query, sharing, and updates. For example, in one implementation, the ICST cloud may query on solution history of linked social robots in response to a solution query, e.g., see 354-374 in FIG. 3B. In another implementation, the ICST cloud may share the feedback, solution updates from an ICST robot to the robot's social group so that other robots in the social group may obtain feedback on a solution, and/or solution updates. For example, when an ICST robot cleaner (e.g., see 110 in FIG. 1A) uploads solution updates on “auto-carpet steaming and drying,” the ICST cloud may send such updates to other ICST robot cleaners linked to the ICST robot cleaner.

The ICST may retrieve a list of linked intelligent terminal profiles 355, and form a query on the service request history of the linked intelligent terminals, using similar query rules as that at 348. If a solution is located 360, the ICST may proceed to generate the record of solution match 372, and send the queried solution to a rule engine 374 to determine whether it is compatible. Otherwise, the ICST may progressively search a database of linked intelligent terminals by expanding the query to second, third, etc. degree linked intelligent terminal profiles 362. Within implementations, the ICST may configure the progressive query mechanism so that the degrees of search may be pre-determined.

Within implementations, if no solution is found from the query at 365, the ICST may generate a notification of “solution not found” 370 and flag the service request as “unsolved” 373. In further implementations, the ICST may send the unsolved service request to a service vendor 375 (e.g., Apple, Google, etc.).

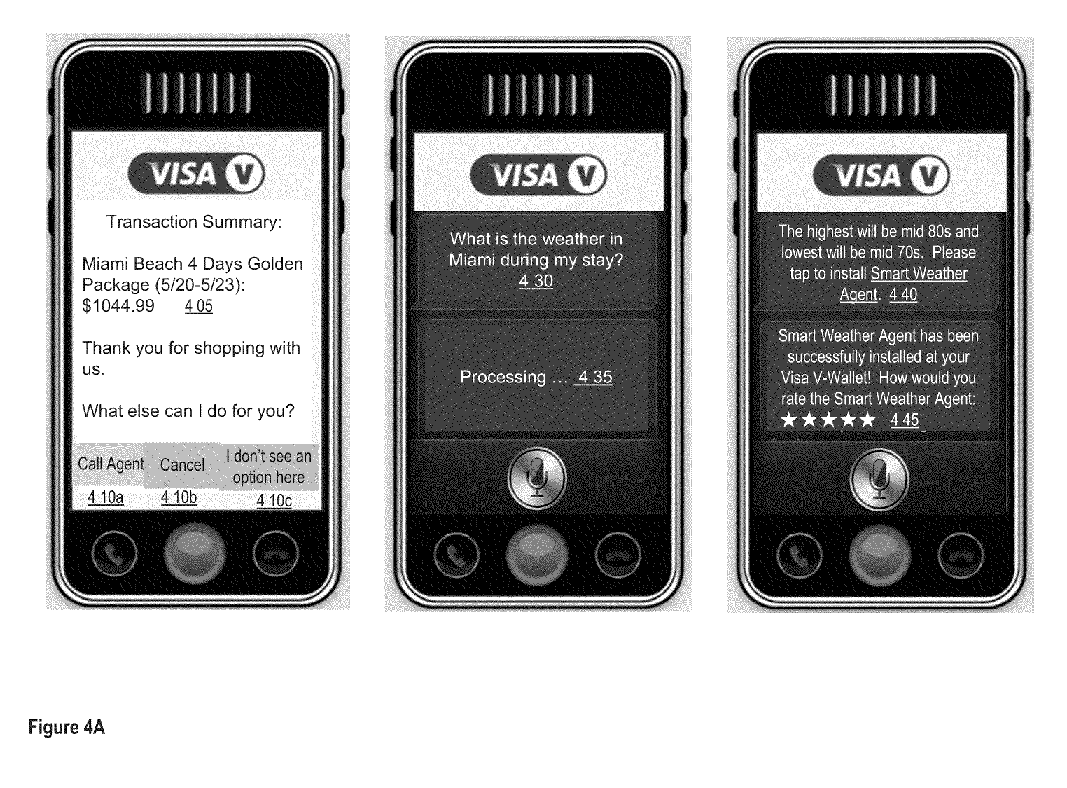

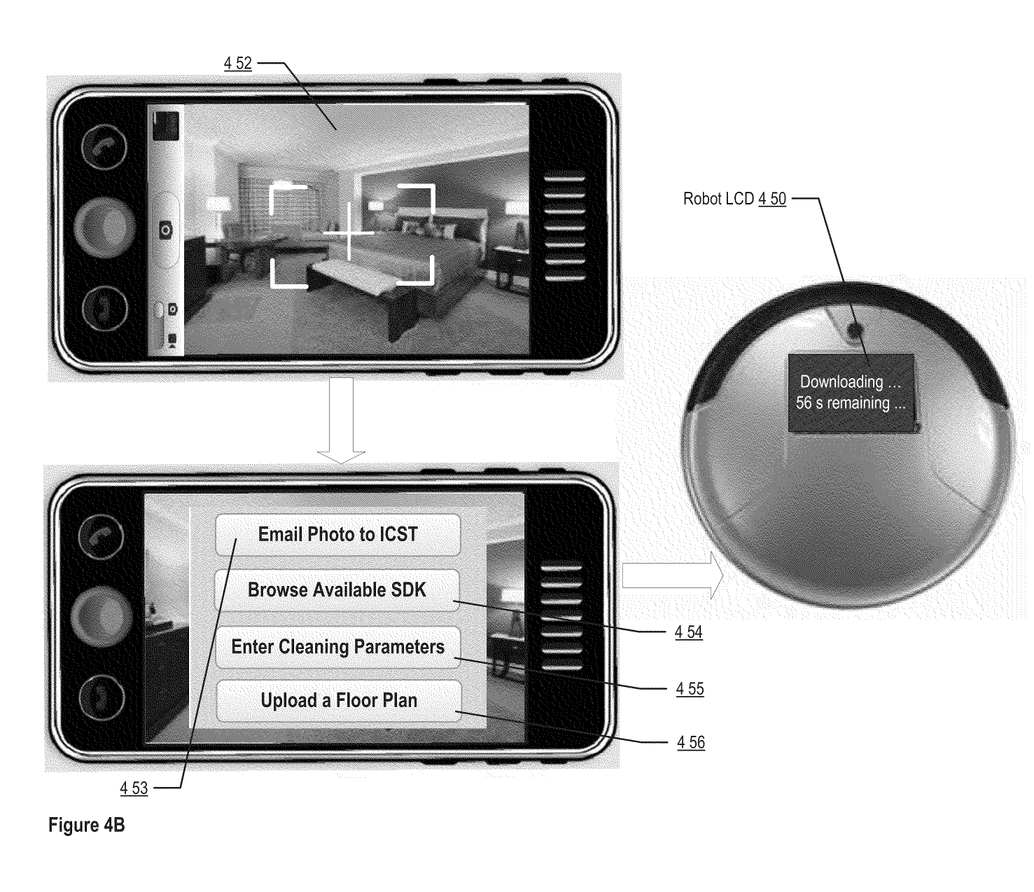

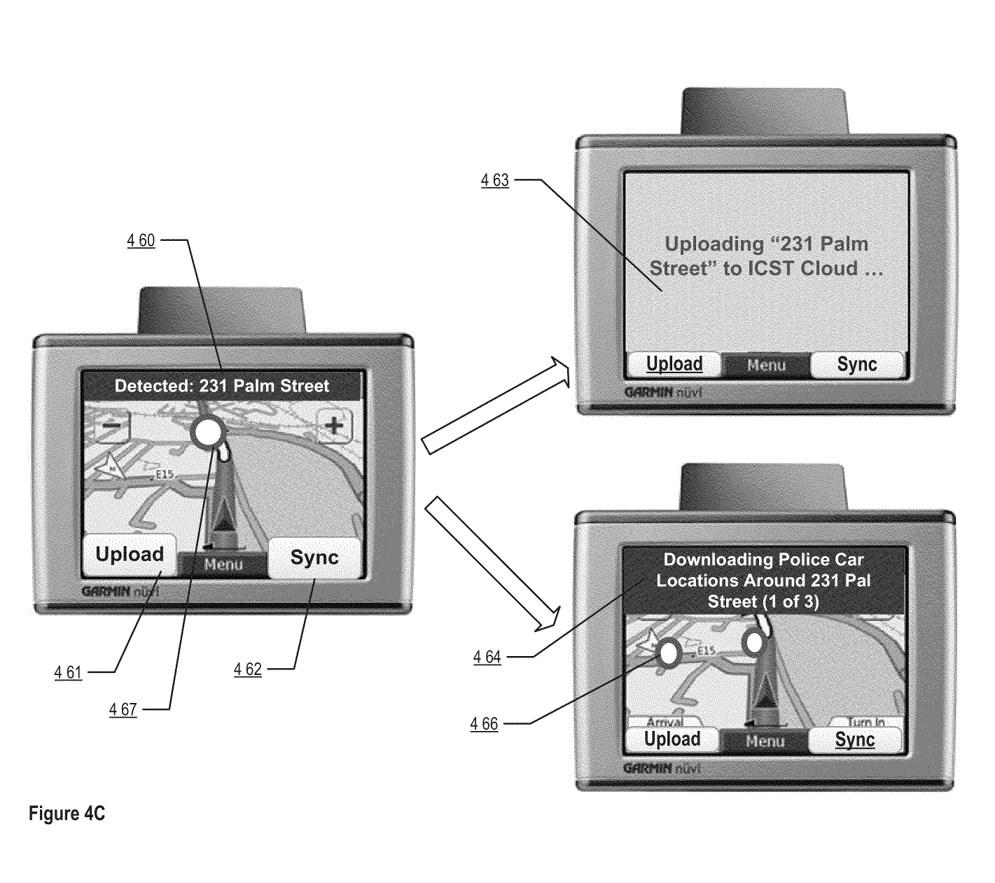

FIG. 3C provides a logic flow illustrating user feedback performance analysis within implementations of the ICST. Within implementations, the ICST may retrieve a list of unprocessed service request solution history associated with an intelligent terminal 378. For every record 380, the ICST may determine whether there is a solution matched to the service request 382. If yes, the ICST may determine whether there is any user feedback 383 to include in the feedback performance analysis. In one implementation, the ICST may determine a type of the feedback 385. If it is an indicating of user satisfaction of a provided solution (e.g., a user rating of the solution, a response to a satisfaction survey, etc.), the ICST may determine a user satisfaction level with the solution 387. For example, a user may submit a rating of the solution, e.g., see in FIG. 4A. The ICST may then store the solution as a match to the service request when the user rating indicates the user is satisfied (e.g., a 4 star or 5 star rating, etc.). In another implementation, the ICST may label the solution as a non-match to the service request when the user rating indicates the user is not satisfied 390, and may exclude the labeled solution in future query of the service request.

In another implementation, if the feedback comprises further inquiry, e.g., the user may submit further description of a desired service when no result, or a dissatisfactory result is returned, the ICST may parse the further request to key terms 392. The ICST may revise the query formula based on the updated query conditions 395 based on the user submitted further inquiry, and re-query the database 398 for solutions. For example, when a user submits a service request “what is the weather in Miami during my stay” after using his Visa wallet to book a vacation package, the ICST may return the result of a current weather in Miami after querying for a solution; the user may then refine the service request by stating “what is the weather in Miami during the dates of my purchased Miami vacation package,” the ICST may then refine the search so that the solution may include the feature to determine the dates of a purchased travel package and retrieve weather information.

FIG. 4A provides an exemplary screen shot illustrating a cloud enabled intelligent mobile wallet service within implementations of the ICST. For example, the user may use his mobile wallet to purchase a Miami beach 4 days golden package for the dates May 20-May 23, e.g., at 405. Upon receiving the purchase confirmation at his wallet, the wallet may provide options for the user to call agent to confirm 410a, cancel the order 410b. If the user wants additional services, he may indicate a desired service is not shown 410c. In one implementation, the user may type a request “what is the weather in Miami during my stay?” 430. In another implementation, the intelligent mobile wallet may provide a voice enabled user interface so that the user may speak out his desired service. The mobile wallet may then process the received service request. In one implementation, after a successful query in the cloud, the mobile wallet may provide the option to install a “Smart Weather Agent” 440 to the mobile wallet. The mobile wallet may also receive user feedbacks on the performance of the provided solution by requesting the user to submit a rating 445. An exemplary data structure of the instructions for determining the weather at the location of a user is provided at 712 in FIG. 7, wherein a centralized personal information platform may harvest and aggregate data from different ICST terminals and provide a solution (e.g., the weather, etc.) based on the received query.

FIG. 4B provides exemplary screen user interfaces illustrating using a mobile device to submit robot service requests within embodiments of the ICST. Within implementations, a user may operate a camera enabled mobile device, such as an Apple iPhone, a Google Android, and/or the like, to capture an image of a room 452. The user may email the photo to an ICST cloud 453 to request a cleaning solution based on the type of floor of the captured room photo. In other implementations, the user may request to browse a list of available SDK 454, enter cleaning parameters (e.g., vacuum or brush, mop, etc.) 455, upload a floor plan picture 456, and/or the like. Upon submitting the request to the ICST cloud, the robot terminal may download a SDK package 450 showing the status of downloading via a robot LCD screen 450.

FIG. 4C provides exemplary screen user interfaces illustrating using a smart detector installed on a vehicle to share police car detection information among the ICST cloud within embodiments of the ICST. Within implementations, a robot, e.g., the smart detector may detect a police car location 460 on a GPS alike screen user interface, showing the location of the police car 267. The user may elect to upload such information for sharing among the cloud 461, and/or to synchronize with the ICST cloud to obtain police car locations captured by other detectors 462.

In one implementation, if the user selects to proceed with “upload” 461, the smart detector may upload the detected police car location with a timestamp to the ICST cloud 463. In another implementation, if the user selects to proceed with “Sync” 462, the smart detector may download police car locations detected by other detectors from the ICST cloud around its location 464, e.g., showing another police car location 466 on a GPS map alike screen.

### Consumer Personal Information Capturing

Within implementations, the ICST cloud 100 (e.g., see FIGS. 1A-1E, etc.) may obtain various human behavioral information, such as but not limited to mobile device location coordinate information transmissions, real-time reality visual capturing, mixed gesture capturing, bio-sensor data, ICST robot queries for solutions, real-time behavior-sensitive product purchase related information, shopping purchase transaction notifications, and electronic receipts, and/or the like, and serve as a consumer personal information aggregation platform (e.g., see FIGS. 7-54C). In one implementation, the ICST robot terminals in various forms may facilitate collecting and uploading such human behavioral data to the ICST cloud. For example, in one implementation, the ICST robot terminals may serve as originators 711 (e.g., see FIG. 7) to obtain consumer purchase, product preference related information and upload it to the consolidated database 704a. In one implementation, such ICST robot terminals may take various different forms such as, but not limited to an ICST robot cleaner, ICST wearable devices (e.g., a hat, a badge, a brooch, electronic jewelry, etc.), ICST smart assistant (e.g., a quadrocopter, etc.), sand/or the like.

In one implementation, the ICST cloud may obtain various data from the ICST robots and perform data mining on the obtained data to determine consumer interests, preferences in future shopping. For example, in one implementation, an ICST solution query from an ICST robot cleaner (e.g., see 101a in FIG. 1A) to seek for a solution to steam the carpet may indicate the consumer has carpeted floors at home, and may be interested in carpets, home decorations, carpet cleaning products, and/or the like. As another example, an ICST solution query to inquire about the location of a police car may provide updated GPS location information of the consumer to the cloud (e.g., see 101b, 132 in FIG. 1B); and the ICST cloud may determine the regular area of driving scope of the consumer based on a plurality of geo-locations. As another example, an ICST solution query to inquire about surveillance instructions (e.g., see FIGS. 1D-1E) may provide GPS information of the consumer's home address, which may be used as a second-factor confirmation of the consumer's billing/shipping address, and/or the like.

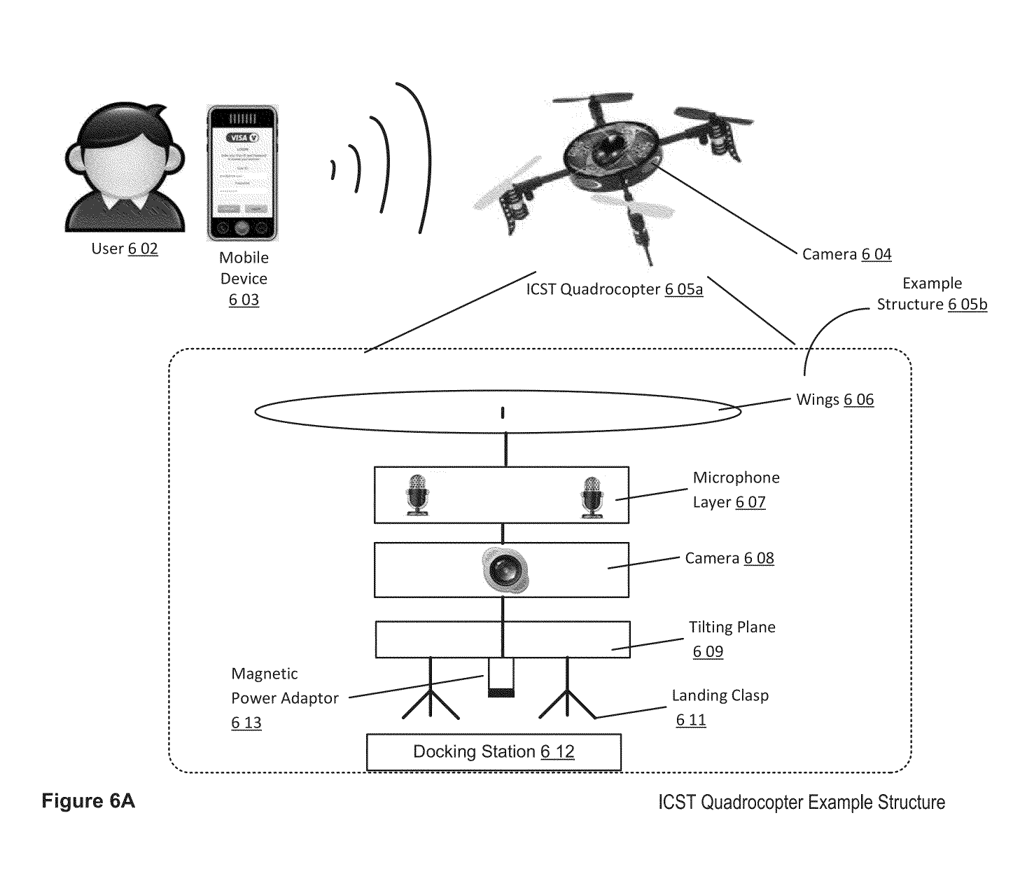

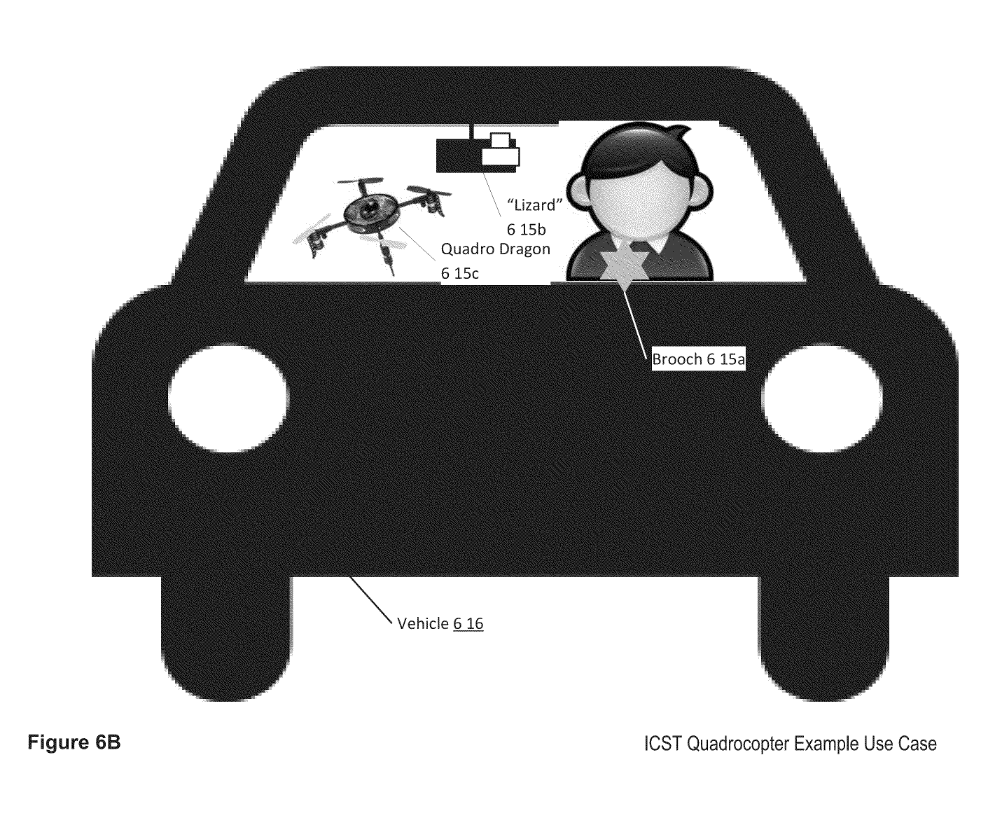

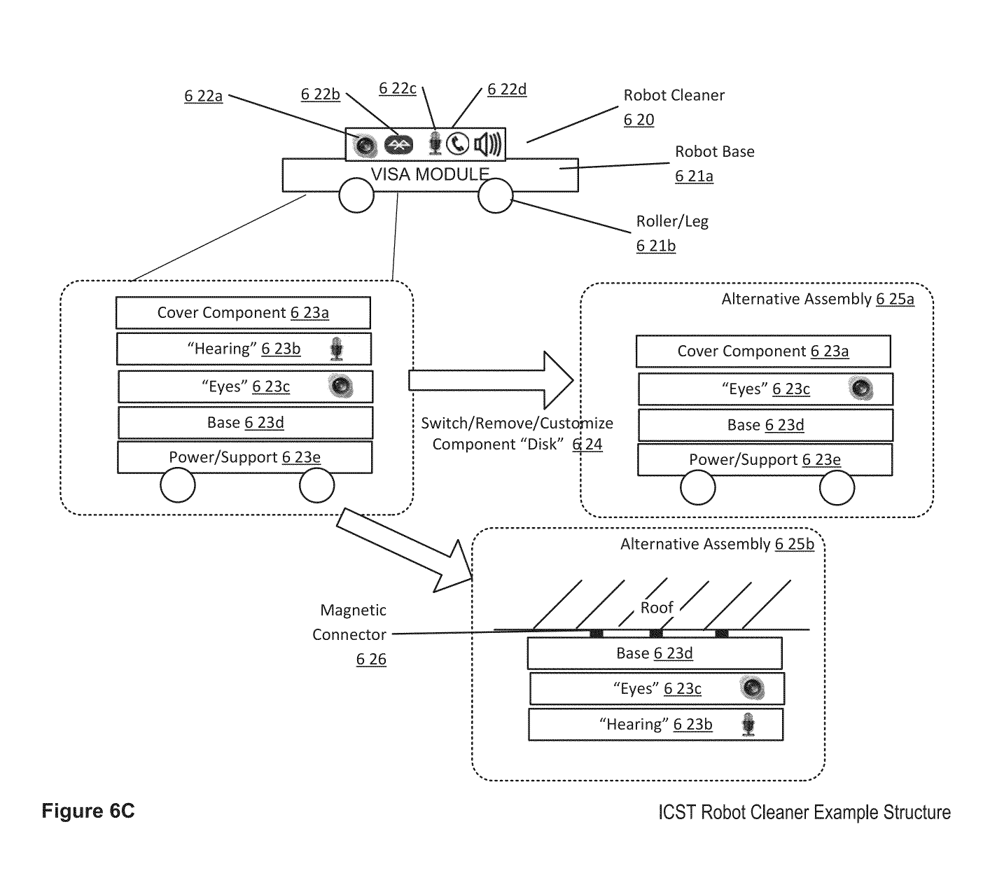

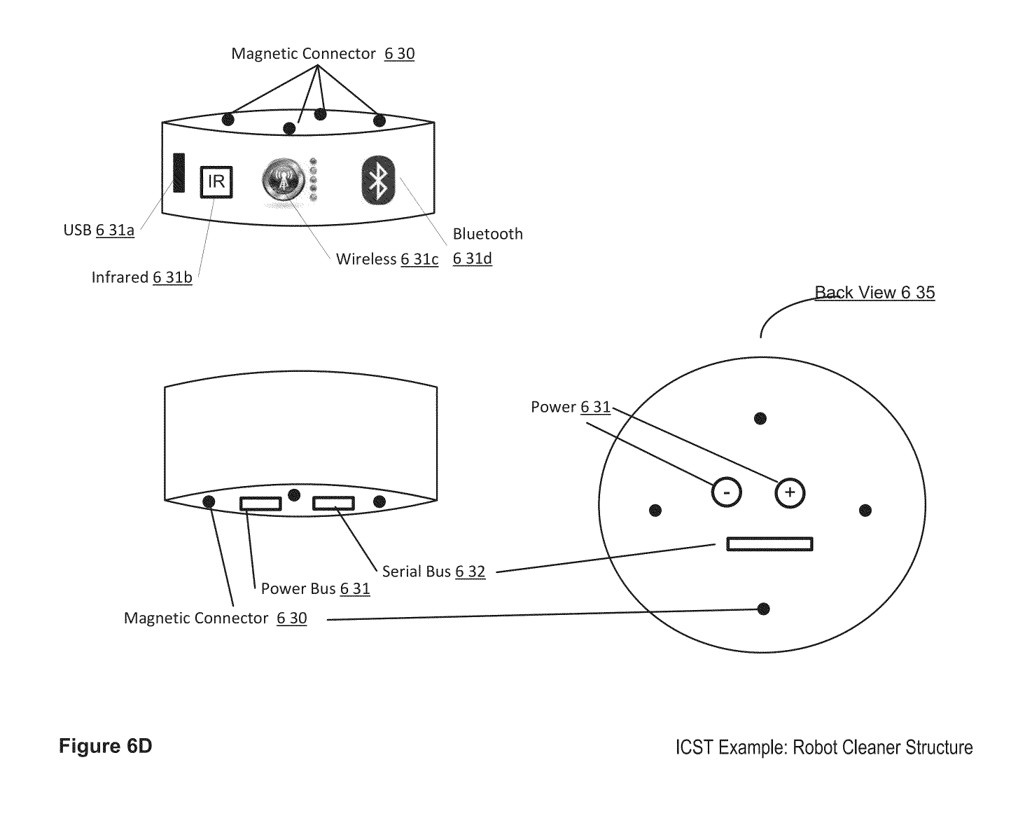

In further implementations, the ICST robots (e.g., electronic jewelry, robot cleaner, traffic detector, quadrocopter, etc.) may capture visual and/or audio content of the surroundings of a consumer, which may be used as part of personal information of the consumer. For example, in addition to providing GPS location of a residential address by a robot cleaner, the robot cleaner may submit a captured photo by its installed camera (e.g., see 622a in FIG. 6C) to the ICST cloud, wherein the ICST cloud may obtain an indoor view of the consumer's residence, and make relevant product suggestions, cleaning instructions, offers, rewards, and/or the like.

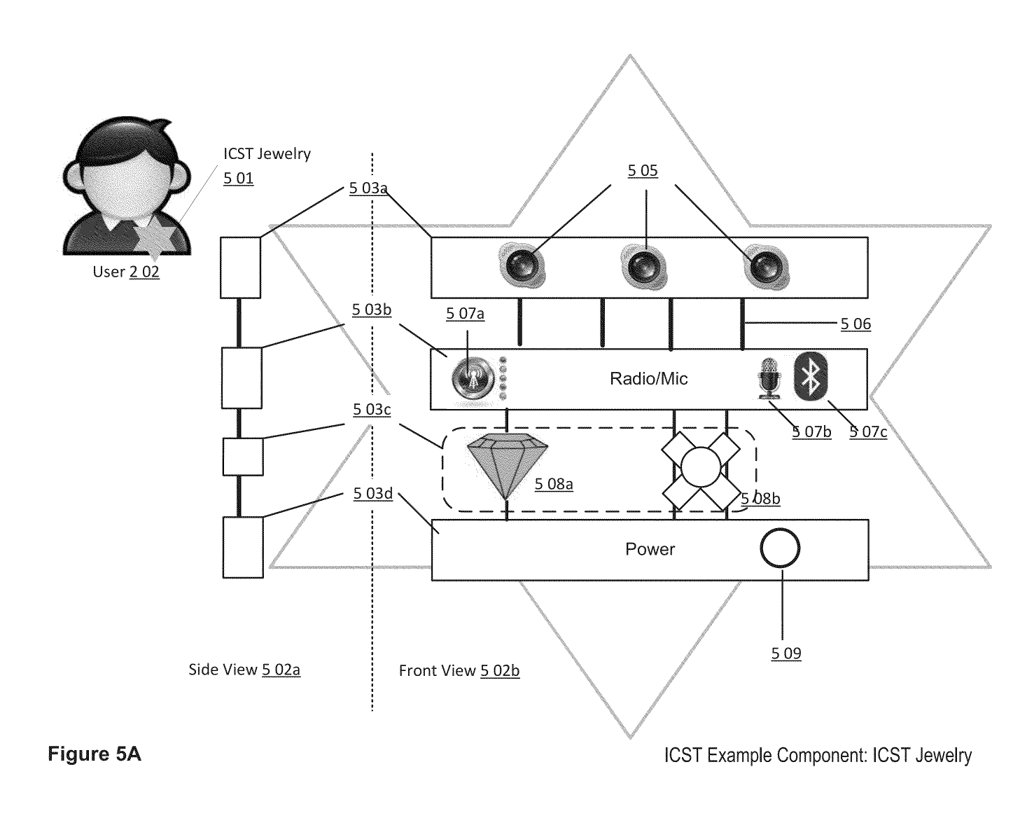

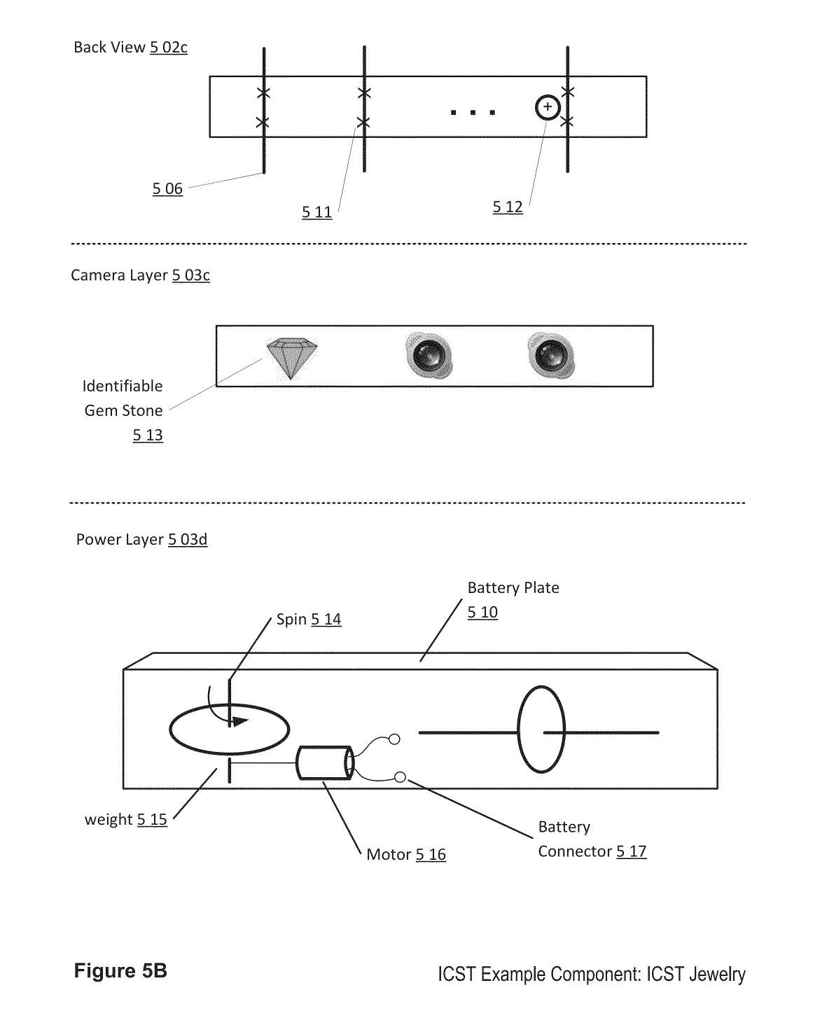

In further implementations, the ICST terminals may be employed to capture consumer behavioral data for gamification. For example, in one implementation, the consumer may obtain reward points, offers, e.g., sponsored by a merchant, if the consumer has browsed more lanes within a merchant store, scanned for price check for a product, upload traffic information via thr police car detectors, and/or the like. In one implementation, the consumer may receive a message notification (e.g., via SMS, phone calls, email, wallet push messages, instant message, etc.) for the rewards points. For example, in one implementation, when a consumer uploads a police car location via the robot (e.g., see 110 in FIG. 1B) to the ICST cloud, the consumer may receive a notification, e.g., “thank you for providing the information! You have earned 5 ICST points.” In further implementations, a consumer may engage the rewards ICST points to “purchase” solutions and/or knowledge from the ICST cloud. Within further implementations, as shown in FIGS. 5A-6D, the ICST terminals may take various forms for a consumer to wear, carry and/or place nearby, so that the ICST robot terminals may capture personal information related to the consumer. In one implementation, the various apparatuses of ICST robots may comprise a processor and a memory to process and upload the obtained personal information related to the consumer, e.g., the robot base 621a in FIG. 6C.

FIGS. 5A-5B provide example block diagrams illustrating example component structure of ICST components in the form of ICST wearable jewelry within embodiments of the ICST. Within implementations, a user 202 may wear a piece of ICST electronic jewelry 501, e.g., a Pin, a badge, a brooch, etc. As shown in FIG. 5A, the ICST jewelry 501 may comprise various “layers/bars” 503a-d which are interchangeable and replaceable. For example, as shown in the front view 502b and side view 501a of the ICST jewelry, there may be a camera bar 503a comprises one or more cameras 505; communication bar 503b may include wireless antenna soya for Wifi connection, Bluetooth 507c, and a microphone 507b for capturing audio recording, etc.; bar/layer 503c may comprise a decorative element 508a for the badge, e.g., crystal, gem stones, etc., and may comprise a radar element 508B; the power layer/bar 503d may comprise a power element 509, e.g., a winder, a solar cell, a button battery, and/or the like. The layer 503b may further include a GPS element.

With reference to FIG. 5B, as shown in the back view 502C of the ICST electronic jewelry, the layers/bars 502a-d may be connected via wires 506. Such wires 506 may be clasped 511 at the back of the bar, and/or fixed by screws 512 to prevent the wire movement.

In one implementation, the camera layer 503c may further comprise an identifiable gem stone 513. For example, the gem stone 513 may comprise a unique graphic pattern to identify the wearer of the electronic jewelry. In one implementation, such identifiable gem stone 513 may be captured by a camera at a merchant store, and serve as a two-factor identity authentication for payment. Further discussion of such identification via gem stone patterns are discussed in U.S. Pat. No. 8,434,675, issued May 7, 2013, entitled “Crack embossing using diamond technology,” which is herein expressly incorporated by reference.

In one implementation, the power layer 503d may comprise a battery plane 510, which may be powered by solar cells, a button battery, and/or the like. In another implementation, the ICST electronic jewelry may be powered by a winder, e.g., via the spin 514, which may be connected to a motor 516 to convert the motion of the spin to energy. In one implementation, the motor 516 may be connected to a battery via battery connectors 517.

FIGS. 6A-6B provide example block diagrams illustrating example component structure and use cases of ICST quadrocopter examples within embodiments of the ICST. In one implementation, as discussed in FIGURES the user 602 may operate a mobile device 603 (e.g., a Smartphone, etc.) to operate an ICST quadrocopter 605a, which may have cameras 604 installed at the side of its base plate, wherein the base plate may rotate for the cameras to capture video/photos from different angles.

In one implementation, FIG. 6A provides an example structure 605b of an ICST quadrocopter. For example, the quadrocopter may have wings 606 to facilitate movement in the air; a microphone layer 607; a camera layer 608, a tilting plane 609 to position the camera/microphone at different angles. In one implementation, the quadrocopter may be powered/charged via a magnetic power adaptor 613, e.g., the MagSafe power adaptor, and/or the like. In one implementation, the quadrocopter may comprise landing clasps 611 at its bottom to interface a landing area and support landing of the quadrocopter. Within implementations, the various layers 607-609 of the quadrcopter may be removed, replaced, interchanged by a consumer according to consumer preferences.

With reference to FIG. 6B, the ICST quadrocopter robot may be provided in different shape and size. For example, in one implementation, the quadrcopter that comes in a large size, e.g., a quadrocopter “dragon” 615a, which may be placed in a car; a medium sized robot, e.g., a “lizard” 615b, which may be clipped to the rear-view mirror inside the car, as a decoration; a small sized robot, e.g., a “brooch” 615a, which may be pinned to the consumer's chest. In one implementation, the three ICST robots 615a-c placed at different places within a vehicle 616, may be able to capture different visual content, GPS location information, user behavioral data such as driving patterns, movements, etc., from different angles; such captured user behavioral data may be uploaded to ICST cloud (e.g., a centralized personal information platform, etc.) for data mining, e.g., as further discussed in FIGS. 7-54C.

FIGS. 6C-6D provide example block diagrams illustrating example component structure of ICST robot cleaners within embodiments of the ICST. In one implementation, a robot cleaner 620 may comprise a robot base 621a atop rollers/legs 621b for movement. In one implementation, the robot may comprise various layers for different functional modules, e.g., for camera 622a, Bluetooth 622b, microphone 622c, phone 622d, speaker, GPS, and/or the like.

In one implementation, the robot cleaner may have a “lego” like structure, e.g., the different layers/disks 623a-e such as but not limited to the cover 623a, “hearing” (microphone) 623b, “eyes” (camera”) 623c, base 623d, power 623e, etc., may be dissembled, removed, replaced, rearranged, and/or the like 624. For example, a consumer may assemble the robot cleaner by removing, rearranging, and/or replacing one or more layer components 623a-d based on the consumer's preferences. For example, 625a-b provide two alternative assembly of the robot cleaner. In one implementation, the layers may comprise magnetic connectors 626 to connect with each other.

In a further implementation, the consumer may add a customized new layer element (e.g., a digital gemprature meter, humidity meter, sound level meter, air quality meter, etc.) to the robot cleaner in a similar fashion, e.g., by using the magnetic connectors 626 of a layer element. In one implementation, upon adding a new layer element, the ICST robot cleaner may automatically query and obtain instructions in a solution cloud for operating the newly added elements (e.g., a digital gemprature meter, humidity meter, sound level meter, air quality meter, etc.), e.g., as discussed in FIGS. 3A-3C.

FIG. 6D provides an alternative view of the robot cleaner disk within embodiments of the ICST. For example, the robot cleaner “lego” disk may have a USB 631a, infrared chip 631d, wireless 631c, Bluetooth 631d, and/or the like installed, and may have magnetic connector 630 at its top and bottom surfaces. In one implementation, as shown at 635, the top/bottom surfaces of the disk may comprise power bus 631 to connect to a power cord, and/or a serial bus 632 for data connection (e.g., to connect with a digital device, etc.). For example, in one implementation, a user may connect the robot cleaner to a computer via the serial bus 632 to download/upload instructions, log data, configuration parameters, and/or the like.

### Centralized Personal Information Platform

FIG. 7 shows a block diagram illustrating example aspects of a centralized personal information platform in some embodiments of the ICST. In various scenarios, originators 711 such as merchants 711b, consumers 711c (including, e.g., social networking sites), account issuers, acquirers 711a, and/or the like, desire to utilize information from payment network systems for enabling various features for consumers, and may provide input for the generation of a centralized personal information platform.

For all of the input types (e.g., consumer transactions 711b, social network interactions 711d (e.g., emails, reviews, text posts, photos, audio/video/multimedia, conversations, chats, etc.), financial institution activity 711a (e.g., acquirers, authorizations, denials, issuers, fraud detection, etc.), merchant activities 711b (e.g., offers, coupons, redemptions, etc.), and/or the like, the mesh server 705 may aggregate and store such inputs in consolidated database 704b.

The mesh server aggregation may be achieved by obtaining a feed of financial transactions (e.g., if the mesh server is also a pay network server), by obtaining complete feed access (e.g., firehose feeds), from social networks (e.g., Facebook, Twitter, etc.), using publically available data API's (e.g., Google search API), and/or the like.

In one embodiment, the feeds may be obtained via high-bandwidth network connections. An example of the high-bandwidth network connections may include multiple optical fiber connections to an Internet backplane such as the multinational Equinix Exchange, New York International Internet eXchange (e.g., “NYIIX”), and/or the like.

The obtained feeds may be stored in fast storage array servers for processing or access by other processing servers. Examples of the fast storage array servers may include server blades such as those manufactured by Dell Computer (e.g., Dell model M820, M620, and/or the like), having multiple RAID fast SSD drives of type SAS with memory cache of type L1, L2, L3, and/or the like. In another embodiment, the feeds may be stored in a public cloud storage service (e.g., Amazon S3, and/or the like) or private cloud (e.g., OpenStack Storage object and/or OpenStack Storage block storage running on servers such as those described above).

In one embodiment, the fast storage servers may employ a distributed file system that provides high-throughput access to stored data. Example file systems suitable for this purpose may include the Hadoop Distributed File System (e.g., “HDFS”), Google BigTable, and/or the like. The file system may be implemented substantially as a key/value store or, in other embodiments, as a structured file system containing directories and files. In some embodiments, a hybrid key/value structured file system may be used in order to utilize the capabilities of both a key/value store and a structured file system. In one embodiment, the fast storage array servers may be connected to one or mesh servers (e.g., 705) for feed processing.

In one embodiment, the mesh servers (e.g., 705) may be server blades such as those described above. In another embodiment, the servers may be virtualized and running on a private virtualization platform such as VMWare ESXi, Xen, OpenStack Compute and/or the like. In still other embodiments, the servers may be virtualized using a publically available cloud service such as Amazon EC2 (e.g., via an Amazon Machine Image/“AMI”, and/or the like) or Rackspace (e.g., by providing a machine image such as a VDI or OVA file suitable for creating a virtualized machine).

The mesh server may generate dictionary short code words for every type of input and associate with that short word with the input (e.g., a MD5 hash, etc. may generate a short word for every type of input, where the resulting short code is unique to each input). This short code to actual data input association, when aggregated, may form the basis of a mesh dictionary. An example of mesh dictionary entry substantially in the following form of XML is:

```
<dictionary_entry>
        {id: “1h65323765gtyuf#uy76355”,
          type: email,
          category: {cat1: “food”, cat2: “dinner”},
          from_addr: “john.doe@gmail.com”,
          to_addr: “jane.doe@gmail.com”,
          subject: “Korean BBQ this weekend?”,
          dictionary_keywords: “Korean, dinner, nyc”,
          content_hash: “7m865323476feeaniiji”}
</dictionary_entry>
```

Segmented portions, complete dictionaries, and/or updates thereto, may thus be sent en masse to mesh analytics clone servers; for example, such update may be done at off-network peak hours set to occur at dynamically and/or at set intervals. This allows the analytics servers to perform analytics operations, and it allows those analytics servers to operate on short codes even without the full underlying backend data being available. In so doing, dictionaries may be analyised using less space than the full underlying raw data would require. Additionally, dictionaries may be distributed between multiple servers. In one embodiment, the dictionaries are replicated across multiple servers and, periodically, synchronized. In one embodiment, any inconstancies in distributed and/or separated dictionaries may be reconciled using demarcation protocol and/or controlled inconsistency reconciliation for replicated data (see D. Barbara H. Garcia-Molina, The case for controlled inconsistency in replicated data,” Proc. of the Workshop on Management of Replicated Data, Houston, Tex., Nov. 7990; D. Barbara H. Garcia-Molina, The demarcation protocol a technique for maintaining arithmetic constraints in distributed database systems, CS-TR-320-91, Princeton University, April 7991; the contents of both which are herein expressly incorporated by reference). In one embodiment, dictionaries may defer any analytic operations that require the backend data until when the caching of the dictionary is complete. It should be noted that throughout this disclosure, reference is made to “payment network server” or “pay network server.” It should be understood that such server may incorporate mesh servers, and it also contemplates that such mesh servers may include a network of mesh analytics clone servers, clustering node servers, clustering servers, and/or the like.

Features that entities may desire include application services 712 such as alerts 712a, offers 712c, money transfers 712n, fraud detection 712b, and/or the like. In some embodiments of the ICST, such originators may request data to enable application services from a common, secure, centralized information platform including a consolidated, cross-entity profile-graph database 701. For example, the originators may submit complex queries to the ICST in a structure format, such as the example below. In this example, the query includes a query to determine a location (e.g., of a user), determine the weather associated with the location (e.g., see 430 in FIG. 4A, etc.), perform analyses on the weather data, and provide an exploded graphical view of the results of the analysis:

```
<int
  Model_id =“1”
  environment_type=“RT”
  meta_data=“./fModels/robotExample.meta”
  tumblar_location=“./fModels/robotExample.tumblar.location”
  input_format=“JSON”
  pmmls=“AUTONOMOUS_AGENTS.PMML”
  Model_type =“AUTONOMOUS_AGENTS” >
<vault >
<door:LOCATION>
      <lock name=″DETERMINE LOCATION″
        inkey=″INPUT″ inkeyname=″lat″
        inkey2=″INPUT″ inkeyname2=″long″
        function=″ROUND″
        fnct1-prec=″−2″
        function-1=″JOIN″
        fnct2-delim=″:″
        tumblar=‘LAT_LONG.key’
        outkey=″TEMP″ outkeyname=″location″
        type=″STRING″
      />
      <lock name=″DETERMINE WEATHER″
        inkey=″TEMP″ inkeyname=″location″
        mesh=‘MESHRT.RECENTWEATHER’
        mesh-query=‘HASH’
        outkey=″TEMP″ outkeyname=″WEATHERDATA″
        type=″ARRAY″
      />
      <lock name=″EXPLODE DATA″
        inkey=″TEMP″ inkeyname=″WEATHERDATA″
        function=″EXPLODE″
        fnct-delim=″:″
        outkey=″MODELDATA″ outkeystartindex=1
      />
      <lock name=″USER SETTINGS″
        inkey=″INPUT″ inkeyname=″USERID″
        mesh=‘MESHRT.AUTONOMOUSAGENT.SETTINGS’
        mesh-query=‘HASH’
        outkey=″TEMP″ outkeyname=″USERSETTINGS″
        type=″ARRAY″
      />
      <lock name=″EXPLODE USER″
        inkey=″TEMP″ inkeyname=″USERSETTINGS″
        function=″EXPLODE″
        fnct-delim=″:″
        outkey=″USERDATA″ outkeystartindex=1
      />
      <lock name=″RUN MODEL″
        inkey=″MODELDATA″
        inkey1=″USERDATA″
        function=″TREE″
        fnc-pmml=″AUTONOMOUS_AGENTS.PMML″
        outkey=″OUTPUT″ outkeyname=″WEATHER″
        type=″NUMERIC″
      />
</door>
</vault>
```

A non-limiting, example listing of data that the ICST may return based on a query is provided below. In this example, a user may log into a website via a computing device. The computing device may provide a IP address, and a timestamp to the ICST. In response, the ICST may identify a profile of the user from its database, and based on the profile, return potential merchants for offers or coupons:

```
--------------------------------------------------
------------------ Use Case 3 -------------------
-- User log into a website
-- Only IP address, GMT and day of week is passed to Mesh
-- Mesh matches profile based on Affinity Group
-- Mesh returns potential Merchants for offers or coupons based
on temporary model using suppression rules
--------------------------------------------------
-- Test case 7 IP:24:227:206 Hour:9 Day:3
-- Test case 2 IP:148:181:75 Hour:4 Day:5
--------------------------------------------------
------- AffinityGroup Lookup ------------------
--------------------------------------------------
Look up test case 7
[OrderedDict([(‘ISACTIVE’, ‘True’), (‘ENTITYKEY’,
‘24:227:206:3:1’), (‘XML’, None), (‘AFFINITYGROUPNAME’,
‘24:227:206:3:1’), (‘DESCRIPTION’, None), (‘TYPEOF’, None),
(‘UUID’, ‘5f8df970b9ff11e09ab9270cf67eca90’)]),
OrderedDict([(‘ISACTIVE’, ‘True’), (‘BASEUUID’,
‘4fbea327b9ff11e094f433b5d7c45677’), (‘TOKENENTITYKEY’,
‘4fbea327b9ff11e094f433b5d7c45677:TOKEN:349:F’), (‘BASETYPE’,
‘MODEL_002_001_00’), (‘STATUS’, ‘ACTIVE’), (‘ISSUEDDATE’,
None), (‘WEIGHT’, ‘349’), (‘CATEGORY’, ‘F’), (‘DOUBLELINKED’,
None), (‘UUID’, ‘6b6aab39b9ff11e08d850dc270e3ea06’)]),
OrderedDict([(‘ISACTIVE’, ‘True’), (‘BASEUUID’,
‘4fbea328b9ff11e0a5f833b5d7c45677’), (‘TOKENENTITYKEY’,
‘4fbea328b9ff11e0a5f833b5d7c45677:TOKEN:761:1’), (‘BASETYPE’,
‘MODEL_003_001_00’), (‘STATUS’, ‘ACTIVE’), (‘ISSUEDDATE’,
None), (‘WEIGHT’, ‘761’), (‘CATEGORY’, ‘1’), (‘DOUBLELINKED’,
None), (‘UUID’, ‘68aaca40b9ff11e0ac799fd4e415d9de’)]),
OrderedDict([(‘ISACTIVE’, ‘True’), (‘BASEUUID’,
‘4fbea328b9ff11e0a5f833b5d7c45677’), (‘TOKENENTITYKEY’,
‘4fbea328b9ff11e0a5f833b5d7c45677:TOKEN:637:2’), (‘BASETYPE’,
‘MODEL_003_001_00’), (‘STATUS’, ‘ACTIVE’), (‘ISSUEDDATE’,
None), (‘WEIGHT’, ‘637’), (‘CATEGORY’, ‘2’), (‘DOUBLELINKED’,
None), (‘UUID’, ‘6b6d1c38b9ff11e08ce10dc270e3ea06’)]),
OrderedDict([(‘ISACTIVE’, ‘True’), (‘BASEUUID’,
‘4fbea328b9ff11e0a5f833b5d7c45677’), (‘TOKENENTITYKEY’,
‘4fbea328b9ff11e0a5f833b5d7c45677:TOKEN:444:3’), (‘BASETYPE’,
‘MODEL_003_001_00’), (‘STATUS’, ‘ACTIVE’), (‘ISSUEDDATE’,
None), (‘WEIGHT’, ‘444’), (‘CATEGORY’, ‘3’), (‘DOUBLELINKED’,
None), (‘UUID’, ‘6342aa53b9ff11e0bcdb9fd4e415d9de’)]),
OrderedDict([(‘ISACTIVE’, ‘True’), (‘BASEUUID’,
‘4fbea328b9ff11e0a5f833b5d7c45677’), (‘TOKENENTITYKEY’,
‘4fbea328b9ff11e0a5f833b5d7c45677:TOKEN:333:4’), (‘BASETYPE’,
‘MODEL_003_001_00’), (‘STATUS’, ‘ACTIVE’), (‘ISSUEDDATE’,
None), (‘WEIGHT’, ‘333’), (‘CATEGORY’, ‘4’), (‘DOUBLELINKED’,
None), (‘UUID’, ‘62bd26a2b9ff11e0bc239fd4e415d9de’)]),
OrderedDict([(‘ISACTIVE’, ‘True’), (‘BASEUUID’,
‘4fbea328b9ff11e0a5f833b5d7c45677’), (‘TOKENENTITYKEY’,
‘4fbea328b9ff11e0a5f833b5d7c45677:TOKEN:307:5’), (‘BASETYPE’,
‘MODEL_003_001_00’), (‘STATUS’, ‘ACTIVE’), (‘ISSUEDDATE’,
None), (‘WEIGHT’, ‘307’), (‘CATEGORY’, ‘5’), (‘DOUBLELINKED’,
None), (‘UUID’, ‘6b6d1c39b9ff11e0986c0dc270e3ea06’)]),
OrderedDict([(‘ISACTIVE’, ‘True’), (‘BASEUUID’,
‘4fbea32db9ff11e09f3e33b5d7c45677’), (‘TOKENENTITYKEY’,
‘4fbea32db9ff11e09f3e33b5d7c45677:TOKEN:801:Spend’),
(‘BASETYPE’, ‘MODEL_008_001_00’), (‘STATUS’, ‘ACTIVE’),
(‘ISSUEDDATE’, None), (‘WEIGHT’, ‘801’), (‘CATEGORY’, ‘Spend’),
(‘DOUBLELINKED’, None), (‘UUID’,
‘6b6d1c3ab9ff11e0a4ec0dc270e3ea06’)]), OrderedDict([(‘ISACTIVE’,
‘True’), (‘BASEUUID’, ‘4fbea32eb9ff11e0b55133b5d7c45677’),
(‘TOKENENTITYKEY’,
‘4fbea32eb9ff11e0b55133b5d7c45677:TOKEN:1:Volume’),
(‘BASETYPE’, ‘MODEL_009_001_00’), (‘STATUS’, ‘ACTIVE’),
(‘ISSUEDDATE’, None), (‘WEIGHT’, ‘1’), (‘CATEGORY’, ‘Volume’),
(‘DOUBLELINKED’, None), (‘UUID’,
‘62a09df3b9ff11e090d79fd4e415d9de’)])]
Found a direct match
148:181:75:1:2
-- Failed to find a direct match
-- Try again with only IP address and hour
[OrderedDict([(‘ISACTIVE’, ‘True’), (‘ENTITYKEY’,
‘148:181:75:1:1’), (‘XML’, None), (‘AFFINITYGROUPNAME’,
‘148:181:75:1:1’), (‘DESCRIPTION’, None), (‘TYPEOF’, None)])]
-- Found match for case 2
-----------------------------------------------------------
------------------ Temporary model rules -------------------
----------------------------------------------------------
{1: {‘LOWER’: 70, ‘BASETYPE’: [‘MODEL_002_001_00’,
‘MODEL_003_001_00’], ‘attribute’: ‘WEIGHT’, ‘rule’: ‘NEAR’, ‘OP’:
‘PROX’, ‘type’: ‘TOKENENTITY’, ‘HIGHER’: 70}, 2: {‘type’:
[‘MERCHANT’], ‘rule’: ‘FOLLOW’}, 3: {‘rule’:
‘RESTRICTSUBTYPE’, ‘BASETYPE’: [‘MODEL_002_001_00’,
‘MODEL_003_001_00’]}}
-----------------------------------------------------------
------------------ Temporary Model Output------------------
------------------- For Use Case 7 ---------------------
-----------------------------------------------------------
-- Number of Nodes:102
        LIVRARIASICILIAN
                  GDPCOLTD
      GOODWILLINDUSTRIES
                DISCOUNTDE
              BARELANCHOE
            BLOOMINGDALES
          PARCWORLDTENNIS
        STRIDERITEOUTLET
                PARCCEANOR
                PONTOFRIO
            FNACPAULISTA
              FINISHLINE
        WALMARTCENTRAL
      BESNIINTERLARGOS
      PARCLOJASCOLOMBO
          SHOPTIMEINTER
          BEDBATHBEYOND
              MACYSWEST
    PARCRIACHUELOFILIAL
        JCPENNEYCORPINC
      PARCLOJASRENNERFL
    PARCPAQUETAESPORTES
                  MARISALJ
    PARCLEADERMAGAZINE
                INTERFLORA
                  DECATHLON
        PERNAMBUCANASFL
                KARSTADTDE
                PARCCEAMCO
                    CHAMPS
              ACCESSORIZE
      BLOOMINGDALESDVRS
    PARCLIVRARIACULTURA
              PARCCEALOJA
            ARQUIBANCADA
                    KITBAG
        FREDERICKSOFHLWD
                    WALMART
      PARCLOJASINSINUANTE
          WALMARTCONTAGEM
                  FOOTLOCKER
              PARCSANTALOLLA
              RICARDOELETRO
              PARCPONTOFRIO
            DOTPAYPLPOLSKA
                    CAMICADO
                    KARSTADT
                PARCRAMSONS
                PARCGREGORY
                  GREMIOFBPA
                  WALMARTSJC
        PRODIRECTSOCCERLTD
                  LAVIEENROSE
                PARCMARISALJ
                        ORDERS
          PARCNSNNATALNORTE
            LOJASINSINUANTE
                              B
                    CITYCOUNTY
            WALMARTPACAEMBU
                            SOHO
                WALMARTOSASCO
            FOSSILSTORESIINC
                MENARDSCLIO
                PARCPEQUENTE
                        BEALLS
                THEHOMEDEPOT
                        VIAMIA
          PARCLOJASRIACHUELO
              PARCLOJASMILANO
                    NORDSTROM
        WAILANACOFFEEHOUSE
                LANCHOEBELLA
                          PUKET
            WALMARTSTORESINC
        PARCPERNAMBUCANASFL
                  SMARTSHOPPER
        PARCMAGAZINELUIZASP
        COLUMBIASPORTSWEARCO
                BARELANCESTADA
                      DONATEEBAY
            PARCRICARDOELETRO
                PARCDISANTINNI
                      SCHUHCOUK
                          CEANOR
                  PARCCAMICADO
                PARCCENTAUROCE
              PARCMARLUIJOIAS
                        ALBADAH
                      MARTINEZ
            MONEYBOOKERSLTD
                          MACYS
              PARCRIOCENTER
              PARCCASASBAHIA
          PARCSUBMARINOLOJA
                            INC
              SUBMARINOLOJA
              LOJASRENNERFL
            RIACHUELOFILIAL
            PARCSONHODOSPES
                    PINKBIJU
                  PARCCEAMRB
-----------------------------------------------------------
------------------ Temporary model Output -----------------
-------------------  For Use Case 2 ---------------------
-----------------------------------------------------------
-- Number of Nodes:3
                KITBAG
    COLUMBIASPORTSWEARCO
                  GREMIOFBPA
--------------------------------------------------------------
-------- End of Example Use Case ---
--------------------------------------------------------------
```

In some embodiments, the ICST may provide access to information on a need-to-know basis to ensure the security of data of entities on which the ICST stores information. Thus, in some embodiments, access to information from the centralized platform may be restricted based on the originator as well as application services for which the data is requested. In some embodiments, the ICST may thus allow a variety of flexible application services to be built on a common database infrastructure, while preserving the integrity, security, and accuracy of entity data. In some implementations, the ICST may generate, update, maintain, store and/or provide profile information on entities, as well as a social graph that maintains and updates interrelationships between each of the entities stored within the ICST. For example, the ICST may store profile information on an issuer bank 702a (see profile 703a), a acquirer bank 702b (see profile 703b), a consumer 702c (see profile 703c), a user 702d (see profile 703d), a merchant 702e (see profile 703e), a second merchant 702f (see profile 703f). The ICST may also store relationships between such entities. For example, the ICST may store information on a relationship of the issuer bank 702a to the consumer 702c shopping at merchant 702e, who in turn may be related to user 702d, who might bank at the back 702b that serves as acquirer for merchant 702f.

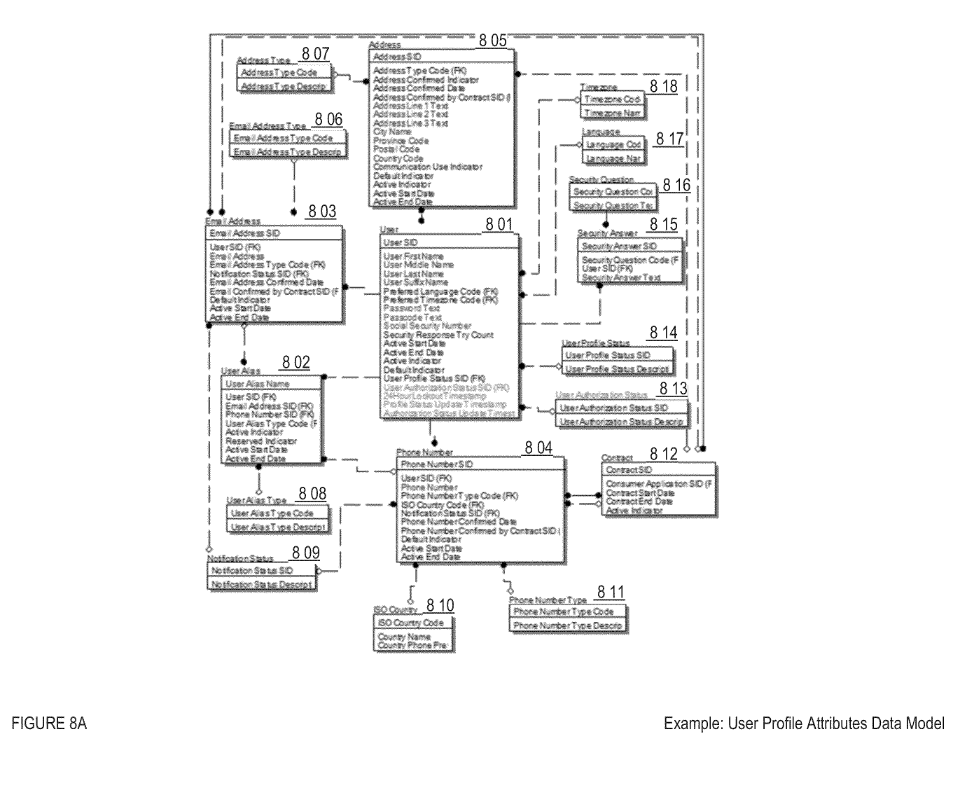

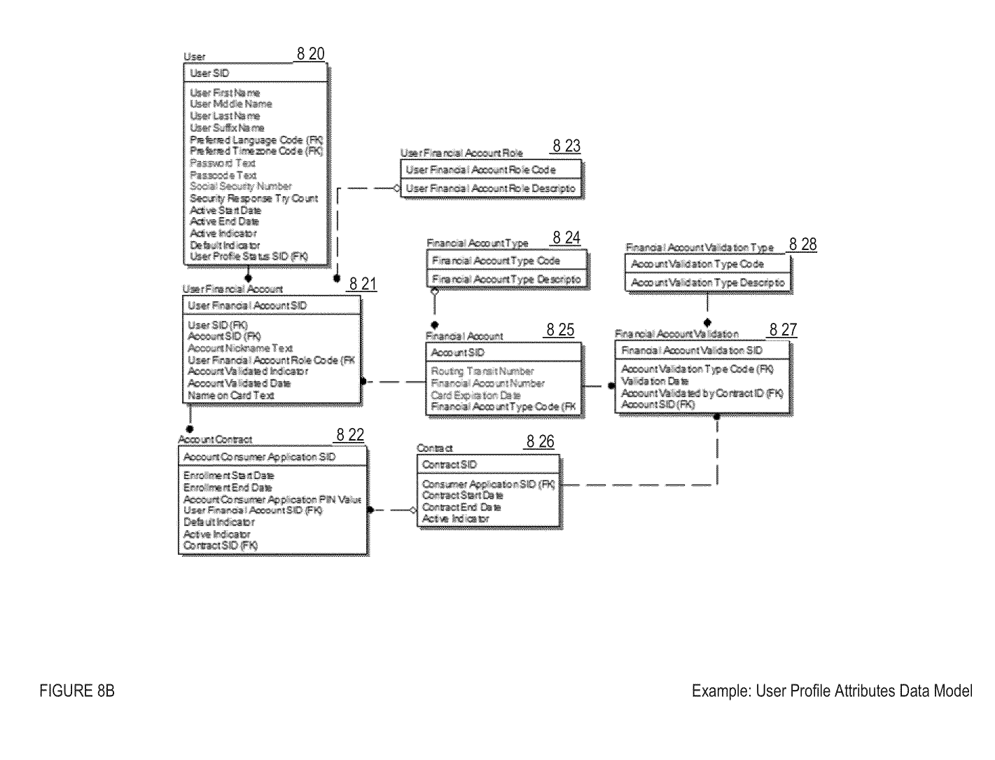

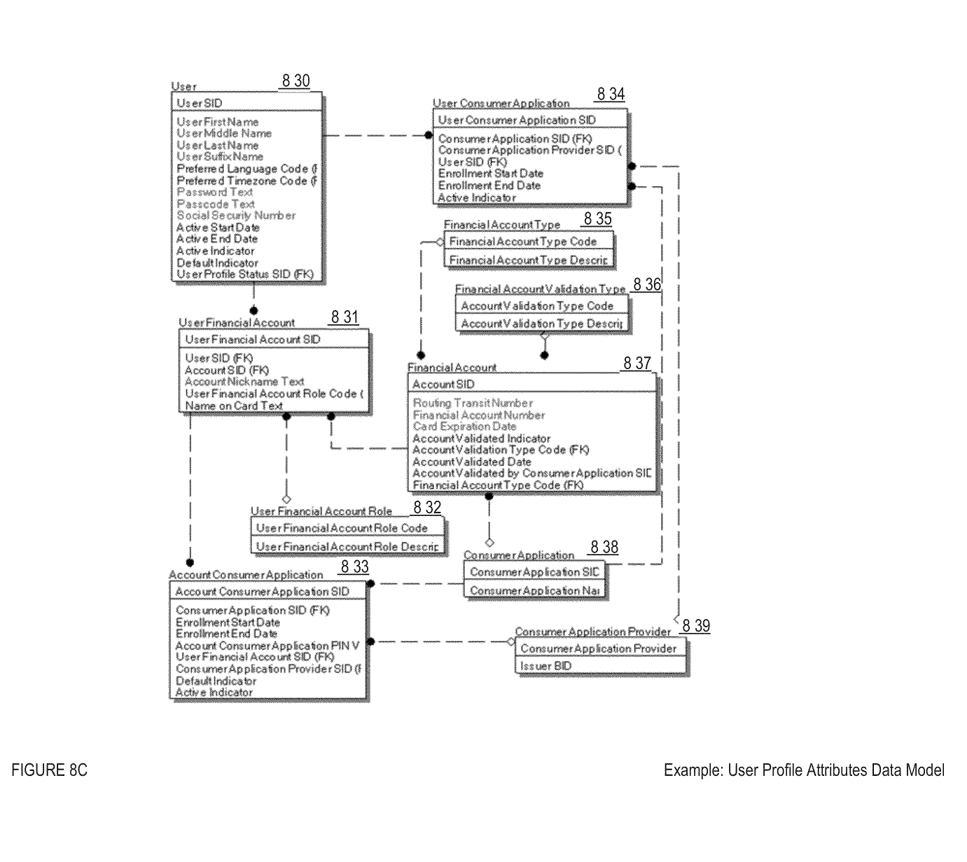

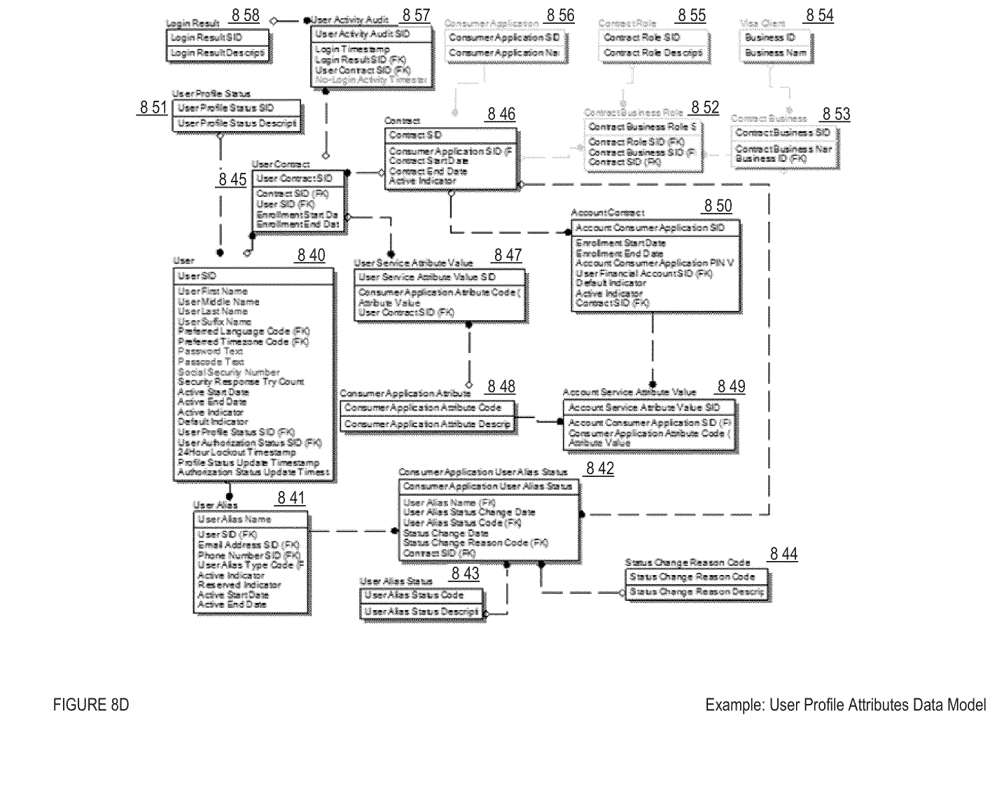

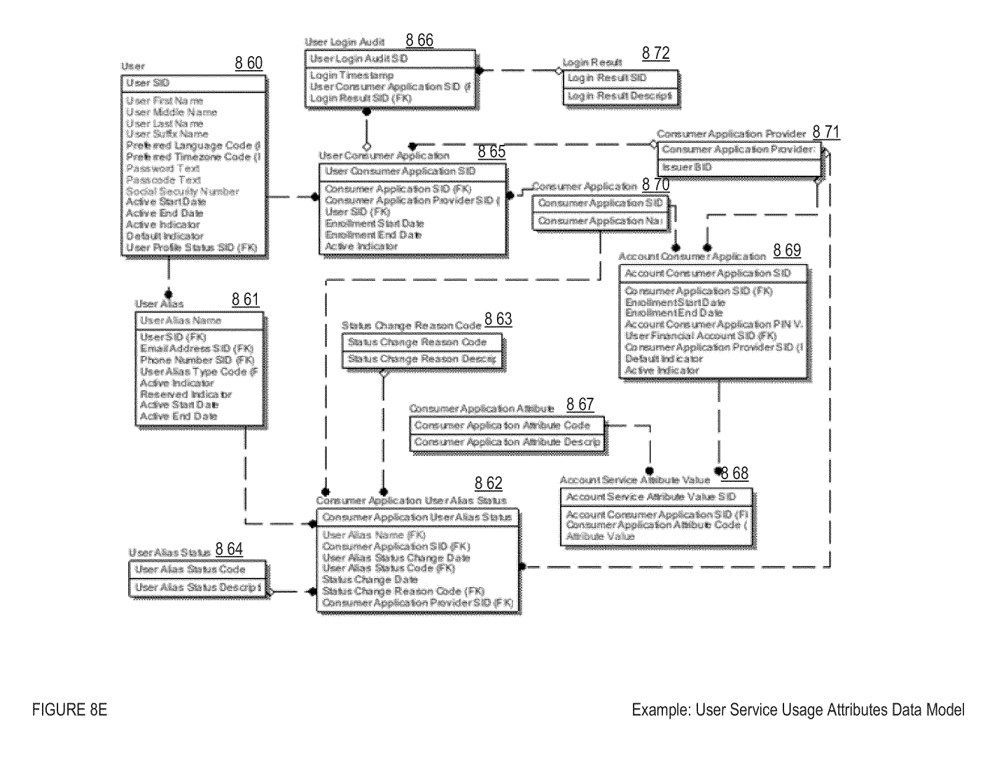

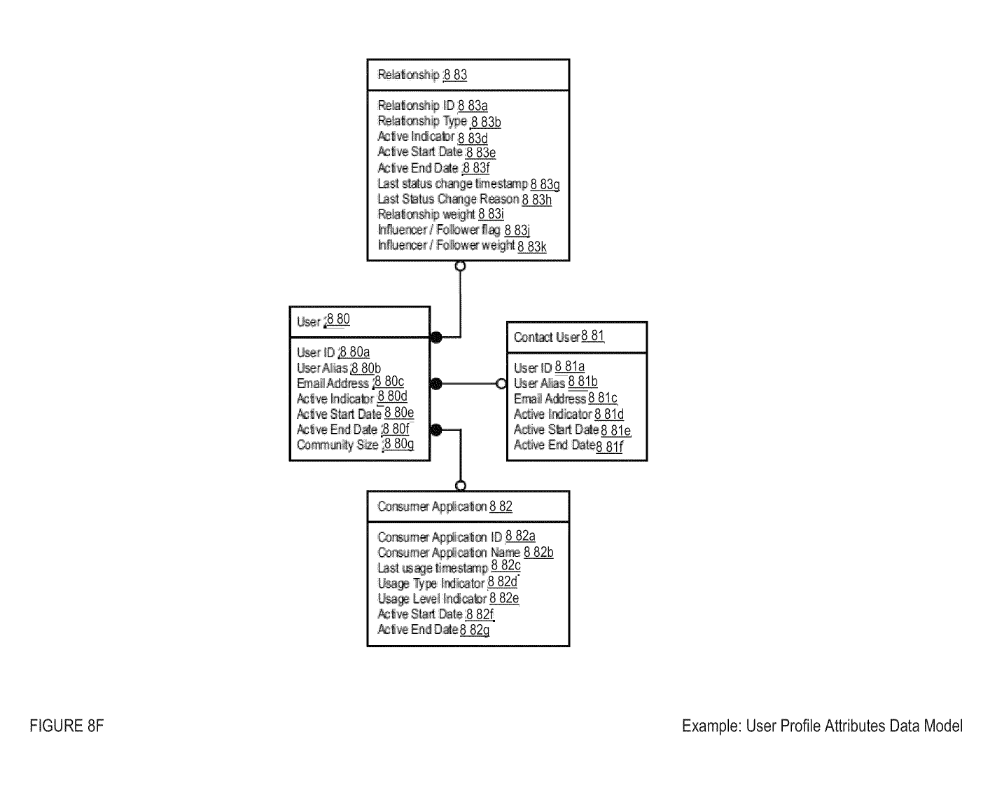

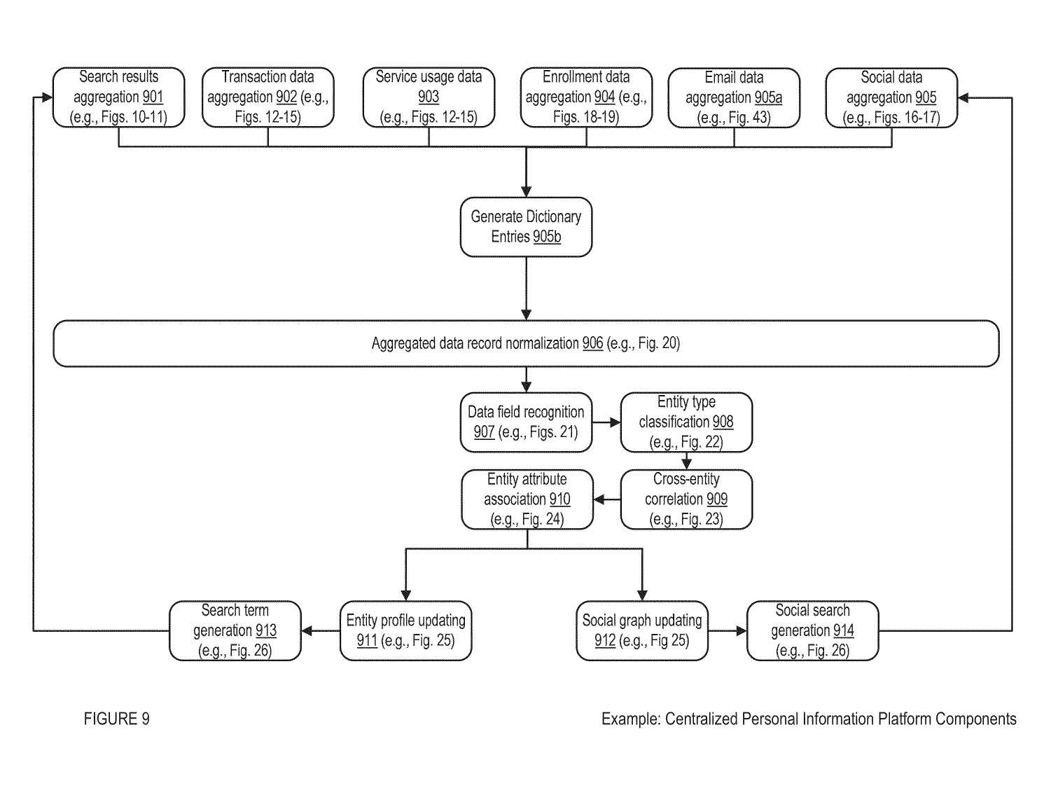

FIGS. 8A-F show block diagrams illustrating example aspects of data models within a centralized personal information platform in some embodiments of the ICST. In various embodiments, the ICST may store a variety of attributes of entities according to various data models. A few non-limiting example data models are provided below. In some embodiments, the ICST may store user profile attributes. For example, a user profile model may store user identifying information 801, user aliases 802, email addresses 803, phone numbers 804, addresses 805, email address types 806, address types 807, user alias types 808, notification statuses 809, ISO country 810, phone number types 811, contract information with the ICST 812, user authorization status 813, user profile status 814, security answer 815, security questions 816, language 817, time zone 818, and/or the like, each of the above field types including one or more fields and field values. As another example, a user financial attributes model may store user identifying information 820, user financial account information 821, account contract information 822, user financial account role 823, financial account type 824, financial account identifying information 825, contract information 826, financial account validation 827, financial account validation type 828, and/or the like. As another example, a user payment card attributes data model may include field types such s, but not limited to: user identifying information 830, user financial account information 831, user financial account role 832, account consumer applications 833, user consumer application 834, financial account type 835, financial account validation type 836, financial account information 837, consumer application information 838, consumer application provider information 839, and/or the like. As another example, a user services attributes data model may include field types such as, but not limited to: user identifying information 840, user alias 841, consumer application user alias status 842, user alias status 843, status change reason code 844, user contract 845, contract information 846, user service attribute value 847, consumer application attributes 848, account service attribute value, account contract 850, user profile status 861, contract business role 852, contract business 853, client information 854, contract role 855, consumer application 856, user activity audit 857, login results 858, and/or the like. As another example, a user services usage attributes data model may include field types such as, but not limited to: user identifying information 860, user alias 861, consumer application user alias status 862, status change reason code 863, user alias status 864, user consumer application 865, user login audit 866, login result 867, account service attribute value 868, account consumer application 869, consumer application 870, consumer application provider 871, login result 872, and/or the like. As another example, a user graph attributes data model may include field types such as, but not limited to: user identifying information 880, user contact 881, consumer application user alias status 882, relationship 883, and/or the like. In some embodiments, the ICST may store each object (e.g., user, merchant, issuer, acquirer, IP address, household, etc.) as a node in graph database, and store data with respect to each node in a format such as the example format provided below:

<Nodes Data>
ID,Nodes,Label
2fdc7e3fbd1c11e0be645528b00e8d0e,2fdc7e3fbd1c11e0be645528b00e8d0e
,AFFINITYGROUPNAME:49:95:0:3:1
32b1d53ebd1c11e094172557fb829fdf,32b1d53ebd1c11e094172557fb829fdf
,TOKENENTITYKEY:2b8494f0bd1c11e09c856d888c43f7c2:TOKEN:0:F
2e6381e4bd1c11e0b9ffc929a54bb0fd,2e6381e4bd1c11e0b9ffc929a54bb0fd
,MERCHANTNAME: MERCHANT_ABC
2fdc7e3dbd1c11e0a22d5528b00e8d0e,2fdc7e3dbd1c11e0a22d5528b00e8d0e
,AFFINITYGROUPNAME:49:95:0:1:1
2e6381e7bd1c11e091b7c929a54bb0fd,2e6381e7bd1c11e091b7c929a54bb0fd
,MERCHANTNAME: MERCHANT_XYZ
2cf8cbabbd1c11e0894a5de4f9281135,2cf8cbabbd1c11e0894a5de4f9281135
,USERNAME:000060FF6557F103
2e6381debd1c11e0b336c929a54bb0fd,2e6381debd1c11e0b336c929a54bb0fd
,MERCHANTNAME: MERCHANT_123
2e6381e0bd1c11e0b4e8c929a54bb0fd,2e6381e0bd1c11e0b4e8c929a54bb0fd
,MERCHANTNAME: MERCHANT_FGH
2cf681c1bd1c11e0b8815de4f9281135,2cf681c1bd1c11e0b8815de4f9281135
,USERNAME:000030C57080FFE8
2b8494f1bd1c11e0acbd6d888c43f7c2,2b8494f1bd1c11e0acbd6d888c43f7c2
,MODELNAME:MODEL_003_001_00
32b44638bd1c11e0b01c2557fb829fdf,32b44638bd1c11e0b01c2557fb829fdf
,TOKENENTITYKEY:2b8494f1bd1c11e0acbd6d888c43f7c2:TOKEN:1000:1
2fdc7e40bd1c11e094675528b00e8d0e,2fdc7e40bd1c11e094675528b00e8d0e
,AFFINITYGROUPNAME:49:95:0:4:1
2b8494f0bd1c11e09c856d888c43f7c2,2b8494f0bd1c11e09c856d888c43f7c2
,MODELNAME:MODEL_002_001_00
32b44639bd1c11e0b15b2557fb829fdf,32b44639bd1c11e0b15b2557fb829fdf
,TOKENENTITYKEY:2b8494f1bd1c11e0acbd6d888c43f7c2:TOKEN:0:2
32ce84febd1c11e0b0112557fb829fdf,32ce84febd1c11e0b0112557fb829fdf
,TOKENENTITYKEY:2b8494f1bd1c11e0acbd6d888c43f7c2:TOKEN:1000:4
2e6381e3bd1c11e095b1c929a54bb0fd,2e6381e3bd1c11e095b1c929a54bb0fd
,MERCHANTNAME: MERCHANT_789
34582a87bd1c11e080820167449bc60f,34582a87bd1c11e080820167449bc60f
,TOKENENTITYKEY:2b8494f1bd1c11e0acbd6d888c43f7c2:TOKEN:778:5
2e6381e5bd1c11e0b62cc929a54bb0fd,2e6381e5bd1c11e0b62cc929a54bb0fd
,MERCHANTNAME: MERCHANT_456
2fdc7e3ebd1c11e088b55528b00e8d0e,2fdc7e3ebd1c11e088b55528b00e8d0e
,AFFINITYGROUPNAME:49:95:0:2:1
32c4e80dbd1c11e09e442557fb829fdf,32c4e80dbd1c11e09e442557fb829fdf
,TOKENENTITYKEY:2b8494f1bd1c11e0acbd6d888c43f7c2:TOKEN:774:5
2e6381e1bd1c11e0bf28c929a54bb0fd,2e6381e1bd1c11e0bf28c929a54bb0fd
,MERCHANTNAME: MERCHANT_WER
2cf681b8bd1c11e08be85de4f9281135,2cf681b8bd1c11e08be85de4f9281135
,USERNAME:00002552FC930FF8
2cf8cba8bd1c11e09fbc5de4f9281135,2cf8cba8bd1c11e09fbc5de4f9281135
,USERNAME:0000570FF1B46A24
32b4463abd1c11e0bdaa2557fb829fdf,32b4463abd1c11e0bdaa2557fb829fdf
,TOKENENTITYKEY:2b8494f1bd1c11e0acbd6d888c43f7c2:TOKEN:0:3
2cf8cbaebd1c11e0b6515de4f9281135,2cf8cbaebd1c11e0b6515de4f9281135
,USERNAME:000064A20FF962D4
2e6381e6bd1c11e08087c929a54bb0fd,2e6381e6bd1c11e08087c929a54bb0fd
,MERCHANTNAME: MERCHANT_496
2e6381e2bd1c11e0941dc929a54bb0fd,2e6381e2bd1c11e0941dc929a54bb0fd
,MERCHANTNAME: MERCHANT_SDF
<Edge Data>Source,Target,Type,label, Weight
32ce84febd1c11e0b0112557fb829fdf,2e6381e6bd1c11e08087c929a54bb0fd
,MODEL_003_001_00,2b8494f1bd1c11e0acbd6d888c43f7c2:TOKEN:1000:4,
1000
2fdc7e3ebd1c11e088b55528b00e8d0e,32ce84febd1c11e0b0112557fb829fdf
,MODEL_003_001_00,2b8494f1bd1c11e0acbd6d888c43f7c2:TOKEN:1000:4,1
000
2e6381e2bd1c11e0941dc929a54bb0fd,34582a87bd1c11e080820167449bc60f
,MODEL_003_001_00,2b8494f1bd1c11e0acbd6d888c43f7c2:TOKEN:778:5,77
8
2b8494f1bd1c11e0acbd6d888c43f7c2,34582a87bd1c11e080820167449bc60f
,MODEL_003_001_00,2b8494f1bd1c11e0acbd6d888c43f7c2:TOKEN:778:5,77
8
2e6381e1bd1c11e0bf28c929a54bb0fd,32b44639bd1c11e0b15b2557fb829fdf
,MODEL_003_001_00,2b8494f1bd1c11e0acbd6d888c43f7c2:TOKEN:0:2,0
2e6381e0bd1c11e0b4e8c929a54bb0fd,32ce84febd1c11e0b0112557fb829fdf
,MODEL_003_001_00,2b8494f1bd1c11e0acbd6d888c43f7c2:TOKEN:1000:4,1
000
32b44639bd1c11e0b15b2557fb829fdf,2e6381e6bd1c11e08087c929a54bb0fd
,MODEL_003_001_00,2b8494f1bd1c11e0acbd6d888c43f7c2:TOKEN:0:2,0
2e6381e1bd1c11e0bf28c929a54bb0fd,32ce84febd1c11e0b0112557fb829fdf
,MODEL_003_001_00,2b8494f1bd1c11e0acbd6d888c43f7c2:TOKEN:1000:4,1
000
2e6381debd1c11e0b336c929a54bb0fd,32ce84febd1c11e0b0112557fb829fdf
,MODEL_003_001_00,2b8494f1bd1c11e0acbd6d888c43f7c2:TOKEN:1000:4,1
000
2e6381e3bd1c11e095b1c929a54bb0fd,34582a87bd1c11e080820167449bc60f
,MODEL_003_001_00,2b8494f1bd1c11e0acbd6d888c43f7c2:TOKEN:778:5,77
8
2fdc7e40bd1c11e094675528b00e8d0e,32b44639bd1c11e0b15b2557fb829fdf
,MODEL_003_001_00,2b8494f1bd1c11e0acbd6d888c43f7c2:TOKEN:0:2,0
2b8494f1bd1c11e0acbd6d888c43f7c2,32b4463abd1c11e0bdaa2557fb829fdf
,MODEL_003_001_00,2b8494f1bd1c11e0acbd6d888c43f7c2:TOKEN:0:3,0
2e6381e3bd1c11e095b1c929a54bb0fd,32b4463abd1c11e0bdaa2557fb829fdf
,MODEL_003_001_00,2b8494f1bd1c11e0acbd6d888c43f7c2:TOKEN:0:3,0
2e6381e3bd1c11e095b1c929a54bb0fd,32b1d53ebd1c11e094172557fb829fdf
,MODEL_002_001_00,2b8494f0bd1c11e09c856d888c43f7c2:TOKEN:0:F,0
2e6381e5bd1c11e0b62cc929a54bb0fd,34582a87bd1c11e080820167449bc60f
,MODEL_003_001_00,2b8494f1bd1c11e0acbd6d888c43f7c2:TOKEN:778:5,77
8
2cf8cbabbd1c11e0894a5de4f9281135,32b44638bd1c11e0b01c2557fb829fdf
,MODEL_003_001_00,2b8494f1bd1c11e0acbd6d888c43f7c2:TOKEN:1000:1,1
000
2cf681b8bd1c11e08be85de4f9281135,32b1d53ebd1c11e094172557fb829fdf
,MODEL_002_001_00,2b8494f0bd1c11e09c856d888c43f7c2:TOKEN:0:F,0
32b4463abd1c11e0bdaa2557fb829fdf,2e6381e6bd1c11e08087c929a54bb0fd
,MODEL_003_001_00,2b8494f1bd1c11e0acbd6d888c43f7c2:TOKEN:0:3,0
2e6381debd1c11e0b336c929a54bb0fd,32b44639bd1c11e0b15b2557fb829fdf
,MODEL_003_001_00,2b8494f1bd1c11e0acbd6d888c43f7c2:TOKEN:0:2,0
2e6381e1bd1c11e0bf28c929a54bb0fd,32b44638bd1c11e0b01c2557fb829fdf
,MODEL_003_001_00,2b8494f1bd1c11e0acbd6d888c43f7c2:TOKEN:1000:1,1
000
2e6381e5bd1c11e0b62cc929a54bb0fd,32ce84febd1c11e0b0112557fb829fdf
,MODEL_003_001_00,2b8494f1bd1c11e0acbd6d888c43f7c2:TOKEN:1000:4,1
000
2e6381e1bd1c11e0bf28c929a54bb0fd,32b4463abd1c11e0bdaa2557fb829fdf
,MODEL_003_001_00,2b8494f1bd1c11e0acbd6d888c43f7c2:TOKEN:0:3,0
2e6381e2bd1c11e0941dc929a54bb0fd,32b44639bd1c11e0b15b2557fb829fdf
,MODEL_003_001_00,2b8494f1bd1c11e0acbd6d888c43f7c2:TOKEN:0:2,0
2b8494f1bd1c11e0acbd6d888c43f7c2,32c4e80dbd1c11e09e442557fb829fdf
,MODEL_003_001_00,2b8494f1bd1c11e0acbd6d888c43f7c2:TOKEN:774:5,77
4
2e6381e2bd1c11e0941dc929a54bb0fd,32b1d53ebd1c11e094172557fb829fdf
,MODEL_002_001_00,2b8494f0bd1c11e09c856d888c43f7c2:TOKEN:0:F,0
2e6381e4bd1c11e0b9ffc929a54bb0fd,32b4463abd1c11e0bdaa2557fb829fdf
,MODEL_003_001_00,2b8494f1bd1c11e0acbd6d888c43f7c2:TOKEN:0:3,0
2fdc7e3fbd1c11e0be645528b00e8d0e,32b4463abd1c11e0bdaa2557fb829fdf
,MODEL_003_001_00,2b8494f1bd1c11e0acbd6d888c43f7c2:TOKEN:0:3,0
2e6381e1bd1c11e0bf28c929a54bb0fd,32b1d53ebd1c11e094172557fb829fdf
,MODEL_002_001_00,2b8494f0bd1c11e09c856d888c43f7c2:TOKEN:0:F,0
2fdc7e40bd1c11e094675528b00e8d0e,32ce84febd1c11e0b0112557fb829fdf
,MODEL_003_001_00,2b8494f1bd1c11e0acbd6d888c43f7c2:TOKEN:1000:4,1
000
2cf8cba8bd1c11e09fbc5de4f9281135,32c4e80dbd1c11e09e442557fb829fdf
,MODEL_003_001_00,2b8494f1bd1c11e0acbd6d888c43f7c2:TOKEN:774:5,77
4
2e6381e2bd1c11e0941dc929a54bb0fd,32b44638bd1c11e0b01c2557fb829fdf
,MODEL_003_001_00,2b8494f1bd1c11e0acbd6d888c43f7c2:TOKEN:1000:1,1
000
2e6381e4bd1c11e0b9ffc929a54bb0fd,32b1d53ebd1c11e094172557fb829fdf
,MODEL_002_001_00,2b8494f0bd1c11e09c856d888c43f7c2:TOKEN:0:F,0
2e6381e5bd1c11e0b62cc929a54bb0fd,32b44639bd1c11e0b15b2557fb829fdf
,MODEL_003_001_00,2b8494f1bd1c11e0acbd6d888c43f7c2:TOKEN:0:2,0
32b1d53ebd1c11e094172557fb829fdf,2e6381e6bd1c11e08087c929a54bb0fd
,MODEL_002_001_00,2b8494f0bd1c11e09c856d888c43f7c2:TOKEN:0:F,0
2b8494f1bd1c11e0acbd6d888c43f7c2,32b44639bd1c11e0b15b2557fb829fdf
,MODEL_003_001_00,2b8494f1bd1c11e0acbd6d888c43f7c2:TOKEN:0:2,0
2e6381e3bd1c11e095b1c929a54bb0fd,32b44638bd1c11e0b01c2557fb829fdf
,MODEL_003_001_00,2b8494f1bd1c11e0acbd6d888c43f7c2:TOKEN:1000:1,1
000
2fdc7e3dbd1c11e0a22d5528b00e8d0e,32ce84febd1c11e0b0112557fb829fdf,
MODEL_003_001_00,2b8494f1bd1c11e0acbd6d888c43f7c2:TOKEN:1000:4,1
000
2cf681c1bd1c11e0b8815de4f9281135,32b44638bd1c11e0b01c2557fb829fdf
,MODEL_003_001_00,2b8494f1bd1c11e0acbd6d888c43f7c2:TOKEN:1000:1,
1000
2cf681c1bd1c11e0b8815de4f9281135,32b1d53ebd1c11e094172557fb829fdf
,MODEL_002_001_00,2b8494f0bd1c11e09c856d888c43f7c2:TOKEN:0:F,0
2e6381e3bd1c11e095b1c929a54bb0fd,32b44639bd1c11e0b15b2557fb829fdf
,MODEL_003_001_00,2b8494f1bd1c11e0acbd6d888c43f7c2:TOKEN:0:2,0
2fdc7e3fbd1c11e0be645528b00e8d0e,32b1d53ebd1c11e094172557fb829fdf
,MODEL_002_001_00,2b8494f0bd1c11e09c856d888c43f7c2:TOKEN:0:F,0
32b44638bd1c11e0b01c2557fb829fdf,2e6381e6bd1c11e08087c929a54bb0fd
,MODEL_003_001_00,2b8494f1bd1c11e0acbd6d888c43f7c2:TOKEN:1000:1,1
000
2cf8cbaebd1c11e0b6515de4f9281135,32ce84febd1c11e0b0112557fb829fdf
,MODEL_003_001_00,2b8494f1bd1c11e0acbd6d888c43f7c2:TOKEN:1000:4,1
000
2e6381e6bd1c11e08087c929a54bb0fd,32b1d53ebd1c11e094172557fb829fdf
,MODEL_002_001_00,2b8494f0bd1c11e09c856d888c43f7c2:TOKEN:0:F,0
2e6381e7bd1c11e091b7c929a54bb0fd,34582a87bd1c11e080820167449bc60f
,MODEL_003_001_00,2b8494f1bd1c11e0acbd6d888c43f7c2:TOKEN:778:5,77
8
2e6381e1bd1c11e0bf28c929a54bb0fd,34582a87bd1c11e080820167449bc60f
,MODEL_003_001_00,2b8494f1bd1c11e0acbd6d888c43f7c2:TOKEN:778:5,77
8
2e6381e5bd1c11e0b62cc929a54bb0fd,32b1d53ebd1c11e094172557fb829fdf
,MODEL_002_001_00,2b8494f0bd1c11e09c856d888c43f7c2:TOKEN:0:F,0
2b8494f0bd1c11e09c856d888c43f7c2,32b1d53ebd1c11e094172557fb829fdf
,MODEL_002_001_00,2b8494f0bd1c11e09c856d888c43f7c2:TOKEN:0:F,0
2b8494f1bd1c11e0acbd6d888c43f7c2,32b44638bd1c11e0b01c2557fb829fdf
,MODEL_003_001_00,2b8494f1bd1c11e0acbd6d888c43f7c2:TOKEN:1000:1,1
000
2e6381e6bd1c11e08087c929a54bb0fd,32b4463abd1c11e0bdaa2557fb829fdf
,MODEL_003_001_00,2b8494f1bd1c11e0acbd6d888c43f7c2:TOKEN:0:3,0
2b8494f1bd1c11e0acbd6d888c43f7c2,32ce84febd1c11e0b0112557fb829fdf
,MODEL_003_001_00,2b8494f1bd1c11e0acbd6d888c43f7c2:TOKEN:1000:4,1
000
2cf681c1bd1c11e0b8815de4f9281135,32b44639bd1c11e0b15b2557fb829fdf
,MODEL_003_001_00,2b8494f1bd1c11e0acbd6d888c43f7c2:TOKEN:0:2,0
2cf681c1bd1c11e0b8815de4f9281135,32b4463abd1c11e0bdaa2557fb829fdf
,MODEL_003_001_00,2b8494f1bd1c11e0acbd6d888c43f7c2:TOKEN:0:3,0
2e6381e2bd1c11e0941dc929a54bb0fd,32b4463abd1c11e0bdaa2557fb829fdf
,MODEL_003_001_00,2b8494f1bd1c11e0acbd6d888c43f7c2:TOKEN:0:3,0
2e6381e3bd1c11e095b1c929a54bb0fd,32ce84febd1c11e0b0112557fb829fdf
,MODEL_003_001_00,2b8494f1bd1c11e0acbd6d888c43f7c2:TOKEN:1000:4,1
000
2e6381e6bd1c11e08087c929a54bb0fd,32ce84febd1c11e0b0112557fb829fdf
,MODEL_003_001_00,2b8494f1bd1c11e0acbd6d888c43f7c2:TOKEN:1000:4,1
000
2e6381e6bd1c11e08087c929a54bb0fd,34582a87bd1c11e080820167449bc60f
,MODEL_003_001_00,2b8494f1bd1c11e0acbd6d888c43f7c2:TOKEN:778:5,77
8
2e6381e6bd1c11e08087c929a54bb0fd,32b44638bd1c11e0b01c2557fb829fdf
,MODEL_003_001_00,2b8494f1bd1c11e0acbd6d888c43f7c2:TOKEN:1000:1,1
000
2fdc7e3ebd1c11e088b55528b00e8d0e,32b44639bd1c11e0b15b2557fb829fdf
,MODEL_003_001_00,2b8494f1bd1c11e0acbd6d888c43f7c2:TOKEN:0:2,0
2e6381e5bd1c11e0b62cc929a54bb0fd,32b4463abd1c11e0bdaa2557fb829fdf
,MODEL_003_001_00,2b8494f1bd1c11e0acbd6d888c43f7c2:TOKEN:0:3,0
2e6381e4bd1c11e0b9ffc929a54bb0fd,34582a87bd1c11e080820167449bc60f
,MODEL_003_001_00,2b8494f1bd1c11e0acbd6d888c43f7c2:TOKEN:778:5,77
8
2e6381e4bd1c11e0b9ffc929a54bb0fd,32b44638bd1c11e0b01c2557fb829fdf
,MODEL_003_001_00,2b8494f1bd1c11e0acbd6d888c43f7c2:TOKEN:1000:1,1
000
34582a87bd1c11e080820167449bc60f,2e6381e6bd1c11e08087c929a54bb0fd
,MODEL_003_001_00,2b8494f1bd1c11e0acbd6d888c43f7c2:TOKEN:778:5,77
8
2e6381e6bd1c11e08087c929a54bb0fd,32b44639bd1c11e0b15b2557fb829fdf
,MODEL_003_001_00,2b8494f1bd1c11e0acbd6d888c43f7c2:TOKEN:0:2,0
2e6381e5bd1c11e0b62cc929a54bb0fd,32b44638bd1c11e0b01c2557fb829fdf
,MODEL_003_001_00,2b8494f1bd1c11e0acbd6d888c43f7c2:TOKEN:1000:1,1
000
2fdc7e3fbd1c11e0be645528b00e8d0e,32b44638bd1c11e0b01c2557fb829fdf
,MODEL_003_001_00,2b8494f1bd1c11e0acbd6d888c43f7c2:TOKEN:1000:1,1
000
2cf681b8bd1c11e08be85de4f9281135,32b44639bd1c11e0b15b2557fb829fdf
,MODEL_003_001_00,2b8494f1bd1c11e0acbd6d888c43f7c2:TOKEN:0:2,0
2e6381e4bd1c11e0b9ffc929a54bb0fd,32b44639bd1c11e0b15b2557fb829fdf
,MODEL_003_001_00,2b8494f1bd1c11e0acbd6d888c43f7c2:TOKEN:0:2,0
2cf681b8bd1c11e08be85de4f9281135,32b4463abd1c11e0bdaa2557fb829fdf
,MODEL_003_001_00,2b8494f1bd1c11e0acbd6d888c43f7c2:TOKEN:0:3,0
2e6381e4bd1c11e0b9ffc929a54bb0fd,32ce84febd1c11e0b0112557fb829fdf
,MODEL_003_001_00,2b8494f1bd1c11e0acbd6d888c43f7c2:TOKEN:1000:4,1
000
2e6381e2bd1c11e0941dc929a54bb0fd,32ce84febd1c11e0b0112557fb829fdf
,MODEL_003_001_00,2b8494f1bd1c11e0acbd6d888c43f7c2:TOKEN:1000:4,1
000
2fdc7e3dbd1c11e0a22d5528b00e8d0e,32b44639bd1c11e0b15b2557fb829fdf
,MODEL_003_001_00,2b8494f1bd1c11e0acbd6d888c43f7c2:TOKEN:0:2,0
2cf681b8bd1c11e08be85de4f9281135,32b44638bd1c11e0b01c2557fb829fdf
,MODEL_003_001_00,2b8494f1bd1c11e0acbd6d888c43f7c2:TOKEN:1000:1,1
000

In alternate examples, the ICST may store data in a JavaScript Object Notation (“JSON”) format. The stored information may include data regarding the object, such as, but not limited to: commands, attributes, group information, payment information, account information, etc., such as in the example below:

{‘MERCHANT’: {‘TYPEOFTYPES’: [‘MERCHANTS’, ‘SYNTHETICNETWORKS’],
‘FUNCTIONS’: {‘ENTITYCREATION’: ‘putNetwork’}
, ‘UNIQUEATTIBUTES’: [‘MERCHANTNAME’],
‘TOKENENTITIESRELATIONSHIPS’: [ ],‘ATTRIBUTES’: {‘MERCHANT’: (2,
‘STRING’, 0, ‘VALUE’), ‘MERCH_ZIP_CD’: (7, ‘STRING’, 0, ‘VALUE’),
‘MERCH_NAME’: (8, ‘STRING’, 0, ‘VALUE’), ‘MERCHANTNAME’: (3,
‘STRING’, 0, ‘VALUE’), ‘ACQ_CTRY_NUM’: (4, ‘STRING’, 0, ‘VALUE’),
‘ACQ_PCR’: (6, ‘STRING’, 0, ‘VALUE’), ‘ACQ_REGION_NUM’: (5,
‘STRING’, 0, ‘VALUE’), ‘ISACTIVE’: (0, ‘BOOL’, 1, ‘VALUE’),
‘ENTITYKEY’: (1,‘STRING’, 0, ‘VALUE’)}
}
, ‘AFFINITYGROUP’: {‘TYPEOFTYPES’: [‘AFFINITYGROUPS’],
‘FUNCTIONS’: {‘ENTITYCREATION’: ‘putNetwork’}
, ‘UNIQUEATTIBUTES’: [‘AFFINITYGROUPNAME’],
‘TOKENENTITIESRELATIONSHIPS’: [ ], ‘ATTRIBUTES’: {‘XML’: (2,
‘STRING’, 0, ‘VALUE’), ‘DESCRIPTION’: (4, ‘STRING’, 0, ‘VALUE’),
‘ENTITYKEY’: (1, ‘STRING’, 0, ‘VALUE’), ‘TYPEOF’: (5, ‘STRING’,
0, ‘VALUE’), ‘AFFINITYGROUPNAME’: (3, ‘STRING’, 0, ‘VALUE’),
‘ISACTIVE’: (0, ‘BOOL’, 1, ‘VALUE’)}
}
, ‘CASCADINGPAYMENT’: {‘TYPEOFTYPES’: [‘CASCADINGPAYMENT’],
‘FUNCTIONS’: {‘ENTITYCREATION’: ‘putNetwork’}
, ‘UNIQUEATTIBUTES’: [‘CASCADINGPAYMENTNAME’],
‘TOKENENTITIESRELATIONSHIPS’: [‘GROUP’], ‘ATTRIBUTES’: {‘STATUS’:
(2, ‘STRING’, 0, ‘VALUE’), ‘EXPDT’: (6, ‘DATETIME’, 0, ‘VALUE’),
‘GROUP’: (3, ‘STRING’, 0, ‘VALUE’), ‘RESTRICTIONS’: (7, ‘DICT’,
0, ‘VALUE’), ‘CASCADINGPAYMENTNAME’: (4, ‘STRING’, 0, ‘VALUE’),
‘STARTDT’: (5, ‘DATETIME’, 0, ‘VALUE’), ‘ISACTIVE’: (0, ‘BOOL’,
1, ‘VALUE’), ‘ENTITYKEY’: (1, ‘STRING’, 0, ‘VALUE’)}
}
, ‘GROUP’: {‘TYPEOFTYPES’: [ ], ‘FUNCTIONS’: {‘ENTITYCREATION’:
‘putNetwork’}
, ‘UNIQUEATTIBUTES’: [‘GROUPNAME’], ‘TOKENENTITIESRELATIONSHIPS’:
{ }
, ‘ATTRIBUTES’: {‘GROUPNAME’: (2, ‘STRING’, 0, ‘VALUE’),
‘DESCRIPTION’: (2, ‘STRING’, 0, ‘VALUE’), ‘ISACTIVE’: (0, ‘BOOL’,
1, ‘VALUE’), ‘ENTITYKEY’: (1, ‘STRING’, 0, ‘VALUE’)}
}
, ‘USERS’: {‘TYPEOFTYPES’: [ ], ‘FUNCTIONS’: {‘ENTITYCREATION’:
‘putNetwork’}
, ‘UNIQUEATTIBUTES’: [‘USERSID’], ‘TOKENENTITIESRELATIONSHIPS’:
{ }
, ‘ATTRIBUTES’: {‘USERSID’: (2, ‘STRING’, 0, ‘VALUE’),
‘ISACTIVE’: (0, ‘BOOL’, 1, ‘VALUE’), ‘ENTITYKEY’: (1, ‘STRING’,
0, ‘VALUE’)}
}
, ‘TWITTERUSER’: {‘TYPEOFTYPES’: [‘TOKENENTITY’], ‘FUNCTIONS’:
{‘ENTITYCREATION’: ‘putWGTNetwork’}
, ‘UNIQUEATTIBUTES’: [‘USERNAME’], ‘TOKENENTITIESRELATIONSHIPS’:
[‘USER’], ‘ATTRIBUTES’: {‘USERNAME’: (2, ‘STRING’, 0, ‘VALUE’),
‘CITY’: (5, ‘STRING’, 0, ‘VALUE’), ‘ENTITYKEY’: (1, ‘STRING’, 0,
‘VALUE’), ‘USERLINK’: (6, ‘STRING’, 0, ‘VALUE’), ‘FULLNAME ’: (4,
‘STRING’, 0, ‘VALUE’), ‘USERTAG’: (3, ‘STRING’, 0, ‘VALUE’),
‘ISACTIVE’: (0, ‘BOOL’, 1, ‘VALUE’)}
}
, ‘COUPON’: {‘TYPEOFTYPES’: [‘COUPON’], ‘FUNCTIONS’:
{‘ENTITYCREATION’: ‘putNetwork’}
, ‘UNIQUEATTIBUTES’: [‘COUPONNAME’],
‘TOKENENTITIESRELATIONSHIPS’: [‘MERCHANT’], ‘ATTRIBUTES’:
{‘STATUS’: (2, ‘STRING’, 0, ‘VALUE’), ‘MERCHANT’: (3, ‘STRING’,
0, ‘VALUE’), ‘TITLE’: (5, ‘STRING’, 0, ‘VALUE’), ‘NOTES’: (7,
‘STRING’, 0, ‘VALUE’), ‘UPDATEDBY’: (11, ‘STRING’, 0, ‘VALUE’),
‘ENTITYKEY’: (1, ‘STRING’, 0, ‘VALUE’), ‘DECRIPTION ’: (6,
‘STRING’, 0, ‘VALUE’), ‘CREATEDBY’: (10, ‘STRING’, 0, ‘VALUE’)
, ‘LASTUPDATEDT’: (9, ‘DATETIME’, 0, ‘VALUE’), ‘EXPDT’: (13,
‘DATETIME’, 0, ‘VALUE’), ‘RESTRICTIONS’: (14, ‘DICT’, 0,
‘VALUE’), ‘COUPONNAME ’: (4, ‘STRING’, 0, ‘VALUE’), ‘CREATIONDT’:
(8, ‘DATETIME’, 0, ‘VALUE’), ‘STARTDT’: (12, ‘DATETIME’, 0,
‘VALUE’), ‘ISACTIVE’: (0, ‘BOOL’, 1, ‘VALUE’)}
}
, ‘MEMBERSHIP’: {‘TYPEOFTYPES ’: [‘MEMBERSHIPS’], ‘FUNCTIONS’:
{‘ENTITYCREATION’: ‘putNetwork’}
, ‘UNIQUEATTIBUTES’: [‘MEMBERSHIPNAME’],
‘TOKENENTITIESRELATIONSHIPS’: [‘MERCHANT’], ‘ATTRIBUTES’:
{‘STATUS’: (2, ‘STRING’, 0, ‘VALUE’), ‘MERCHANT’: (3, ‘STRING’,
0, ‘VALUE’), ‘RESTRICTIONS’: (7, ‘DICT’, 0, ‘VALUE’),
‘MEMBERSHIPNAME’: (4, ‘STRING’, 0, ‘VALUE’), ‘STARTDT’: (5,
‘DATETIME’, 0, ‘VALUE’), ‘EXPDT ’: (6, ‘DATETIME’, 0, ‘VALUE’),
‘ISACTIVE’: (0, ‘BOOL’, 1, ‘VALUE’), ‘ENTITYKEY’: (1, ‘STRING’,
0, ‘VALUE’)}
}
, ‘USERSECURITY’: {‘TYPEOFTYPES’: [‘SECURITY’], ‘FUNCTIONS’:
{‘ENTITYCREATION’: ‘putNetwork’}
, ‘UNIQUEATTIBUTES’: [‘USERSECURITYNAME’],
‘TOKENENTITIESRELATIONSHIPS’: [‘USER’], ‘ATTRIBUTES’: {‘STATUS’:
(2, ‘STRING’, 0, ‘VALUE’), ‘EXPDT’: (6, ‘DATETIME’, 0, ‘VALUE’),
‘USERSECURITYNAME’: (4, ‘STRING’, 0, ‘VALUE’), ‘USER’: (3,
‘STRING’, 0, ‘VALUE’), ‘RESTRICTIONS’: (7, ‘DICT’, 0, ‘VALUE’),
‘STARTDT’: (5, ‘DATETIME’, 0, ‘VALUE’), ‘ISACTIVE’: (0, ‘BOOL’,
1, ‘VALUE’), ‘ENTITYKEY’: (1, ‘STRING’, 0, ‘VALUE’)}
}
, ‘MCC’: {‘TYPEOFTYPES’: [‘MCC’], ‘FUNCTIONS’: {‘ENTITYCREATION’:
‘putWGTNetwork’}
, ‘UNIQUEATTIBUTES’: [‘MCCNAME’, ‘MCC’],
‘TOKENENTITIESRELATIONSHIPS’: [‘MCCSEG’], ‘ATTRIBUTES’:
{‘MCCSEG’: (4, ‘STRING’, 0, ‘VALUE’), ‘MCC’: (2, ‘STRING’, 0,
‘VALUE’), ‘MCCNAME’: (3, ‘STRING’, 0, ‘VALUE’), ‘ISACTIVE’: (0,
‘BOOL’, 1, ‘VALUE’), ‘ENTITYKEY’: (1, ‘STRING’, 0, ‘VALUE’)}
}
, ‘ZIPCODE’: {‘TYPEOFTYPES’: [‘LOCATION’], ‘FUNCTIONS’:
{‘ENTITYCREATION’: ‘putNetwork’}
, ‘UNIQUEATTIBUTES’: [‘ZIPCODE’], ‘TOKENENTITIESRELATIONSHIPS’:
[ ], ‘ATTRIBUTES’: {‘STATE’: (4, ‘STRING’, 0, ‘VALUE’),
‘POPULATION’: (3, ‘STRING’, 0, ‘VALUE’), ‘ZIPCODE’: (2, ‘STRING’,
0, ‘VALUE’), ‘ISACTIVE’: (0, ‘BOOL’, 1, ‘VALUE’), ‘ENTITYKEY’:
(1, ‘STRING’, 0, ‘VALUE’)}
}
, ‘PAYMENTCARD’: {‘TYPEOFTYPES’: [‘PAYMENTCARDS’], ‘FUNCTIONS’:
{‘ENTITYCREATION’: ‘putNetwork’}
, ‘UNIQUEATTIBUTES’: [‘CARDNUMBER’],
‘TOKENENTITIESRELATIONSHIPS’: [‘USER’], ‘ATTRIBUTES’: {‘EXPDATE’:
(5, ‘DATETIME’, 0, ‘VALUE’), ‘ENTITYKEY’: (1, ‘STRING’, 0,
‘VALUE’), ‘CARDTYPE’: (4, ‘STRING’, 0, ‘VALUE’), ‘CARDNUMBER’:
(2, ‘STRING’, 0, ‘VALUE’), ‘USER’: (3, ‘STRING’, 0, ‘VALUE’),
‘ISACTIVE’: (0, ‘BOOL’, 1, ‘VALUE’)}
}
, ‘GENERICTOKEN’: {‘TYPEOFTYPES’: [‘COUPON’], ‘FUNCTIONS’:
{‘ENTITYCREATION’: ‘putNetwork’}
, ‘UNIQUEATTIBUTES’: [‘GENERICTOKENNAME’],
‘TOKENENTITIESRELATIONSHIPS’: [‘MERCHANT’], ‘ATTRIBUTES’:
{‘STATUS’: (2, ‘STRING’, 0, ‘VALUE’), ‘MERCHANT’: (3, ‘STRING’,
0, ‘VALUE’), ‘TITLE’: (5, ‘STRING’, 0, ‘VALUE’), ‘NOTES’: (7,
‘STRING’, 0, ‘VALUE’), ‘UPDATEDBY’: (11, ‘STRING’, 0, ‘VALUE’),
‘ENTITYKEY’: (1, ‘STRING’, 0, ‘VALUE’), ‘DECRIPTION ’: (6,
‘STRING’, 0, ‘VALUE’), ‘CREATEDBY’: (10, ‘STRING’, 0, ‘VALUE’),
‘LASTUPDATEDT’: (9, ‘DATETIME’, 0, ‘VALUE’), ‘EXPDT ’: (13,
‘DATETIME’, 0, ‘VALUE’), ‘RESTRICTIONS’: (14, ‘DICT’, 0,
‘VALUE’), ‘STARTDT’: (12, ‘DATETIME’, 0, ‘VALUE’), ‘CREATIONDT’:
(8, ‘DATETIME’, 0, ‘VALUE’), ‘GENERICTOKENNAME’: (4, ‘STRING’, 0,
‘VALUE’), ‘ISACTIVE’: (0, ‘BOOL’, 1, ‘VALUE’)}
}
, ‘USER’: {‘TYPEOFTYPES’: [‘USERS’, ‘SYNTHETICNETWORKS’],
‘FUNCTIONS’: {‘ENTITYCREATION’: ‘putNetwork’}
, ‘UNIQUEATTIBUTES’: [‘USERNAME’], ‘TOKENENTITIESRELATIONSHIPS’:
[‘USERS’], ‘ATTRIBUTES’: {‘USERNAME’: (5, ‘STRING’, 0, ‘VALUE’),
‘USERS’: (2, ‘STRING’, 0, ‘VALUE’), ‘FIRSTNAME’: (3, ‘STRING’, 0,
‘VALUE’), ‘LASTNAME’: (4, ‘STRING’, 0, ‘VALUE’), ‘ENTITYKEY’: (1,
‘STRING’, 0, ‘VALUE’), ‘ISACTIVE’: (0, ‘BOOL’, 1, ‘VALUE’)}
}
, ‘TWEETS’: {‘TYPEOFTYPES’: [‘TOKENENTITY’], ‘FUNCTIONS’:
{‘ENTITYCREATION’: ‘putWGTNetwork’}
, ‘UNIQUEATTIBUTES’: [‘TWEETID’], ‘TOKENENTITIESRELATIONSHIPS’:
[‘TWITTERUSER’], ‘ATTRIBUTES’: {‘Title’: (4, ‘STRING’, 0,
‘VALUE’), ‘RawTweet’: (5, ‘STRING’, 0, ‘VALUE’), ‘DATETIME’: (3,
‘STRING’, 0, ‘VALUE’), ‘CLEANEDTWEET’: (6, ‘STRING’, 0, ‘VALUE’),
‘ENTITYKEY’: (1, ‘STRING’, 0, ‘VALUE’), ‘TWEETID’: (2, ‘STRING’,
0, ‘VALUE’), ‘ISACTIVE’: (0, ‘BOOL’, 1, ‘VALUE’)}
}
, ‘MODEL’: {‘TYPEOFTYPES’: [‘MODELS’], ‘FUNCTIONS’:
{‘ENTITYCREATION’: ‘putNetwork’}
, ‘UNIQUEATTIBUTES’: [‘MODELNAME’], ‘TOKENENTITIESRELATIONSHIPS’:
[‘USER’, ‘MERCHANT’, ‘PAYMENTCARD’], ‘ATTRIBUTES’: {‘XML’: (2,
‘STRING’, 0, ‘VALUE’), ‘MODELNAME’: (3, ‘STRING’, 0, ‘VALUE’),
‘DESCRIPTION’: (4, ‘STRING’, 0, ‘VALUE’), ‘ENTITYKEY’: (1,
‘STRING’, 0, ‘VALUE’), ‘TYPEOF ’: (5, ‘STRING’, 0, ‘VALUE’),
‘ISACTIVE’: (0, ‘BOOL’, 1, ‘VALUE’)}
}
, ‘MCCSEG’: {‘TYPEOFTYPES’: [‘MCCSEG’], ‘FUNCTIONS’:
{‘ENTITYCREATION’: ‘putWGTNetwork’}
, ‘UNIQUEATTIBUTES’: [‘MCCSEGID’], ‘TOKENENTITIESRELATIONSHIPS’:
{ }
, ‘ATTRIBUTES’: {‘MCCSEGID’: (2, ‘STRING’, 0, ‘VALUE’),
‘MCCSEGNAME’: (3, ‘STRING’, 0, ‘VALUE’), ‘ISACTIVE’: (0, ‘BOOL’,
1, ‘VALUE’), ‘ENTITYKEY’: (1, ‘STRING’, 0, ‘VALUE’)}
}
, ‘TOKENENTITY’: {‘TYPEOFTYPES’: [‘TOKENENTITY’], ‘FUNCTIONS’:
{‘ENTITYCREATION’: ‘putWGTNetwork’}
, ‘UNIQUEATTIBUTES’: [‘TOKENENTITYKEY’],
‘TOKENENTITIESRELATIONSHIPS’: { }
, ‘ATTRIBUTES’: {‘STATUS’: (4, ‘STRING’, 0, ‘VALUE’),
‘ISSUEDDATE’: (5, ‘STRING’, 0, ‘VALUE’), ‘DOUBLELINKED’: (8,
‘BOOL’, 1, ‘VALUE’), ‘BASEUUID’: (1, ‘STRING’, 0, ‘VALUE’),
‘WEIGHT’: (6, ‘STRING’, 0, ‘VALUE’), ‘BASETYPE’: (3, ‘STRING’, 0,
‘VALUE’), ‘CATEGORY’: (7, ‘STRING’, 0, ‘VALUE’), ‘ISACTIVE’: (0,
‘BOOL’, 1, ‘VALUE’), ‘TOKENENTITYKEY’: (2, ‘STRING’, 0, ‘VALUE’)}
}
}

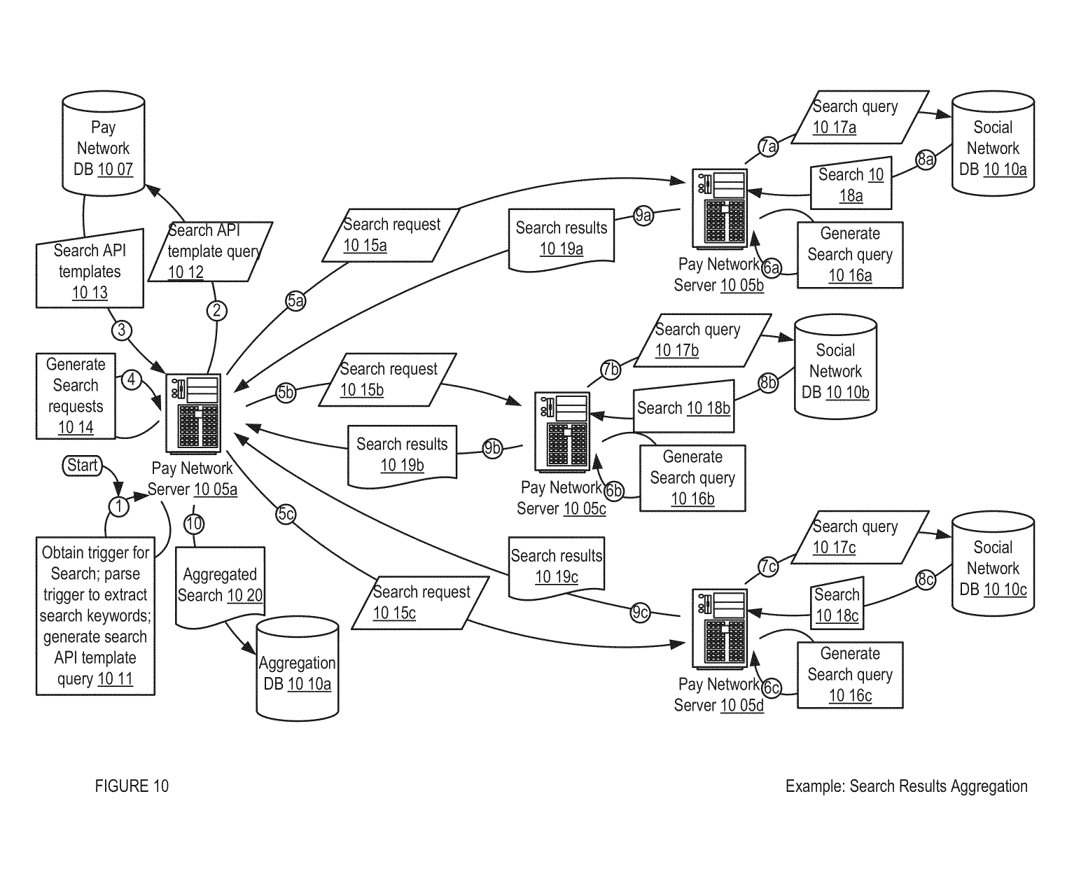

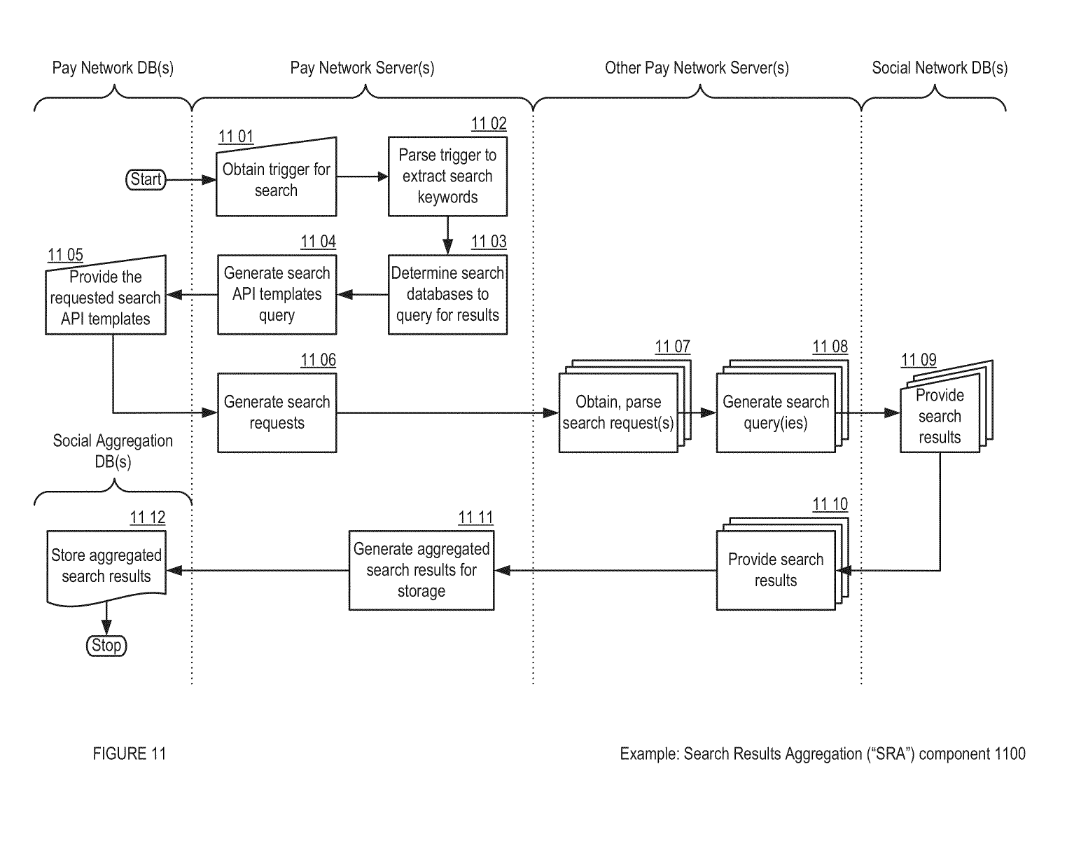

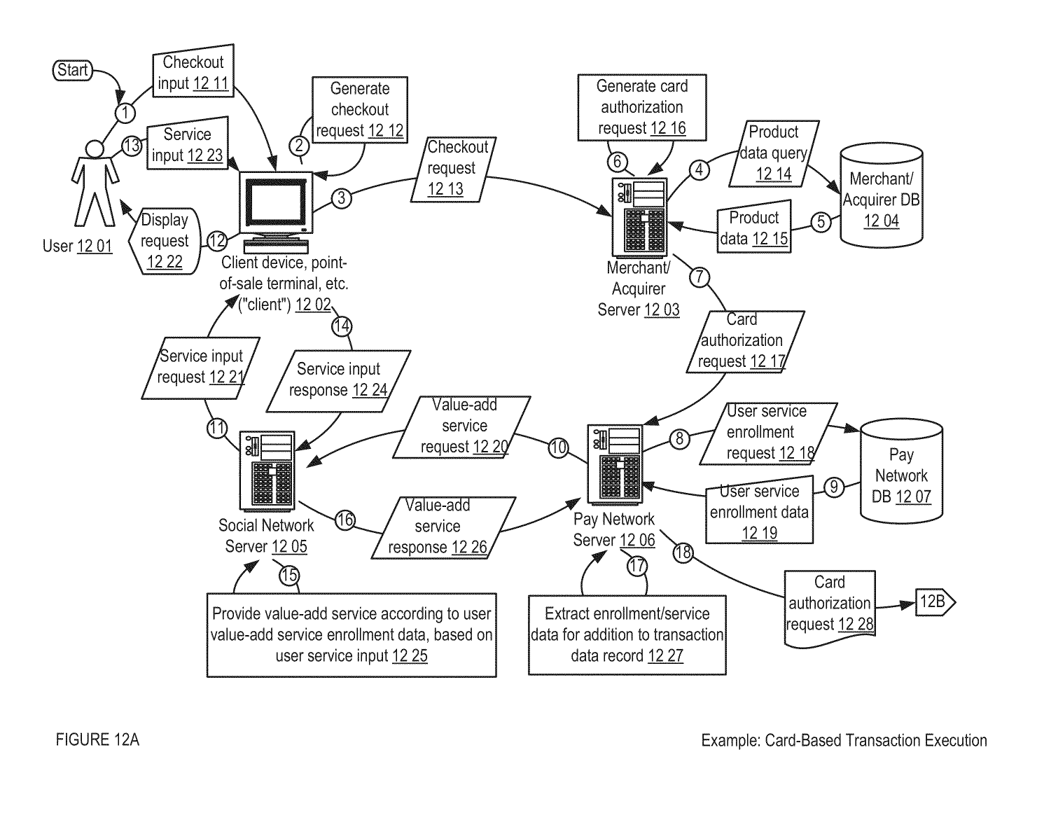

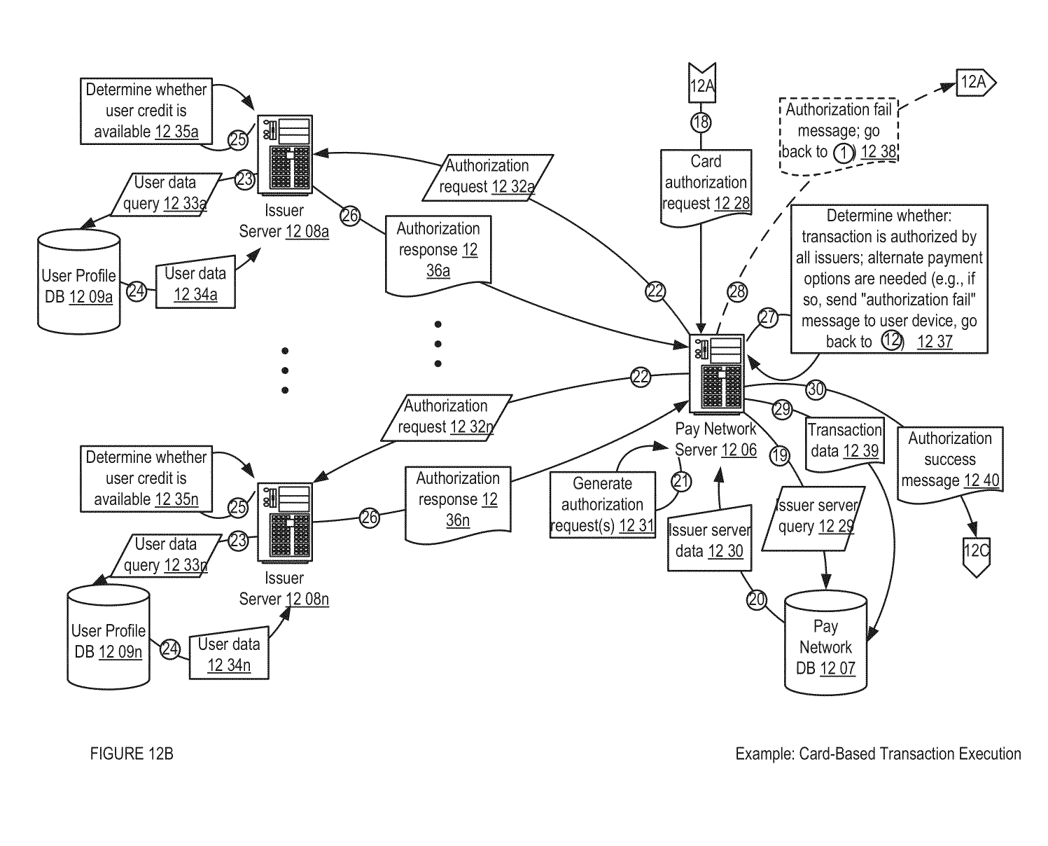

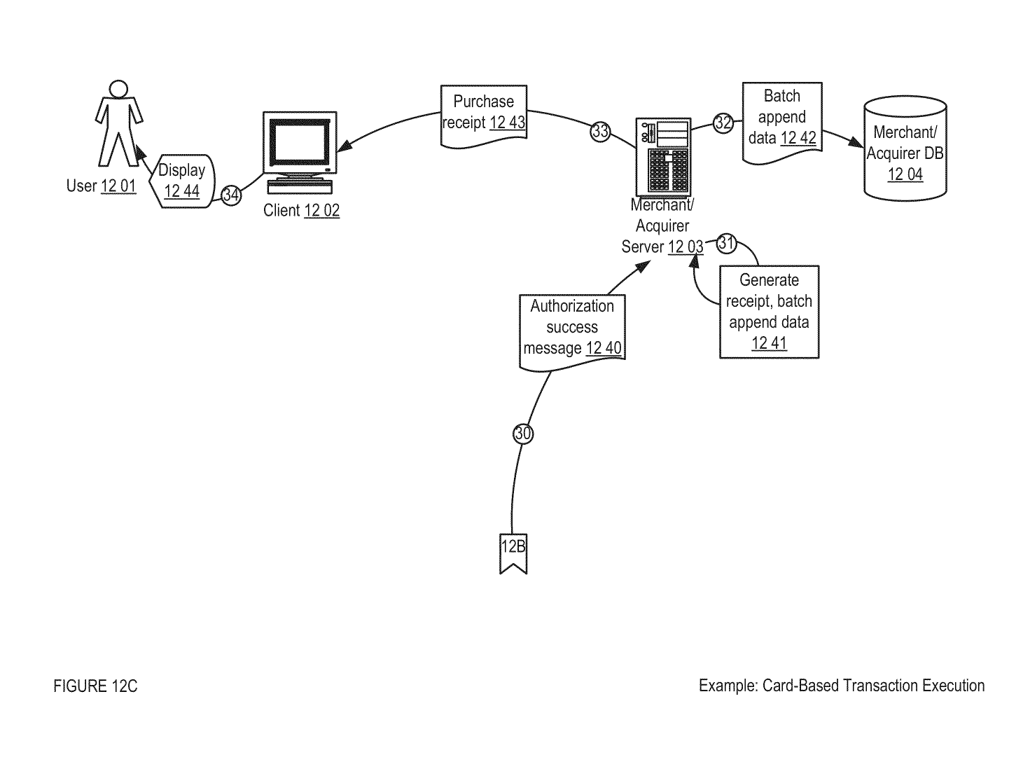

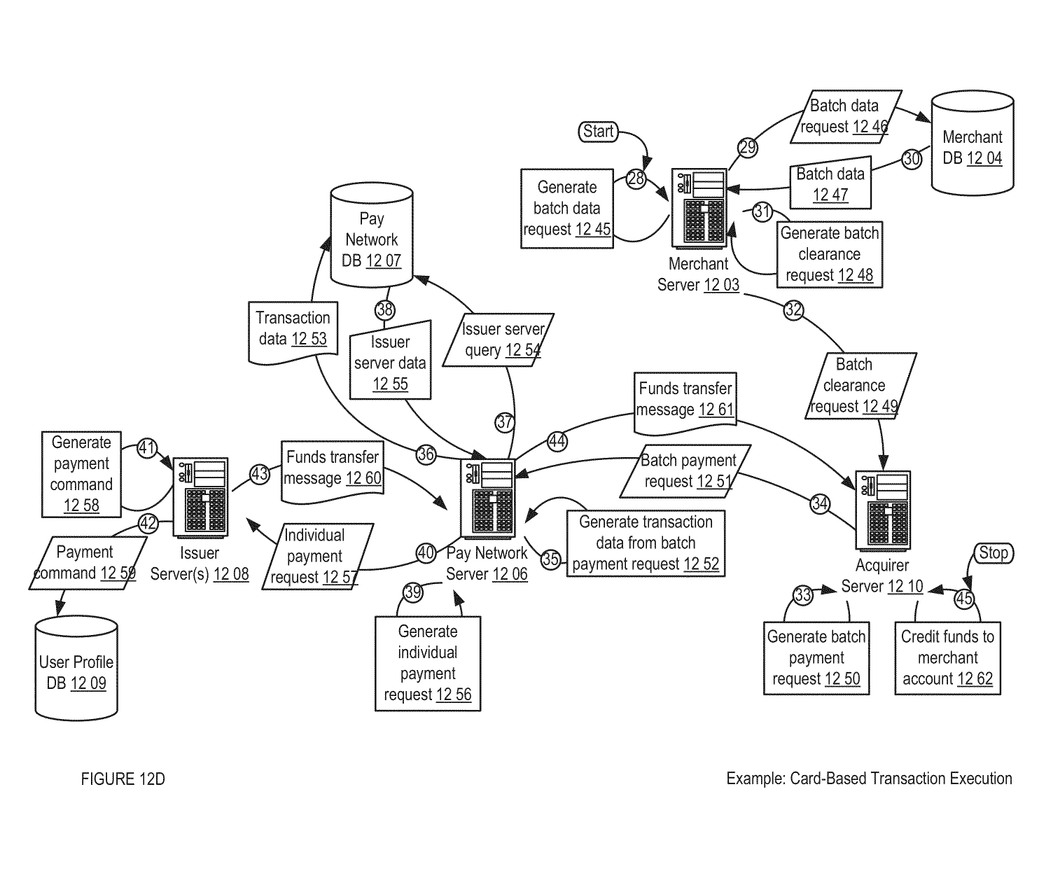

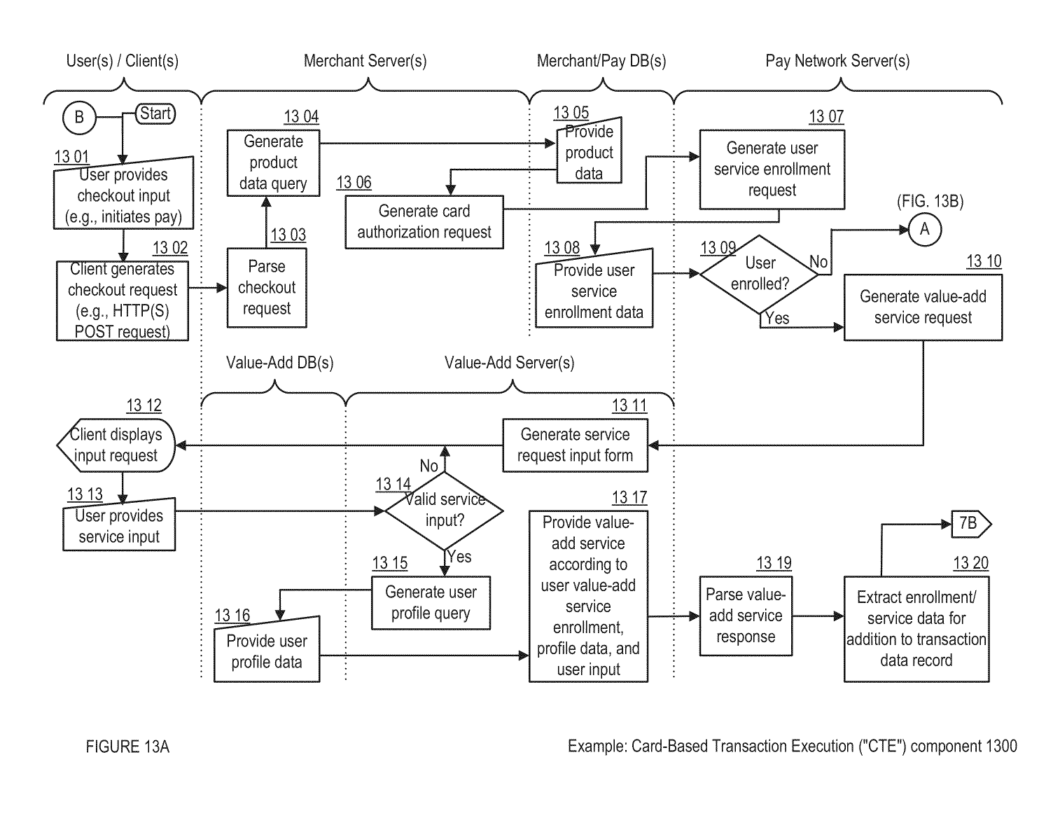

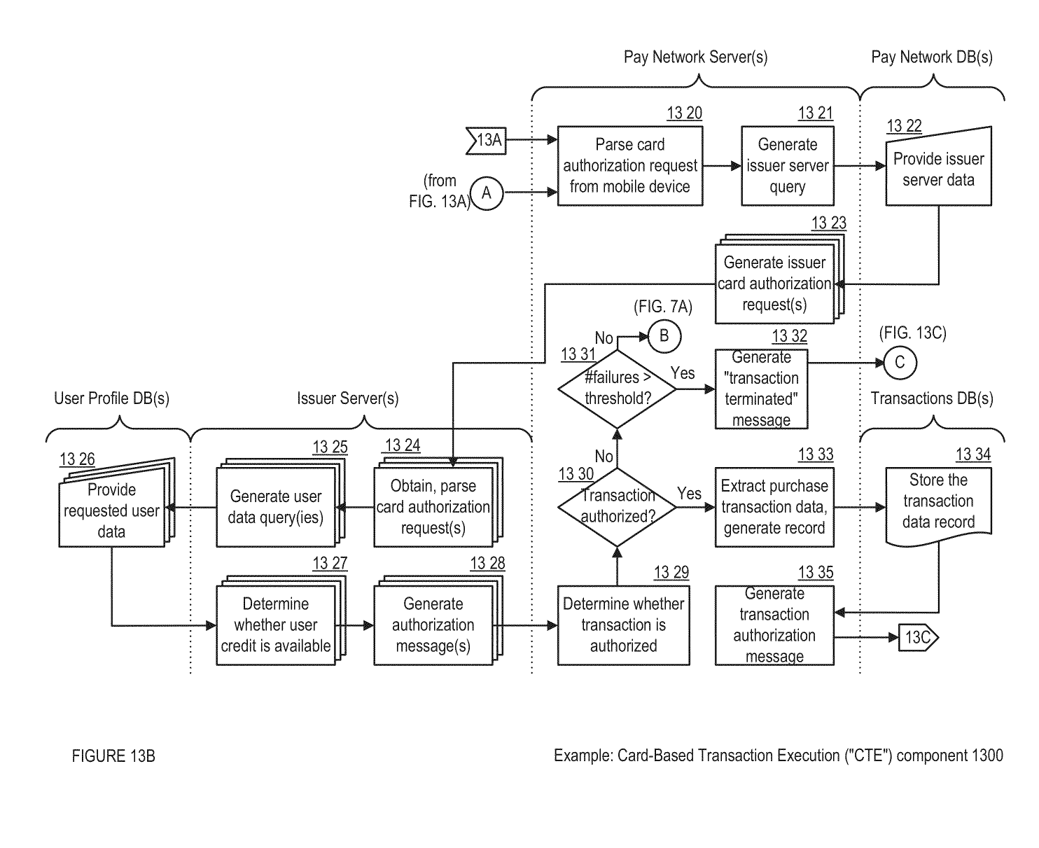

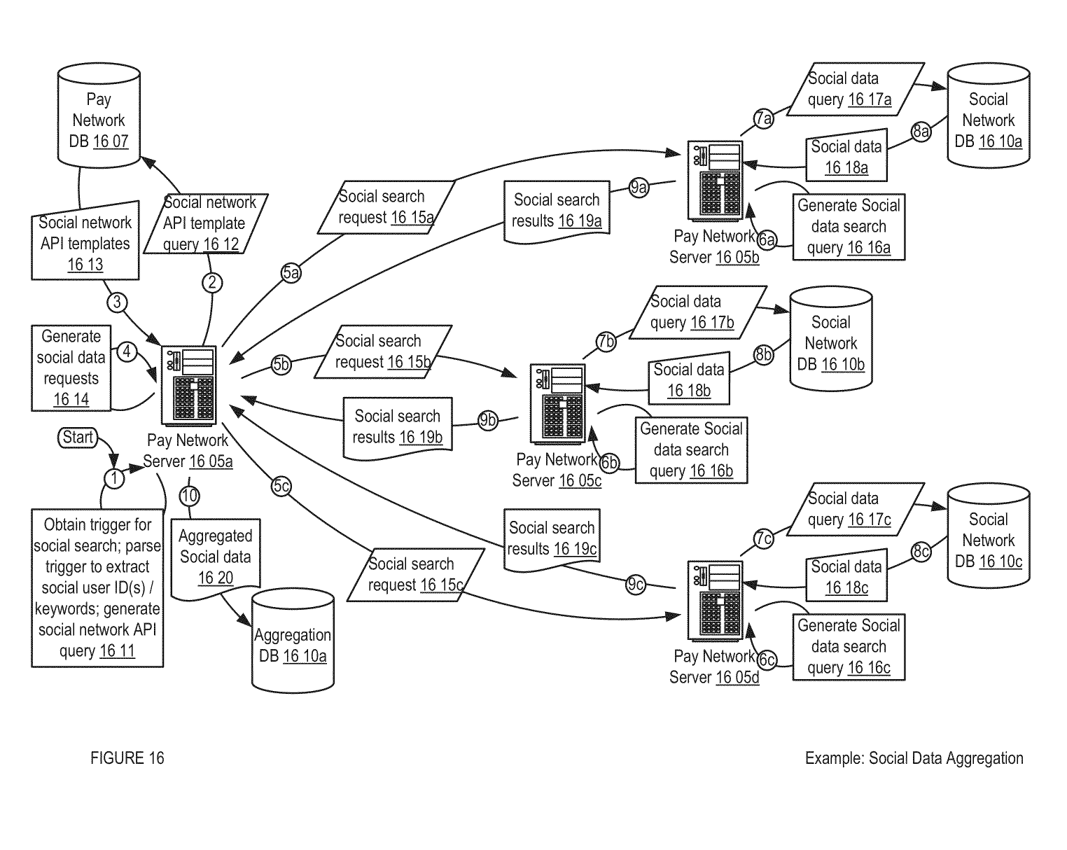

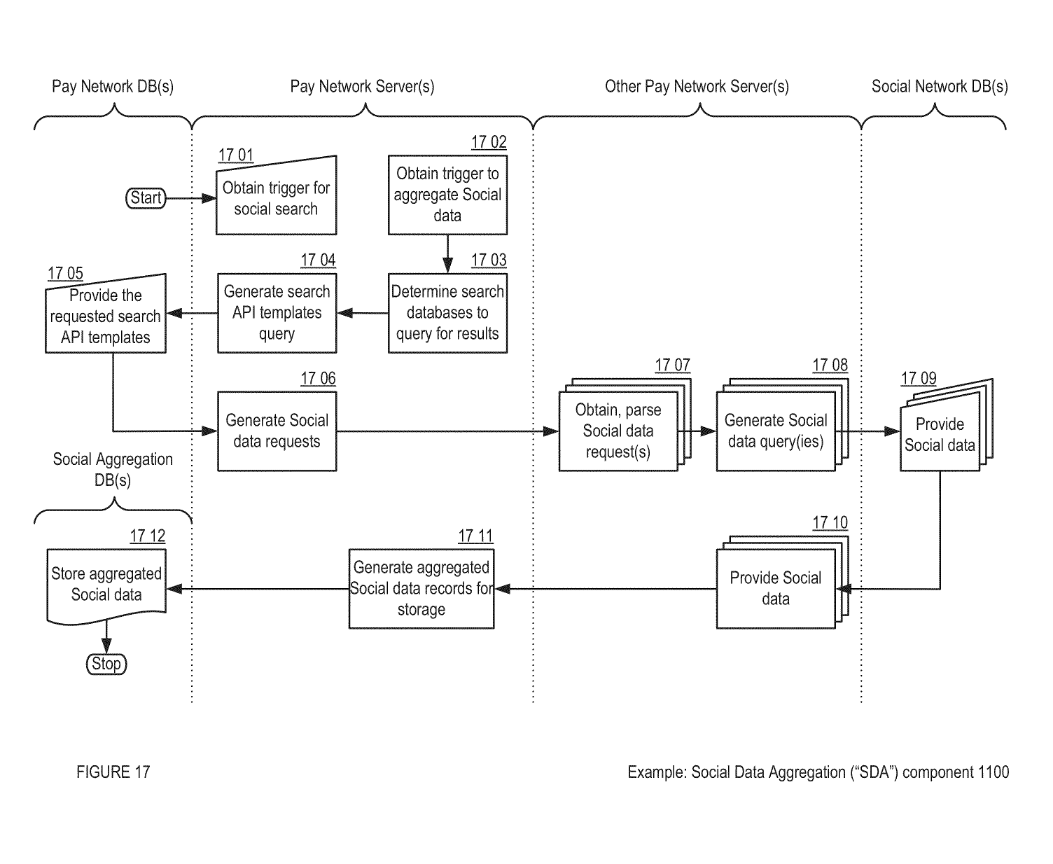

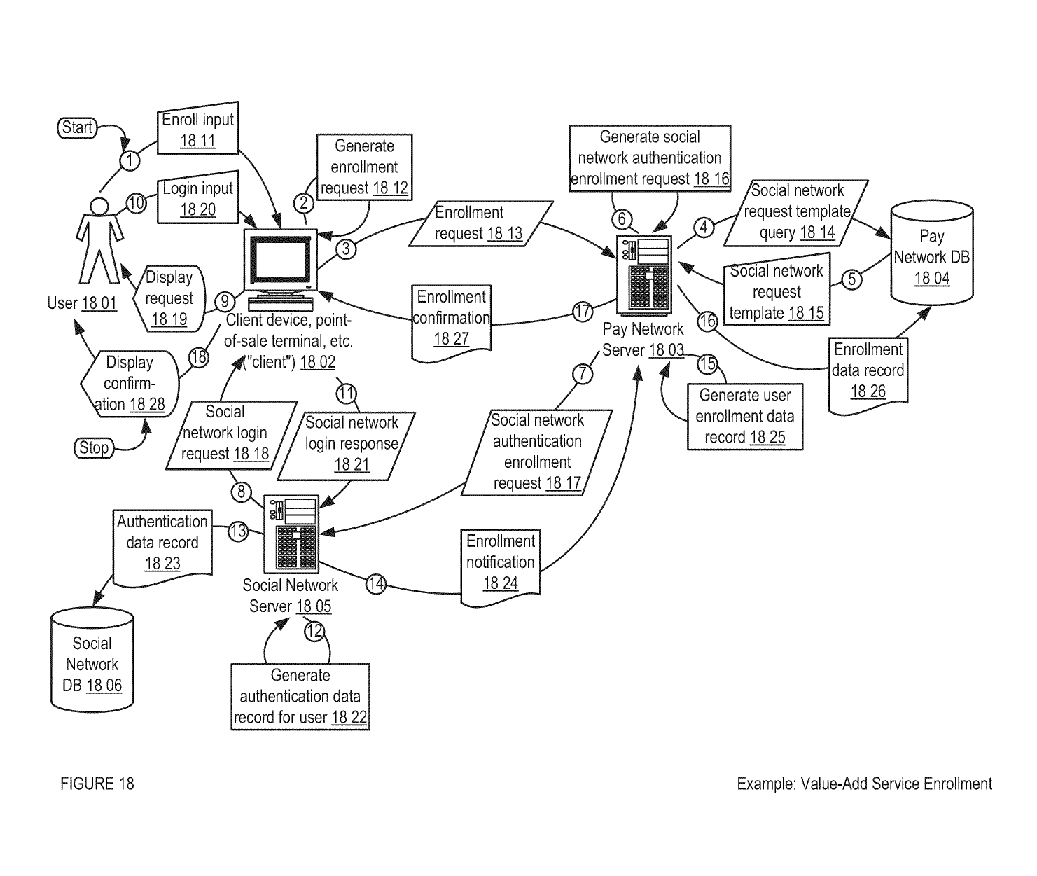

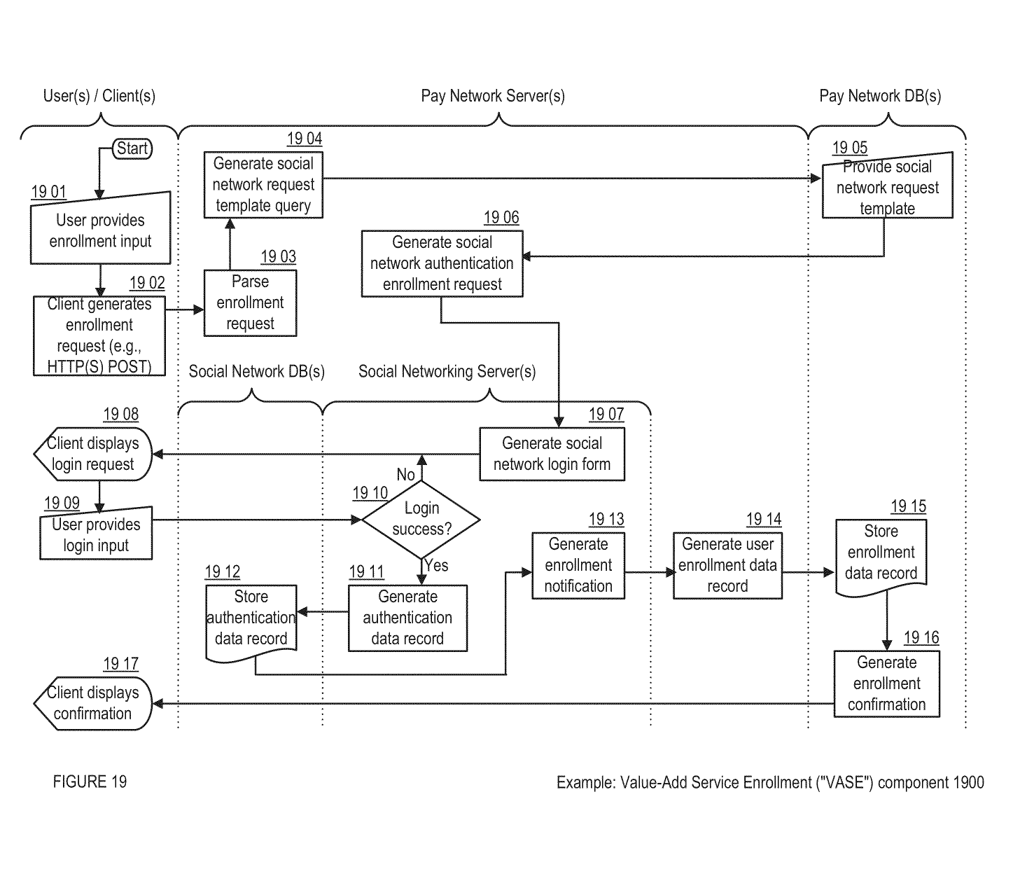

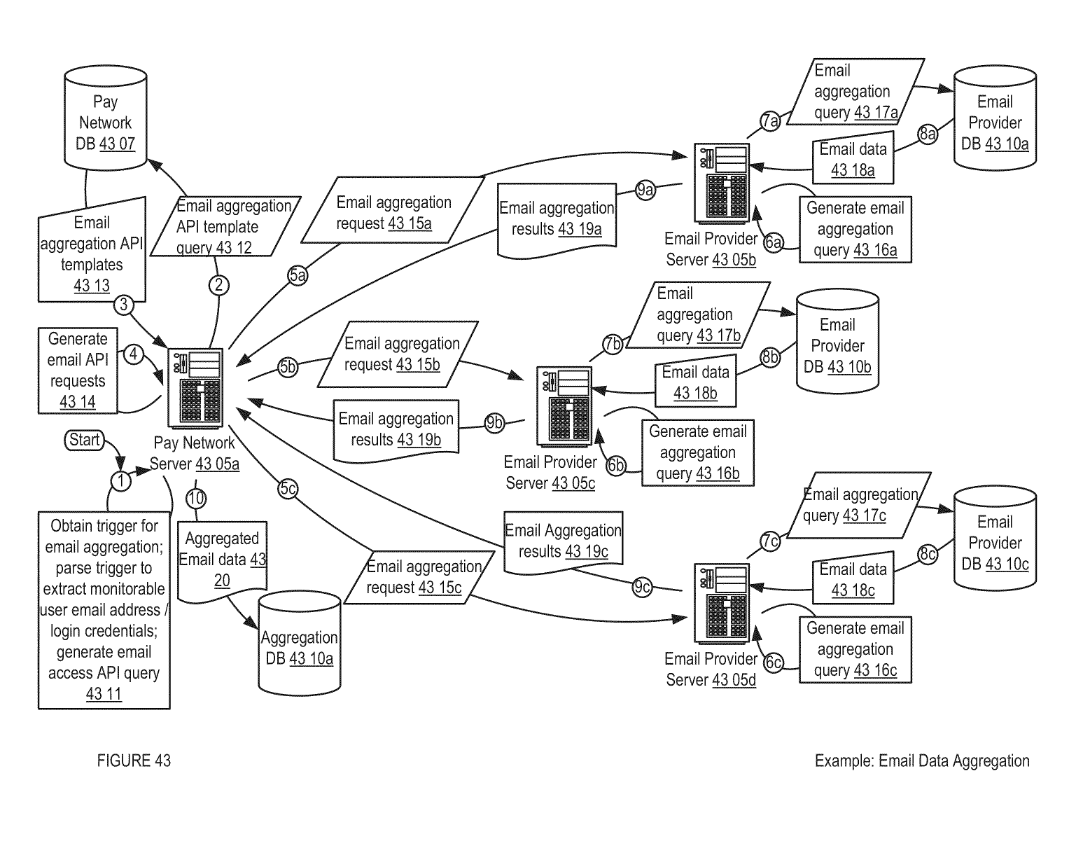

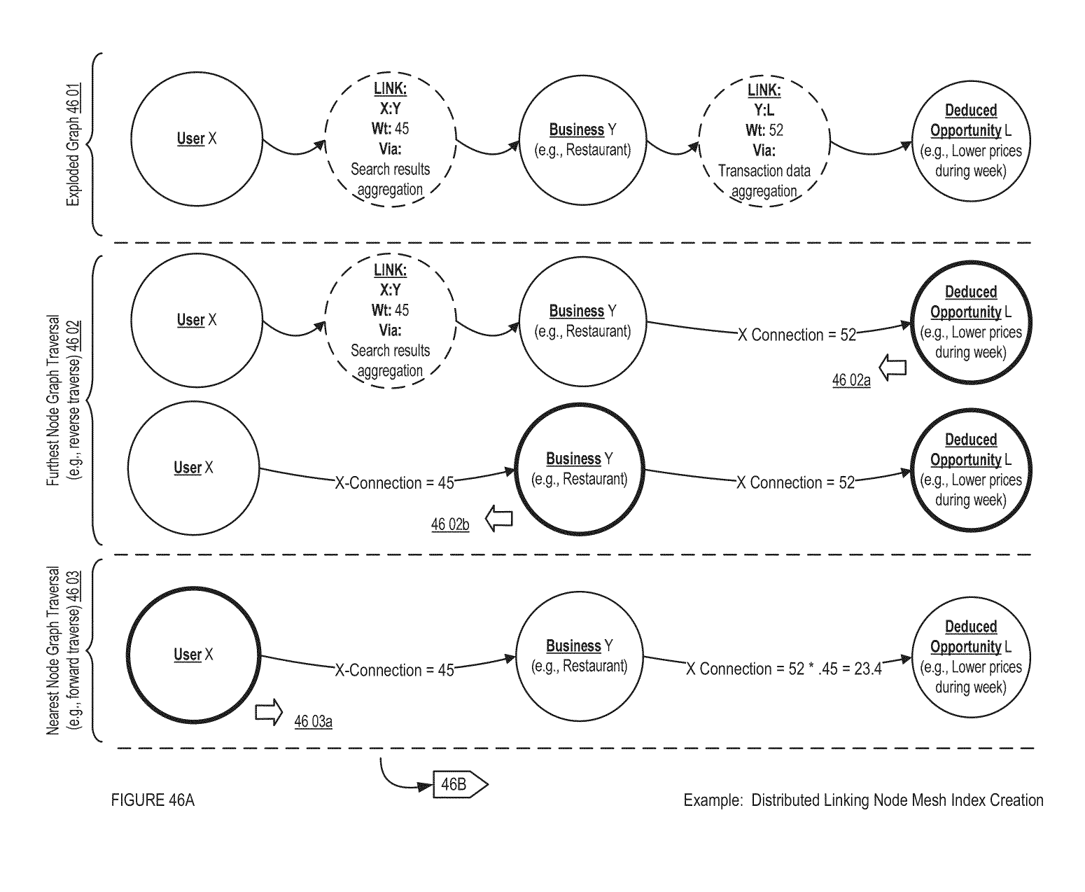

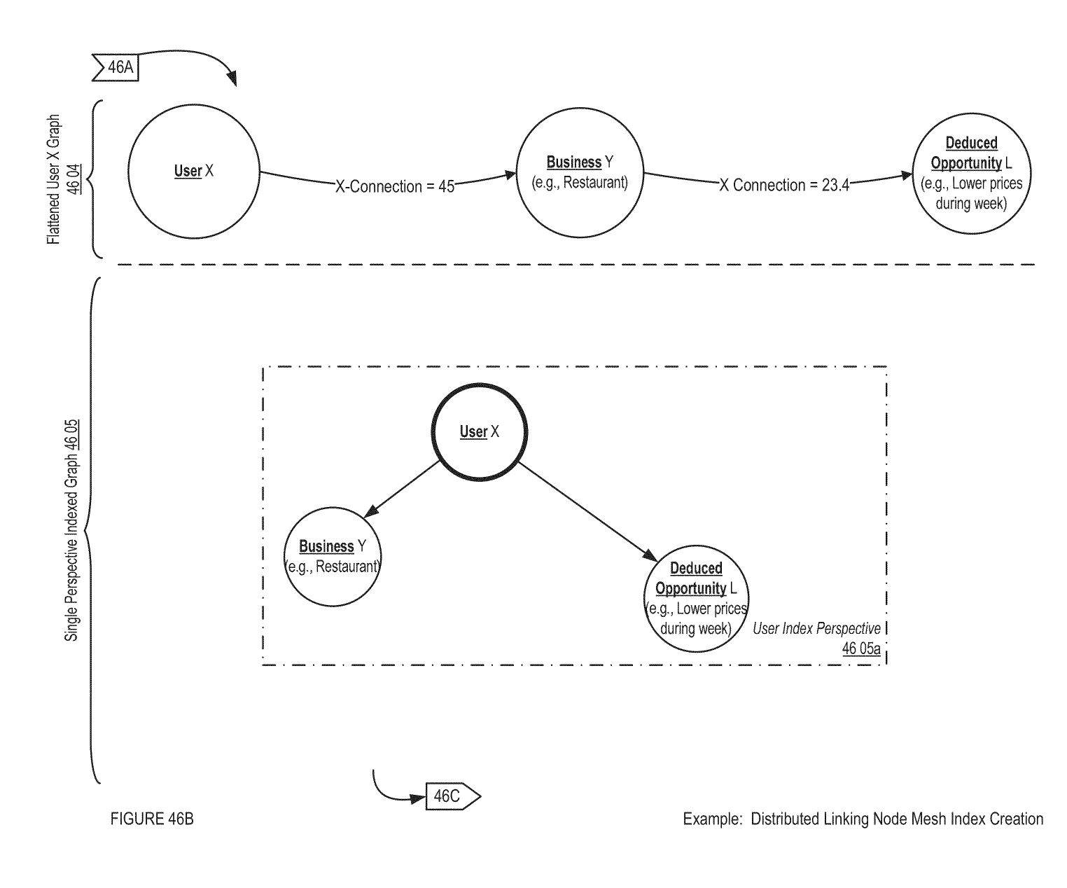

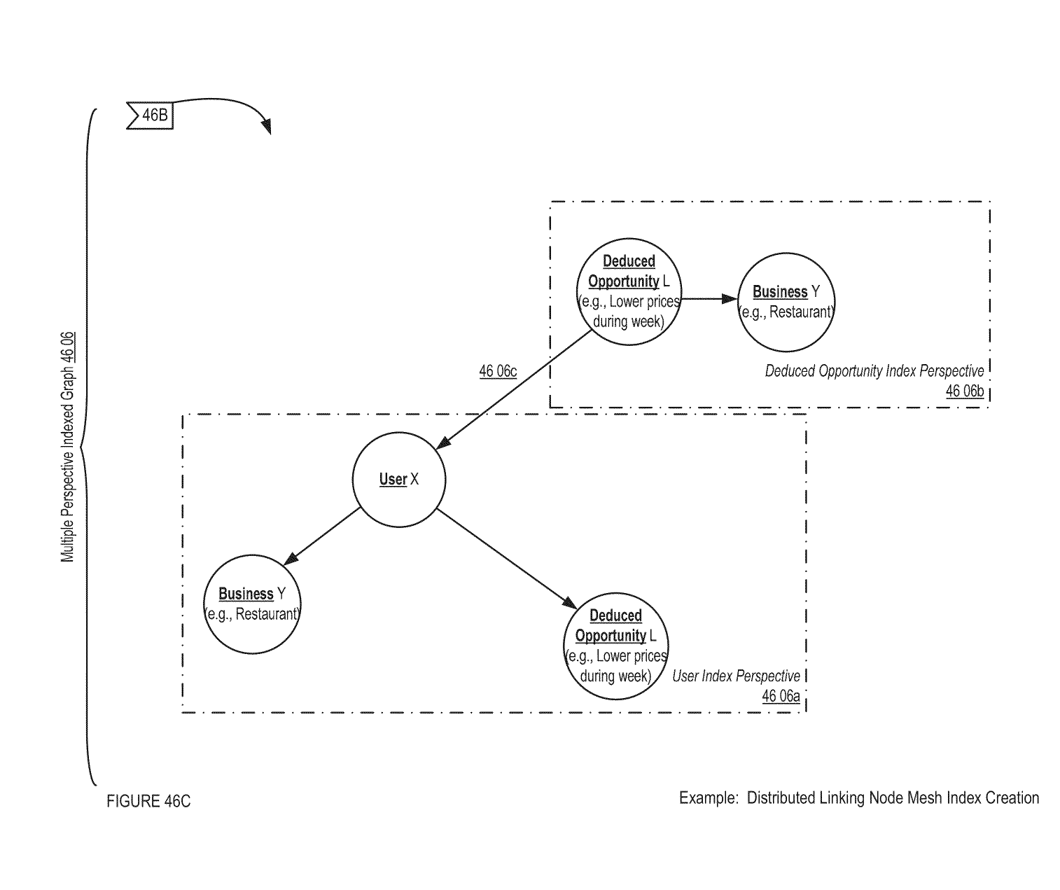

FIG. 9 shows a block diagram illustrating example ICST component configurations in some embodiments of the ICST. In some embodiments, the ICST may aggregate data from a variety of sources to generate centralized personal information. The may also aggregate various types of data in order to generate the centralized personal information. For example, the ICST may utilize search results aggregation component(s) 901 (e.g., such as described in FIGS. 10-11) to aggregate search results from across a wide range of computer networked systems, e.g., the Internet. As another example, the ICST may utilize transaction data aggregation component(s) 902 (e.g., such as described in FIGS. 12-15) to aggregate transaction data, e.g., from transaction processing procedure by a payment network. As another example, the ICST may utilize service usage data aggregation component(s) 903 (e.g., such as described in FIGS. 12-15) to aggregate data on user's usage of various services associated with the ICST. As another example, the ICST may utilize enrollment data component(s) 904 (e.g., such as described in FIGS. 18-19) to aggregate data on user's enrollment into various services associated with the ICST. As another example, the ICST may utilize email data component(s) 905a (e.g., such as described in FIG. 43) to aggregate data regarding the user's email correspondence history into various services associated with the ICST. As another example, the ICST may utilize social data aggregation component(s) 905 (e.g., such as described in FIGS. 16-17) to aggregate data on user's usage of various social networking services accessible by the ICST. In one embodiment, the aggregated data may be used to generate dictionary entries. Further detail regarding the generation of dictionary entries may be found throughout this specification, drawings, and claims and particularly with reference to FIG. 1 and FIG. 46.

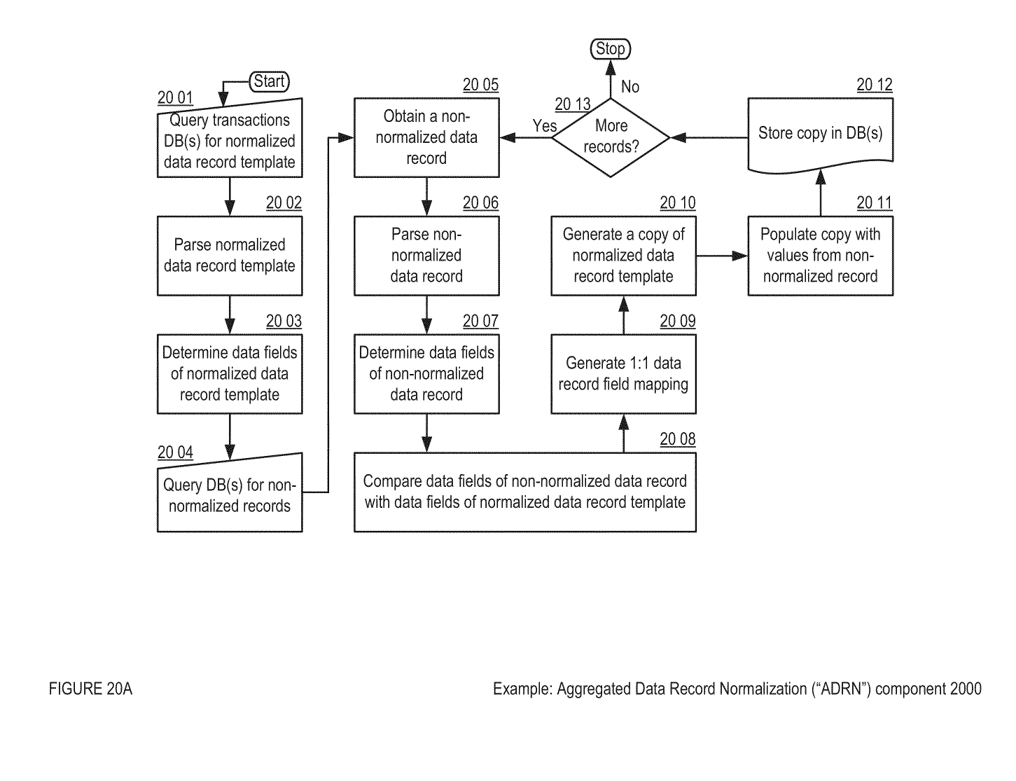

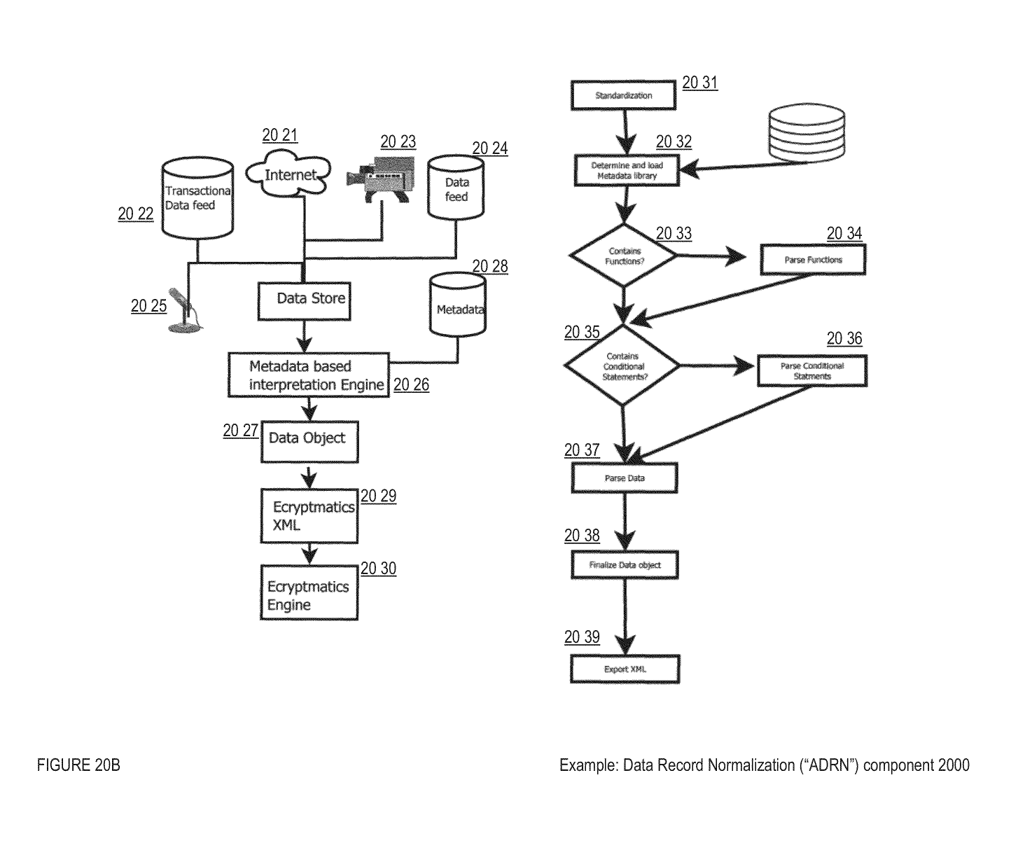

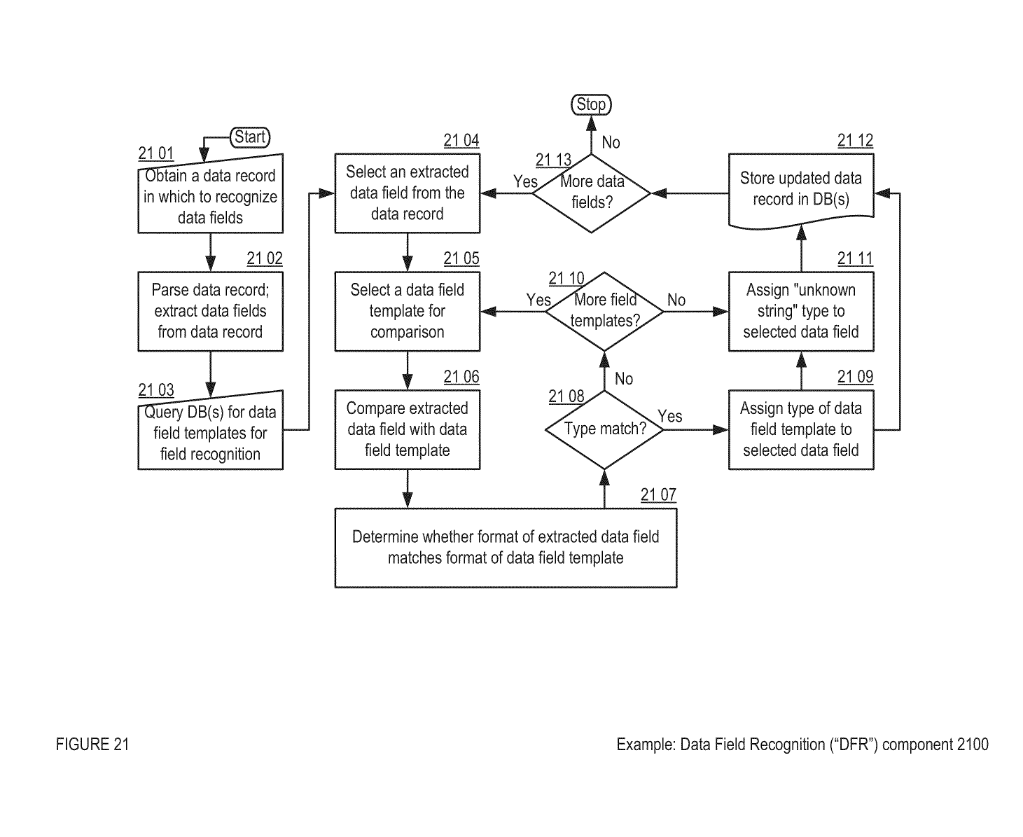

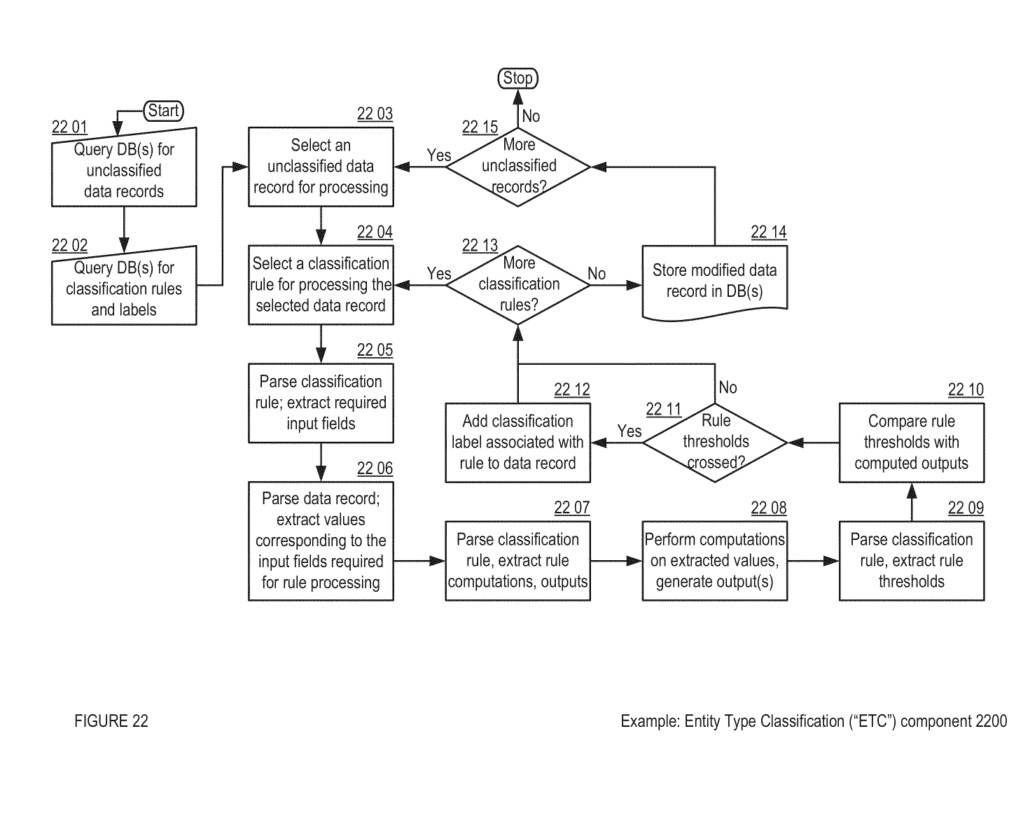

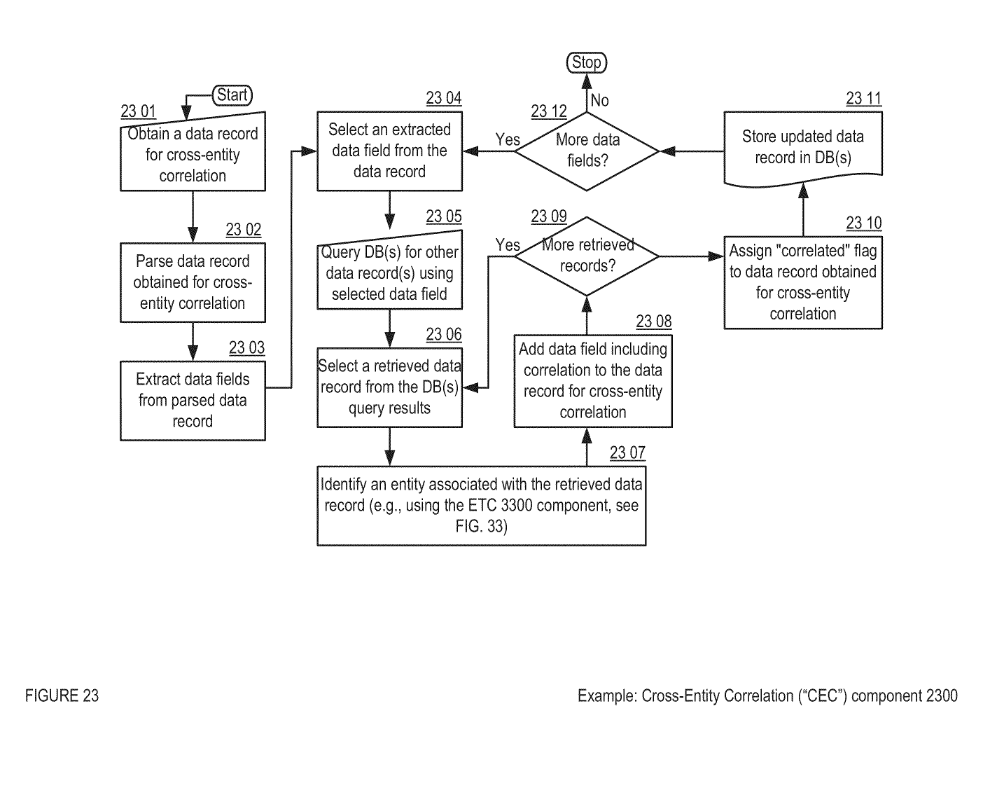

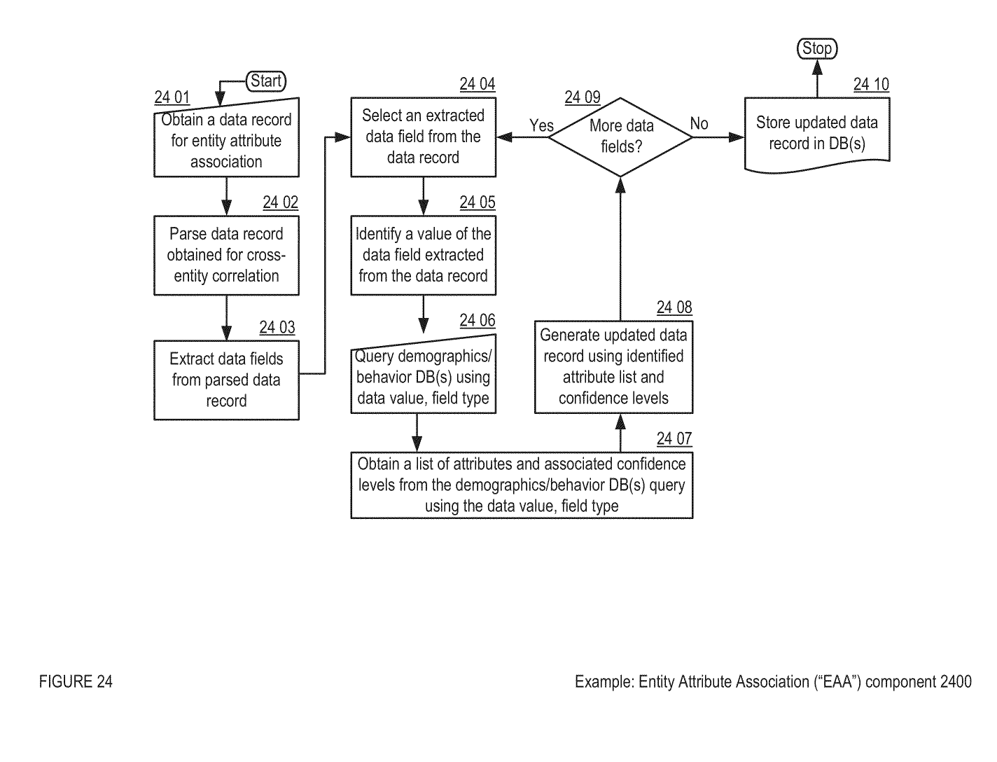

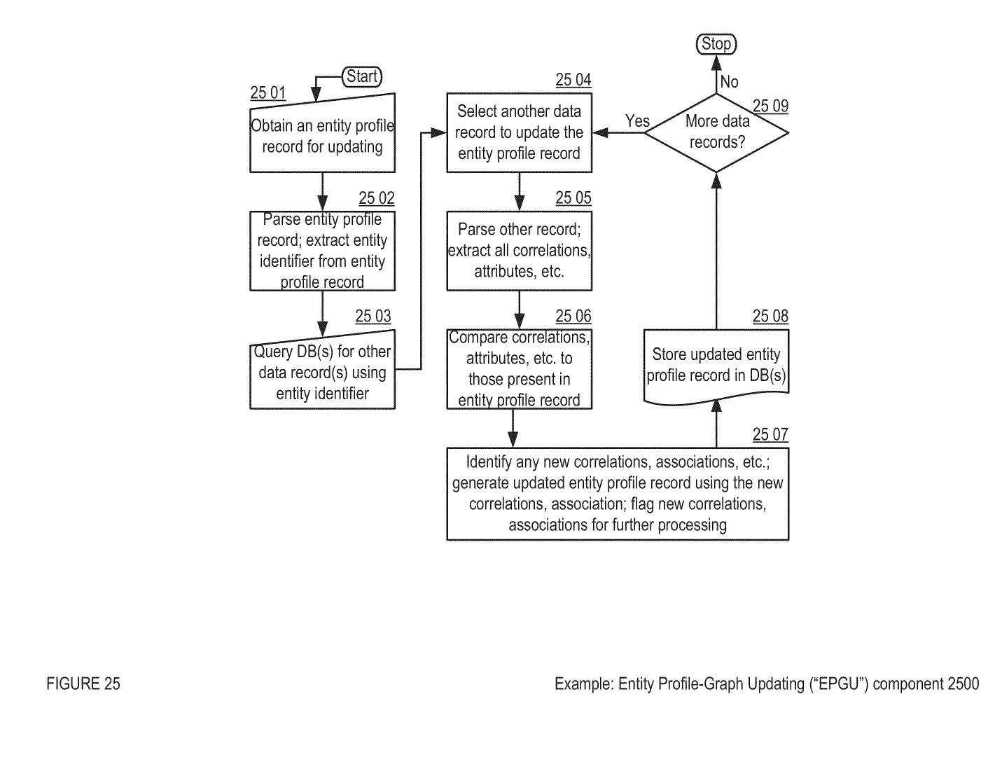

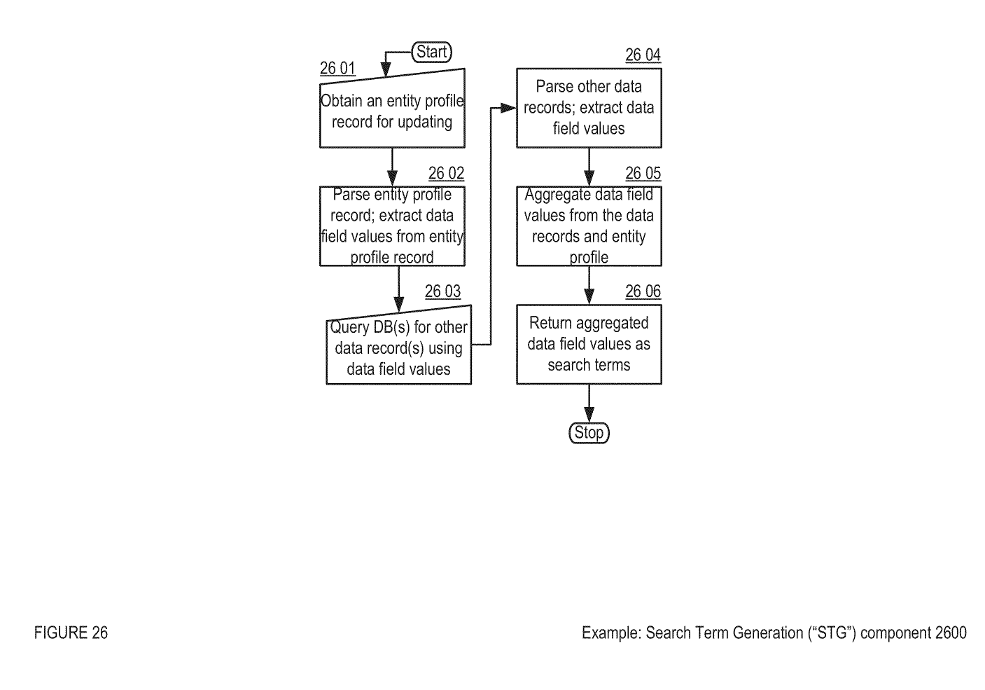

In some embodiments, the ICST may acquire the aggregated data, and normalize the data into formats that are suitable for uniform storage, indexing, maintenance, and/or further processing via data record normalization component(s) 906 (e.g., such as described in FIGS. 20A-B). The ICST may extract data from the normalized data records, and recognize data fields, e.g., the ICST may identify the attributes of each field of data included in the normalized data records via data field recognition component(s) 907 (e.g., such as described in FIG. 21). For example, the ICST may identify names, user ID(s), addresses, network addresses, comments and/or specific words within the comments, images, blog posts, video, content within the video, and/or the like from the aggregated data. In some embodiments, for each field of data, the ICST may classify entity types associated with the field of data, as well as entity identifiers associated with the field of data, e.g., via component(s) 908 (e.g., such as described in FIG. 22). For example, the ICST may identify an Internet Protocol (IP) address data field to be associated with a user ID john.q.public (consumer entity type), a user John Q. Public (consumer entity type), a household (the Public household—a multi-consumer entity type/household entity type), a merchant entity type with identifier Acme Merchant Store, Inc. from which purchases are made from the IP address, an Issuer Bank type with identifier First National Bank associated with the purchases made from the IP address, and/or the like. In some embodiments, the ICST may utilize the entity types and entity identifiers to correlate entities across each other, e.g., via cross-entity correlation component(s) 909 (e.g., such as described in FIG. 23). For example, the ICST may identify, from the aggregated data, that a household entity with identifier H123 may include a user entity with identifier John Q. Public and social identifier john.q.public@facebook.com, a second user entity with identifier Jane P. Doe with social identifier jpdoe@twitter.com, a computer entity with identifier IP address 192.168.4.5, a card account entity with identifier ****1234, a bank issuer entity with identifier AB23145, a merchant entity with identifier Acme Stores, Inc. where the household sub-entities make purchases, and/or the like. In some embodiments, the ICST may utilize the entity identifiers, data associated with each entity and/or correlated entities to identify associations to other entities, e.g., via entity attribute association component(s) 910 (e.g., such as described in FIG. 24). For example, the ICST may identify specific purchases made via purchase transactions by members of the household, and thereby identify attributes of members of the household on the basis of the purchases in the purchase transactions made by members of the household. Based on such correlations and associations, the ICST may update a profile for each entity identified from the aggregated data, as well as a social graph interrelating the entities identified in the aggregated data, e.g., via entity profile-graph updating component(s) 911 (e.g., such as described in FIGS. 25, 46, 47A-E and 48A-C). In some embodiments, the updating of profile and/or social graphs for an entity may trigger a search for additional data that may be relevant to the newly identified correlations and associations for each entity, e.g., via search term generation component(s) 913-314 (e.g., such as described in FIG. 26). For example, the updating of a profile and/or social graph may trigger searches across the Internet, social networking websites, transaction data from payment networks, services enrolled into and/or utilized by the entities, and/or the like. In some embodiments, such updating of entity profiles and/or social graphs may be performed continuously, periodically, on-demand, and/or the like.

FIG. 10 shows a data flow diagram illustrating an example search result aggregation procedure in some embodiments of the ICST. In some implementations, the pay network server may obtain a trigger to perform a search. For example, the pay network server may periodically perform a search update of its aggregated search database, e.g., 1010, with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger to extract keywords using which to perform an aggregated search. The pay network server may generate a query for application programming interface (API) templates for various search engines (e.g., Google™, Bing®, AskJeeves, market data search engines, etc.) from which to collect data for aggregation. The pay network server may query, e.g., 1012, a pay network database, e.g., 1007, for search API templates for the search engines. For example, the pay network server may utilize PHP/SQL commands similar to the examples provided above. The database may provide, e.g., 1013, a list of API templates in response. Based on the list of API templates, the pay network server may generate search requests, e.g., 1014. The pay network server may issue the generated search requests, e.g., 1015a-c, to the search engine servers, e.g., 1001a-c. For example, the pay network server may issue PHP commands to request the search engine for search results. An example listing of commands to issue search requests 1015a-c, substantially in the form of PHP commands, is provided below:

<?PHP
// API URL with access key
$url =
[″https://ajax.googleapis.com/ajax/services/search/web?v=1.0&″

. ″q=” $keywords

“&key=1234567890987654&userip=datagraph.cpip.com″];
// Send Search Request
$ch = curl_init( );
curl_setopt($ch, CURLOPT_URL, $url);
curl_setopt($ch, CURLOPT_RETURNTRANSFER, 1);
curl_setopt($ch, CURLOPT_REFERER, “datagraph.cpip.com”);
$body = curl_exec($ch);
curl_close($ch);
// Obtain, parse search results
$json = json_decode($body);
?>

In some embodiments, the search engine servers may query, e.g., 1017a-c, their search databases, e.g., 1002a-c, for search results falling within the scope of the search keywords. In response to the search queries, the search databases may provide search results, e.g., 1018a-c, to the search engine servers. The search engine servers may return the search results obtained from the search databases, e.g., 1019a-c, to the pay network server making the search requests. An example listing of search results 1019a-c, substantially in the form of JavaScript Object Notation (JSON)-formatted data, is provided below:

{“responseData”: {

“results”: [

{

“GsearchResultClass”: “GwebSearch”,
“unescapedUrl”: “http://en.wikipedia.org/wiki/John_Q_Public”,
“url”: “http://en.wikipedia.org/wiki/John_Q_Public”,
“visibleUrl”: “en.wikipedia.org”,
“cacheUrl”:

“http://www.google.com/search?q\u003dcache:TwrPfhd22hYJ:en.wikipe
dia.org”,

“title”: “\u003cb\u003eJohn Q. Public\u003c/b\u003e -

Wikipedia, the freeencyclopedia”,

“titleNoFormatting”: “John Q. Public - Wikipedia, the free

encyclopedia”,

“content”: “\[1\] In 2006, he served as Chief Technology

Officer...”

},
{

“GsearchResultClass”: “GwebSearch”,
“unescapedUrl”: “http://www.imdb.com/name/nm0385296/”,
“url”: “http://www.imdb.com/name/nm0385296/”,
“visibleUrl”: “www.imdb.com”,
“cacheUrl”:

“http://www.google.com/search?q\u003dcache:1i34KkqnsooJ:www.imdb.
com”,

“title”: “\u003cb\u003eJohn Q. Public\u003c/b\u003e”,
“titleNoFormatting”: “John Q. Public”,
“content”: “Self: Zoolander. Socialite \u003cb\u003eJohn Q.

Public\u003c/b\u003e...”

},
...

],
“cursor”: {

“pages”: [

{ “start”: “0”, “label”: 1 },
{ “start”: “4”, “label”: 2 },
{ “start”: “8”, “label”: 3 },
{ “start”: “12”,“label”: 10 }

],
“estimatedResultCount”: “59600000”,
“currentPageIndex”: 0,
“moreResultsUrl”:

“http://www.google.com/search?oe\u003dutf8\u0026ie\u003dutf8...”

}

}
, “responseDetails”: null, “responseStatus”: 200}

In some embodiments, the pay network server may store the aggregated search results, e.g., 1020, in an aggregated search database, e.g., 1010a.

FIG. 11 shows a logic flow diagram illustrating example aspects of aggregating search results in some embodiments of the ICST, e.g., a Search Results Aggregation (“SRA”) component 1100. In some implementations, the pay network server may obtain a trigger to perform a search, e.g., 1101. For example, the pay network server may periodically perform a search update of its aggregated search database with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger, e.g., 1102, to extract keywords using which to perform an aggregated search. The pay network server may determine the search engines to search, e.g., 1103, using the extracted keywords. Then, the pay network server may generate a query for application programming interface (API) templates for the various search engines (e.g., Google™, Bing®, AskJeeves, market data search engines, etc.) from which to collect data for aggregation, e.g., 1104. The pay network server may query, e.g., 1105, a pay network database for search API templates for the search engines. For example, the pay network server may utilize PHP/SQL commands similar to the examples provided above. The database may provide, e.g., 1105, a list of API templates in response. Based on the list of API templates, the pay network server may generate search requests, e.g., 1106. The pay network server may issue the generated search requests to the search engine servers. The search engine servers may parse the obtained search results(s), e.g., 1107, and query, e.g., 1108, their search databases for search results falling within the scope of the search keywords. In response to the search queries, the search databases may provide search results, e.g., 1109, to the search engine servers. The search engine servers may return the search results obtained from the search databases, e.g., 1110, to the pay network server making the search requests. The pay network server may generate, e.g., 1111, and store the aggregated search results, e.g., 1112, in an aggregated search database.

FIGS. 12A-D show data flow diagrams illustrating an example card-based transaction execution procedure in some embodiments of the ICST. In some implementations, a user, e.g., 1201, may desire to purchase a product, service, offering, and/or the like (“product”), from a merchant. The user may communicate with a merchant server, e.g., 1203, via a client such as, but not limited to: a personal computer, mobile device, television, point-of-sale terminal, kiosk, ATM, and/or the like (e.g., 1202). For example, the user may provide user input, e.g., purchase input 1211, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’
and has a CVV number of 901. ‘990112’ is a service code, and ***
represents decimal digits which change randomly each time the
card is used.)

In some implementations, the client may generate a purchase order message, e.g., 1212, and provide, e.g., 1213, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for

dummies</product_title>

<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. The merchant server may generate a card query request, e.g., 1214 to determine whether the transaction can be processed. For example, the merchant server may attempt to determine whether the user has sufficient funds to pay for the purchase in a card account provided with the purchase order. The merchant server may provide the generated card query request, e.g., 1215, to an acquirer server, e.g., 1204. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

POST /cardquery.php HTTP/1.1
Host: www.acquirer.com
Content-Type: Application/XML
Content-Length: 1224
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for

dummies</product_summary>

<product_quantity>1</product_quantity?

</product>

</purchase_summary>
<transaction_cost>$34.78</transaction_cost>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>

<merchant_auth_key>1NNF484MCP59CHB27365</merchant_auth_ke

y>

</merchant_params>

</card_query_request>

In some implementations, the acquirer server may generate a card authorization request, e.g., 1216, using the obtained card query request, and provide the card authorization request, e.g., 1217, to a pay network server, e.g., 1205. For example, the acquirer server may redirect the HTTP(S) POST message in the example above from the merchant server to the pay network server.

In some implementations, the pay network server may determine whether the user has enrolled in value-added user services. For example, the pay network server may query 1218 a database, e.g., pay network database 1207, for user service enrollment data. For example, the server may utilize PHP/SQL commands similar to the example provided above to query the pay network database. In some implementations, the database may provide the user service enrollment data, e.g., 1219. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message, similar to the example below:

HTTP/1.1 300 Multiple Choices
Location:
https://www.facebook.com/dialog/oauth?client_id=snpa_app_ID&redir
ect_uri=www.paynetwork.com/purchase.php
<html>

<head><title>300 Multiple Choices</title></head>
<body><h1>Multiple Choices</h1></body>

</html>

In some implementations, the pay network server may provide payment information extracted from the card authorization request to the value-add server as part of a value add service request, e.g., 1220. For example, the pay network server may provide a HTTP(S) POST message to the value-add server, similar to the example below:

POST /valueservices.php HTTP/1.1
Host: www.valueadd.com
Content-Type: Application/XML
Content-Length: 1306
<?XML version = “1.0” encoding = “UTF-8”?>
<service_request>

<request_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params>
<!--optional-->
<merchant>

<merchant_id>CQN3Y42N</merchant_id>
<merchant_name>Acme Tech, Inc.</merchant_name>
<user_name>john.q.public</user_name>
<cardlist>

www.acme.com/user/john.q.public/cclist.xml<cardlist>

<user_account_preference>1 3 2 4 7 12

5<user_account_preference>

</merchant>

</service_request>

In some implementations, the value-add server may provide a service input request, e.g., 1221, to the client. For example, the value-add server may provide a HTML input/login form to the client. The client may display, e.g., 1222, the login form for the user. In some implementations, the user may provide login input into the client, e.g., 1223, and the client may generate a service input response, e.g., 1224, for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 1226, and provide the response to the pay network server. For example, the value-add server may provide a HTTP(S) POST message similar to the example below:

POST /serviceresponse.php HTTP/1.1
Host: www.paynet.com
Content-Type: Application/XML
Content-Length: 1306
<?XML version = “1.0” encoding = “UTF-8”?>
<service_response>

<request_ID>4NFU4RG94</order_ID>
<timestamp>2011-02-22 15:22:43</timestamp>
<result>serviced</result>
<servcode>943528976302-45569-003829-04</servcode>

</service_response>

In some implementations, upon receiving the value-add service response from the value-add server, the pay network server may extract the enrollment service data from the response for addition to a transaction data record. In some implementations, the pay network server may forward the card authorization request to an appropriate pay network server, e.g., 1228, which may parse the card authorization request to extract details of the request. Using the extracted fields and field values, the pay network server may generate a query, e.g., 1229, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 1208a-n, of the issuer may maintain details of the user's card account. In some implementations, a database, e.g., pay network database 1207, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to
search
//create query for issuer server data
$query = “SELECT issuer_name issuer_address issuer_id ip_address
mac_address auth_key port_num security_settings_list FROM
IssuerTable WHERE account_num LIKE ′%′ $accountnum”;
$result = mysql_query($query); // perform the search query
mysql_close(“ISSUERS.SQL”); // close database access
?>

In response to obtaining the issuer server query, e.g., 1229, the pay network database may provide, e.g., 1230, the requested issuer server data to the pay network server. In some implementations, the pay network server may utilize the issuer server data to generate a forwarding card authorization request, e.g., 1231, to redirect the card authorization request from the acquirer server to the issuer server. The pay network server may provide the card authorization request, e.g., 1232, to the issuer server. In some implementations, the issuer server, e.g., 1208, may parse the card authorization request, and based on the request details may query 1233 a database, e.g., user profile database 1209, for data of the user's card account. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable WHERE account_num LIKE ′%′ $accountnum”;
$result = mysql_query($query); // perform the search query
mysql_close(“USERS.SQL“); // close database access
?>

In some implementations, on obtaining the user data, e.g., 1234, the issuer server may determine whether the user can pay for the transaction using funds available in the account, e.g., 1235. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 1236, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record from the card authorization request it received, and store, e.g., 1239, the details of the transaction and authorization relating to the transaction in a database, e.g., pay network database 1207. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PurchasesTable (timestamp,
purchase_summary_list, num_products, product_summary,
product_quantity, transaction_cost, account_params_list,
account_name, account_type, account_num, billing_addres, zipcode,
phone, sign, merchant_params_list, merchant_id, merchant_name,
merchant_auth_key)
VALUES (time( ), $purchase_summary_list, $num_products,
$product_summary, $product_quantity, $transaction_cost,
$account_params_list, $account_name, $account_type, $account_num,
$billing_addres, $zipcode, $phone, $sign, $merchant_params_list,
$merchant_id, $merchant_name, $merchant_auth_key)”); // add data
to table in database
mysql_close(″TRANSACTIONS.SQL″); // close connection to database
?>

In some implementations, the pay network server may forward the authorization message, e.g., 1240, to the acquirer server, which may in turn forward the authorization message, e.g., 1240, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1241, and store the XML data file, e.g., 1242, in a database, e.g., merchant database 1204. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_ke

y>

<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some implementations, the server may also generate a purchase receipt, e.g., 1243, and provide the purchase receipt to the client. The client may render and display, e.g., 1244, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 12C, in some implementations, the merchant server may initiate clearance of a batch of authorized transactions. For example, the merchant server may generate a batch data request, e.g., 1245, and provide the request, e.g., 1246, to a database, e.g., merchant database 1204. For example, the merchant server may utilize PHP/SQL commands similar to the examples provided above to query a relational database. In response to the batch data request, the database may provide the requested batch data, e.g., 1247. The server may generate a batch clearance request, e.g., 1248, using the batch data obtained from the database, and provide, e.g., 1241, the batch clearance request to an acquirer server, e.g., 1210. For example, the merchant server may provide a HTTP(S) POST message including XML-formatted batch data in the message body for the acquirer server. The acquirer server may generate, e.g., 1250, a batch payment request using the obtained batch clearance request, and provide the batch payment request to the pay network server, e.g., 1251. The pay network server may parse the batch payment request, and extract the transaction data for each transaction stored in the batch payment request, e.g., 1252. The pay network server may store the transaction data, e.g., 1253, for each transaction in a database, e.g., pay network database 1207. For each extracted transaction, the pay network server may query, e.g., 1254-655, a database, e.g., pay network database 1207, for an address of an issuer server. For example, the pay network server may utilize PHP/SQL commands similar to the examples provided above. The pay network server may generate an individual payment request, e.g., 1256, for each transaction for which it has extracted transaction data, and provide the individual payment request, e.g., 1257, to the issuer server, e.g., 1208. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>

<merchant_auth_key>1NNF484MCP59CHB27365</merchant_auth_ke

y>

</merchant_params>
<purchase_summary>

<num_products>1</num_products>
<product>

<product_summary>Book - XML for

dummies</product_summary>

<product_quantity>1</product_quantity?

</product>

</purchase_summary>

</pay_request>

In some implementations, the issuer server may generate a payment command, e.g., 1258. For example, the issuer server may issue a command to deduct funds from the user's account (or add a charge to the user's credit card account). The issuer server may issue a payment command, e.g., 1259, to a database storing the user's account information, e.g., user profile database 1208. The issuer server may provide a funds transfer message, e.g., 1260, to the pay network server, which may forward, e.g., 1261, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request ID field in the example above) to the merchant. The acquirer server may then transfer the funds specified in the funds transfer message to an account of the merchant, e.g., 1262.

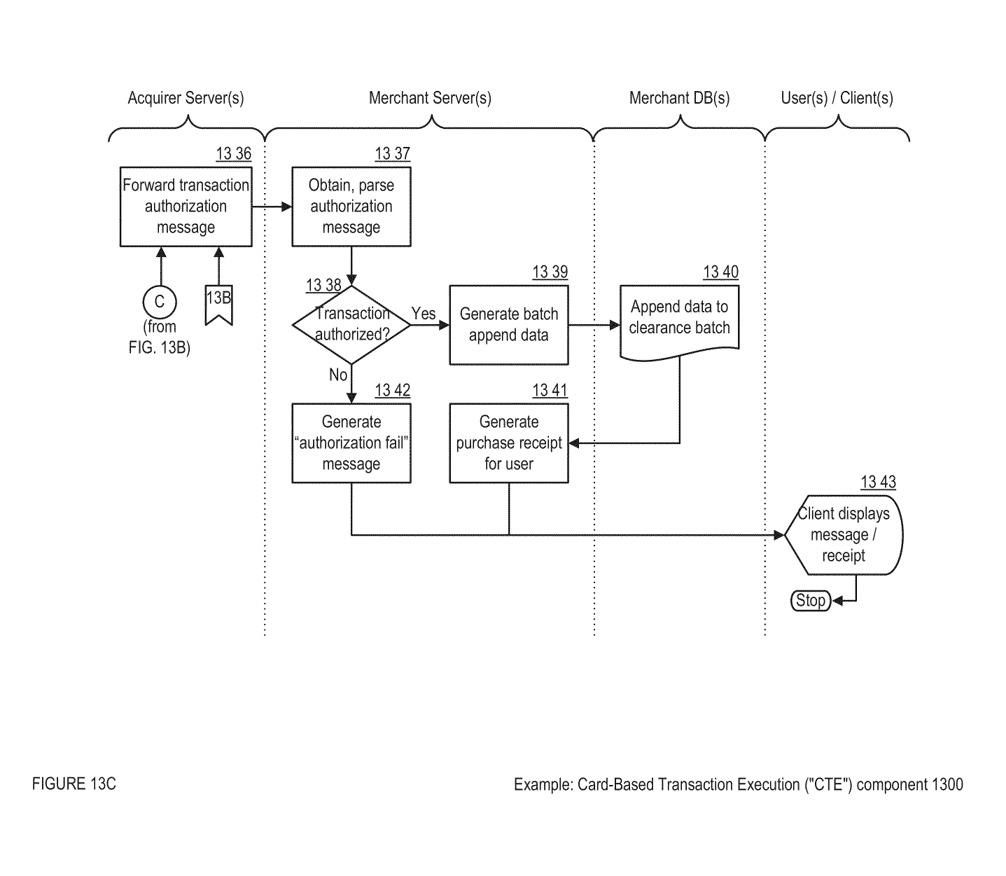

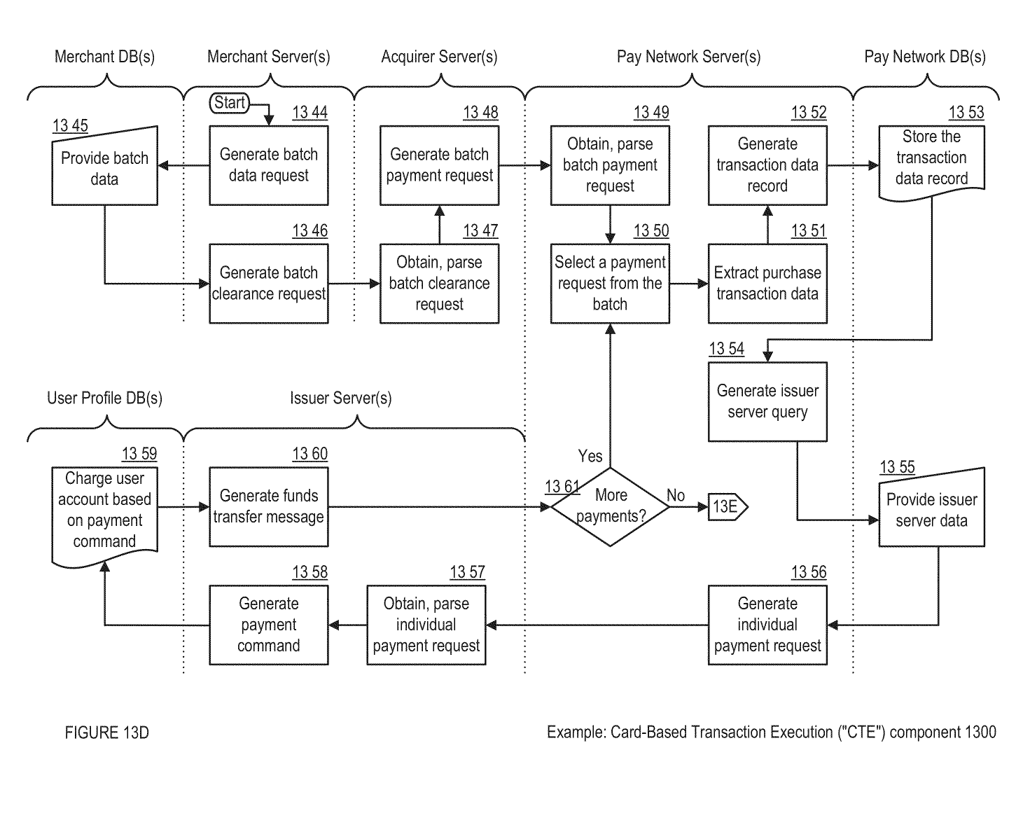

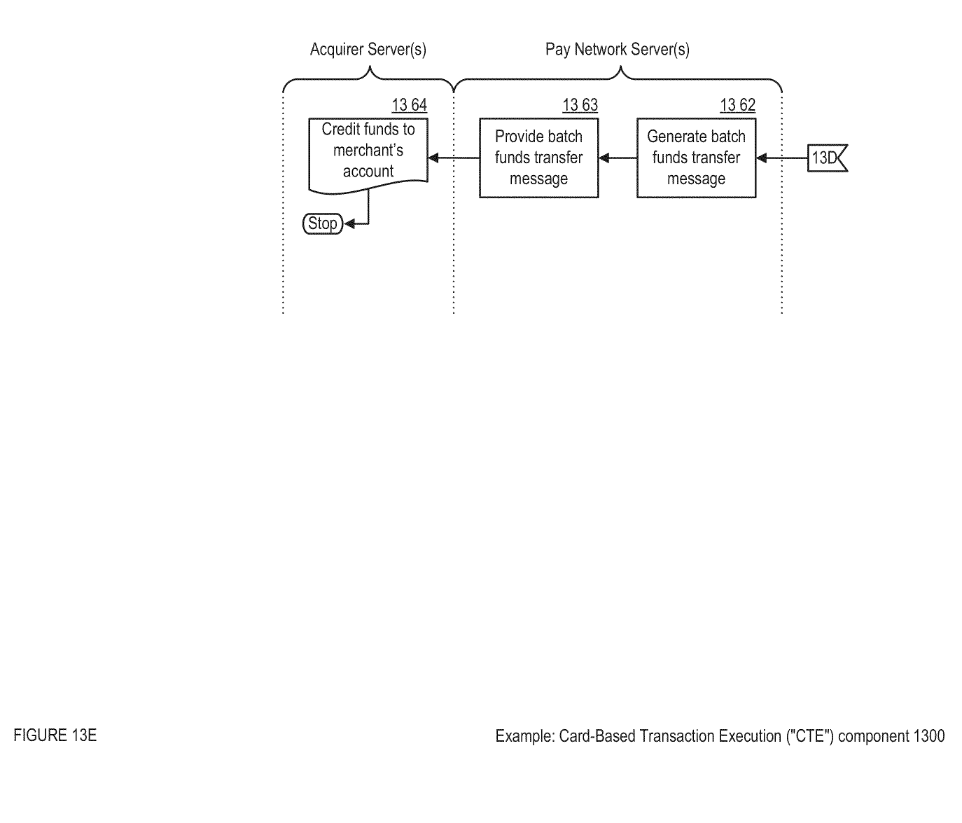

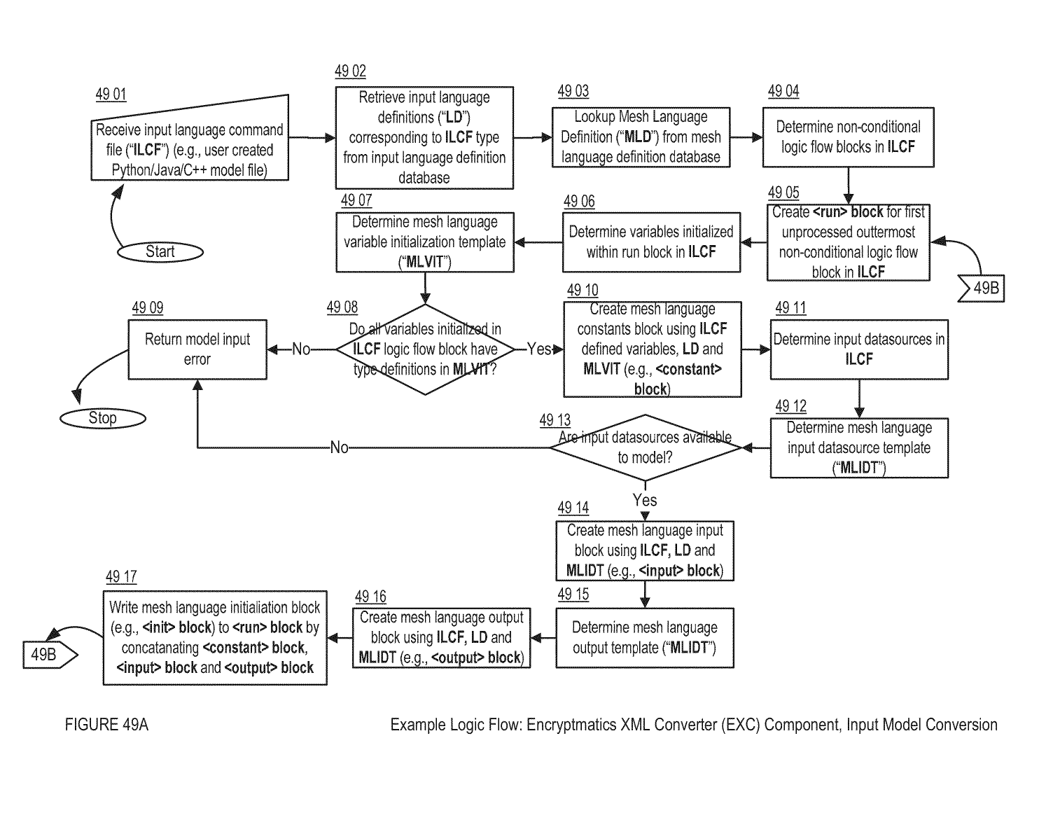

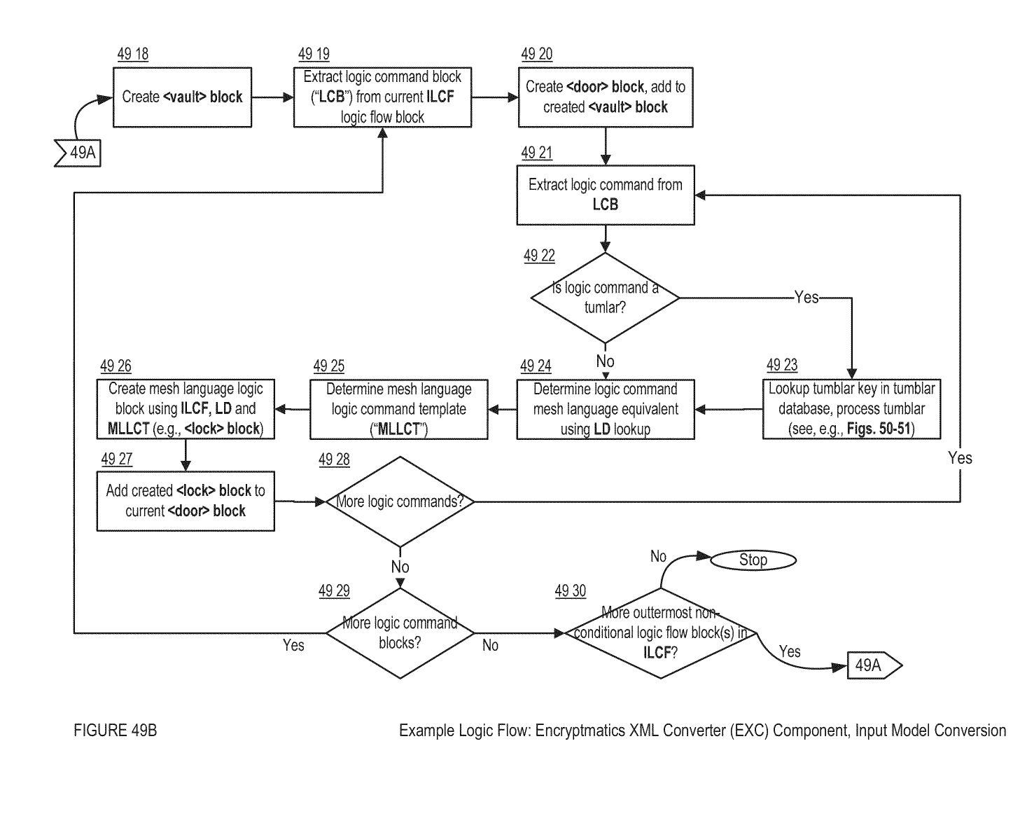

FIGS. 13A-E show logic flow diagrams illustrating example aspects of card-based transaction execution, resulting in generation of card-based transaction data and service usage data, in some embodiments of the ICST, e.g., a Card-Based Transaction Execution (“CTE”) component 1300. In some implementations, a user may provide user input, e.g., 1301, into a client indicating the user's desire to purchase a product from a merchant. The client may generate a purchase order message, e.g., 1302, and provide the generated purchase order message to the merchant server. In some implementations, the merchant server may obtain, e.g., 1303, the purchase order message from the client, and may parse the purchase order message to extract details of the purchase order from the user. Example parsers that the merchant client may utilize are discussed further below with reference to FIG. 49. The merchant may generate a product data query, e.g., 1304, for a merchant database, which may in response provide the requested product data, e.g., 1305. The merchant server may generate a card query request using the product data, e.g., 1304, to determine whether the transaction can be processed. For example, the merchant server may process the transaction only if the user has sufficient funds to pay for the purchase in a card account provided with the purchase order. The merchant server may optionally provide the generated card query request to an acquirer server. The acquirer server may generate a card authorization request using the obtained card query request, and provide the card authorization request to a pay network server.

In some implementations, the pay network server may determine whether the user has enrolled in value-added user services. For example, the pay network server may query a database, e.g., 1307, for user service enrollment data. For example, the server may utilize PHP/SQL commands similar to the example provided above to query the pay network database. In some implementations, the database may provide the user service enrollment data, e.g., 1308. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message. In some implementations, the pay network server may provide payment information extracted from the card authorization request to the value-add server as part of a value add service request, e.g., 1310.

In some implementations, the value-add server may provide a service input request, e.g., 1311, to the client. The client may display, e.g., 1312, the input request for the user. In some implementations, the user may provide input into the client, e.g., 1313, and the client may generate a service input response for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 1317, and provide the response to the pay network server. In some implementations, upon receiving the value-add service response from the value-add server, the pay network server may extract the enrollment service data from the response for addition to a transaction data record, e.g., 1319-1320.

With reference to FIG. 13B, in some implementations, the pay network server may obtain the card authorization request from the acquirer server, and may parse the card authorization request to extract details of the request, e.g., 1320. Using the extracted fields and field values, the pay network server may generate a query, e.g., 1321-722, for an issuer server corresponding to the user's card account. In response to obtaining the issuer server query the pay network database may provide, e.g., 1322, the requested issuer server data to the pay network server. In some implementations, the pay network server may utilize the issuer server data to generate a forwarding card authorization request, e.g., 1323, to redirect the card authorization request from the acquirer server to the issuer server. The pay network server may provide the card authorization request to the issuer server. In some implementations, the issuer server may parse, e.g., 1324, the card authorization request, and based on the request details may query a database, e.g., 1325, for data of the user's card account. In response, the database may provide the requested user data. On obtaining the user data, the issuer server may determine whether the user can pay for the transaction using funds available in the account, e.g., 1326. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 1327, to the pay network server.

In some implementations, the pay network server may obtain the authorization message, and parse the message to extract authorization details. Upon determining that the user possesses sufficient funds for the transaction (e.g., 1330, option “Yes”), the pay network server may extract the transaction card from the authorization message and/or card authorization request, e.g., 1333, and generate a transaction data record using the card transaction details. The pay network server may provide the transaction data record for storage, e.g., 1334, to a database. In some implementations, the pay network server may forward the authorization message, e.g., 1335, to the acquirer server, which may in turn forward the authorization message, e.g., 1336, to the merchant server. The merchant may obtain the authorization message, and parse the authorization message o extract its contents, e.g., 1337. The merchant server may determine whether the user possesses sufficient funds in the card account to conduct the transaction. If the merchant server determines that the user possess sufficient funds, e.g., 1338, option “Yes,” the merchant server may add the record of the transaction for the user to a batch of transaction data relating to authorized transactions, e.g., 1339-740. The merchant server may also generate a purchase receipt, e.g., 1341, for the user. If the merchant server determines that the user does not possess sufficient funds, e.g., 1338, option “No,” the merchant server may generate an “authorization fail” message, e.g., 1342. The merchant server may provide the purchase receipt or the “authorization fail” message to the client. The client may render and display, e.g., 1343, the purchase receipt for the user.

In some implementations, the merchant server may initiate clearance of a batch of authorized transactions by generating a batch data request, e.g., 1344, and providing the request to a database. In response to the batch data request, the database may provide the requested batch data, e.g., 1345, to the merchant server. The server may generate a batch clearance request, e.g., 1346, using the batch data obtained from the database, and provide the batch clearance request to an acquirer server. The acquirer server may generate, e.g., 1348, a batch payment request using the obtained batch clearance request, and provide the batch payment request to a pay network server. The pay network server may parse, e.g., 1349, the batch payment request, select a transaction stored within the batch data, e.g., 1350, and extract the transaction data for the transaction stored in the batch payment request, e.g., 1351. The pay network server may generate a transaction data record, e.g., 1352, and store the transaction data, e.g., 1353, the transaction in a database. For the extracted transaction, the pay network server may generate an issuer server query, e.g., 1354, for an address of an issuer server maintaining the account of the user requesting the transaction. The pay network server may provide the query to a database. In response, the database may provide the issuer server data requested by the pay network server, e.g., 1355. The pay network server may generate an individual payment request, e.g., 1356, for the transaction for which it has extracted transaction data, and provide the individual payment request to the issuer server using the issuer server data from the database.

In some implementations, the issuer server may obtain the individual payment request, and parse, e.g., 1357, the individual payment request to extract details of the request. Based on the extracted data, the issuer server may generate a payment command, e.g., 1358. For example, the issuer server may issue a command to deduct funds from the user's account (or add a charge to the user's credit card account). The issuer server may issue a payment command, e.g., 1359, to a database storing the user's account information. In response, the database may update a data record corresponding to the user's account to reflect the debit/charge made to the user's account. The issuer server may provide a funds transfer message, e.g., 1360, to the pay network server after the payment command has been executed by the database.

In some implementations, the pay network server may check whether there are additional transactions in the batch that need to be cleared and funded. If there are additional transactions, e.g., 1361, option “Yes,” the pay network server may process each transaction according to the procedure described above. The pay network server may generate, e.g., 1362, an aggregated funds transfer message reflecting transfer of all transactions in the batch, and provide, e.g., 1363, the funds transfer message to the acquirer server. The acquirer server may, in response, transfer the funds specified in the funds transfer message to an account of the merchant, e.g., 1364.

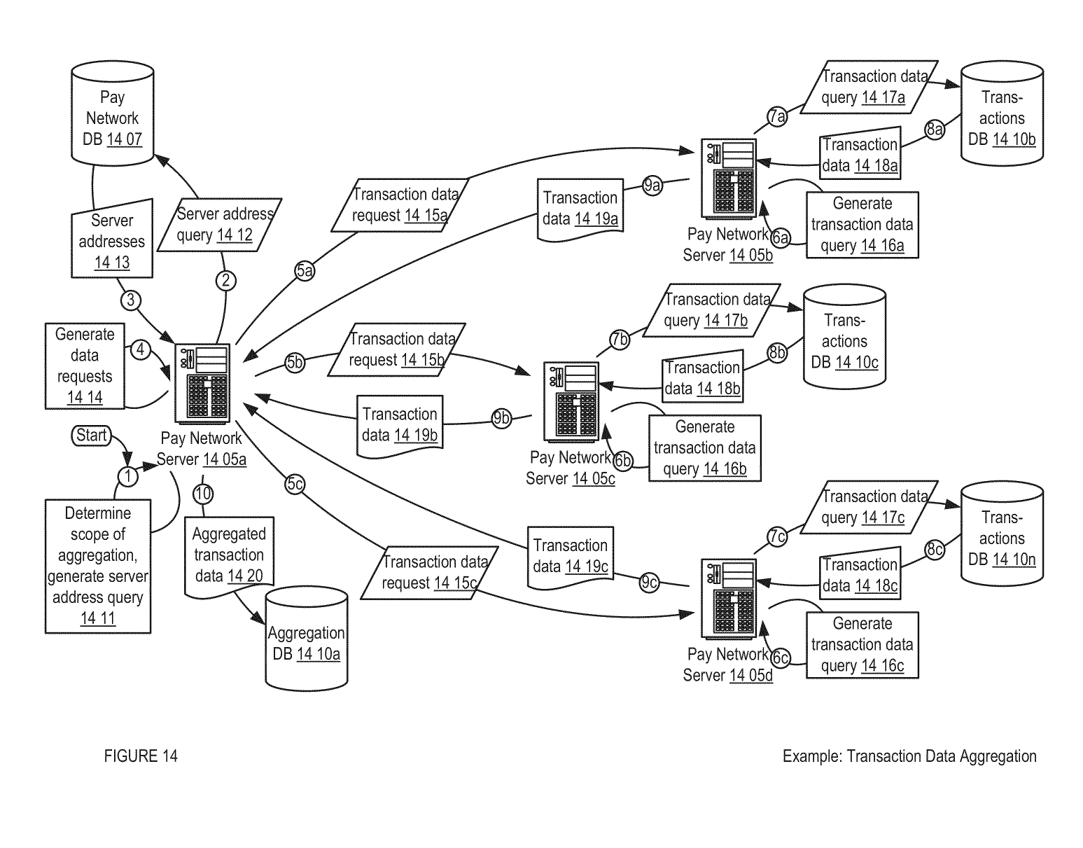

FIG. 14 shows a data flow diagram illustrating an example procedure to aggregate card-based transaction data in some embodiments of the ICST. In some implementations, the pay network server may determine a scope of data aggregation required to perform the analysis, e.g., 1411. The pay network server may initiate data aggregation based on the determined scope. The pay network server may generate a query for addresses of server storing transaction data within the determined scope. The pay network server may query, e.g., 1412, a pay network database, e.g., 1407a, for addresses of pay network servers that may have stored transaction data within the determined scope of the data aggregation. For example, the pay network server may utilize PHP/SQL commands similar to the examples provided above. The database may provide, e.g., 1413, a list of server addresses in response to the pay network server's query. Based on the list of server addresses, the pay network server may generate transaction data requests, e.g., 1414. The pay network server may issue the generated transaction data requests, e.g., 1415a-c, to the other pay network servers, e.g., 1405b-d. The other pay network servers may query, e.g., 1417a-c, their pay network database, e.g., 1407a-d, for transaction data falling within the scope of the transaction data requests. In response to the transaction data queries, the pay network databases may provide transaction data, e.g., 1418a-c, to the other pay network servers. The other pay network servers may return the transaction data obtained from the pay network databases, e.g., 1419a-c, to the pay network server making the transaction data requests, e.g., 1405a. The pay network server, e.g., 1405a, may store the aggregated transaction data, e.g., 1420, in an aggregated transactions database, e.g., 1410a.

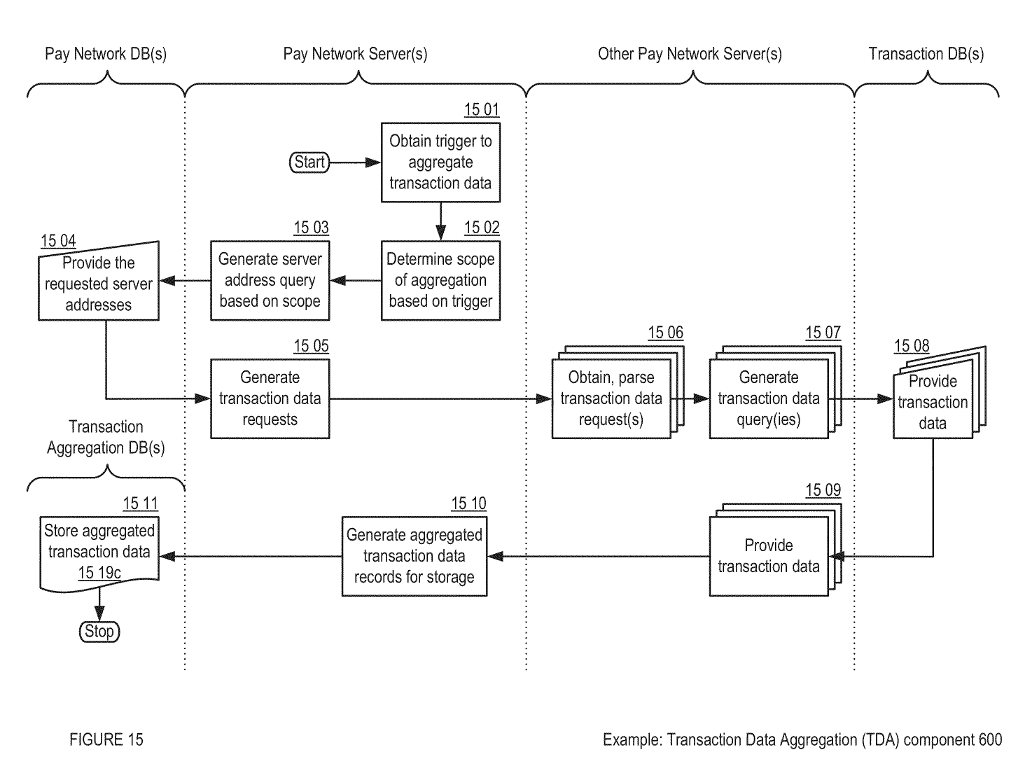

FIG. 15 shows a logic flow diagram illustrating example aspects of aggregating card-based transaction data in some embodiments of the ICST, e.g., a Transaction Data Aggregation (“TDA”) component 1500. In some implementations, a pay network server may obtain a trigger to aggregate transaction data, e.g., 1501. For example, the server may be configured to initiate transaction data aggregation on a regular, periodic, basis (e.g., hourly, daily, weekly, monthly, quarterly, semi-annually, annually, etc.). As another example, the server may be configured to initiate transaction data aggregation on obtaining information that the U.S. Government (e.g., Department of Commerce, Office of Management and Budget, etc) has released new statistical data related to the U.S. business economy. As another example, the server may be configured to initiate transaction data aggregation on-demand, upon obtaining a user investment strategy analysis request for processing. The pay network server may determine a scope of data aggregation required to perform the analysis, e.g., 1502. For example, the scope of data aggregation may be pre-determined. As another example, the scope of data aggregation may be determined based on a received user investment strategy analysis request. The pay network server may initiate data aggregation based on the determined scope. The pay network server may generate a query for addresses of server storing transaction data within the determined scope, e.g., 1503. The pay network server may query a database for addresses of pay network servers that may have stored transaction data within the determined scope of the data aggregation. The database may provide, e.g., 1504, a list of server addresses in response to the pay network server's query. Based on the list of server addresses, the pay network server may generate transaction data requests, e.g., 1505. The pay network server may issue the generated transaction data requests to the other pay network servers. The other pay network servers may obtain and parse the transaction data requests, e.g., 1506. Based on parsing the data requests, the other pay network servers may generate transaction data queries, e.g., 1507, and provide the transaction data queries to their pay network databases. In response to the transaction data queries, the pay network databases may provide transaction data, e.g., 1508, to the other pay network servers. The other pay network servers may return, e.g., 1509, the transaction data obtained from the pay network databases to the pay network server making the transaction data requests. The pay network server may generate aggregated transaction data records from the transaction data received from the other pay network servers, e.g., 1510, and store the aggregated transaction data in a database, e.g., 1511.

FIG. 16 shows a data flow diagram illustrating an example social data aggregation procedure in some embodiments of the ICST. In some implementations, the pay network server may obtain a trigger to perform a social data search. For example, the pay network server may periodically perform an update of its aggregated social database, e.g., 1610, with new information available from a variety of sources, such as the social networking services operating on the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger to extract keywords using which to perform an aggregated social data update. The pay network server may generate a query for application programming interface (API) templates for various social networking services (e.g., Facebook®, Twitter', etc.) from which to collect social data for aggregation. The pay network server may query, e.g., 1612, a pay network database, e.g., 1607, for social network API templates for the social networking services. For example, the pay network server may utilize PHP/SQL commands similar to the examples provided above. The database may provide, e.g., 1613, a list of API templates in response. Based on the list of API templates, the pay network server may generate social data requests, e.g., 1614. The pay network server may issue the generated social data requests, e.g., 1615a-c, to the social network servers, e.g., 1601a-c. For example, the pay network server may issue PHP commands to request the social network servers for social data. An example listing of commands to issue social data requests 1615a-c, substantially in the form of PHP commands, is provided below:

<?PHP
header(‘Content-Type: text/plain’);
// Obtain user ID(s) of friends of the logged-in user
$friends =
json_decode(file_get_contents(′https://graph.facebook.com/me/frie
nds?access token=′$cookie[′oauth_access_token′]), true);
$friend_ids = array_keys($friends);
// Obtain message feed associated with the profile of the logged-
in user
$feed =
json_decode(file_get_contents(‘https:llgraph.facebook.com/me/feed
?access_token=′$cookie[′oauth_access_token′]), true);
// Obtain messages by the user's friends
$result = mysql_query(′SELECT * FROM content WHERE uid IN (′
.implode($friend_ids, ′,′) . ′)′);
$friend_content = array( );
while ($row = mysql_fetch_assoc($result))
$friend_content [ ] $row;
?>

In some embodiments, the social network servers may query, e.g., 1617a-c, their databases, e.g., 1602a-c, for social data results falling within the scope of the social keywords. In response to the queries, the databases may provide social data, e.g., 1618a-c, to the search engine servers. The social network servers may return the social data obtained from the databases, e.g., 1619a-c, to the pay network server making the social data requests. An example listing of social data 1619a-c, substantially in the form of JavaScript Object Notation (JSON)-formatted data, is provided below:

| | |
|---|---|
| [ “data”: | [ |

| | |
|---|---|
| { | “name”: “Tabatha Orloff”, |
| | “id”: “483722”}, |
| { | “name”: “Darren Kinnaman”, |
| | “id”: “86S743”}, |
| { | “name”: “Sharron Jutras”, |
| | “id”: “O91274”} |

] }

In some embodiments, the pay network server may store the aggregated search results, e.g., 1620, in an aggregated search database, e.g., 1610a.

FIG. 17 shows a logic flow diagram illustrating example aspects of aggregating social data in some embodiments of the ICST, e.g., a Social Data Aggregation (“SDA”) component 1700. In some implementations, the pay network server may obtain a trigger to perform a social search, e.g., 1701. For example, the pay network server may periodically perform an update of its aggregated social database with new information available from a variety of sources, such as the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger, e.g., 1702, to extract keywords and/or user ID(s) using which to perform an aggregated search for social data. The pay network server may determine the social networking services to search, e.g., 1703, using the extracted keywords and/or user ID(s). Then, the pay network server may generate a query for application programming interface (API) templates for the various social networking services (e.g., Facebook®, Twitter', etc.) from which to collect social data for aggregation, e.g., 1704. The pay network server may query, e.g., 1705, a pay network database for search API templates for the social networking services. For example, the pay network server may utilize PHP/SQL commands similar to the examples provided above. The database may provide, e.g., 1705, a list of API templates in response. Based on the list of API templates, the pay network server may generate social data requests, e.g., 1706. The pay network server may issue the generated social data requests to the social networking services. The social network servers may parse the obtained search results(s), e.g., 1707, and query, e.g., 1708, their databases for social data falling within the scope of the search keywords. In response to the social data queries, the databases may provide social data, e.g., 1709, to the social networking servers. The social networking servers may return the social data obtained from the databases, e.g., 1710, to the pay network server making the social data requests. The pay network server may generate, e.g., 1711, and store the aggregated social data, e.g., 1712, in an aggregated social database.

FIG. 18 shows a data flow diagram illustrating an example procedure for enrollment in value-add services in some embodiments of the ICST. In some implementations, a user, e.g., 1801, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server, e.g., 1803, via a client such as, but not limited to: a personal computer, mobile device, television, point-of-sale terminal, kiosk, ATM, and/or the like (e.g., 1802). For example, the user may provide user input, e.g., enroll input 1811, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. For example, the user may swipe a payment card at the client 1802. In some implementations, the client may obtain track 1 data from the user's card as enroll input 1811 (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’
and has a CVV number of 901. ‘990112’ is a service code, and ***
represents decimal digits which change randomly each time the
card is used.)

In some implementations, using the user's input, the client may generate an enrollment request, e.g., 1812, and provide the enrollment request, e.g., 1813, to the pay network server. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the pay network server:

POST /enroll.php HTTP/1.1
Host: www.merchant.com
Content-Type: Application/XML
Content-Length: 718
<?XML version = “1.0” encoding = “UTF-8”?>
<enrollment_request>

<cart_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<!--account_params> <optional>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params-->
<checkout_purchase_details>

<num_products>1</num_products>
<product>

<product_type>book</product_type>
<product_params>

<product_title>XML for

dummies</product_title>

<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</checkout_purchase_details>

</enrollment_request>

In some implementations, the pay network server may obtain the enrollment request from the client, and extract the user's payment detail (e.g., XML data) from the enrollment request. For example, the pay network server may utilize a parser such as the example parsers described below in the discussion with reference to FIG. 49. In some implementations, the pay network server may query, e.g., 1814, a pay network database, e.g., 1804, to obtain a social network request template, e.g., 1815, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 1814-1215, is provided below:

<?PHP
header(′Content-Type: text/plain′);
mysql_connect(“254.93.179.112”,$DBserver,$password); // access
database server
mysql_select_db(“SOCIALAUTH.SQL”); // select database table to
search
//create query
$query = “SELECT template FROM EnrollTable WHERE network LIKE
′%′ $socialnet”;
$result = mysql_query($query); // perform the search query
mysql_close(“SOCIALAUTH.SQL”); // close database access
?>

In some implementations, the pay network server may redirect the client to a social network server by providing a HTTP(S) REDIRECT 300 message, similar to the example below:

HTTP/1.1 300 Multiple Choices
Location:

https://www.facebook.com/dialog/oauth?client_id=snpa_app_ID&redir

ect_uri=www.paynetwork.com/enroll.php
<html>

<head><title>300 Multiple Choices</title></head>
<body><h1>Multiple Choices</h1></body>

</html>

In some implementations, the pay network server may provide payment information extracted from the card authorization request to the social network server as part of a social network authentication enrollment request, e.g., 1817. For example, the pay network server may provide a HTTP(S) POST message to the social network server, similar to the example below:

POST /authenticate_enroll.php HTTP/1.1
Host: www.socialnet.com
Content-Type: Application/XML
Content-Length: 1306
<?XML version = “1.0” encoding = “UTF-8”?>
<authenticate_enrollment_request>

<request_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params>

</authenticate_enrollment_request>

In some implementations, the social network server may provide a social network login request, e.g., 1818, to the client. For example, the social network server may provide a HTML input form to the client. The client may display, e.g., 1819, the login form for the user. In some implementations, the user may provide login input into the client, e.g., 1820, and the client may generate a social network login response, e.g., 1821, for the social network server. In some implementations, the social network server may authenticate the login credentials of the user, and access payment account information of the user stored within the social network, e.g., in a social network database. Upon authentication, the social network server may generate an authentication data record for the user, e.g., 1822, and provide an enrollment notification, e.g., 1824, to the pay network server. For example, the social network server may provide a HTTP(S) POST message similar to the example below:

POST /enrollnotification.php HTTP/1.1
Host: www.paynet.com
Content-Type: Application/XML
Content-Length: 1306
<?XML version = “1.0” encoding = “UTF-8”?>
<enroll_notification>

<request_ID>4NFU4RG94</order_ID>
<timestamp>2011-02-22 15:22:43</timestamp>
<result>enrolled</result>

</enroll_notification>

Upon receiving notification of enrollment from the social network server, the pay network server may generate, e.g., 1825, a user enrollment data record, and store the enrollment data record in a pay network database, e.g., 1826, to complete enrollment. In some implementations, the enrollment data record may include the information from the enrollment notification 1824.

FIG. 19 shows a logic flow diagram illustrating example aspects of enrollment in a value-added service in some embodiments of the ICST, e.g., a Value-Add Service Enrollment (“VASE”) component 1900. In some implementations, a user, e.g., 1201, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server via a client. For example, the user may provide user input, e.g., 1901, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some implementations, using the user's input, the client may generate an enrollment request, e.g., 1902, and provide the enrollment request to the pay network server. In some implementations, the ICST may provide an enrollment button which may take the user to an enrollment webpage where account info may be entered into web form fields. In some implementations, the pay network server may obtain the enrollment request from the client, and extract the user's payment detail from the enrollment request. For example, the pay network server may utilize a parser such as the example parsers described below in the discussion with reference to FIG. 49. In some implementations, the pay network server may query, e.g., 1904, a pay network database to obtain a social network request template, e.g., 1905, to process the enrollment request. The social network request template may include instructions, data, login URL, login API call template and/or the like for facilitating social network authentication. In some implementations, the pay network server may provide payment information extracted from the card authorization request to the social network server as part of a social network authentication enrollment request, e.g., 1906. In some implementations, the social network server may provide a social network login request, e.g., 1907, to the client. For example, the social network server may provide a HTML input form to the client. The client may display, e.g., 1908, the login form for the user. In some implementations, the user may provide login input into the client, e.g., 1909, and the client may generate a social network login response for the social network server. In some implementations, the social network server may authenticate the login credentials of the user, and access payment account information of the user stored within the social network, e.g., in a social network database. Upon authentication, the social network server may generate an authentication data record for the user, e.g., 1911, and provide an enrollment notification to the pay network server, e.g., 1913. Upon receiving notification of enrollment from the social network server, the pay network server may generate, e.g., 1914, a user enrollment data record, and store the enrollment data record in a pay network database, e.g., 1915, to complete enrollment. The pay network server may provide an enrollment confirmation, and provide the enrollment confirmation to the client, which may display, e.g., 1917, the confirmation for the user.

FIGS. 20A-B show flow diagrams illustrating example aspects of normalizing aggregated search, enrolled, service usage, transaction and/or other aggregated data into a standardized data format in some embodiments of the ICST, e.g., a Aggregated Data Record Normalization (“ADRN”) component 2000. With reference to FIG. 20A, in some implementations, a pay network server (“server”) may attempt to convert any aggregated data records stored in an aggregated records database it has access to in a normalized data format. For example, the database may have a transaction data record template with predetermined, standard fields that may store data in pre-defined formats (e.g., long integer/double float/4 digits of precision, etc.) in a pre-determined data structure. A sample XML transaction data record template is provided below:

<?XML version = “1.0” encoding = “UTF-8”?>
<transaction_record>

<record_ID>00000000</record_ID>
<norm_flag>false</norm_flag>
<timestamp>yyyy-mm-dd hh:mm:ss</timestamp>
<transaction_cost>$0,000,000,00</transaction_cost>
<merchant_params>

<merchant_id>00000000</merchant_id>
<merchant_name>TBD</merchant_name>

<merchant_auth_key>0000000000000000</merchant_auth_key>
</merchant_params>
<merchant_products>

<num_products>000</num_products>
<product>

<product_type>TBD</product_type>
<product_name>TBD</product_name>
<class_labels_list>TBD<class_labels_list>
<product_quantity>000</product_quantity>
<unit_value>$0,000,000.00</unit_value>
<sub_total>$0,000,000.00</sub_total>
<comment>normalized transaction data record

template</comment>

</product>

</merchant_products>
<user_account_params>

<account_name>JTBD</account_name>
<account_type>TBD</account_type>
<account_num>0000000000000000</account_num>
<billing_line1>TBD</billing_line1>
<billing_line2>TBD</billing_line2>
<zipcode>TBD</zipcode>
<state>TBD</state>
<country>TBD</country>
<phone>00-00-000-000-0000</phone>
<sign>TBD</sign>

</user_account_params>

</transaction_record>

In other embodiments, the transaction data record template may contain integrated logic, regular expressions, executable meta-commands, language commands and/or the like in order to facilitate properly matching aggregated data with the location and format of the data in the template. In some embodiments, the template may contain logic in a non-template language, such as PHP commands being included in an XML file. As such, in one example, a language key may be used by the template (e.g., “php:<command>”, “java:<function>”, and/or the like). In so doing, the matching template may match a vast array of disparate data formats down into a normalized and standardized format. An example transaction data template record substantially in the form of XML is as follows:

<?XML version = “1.0” encoding = “UTF-8”?>
<transaction_record>

<record_ID

default_value=false_return_error
match_length=8
format=integer
regex_search=”(?<=\s|\hat{ })\d+(?=\s|$)”
start_search_offset=”50bytes”>00000000</record_ID>

<norm_flag>false</norm_flag>
<timestamp

default_value=”MySQL:’NOW( )’”
format_after_matching=”php:mktime($value);”>

yyyy-mm-dd hh:mm:ss</timestamp>

<transaction_cost>$0,000,000,00</transaction_cost>
<merchant_params>

<merch_id>00000000</merch_id>
<merch_name>TBD</merch_name>
<merch_auth_key>0000000000000000</merch_auth_key>

</merchant_params>
<merchant_products>

<num_products

min_quantity=1
max_quantity=30>000</num_products>

<product>

<product_type

from_group=”array(‘BOOK’,’CD’,’DVD’)”>

TBD</product_type>

<product_name>TBD</product_name>
<class_labels_list>TBD<class_labels_list>
<product_quantity>000</product_quantity>
<unit_value>$0,000,000.00</unit_value>
<sub_total>$0,000,000.00</sub_total>
<comment>normalized transaction data record

template</comment>

</product>

</merchant_products>
<user_account_params>

<account_name>JTBD</account_name>
<account_type>TBD</account_type>
<account_num>0000000000000000</account_num>
<billing_line1>TBD</billing_line1>
<billing_line2>TBD</billing_line2>
<zipcode>TBD</zipcode>
<state>TBD</state>
<country>TBD</country>
<phone>00-00-000-000-0000</phone>
<sign>TBD</sign>

</user_account_params>

</transaction_record>

In some implementations, the server may query a database for a normalized data record template, e.g., 2001. The server may parse the normalized data record template, e.g., 2002. In some embodiments, the parsing may parse the raw data record (such as using a parser as described herein and with respect to FIG. 49). In other embodiments, the parser may parse a dictionary entry containing a subset of the complete data. Based on parsing the normalized data record template, the server may determine the data fields included in the normalized data record template, and the format of the data stored in the fields of the data record template, e.g., 2003. The server may obtain transaction data records for normalization. The server may query a database, e.g., 2004, for non-normalized records. In one embodiment, no querying is required as the normalization of records may occur in flight (e.g., in real time as data is received). For example, the server may issue PHP/SQL commands to retrieve records that do not have the ‘norm_flag’ field from the example template above, or those where the value of the ‘norm_flag’ field is ‘false’. Upon obtaining the non-normalized transaction data records, the server may select one of the non-normalized transaction data records, e.g., 2005. The server may parse the non-normalized transaction data record, e.g., 2006, and determine the fields present in the non-normalized transaction data record, e.g., 2007. For example, the server may utilize a procedure similar to one described below with reference to FIG. 21 The server may compare the fields from the non-normalized transaction data record with the fields extracted from the normalized transaction data record template. For example, the server may determine whether the field identifiers of fields in the non-normalized transaction data record match those of the normalized transaction data record template, (e.g., via a dictionary, thesaurus, etc.), are identical, are synonymous, are related, and/or the like. Based on the comparison, the server may generate a 1:1 mapping between fields of the non-normalized transaction data record match those of the normalized transaction data record template, e.g., 2009. The server may generate a copy of the normalized transaction data record template, e.g., 2010, and populate the fields of the template using values from the non-normalized transaction data record, e.g., 2011. The server may also change the value of the ‘norm_flag’ field to ‘true’ in the example above. The server may store the populated record in a database (for example, replacing the original version), e.g., 2012. The server may repeat the above procedure for each non-normalized transaction data record (see e.g., 2013), until all the non-normalized transaction data records have been normalized.

With reference to FIG. 20B, in some embodiments, the server may utilize metadata (e.g., easily configurable data) to drive an analytics and rule engine that may convert any structured data into a standardized XML format (“encryptmatics” XML). The encryptmatics XML may then be processed by an encryptmatics engine that is capable of parsing, transforming and analyzing data to generate decisions based on the results of the analysis. Accordingly, in some embodiments, the server may implement a metadata-based interpretation engine that parses structured data, including, but not limited to: web content (see e.g., 2021), graph databases (see e.g., 2022), micro blogs, images or software code (see e.g., 2024), and converts the structured data into commands in the encryptmatics XML file format. For example, the structured data may include, without limitation, software code, images, free text, relational database queries, graph queries, sensory inputs (see e.g., 2023, 2025), and/or the like. A metadata based interpretation engine engine, e.g., 2026, may populate a data/command object, e.g., 2027, based on a given record using configurable metadata, e.g., 2028. The configurable metadata may define an action for a given glyph or keyword contained within a data record. The engine may then process the object to export its data structure as a collection of encryptmatics vaults in a standard encryptmatics XML file format, e.g., 2029. The encryptmatics XML file may then be processed to provide various features by an encryptmatics engine, e.g., 2030.

In some embodiments, the server may obtain the structured data, and perform a standardization routine using the structured data as input (e.g., including script commands, for illustration). For example, the server may remove extra line breaks, spaces, tab spaces, etc. from the structured data, e.g. 2031. The server may determine and load a metadata library, e.g., 2032, using which the server may parse subroutines or functions within the script, based on the metadata, e.g., 2033-2034. In some embodiments, the server may pre-parse conditional statements based on the metadata, e.g., 2035-2036. The server may also parse data 2037 to populate a data/command object based on the metadata and prior parsing, e.g., 2038. Upon finalizing the data/command object, the server may export 2039 the data/command object as XML in standardized encryptmatics format.

FIG. 21 shows a logic flow diagram illustrating example aspects of recognizing data fields in normalized aggregated data records in some embodiments of the ICST, e.g., a Data Field Recognition (“DFR”) component 2100. In some implementations, a server may recognize the type of data fields included in a data record, e.g, date, address, zipcode, name, user ID, email address, payment account number (PAN), CVV2 numbers, and/or the like. The server may select an unprocessed data record for processing, e.g., 2101. The server may parse the data record rule, and extract data fields from the data record, e.g., 2102. The server may query a database for data field templates, e.g., 2103. For example, the server may compare the format of the fields from the data record to the data record templates to identify a match between one of the data field templates and each field within the data record, thus identifying the type of each field within the data record. In one embodiment, the data field templates may be implemented as a collection of regular expressions, a set of interpreted or compiled language commands that when run against the candidate match return boolean true or false if the candidate matches, and/or the like. The server may thus select an extracted data field from the data record, e.g., 2104. The server may select a data field template for comparison with the selected data field, e.g., 2105, and compare the data field template with the selected data field, e.g., 2106, to determine whether format of extracted data field matches format of data field template, e.g., 2107. If the format of the selected extracted data field matches the format of the data field template, e.g., 2108, option “Yes,” the server may assign the type of data field template to the selected data field, e.g., 2109. If the format of the extracted data field does not match the format of the data field template, e.g., 2108, option “No,” the server may try another data field template until no more data field templates are available for comparison, see e.g., 2110. If no match is found, the server may assign “unknown” string as the type of the data field, e.g., 2111. The server may store the updated data record in the database, e.g., 2112. The server may perform such data field recognition for each data field in the data record (and also for each data record in the database), see e.g., 2113.

FIG. 22 shows a logic flow diagram illustrating example aspects of classifying entity types in some embodiments of the ICST, e.g., an Entity Type Classification (“ETC”) component 2200. In some implementations, a server may apply one or more classification labels to each of the data records. For example, the server may classify the data records according to entity type, according to criteria such as, but not limited to: geo-political area, number of items purchased, and/or the like. The server may obtain transactions from a database that are unclassified, e.g., 2201, and obtain rules and labels for classifying the records, e.g., 2202. For example, the database may store classification rules, such as the exemplary illustrative XML-encoded classification rule provided below:

<rule>

<id>PURCHASE_44_45</id>
<name>Number of purchasers</name>
<inputs>num_purchasers</inputs>
<operations>

<1>label = ‘null’</1>
<2>IF (num_purchasers > 1) label = ‘household’</2>

</operations>
<outputs>label</outputs>

</rule>

The server may select an unclassified data record for processing, e.g., 2203. The server may also select a classification rule for processing the unclassified data record, e.g., 2204. The server may parse the classification rule, and determine the inputs required for the rule, e.g., 2205. Based on parsing the classification rule, the server may parse the normalized data record template, e.g., 2206, and extract the values for the fields required to be provided as inputs to the classification rule. The server may parse the classification rule, and extract the operations to be performed on the inputs provided for the rule processing, e.g., 2207. Upon determining the operations to be performed, the server may perform the rule-specified operations on the inputs provided for the classification rule, e.g., 2208. In some implementations, the rule may provide threshold values. For example, the rule may specify that if the number of products in the transaction, total value of the transaction, average luxury rating of the products sold in the transaction, etc. may need to cross a threshold in order for the label(s) associated with the rule to be applied to the transaction data record. The server may parse the classification rule to extract any threshold values required for the rule to apply, e.g., 2209. The server may compare the computed values with the rule thresholds, e.g., 2210. If the rule threshold(s) is crossed, e.g., 2211, option “Yes,” the server may apply one or more labels to the transaction data record as specified by the classification rule, e.g., 2212. For example, the server may apply a classification rule to an individual product within the transaction, and/or to the transaction as a whole. In other embodiments, the rule may specify criteria that may be present in the mesh in order to generate a new entity (e.g., to create a deduced concept or deduced entity). For example, if a given set of mesh aggregated data contain references the a keyword iPhone, a rule may specify that “iPhone” is to be created as a deduced node within the mesh. This may be done in a recursive manner, such as when the creation of the meta-concept of an “iPhone” may subsequently be combined with created meta-concepts of “iMac” and “iPod” in order to create a master deduced concept of “Apple Computer”, which is thereafter associated with “iPhone,” “iMac,” and “iPod”. In so doing, the rules may allow the mesh, given the aggregated content available as well as inputs (such as category inputs) to automatically create meta-concepts based on rules that are themselves unaware of the concepts. In one embodiment, a rule for the creation of a meta-concept, substantially in the form of XML is:

<rule id=”create_deduced_concept_5” type=”deduced_concept”>

<criteria>

<number_keyword_references>

<is type=”greater_than” value=”50” />
<isnot type=”greater_than” value=”500” />

</number_keyword_references>

</criteria>
<if_criteria_met value=”create_entity’ />

</rule>

In the example above, a new deduced entity may be added to the mesh if the number of other entites referencing a given keyword is greater than 50 but less than 500. In one embodiment, the criteria may be specified as a scalar value as shown above. In other embodiments, the criteria may reference a percentage size of the mesh references (such as greater than 5% but less than 10%). In so doing, entities may be added only when they reach a certain absolute threshold, or alternatively when they reach a threshold with respect to the mesh itself. In other embodiments, the criteria may be a function (such as a Python procedure) that may be performed in order to determine if a new meta-entity should be created. In such an embodiment, the rule may take advantage of any language features available (e.g., language method/functions) as well as external data sources (such as by querying Wikipedia for the presence of a page describing the candidate meta-concept, performing a Google Search and only creating the meta concept if greater than a given number of results are returned, and/or the like). In one embodiment, deduced entries may be created based on a specified or relative frequence of occurance matches (e.g., keyword matches, transaction occurances, and/or the like) within a certain time quantum (e.g., 5 orders for an item within a day/week/month, 100 tweeks a minute about a topic, and/or the like). Deduced entities may become actual mesh entities (and actual mesh entities may be come deduced entities) through the application of similar rules. For example, if an entity is deduced but subsequently the data aggregation shows a sufficient social media discussion regarding a deduced concept, the concept may be changed from a deduced concept to a mesh concept. In so doing, the mesh can adapt to evolving entities that may initially exist only by virtue of their relationship to other nodes, but may ultimately become concepts that the mesh may assign to actual entities.

In some implementations, the server may process the transaction data record using each rule (see, e.g., 2213). Once all classification rules have been processed for the transaction record, e.g., 2213, option “No,” the server may store the transaction data record in a database, e.g., 2214. The server may perform such processing for each transaction data record until all transaction data records have been classified (see, e.g., 2215).

FIG. 23 shows a logic flow diagram illustrating example aspects of identifying cross-entity correlation in some embodiments of the ICST, e.g., a Cross-Entity Correlation (“CEC”) component 2300. In some implementations, a server may recognize that two entites in the ICST share common or related data fields, e.g, date, address, zipcode, name, user ID, email address, payment account number (PAN), CVV2 numbers, and/or the like, and thus identify the entities as being correlated. The server may select a data record for cross-entity correlation, e.g., 2301. The server may parse the data record rule, and extract data fields from the data record, e.g., 2302-1703. The server may select an extracted data field from the data record, e.g., 2304, and query a database for other data records having the same data field as the extracted data field, e.g., 2305. From the list of retrieved data records from the database query, the server may select a record for further analysis. The server may identify, e.g., 2307, an entity associated with the retrieved data record, e.g., using the ETC 2200 component discussed above in the description with reference to FIG. 22. The server may add a data field to the data record obtained for cross-entity correlation specifying the correlation to the retrieved selected data record, e.g., 2308. In some embodiments, the server may utilize each data field in the data record obtained for cross-entity correlation to identify correlated entities, see e.g., 2309. The server may add, once complete, a “correlated” flag to the data record obtained for cross-entity correlation, e.g., 2310, e.g., along with as timestamp specifying the time at which the cross-entity correlation was performed. For example, such a timestamp may be used to determine at a later time whether the data record should be processed again for cross-entity correlation. The server may store the updated data record in a database.

FIG. 24 shows a logic flow diagram illustrating example aspects of associating attributes to entities in some embodiments of the ICST, e.g., an Entity Attribute Association (“EAA”) component 2400. In some implementations, a server may associate attributes to an entity, e.g., if the entity id a person, the server may identify a demographic (e.g., male/female), a spend character, a purchase preferences list, a merchants preference list, and/or the like, based on field values of data fields in data records that are related to the entity. In some implementations, a server may obtain a data record for entity attribute association, e.g., 2401. The server may parse the data record rule, and extract data fields from the data record, e.g., 2402-2403. The server may select an extracted data field from the data record, e.g., 2404, and identify a field value for the selected extracted data field from the data record, e.g., 2405. The server may query a database for demographic data, behavioral data, and/or the like, e.g., 2406, using the field value and field type. In response, the database may provide a list of potential attributes, as well as a confidence level in those attribute associations to the entity, see e.g., 2407. The server may add data fields to the data record obtained for entity attribute association specifying the potentially associated attributes and their associated confidence levels, e.g., 2408. In some embodiments, the server may utilize each data field in the data record obtained for cross-entity correlation to identify correlated entities, see e.g., 2409. The server may store the updated data record in a database, e.g., 2410.

FIG. 25 shows a logic flow diagram illustrating example aspects of updating entity profile-graphs in some embodiments of the ICST, e.g., an Entity Profile-Graph Updating (“EPGU”) component 2500. In some implementations, a server may generate/update a profile for an entity whose data is stored within the ICST. The server may obtain an entity profile record for updating, e.g., 2501. The server may parse the entity profile record, and extract an entity identifier data field from the data record, e.g., 2502. The server may query a database for other data records that are related to the same entity, e.g., 2503, using the value for the entity identifier data field. In response, the database may provide a list of other data records for further processing. The server may select one of the other data records to update the entity profile record, e.g., 2504. The server may parse the data record, and extract all correlations, associations, and new data from the other record, e.g., 2505. The server may compare the correlations, attributes, associations, etc., from the other data record with the correlations, associations and attributes from the entity profile. Based on this comparison, the server may identify any new correlations, associations, etc., and generate an updated entity profile record using the new correlations, associations; flag new correlations, associations for further processing, e.g., 2507. In some embodiments, the server may utilize each data record obtained for updating the entity profile record as well as its social graph (e.g., as given by the correlations and associations for the entity), see e.g., 2509. The server may store the updated entity profile record in a database, e.g., 2508.

FIG. 26 shows a logic flow diagram illustrating example aspects of generating search terms for profile-graph updating in some embodiments of the ICST, e.g., a Search Term Generation (“STG”) component 2600. In some implementations, a server may generate/update a profile for an entity whose data is stored within the ICST, by performing search for new data, e.g., across the Internet and social networking services. The server may obtain an entity profile record for updating, e.g., 2601. The server may parse the entity profile record, and extract data field types and field values from the entity profile record, e.g., 2602. The server may query a database for other data records that are related to the same entity, e.g., 2603, using the values for the extracted data fields. In response, the database may provide a list of other data records for further processing. The server may parse the data records, and extract all correlations, associations, and data from the data records, e.g., 2604. The server may aggregate all the data values from all the records and the entity profile record, e.g., 2605. Based on this, the server may return the aggregated data values as search terms to trigger search processes (see e.g., FIG. 9, 901-905), e.g., 2606.

### Electronic Virtual Wallet User Interface

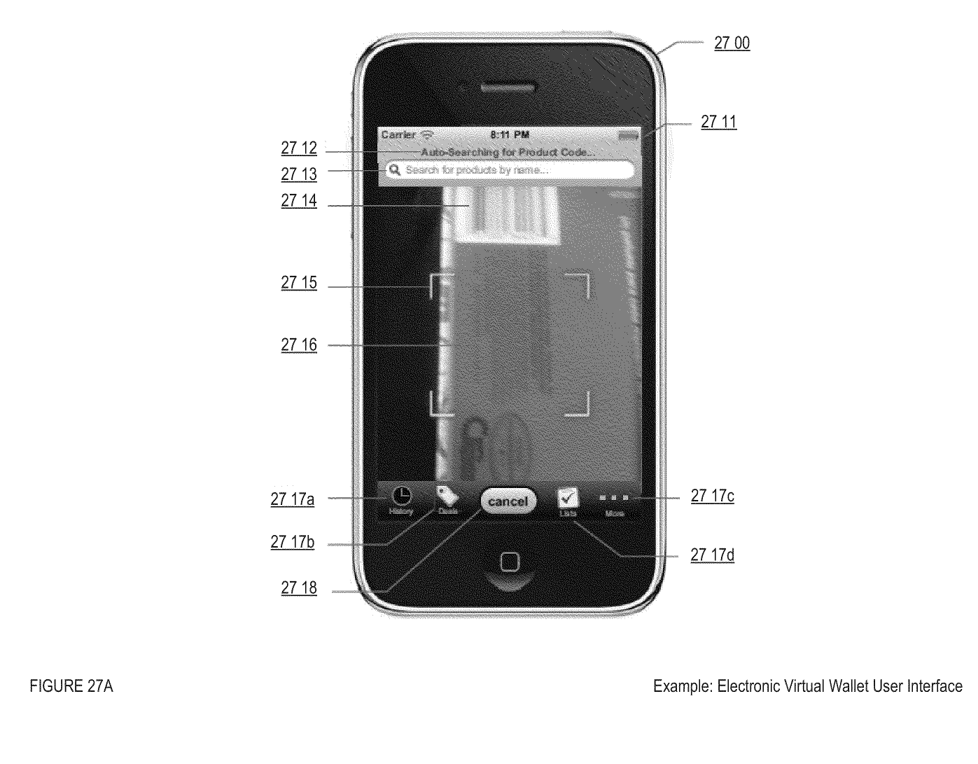

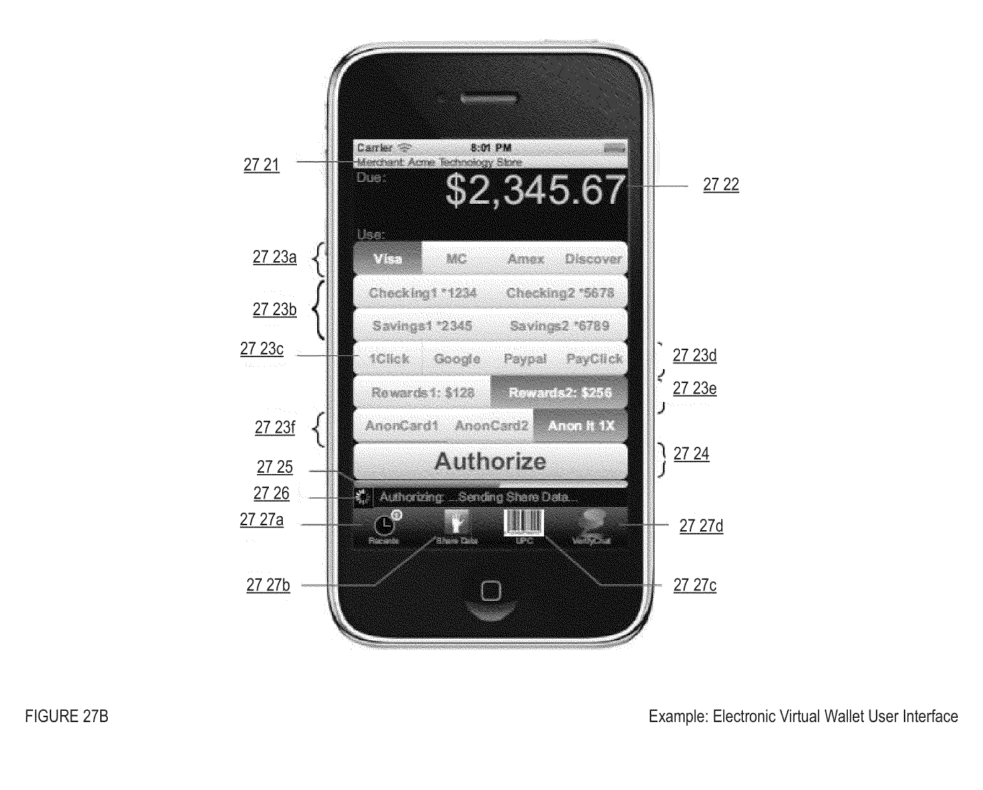

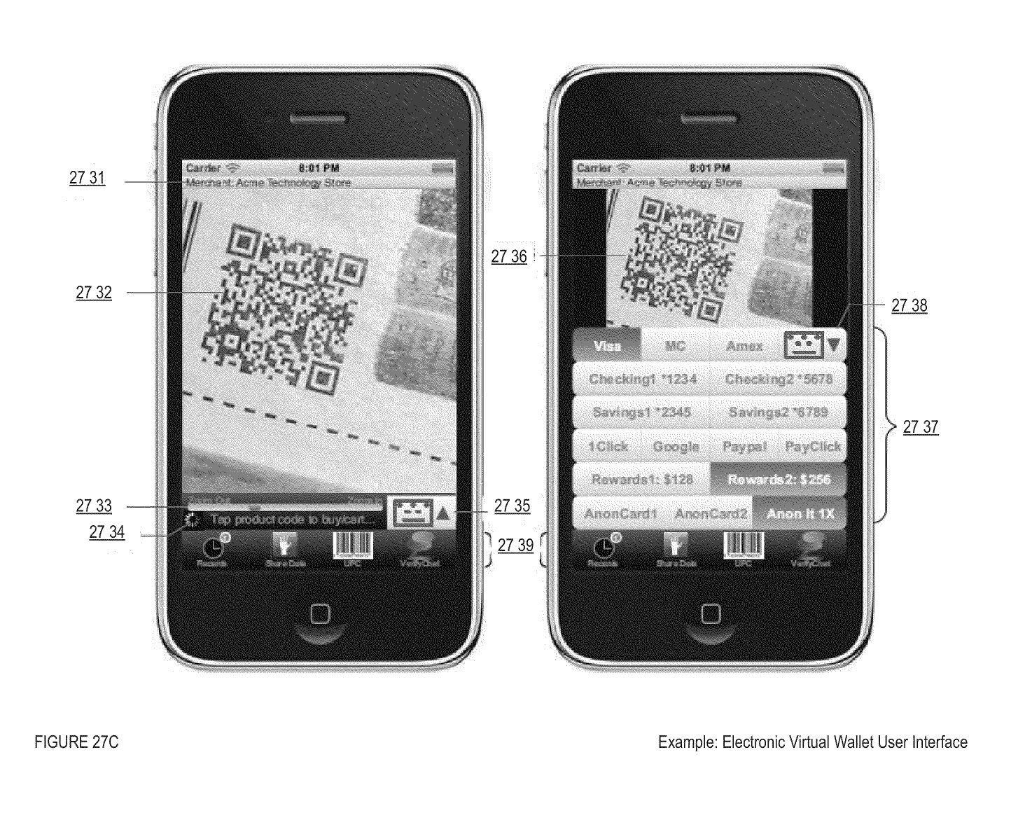

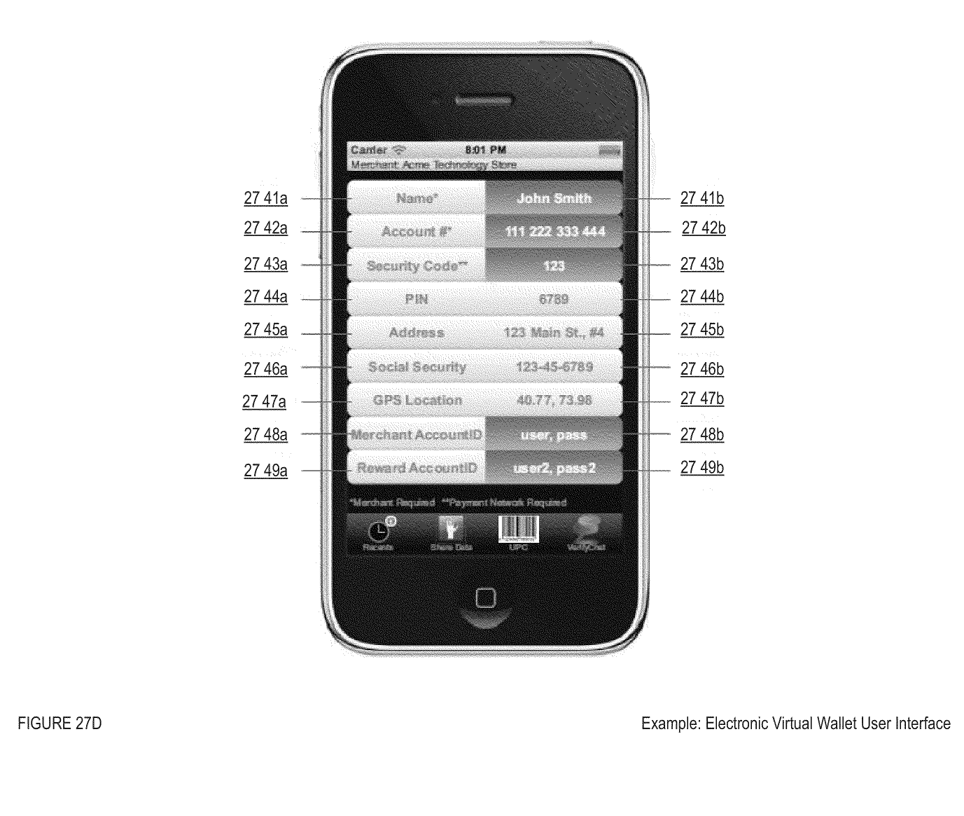

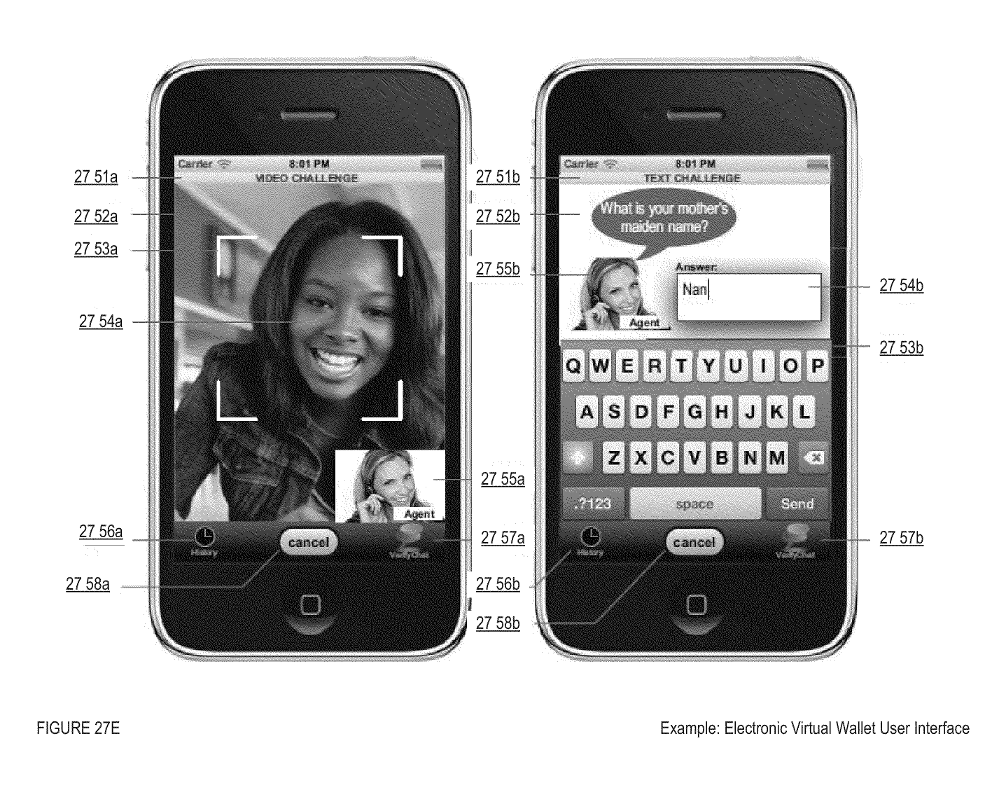

FIGS. 27A-E show user interface diagrams illustrating example features of user interfaces for an electronic virtual wallet in some embodiments of the ICST. With reference to FIG. 27A, in some embodiments, a virtual wallet mobile app, e.g., 2711, executing on a device, e.g., 2700, of a user may include an app interface providing various features for the user. For example, the device may include a camera via which the app may acquire image frames, video data, live video, and/or the like, e.g., 2716. The app may be configured to analyze the incoming data, and search, e.g., 2712, for a product identifier, e.g., 2714, such as barcodes, QR codes and/or the like.

In some embodiments, the app may be configured to automatically detect, e.g., 2712, the presence of a product identifier within an image or video frame grabbed by the device (e.g., via a webcam, in-built camera, etc.). For example, the app may provide a “hands-free” mode of operation wherein the user may move the device to bring product identifiers within the field of view of the image/video capture mechanism of the device, and the app may perform image/video processing operations to automatically detect the product identifier within the field of view. In some embodiments, the app may overlay cross-hairs, target box, and/or like alignment reference markers, e.g., 2715, so that a user may align the product identifier using the reference markers to facilitate product identifier recognition and interpretation.

In some embodiments, the detection of a product identifier may trigger various operations to provide products, services, information, etc. for the user. For example, the app may be configured to detect and capture a QR code having embedded merchant and/or product information, and utilize the information extracted from the QR code to process a transaction for purchasing a product from a merchant. As other examples, the app may be configured to provide information on related products, quotes, pricing information, related offers, (other) merchants related to the product identifier, rewards/loyalty points associated with purchasing the product related to the product identifier, analytics on purchasing behavior, alerts on spend tracking, and/or the like.

In some embodiments, the app may include user interface elements to allow the user to manually search, e.g., 2713, for products (e.g., by name, brand, identifier, etc.). In some embodiments, the app may provide the user with the ability to view prior product identifier captures (see, e.g., 2717a) so that the user may be able to better decide which product identifier the user desires to capture. In some embodiments, the app may include interface elements to allow the user to switch back and forth between the product identification mode and product offer interface display screens (see, e.g., 2717b), so that a user may accurately study deals available to the user before capturing a product identifier. In some embodiments, the user may be provided with information about products, user settings, merchants, offers, etc. in list form (see, e.g., 2717c) so that the user may better understand the user's purchasing options. Various other features may be provided for in the app (see, e.g., 2717d). In some embodiments, the user may desire to cancel product purchasing; the app may provide the user with a user interface element (e.g., 2718) to cancel the product identifier recognition procedure and return to the prior interface screen the user was utilizing.

With reference to FIG. 27B, in some embodiments, the app may include an indication of the location (e.g., name of the merchant store, geographical location, information about the aisle within the merchant store, etc.) of the user, e.g., 2721. The app may provide an indication of a pay amount due for the purchase of the product, e.g., 2722. In some embodiments, the app may provide various options for the user to pay the amount for purchasing the product(s). For example, the app may utilize GPS coordinates associated with the device to determine the merchant store within which the user is present, and direct the user to a website of the merchant. In some embodiments, the app may be configured to make an application programming interface (“API”) call to participating merchants to directly facilitate transaction processing for purchases. In some embodiments, a merchant-branded app may be developed with an in-app purchasing mode, which may directly connect the user into the merchant's transaction processing system. For example, the user may choose from a number of cards (e.g., credit cards, debit cards, prepaid cards, etc.) from various card providers, e.g., 2723a. In some embodiments, the app may provide the user the option to pay the purchase amount using funds included in a bank account of the user, e.g., a checking, savings, money market, current account, etc., e.g., 2723b. In some embodiments, the user may have set default options for which card, bank account, etc. to use for the purchase transactions via the app. In some embodiments, such setting of default options may allow the user to initiate the purchase transaction via a single click, tap, swipe, and/or other remedial user input action, e.g., 2723c. In some embodiments, when the user utilizes such an option, the app may utilize the default settings of the user to initiate the purchase transaction. In some embodiments, the app may allow the user to utilize other accounts (e.g., Google™ Checkout, Paypal™ account, etc.) to pay for the purchase transaction, e.g., 2723d. In some embodiments, the app may allow the user to utilize rewards points, airline miles, hotel points, electronic coupons, printed coupons (e.g., by capturing the printed coupons similar to the product identifier) etc., to pay for the purchase transaction, e.g., 2723e. In some embodiments, the app may provide an option to provide express authorization before initiating the purchase transaction, e.g., 2724. In some embodiments, the app may provide a progress indicator provide indication on the progress of the transaction after the user has selected an option to initiate the purchase transaction, e.g., 2725. In some embodiments, the app may provide the user with historical information on the user's prior purchases via the app, e.g., 2727a. In some embodiments, the app may provide the user with an option to share information about the purchase (e.g., via email, SMS, wall posting on Facebook®, tweet on Twitter™, etc.) with other users and/or control information shared with the merchant, acquirer, payment network etc., to process the purchase transaction, e.g., 2727b. In some embodiments, the app may provide the user an option to display the product identification information captured by the client device (e.g., in order to show a customer service representative at the exit of a store the product information), e.g., 2727c. In some embodiments, the user, app, device and or purchase processing system may encounter an error in the processing. In such scenarios, the user may be able to chat with a customer service representative (e.g., VerifyChat 2727d) to resolve the difficulties in the purchase transaction procedure.

In some embodiments, the user may select to conduct the transaction using a one-time anonymized credit card number, see e.g., 2723f. For example, the app may utilize a pre-designated anonymized set of card details (see, e.g., “AnonCard1,” “AnonCard2”). As another example, the app may generate, e.g., in real-time, a one-time anonymous set of card details to securely complete the purchase transaction (e.g., “Anon It 1X”). In such embodiments, the app may automatically set the user profile settings such that the any personal identifying information of the user will not be provided to the merchant and/or other entities. In some embodiments, the user may be required to enter a user name and password to enable the anonymization features.

With reference to FIG. 27C, in some embodiments, the user interface elements of the app may be advantageously arranged to provide the user the ability to process a purchase with customized payment parameters with a minimum number of user inputs applied to the user's device. For example, if the user has a QR pay code, e.g., 2732, within the viewing angle of a camera included in the user's mobile device, the user may activate a user interface element to snap the QR code. In some embodiments, the user may control the field of view of the camera using a user interface zoom element, e.g., 2733. In some embodiments, the user interface may be designed such that the user may touch an image of a QR code displayed on the screen to capture the QR code (see e.g., 2734). For example, the position of the user's touch may be utilized as an input by an image processing module executing on the user's device to process the displayed video frame (and/or adjacent video frames), and extract the QR code from the frame(s) based on the user's input. For example, the user's touch may provide an approximate center point of the QR code. Using this information, the image processing module may be able to better perform an automated QR code image recognition, and accordingly capture the correct QR code (e.g., if portions of many QR codes are displayed within the video frame(s)) selected by the user for capture and processing.

In some embodiments, the app may utilize predetermined default settings for a particular merchant, e.g., 2731, to process the purchase based on the QR code (e.g., in response to the user touching an image of a QR code displayed on the screen of the user device). However, if the user wishes to customize the payment parameters, the user may activate a user interface element 2735(or e.g., press and continue to hold the image of the QR code 2732). Upon doing so, the app may provide a pop-up menu, e.g., 2737, providing a variety of payment customization choices, such as those described with reference to FIG. 27B. The user may, e.g., drag the user's finger to the appropriate settings the user prefers, and release the user's finger from the touchscreen of the user's mobile device to select the setting for payment processing. In alternate embodiments, the payment settings options, e.g., 2737, and QR capture activation button, e.g., 2736 may be included in the user interface along with a window for capturing the QR code via the mobile device's camera. In alternate embodiments, the user's mobile device may generate a hybrid QR code-payment settings graphic, and the POS terminal (or user's trusted computing device) may capture the entire graphic for payment processing. In some embodiments, the app may provide a user interface element 2738 for the user to minimize the payment options settings user interface elements. In some embodiments, the app may provide additional user interface elements, e.g., 2739, to display previous purchases, data shared about those purchases, purchase receipts (e.g., via barcodes) and customer support options (e.g., VerifyChat).

With reference to FIG. 27D, in some embodiments, the user may be able to view and/or modify the user profile and/or settings of the user, e.g., by activating user interface element 2722 (of FIG. 27B). For example, the user may be able to view/modify a user name (e.g., 2741a-b), account number (e.g., 2742a-b), user security access code (e.g., 2743a-b), user pin (e.g., 2744a-b), user address (e.g., 2745a-b), social security number associated with the user (e.g., 2746a-b), current device GPS location (e.g., 2747a-b), user account of the merchant in whose store the user currently is (e.g., 2748a-b), the user's rewards accounts (e.g., 2749a-b), and/or the like. In some embodiments, the user may be able to select which of the data fields and their associated values should be transmitted to facilitate the purchase transaction, thus providing enhanced data security for the user. For example, in the example illustration in FIG. 27D, the user has selected the name 2741a, account number 2742a, security code 2743a, merchant account ID 2748a and rewards account ID 2749a as the fields to be sent as part of the notification to process the purchase transaction. In some embodiments, the user may toggle the fields and/or data values that are sent as part of the notification to process the purchase transactions. In some embodiments, the app may provide multiple screens of data fields and/or associated values stored for the user to select as part of the purchase order transmission. In some embodiments, the app may obtain the GPS location of the user. Based on the GPS location of the user, the app may determine the context of the user (e.g., whether the user is in a store, doctor's office, hospital, postal service office, etc.). Based on the context, the app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some embodiments, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 27E, in some embodiments, the app executing on the user's device may provide a “VerifyChat” feature for fraud prevention (e.g., by activating UI element 2727d in FIG. 27B). For example, the ICST may detect an unusual and/or suspicious transaction. The ICST may utilize the VerifyChat feature to communicate with the user, and verify the authenticity of the originator of the purchase transaction. In various embodiments, the ICST may send electronic mail message, text (SMS) messages, Facebook® messages, Twitter™ tweets, text chat, voice chat, video chat (e.g., Apple FaceTime), and/or the like to communicate with the user. For example, the ICST may initiate a video challenge for the user, e.g., 2751a. For example, the user may need to present him/her-self via a video chat, e.g., 2752a. In some embodiments, a customer service representative, e.g., agent 2755a, may manually determine the authenticity of the user using the video of the user. In some embodiments, the ICST may utilize face, biometric and/or like recognition (e.g., using pattern classification techniques) to determine the identity of the user, e.g., 2754a. In some embodiments, the app may provide reference marker (e.g., cross-hairs, target box, etc.), e.g., 2753a, so that the user may the video to facilitate the ICST's automated recognition of the user. In some embodiments, the user may not have initiated the transaction, e.g., the transaction is fraudulent. In such embodiments, the user may cancel, e.g., 2758a, the challenge. The ICST may then cancel the transaction, and/or initiate fraud investigation procedures on behalf of the user. In some embodiments, the app may provide additional user interface elements, e.g., to display previous session 2756a, and provide additional customer support options (e.g., VerifyChat 2757a).

In some embodiments, the ICST may utilize a text challenge procedure to verify the authenticity of the user, e.g., 2751b. For example, the ICST may communicate with the user via text chat, SMS messages, electronic mail, Facebook® messages, Twitter™ tweets, and/or the like. The ICST may pose a challenge question, e.g., 2752b, for the user. The app may provide a user input interface element(s) (e.g., virtual keyboard 2753b) to answer the challenge question posed by the ICST. In some embodiments, the challenge question may randomly selected by the ICST automatically; in some embodiments, a customer service representative 2755b may manually communicate with the user. In some embodiments, the user may not have initiated the transaction, e.g., the transaction is fraudulent. In such embodiments, the user may cancel, e.g., 2758b, the text challenge. The ICST may then cancel the transaction, and/or initiate fraud investigation procedures on behalf of the user. In some embodiments, the app may provide additional user interface elements, e.g., to display previous session 2756b, and provide additional customer support options (e.g., VerifyChat 2757b).

### Merchant Analytics Platform

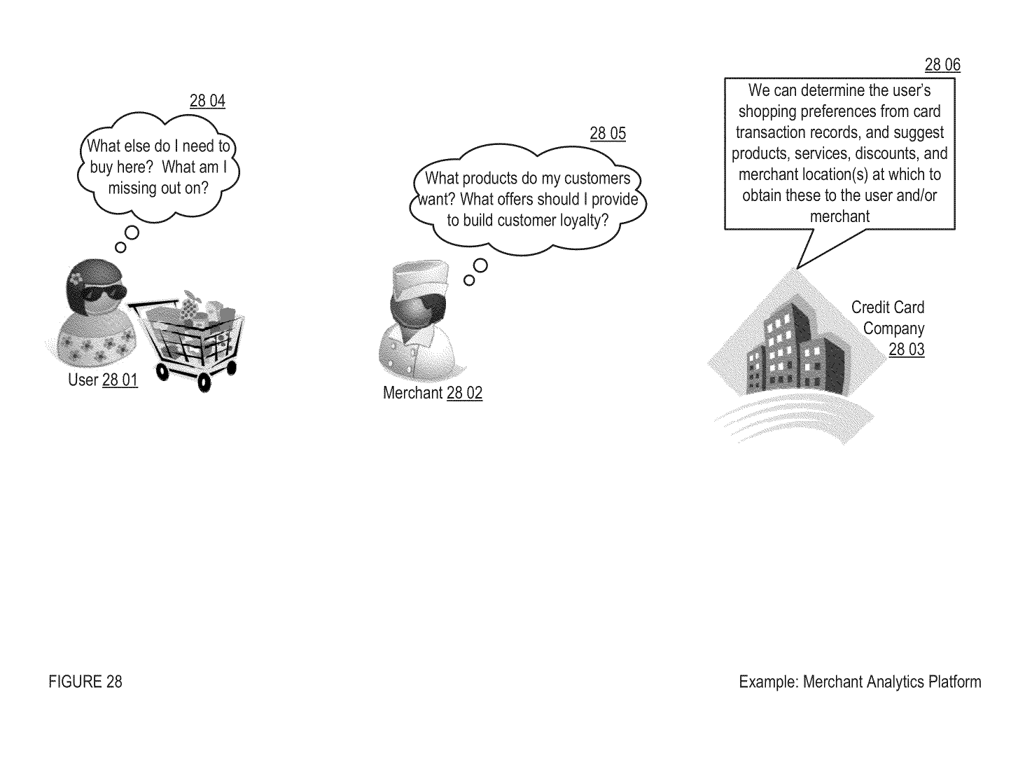

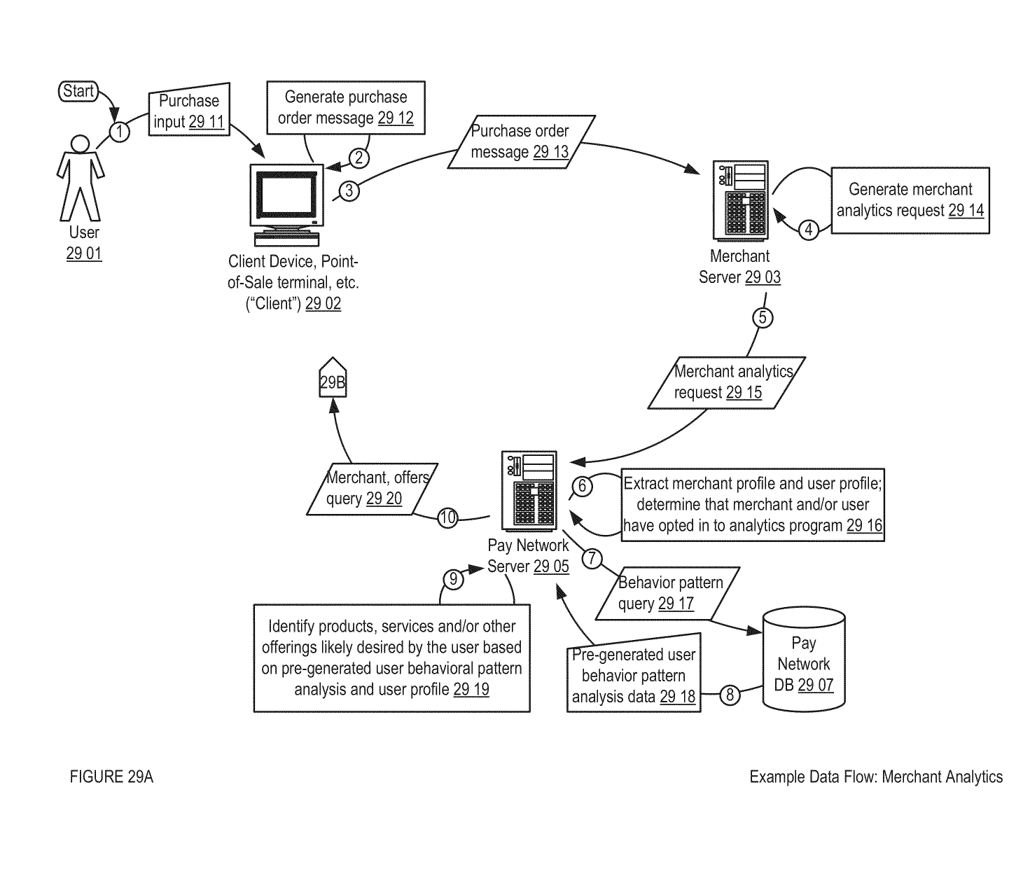

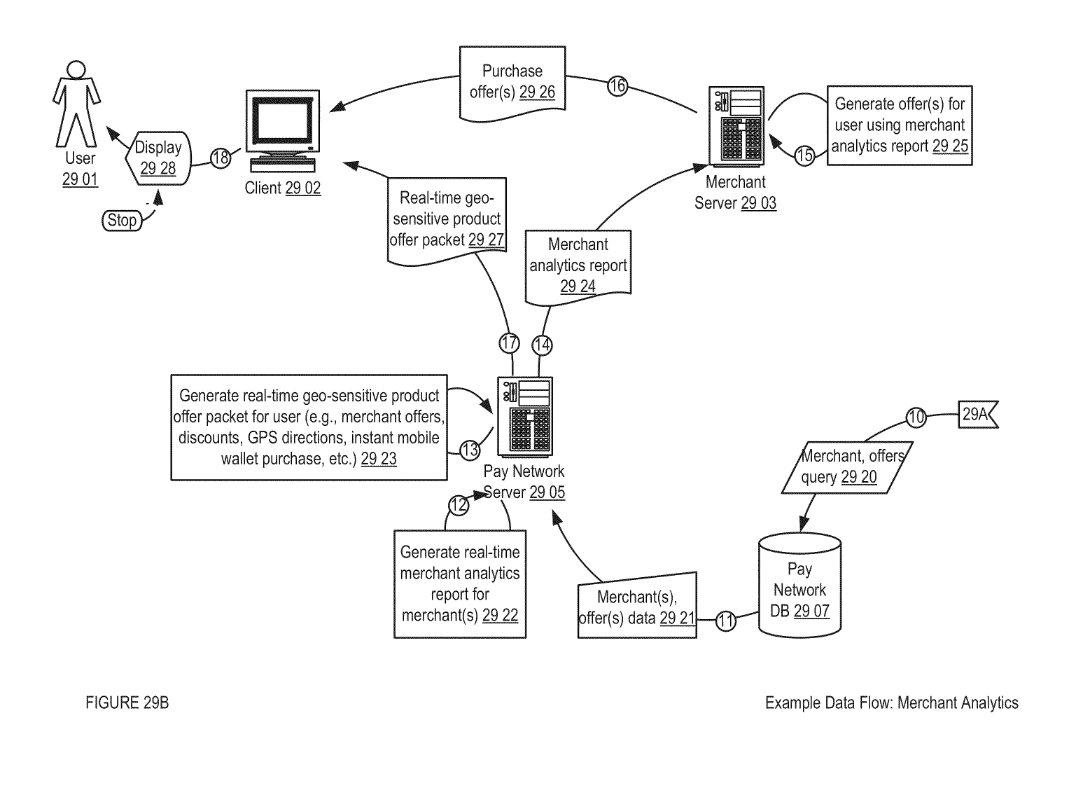

FIG. 28 shows a block diagram illustrating example aspects of a merchant analytics platform in first set of embodiments of the ICST. In some implementations, a user, e.g., 2801, may desire to purchase products from a merchant. For example, the user may utilize a card (e.g., a credit card, debit, card, prepaid card, charge card, etc.) to purchase products, services, and/or other offerings (“products”) from a merchant 2802. In some implementations, the user may exhibit consumption patterns. For example, the user may often buy a similar set of products simultaneously each time the user shops. In some implementations, the purchasing patterns of the user may be reflected in the card transactions conducted by the user. For example, the consumption patterns may reflect in card transaction records of the transactions conducted by the user, which may be mined by a card company, e.g., 2803. In some implementations, information as to the general preferences of the user, purchasing preferences of the user, cost-sensitivities of the user, etc. may be gleaned from studying the aggregated card transaction records pertaining to the user. For example, analysis of the aggregated user card transaction records may indicate a preference for shopping within a particular geographical area, at particular times, with particular merchants, for particular products types, categories, brand names, quantities, and/or the like. As another example, analysis of the aggregated card transaction records may indicate correlations between purchases of the user. For example, the analysis may provide the ability to predict (with a known confidence level) that a user may purchase product B given that the user has purchased (or intends to purchase) product A (or products A, and/or C, and/or D, etc.). Thus, in some implementations, analysis of the aggregated card transaction records of a user may allow the ICST to provide suggestions to the merchant and/or user as to products that the user is likely to be interested in purchasing. For example, a user may desire suggestions as to what products, services, offerings, deals that user may be interested in, e.g., 2804. In some implementations, the ICST may provide such suggestions, e.g., 2806, to the user on a real-time basis (e.g., as the user is scanning products at a point-of-sale terminal, as the user is performing a price check, as the user is paying for a purchase, etc., as the user walks by a merchant where the ICST determines that products of interest to the user are available, etc.). In some implementations, a merchant, e.g., 2802, may desire to understand customer behavior better so that the merchant may determine which products to provide for customers to generate maximum retail sales, generate customer loyalty, etc, e.g., 2805. In some implementations, the ICST may provide merchant analytics reports to the merchant including recommendations of product, service, discount, Groupon® offers, and/or other offers that the merchant can make to the user based on the user's behavioral patterns, e.g., 2806.

FIGS. 29A-B show data flow diagrams illustrating an example procedure to provide a user and/or merchant offers for products, services and/or the like, using user behavior patterns derived from card-based transaction data in some embodiments of the ICST. In some implementations, a user, e.g., 2901, may desire to purchase a product, service, offering, and/or the like (“product”), from a merchant. The user may communicate with a merchant server, e.g., 2903, via a client such as, but not limited to: a personal computer, mobile device, television, point-of-sale terminal, kiosk, ATM, pharmacy store, store counter, and/or the like (e.g., client 2902). For example, the user may provide user input, e.g., purchase input 2911, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’
and has a CVV number of 901. ‘990112’ is a service code, and ***
represents decimal digits which change randomly each time the
card is used.)

In some implementations, the client may generate a purchase order message, e.g., 2912, and provide, e.g., 2913, the generated purchase order message to the merchant server, e.g., 2903. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for

dummies</product_title>

<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may, in response to receiving the purchase order message from the client, generate, e.g., 2914, a request for merchant analytics from a pay network server, e.g., 2905, so that the merchant may provide product offerings for the user. For illustration, in the example above, the merchant server may add an XML-encoded data structure to the body of the purchase order message, and forward the message to the pay network server. An example XML-encoded data snippet that the merchant server may add to the body of the purchase order message before forwarding to the pay network server is provided below:

<analytics_request>

<request_ID>NEUI4BGF9</request_ID>
<details>

<type>products OR services OR discounts</type>
<deliver_to>user AND merchant</deliver_to>
<timeframe>realtime</timeframe>
<user_priority>high</user_priority>
<data_source>appended</data_source>

</details>
<merchant_params>

<merchant_ID>3FBCR4INC</merchant_id>
<merchant_name>Books & Things, Inc.</merchant_name>

<merchant_auth_key>1NNF484MCP59CHB27365</merchant_auth_ke

y>

</merchant_params>

</analytics_request>

The merchant server may provide the merchant analytics request, e.g., 2915, to the pay network server. In some implementations, the pay network server may extract the merchant and user profile information from the merchant analytics request. For illustration, the pay network server may extract values of the ‘merchant_ID’ and ‘user_ID’ fields from the merchant analytics request in the examples above. Using the merchant and user profile information, the pay network server may determine whether the merchant and/or user are enrolled in the merchant analytics program. In some implementations, the pay network server may provide the results of merchant analytics only to those entities that are enrolled in the merchant analytics program. For example, the server may query a database, e.g., pay network database 2907, to determine whether the user and/or merchant are enrolled in the merchant analytics program. In some implementations, the pay network server may generate a query the database for user behavior patterns of the user for merchant analytics, e.g., 2917. For example, the database may be a relational database responsive to Structured Query Language (“SQL”) commands. The pay network server may execute a hypertext preprocessor (“PHP”) script including SQL commands to query the database for user behavior patterns of the user. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“USERS.SQL”); // select database table to search
//create query for issuser server data
$query = “SELECT behavior_profile_XML FROM UserBehaviorTable
WHERE userid LIKE ′%′ $user_id”;
$result = mysql_query($query); // perform the search query
mysql_close(“USERS.SQL”); // close database access
?>

In response to obtaining the issuer server query, e.g., 2917, the pay network database may provide, e.g., 2918, the requested behavior patterns data to the pay network server. For example, the user behavior patterns data may comprise pair-wise correlations of various variables to each other, and/or raw user transaction patterns. An example XML-encoded user behavoir pattern data file is provided below:

<?XML version = “1.0” encoding = “UTF-8”?>
<last_updated>2011-02-22 15:22:43</timestamp>
<user_ID>john.q.public@gmail.com</user_ID>
<pair_correlation_data>

<pair><time>AM</time><pdt>A</pdt><confidence>0.65</confid

ence></pair>

<pair><pdt>B</pdt><pdt>A</pdt><confidence>0.95</confidenc

e></pair>

<pair><zip>98456</zip><pdt>A</pdt><confidence>0.25</confi

dence></pair>

<pair><time>PM</time><zip>98465</zip><confidence>0.45</co

nfidence></pair>
</pair_correlation_data>
<raw_data>

<transaction>
<timestamp>2011-02-21 15:32:01</timestamp>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</transaction>
.
.
.
<transaction>

. . .

</transaction>

</raw_data>

In some implementations, the pay network server may identify products, services and/or other offerings likely desired by the user based on pre-generated user behavioral pattern analysis and user profile, e.g., 2919. The pay network server may generate a query, e.g., 2920, for merchants that may be able to provide the identified products, services, and/or offerings for the user. For example, the pay network server may generate a query based on the GPS coordinates of the user (e.g., obtained from the user's smartphone), the merchant store in which the user currently is present, etc., for merchants in the vicinity of the user who may have products included within the identified products likely desired by the user. In some implementations, the pay network server may also generate a query for offers (e.g., discount offers, Groupon® offers, etc.) that the merchant may be able to offer for the users. For example, the pay network server may utilize PHP/SQL commands similar to those provided above to query a database. In response, the database may provide, e.g., 2921, the requested merchant and/or offer data to the pay network server. In some implementations, the pay network server may generate a real-time merchant analytics report for the merchant, e.g., 2922. In some implementations, the pay network server may generate a real-time geo-sensitive product offer packet for the user, e.g., including such items as (but not limited to): merchant names, location, directions, offers, discounts, interactive online purchase options, instant mobile wallet purchase ability, order hold placing features (e.g., to hold the items for pick up so as to prevent the items going out of stock, e.g., during seasonal shopping times), and/or the like. In some implementations, the pay network server may provide the merchant analytics report, e.g., 2924, to the merchant server, and may provide the real-time geo-sensitive product offer packet, e.g., 2927, to the client. In some implementations, the merchant server may utilize the pay network server's merchant analytics report to generate, e.g., 2925, offer(s) for the user. The merchant server may provide the generated offer(s), e.g., 2926, to the user. In some implementations, the client may render and display, e.g., 2928, the real-time geo-sensitive product offer packet from the pay network server and/or purchase offer(s) from the merchant to the user.

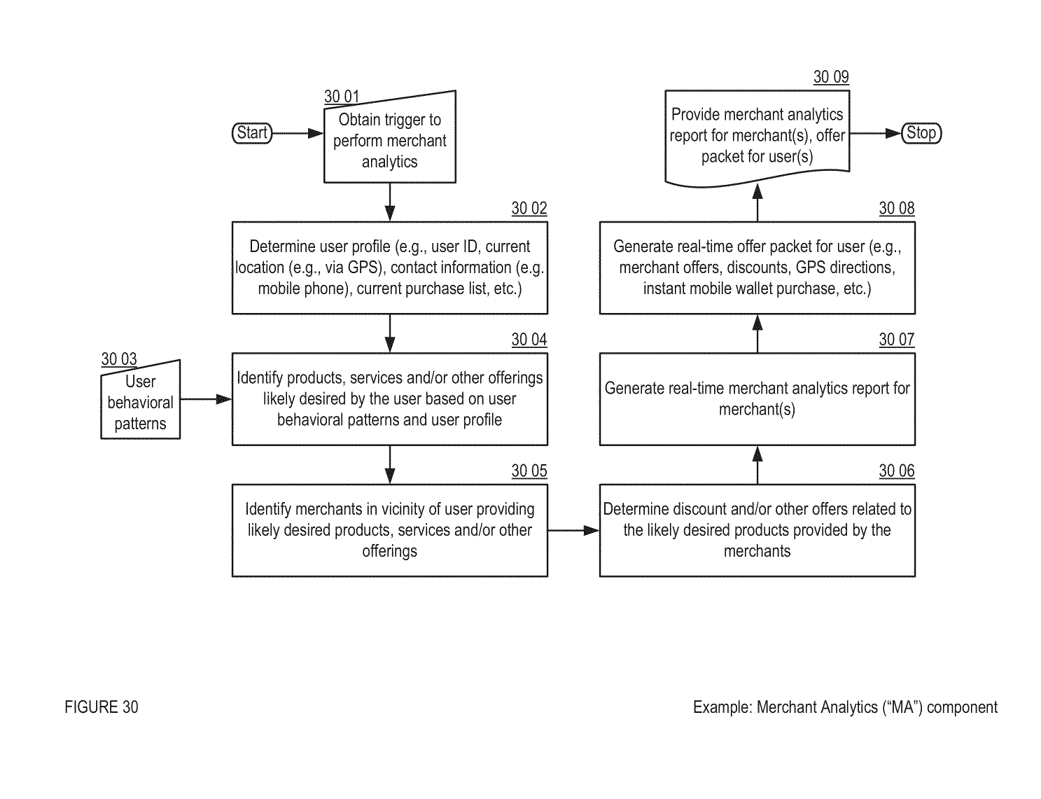

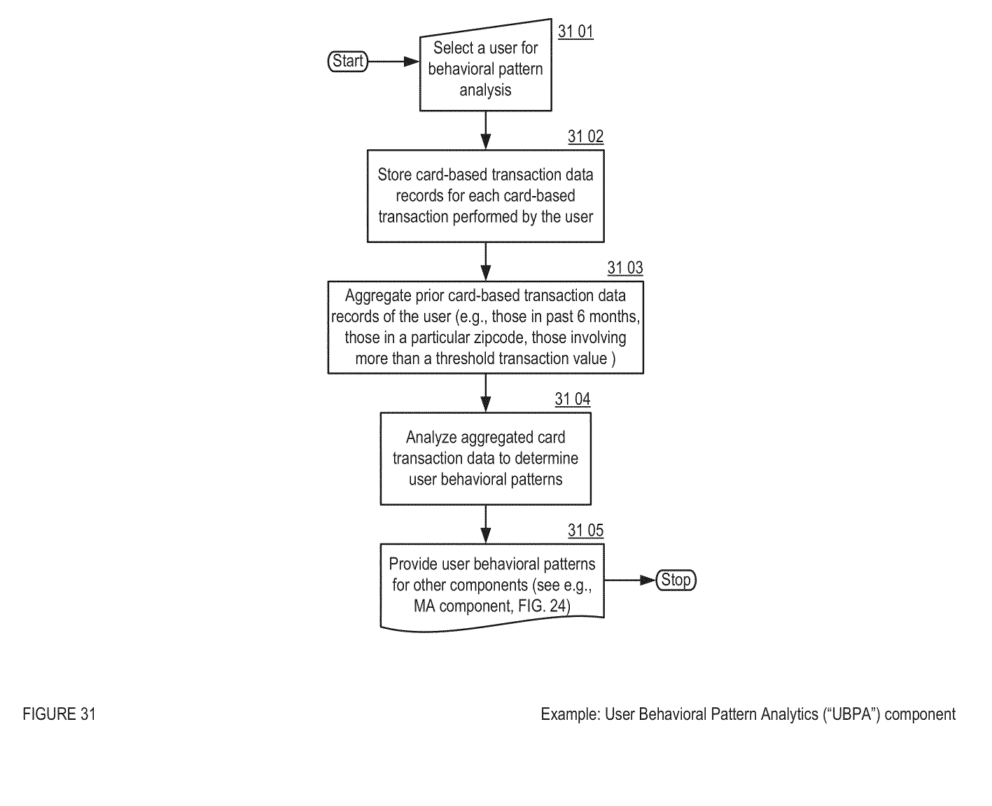

FIG. 30 shows a logic flow diagram illustrating example aspects of providing a user and/or merchant offers for products, services and/or the like, using user behavior patterns derived from card-based transaction data in some embodiments of the ICST, e.g., a Merchant Analytics (“MA”) component. In some implementations, the ICST may obtain a trigger to perform merchant analytics. For example a user may desire to purchase a product, service, offering, and/or the like (“product”), from a merchant (e.g., start scanning products in the checkout counter of the merchant's store), or may initiate a purchase transaction (e.g., attempt to pay for products purchased at the merchant store). In some implementations, the ICST may extract, e.g., 3002, the merchant and user profile information from the merchant analytics request. For example, the ICST may extract fields such as, but not limited to: user_ID, user_name, timestamp, merchant_ID, merchant_name, merchant_type, and/or the like. Using the merchant and/or user profile information, the ICST may generate a query the database for user behavior patterns, e.g., 3003, of the user for merchant analytics. In some implementations, the ICST may identify products, services and/or other offerings likely desired by the user based on pre-generated user behavioral pattern analysis and user profile, e.g., 3004. The ICST may identify, e.g., 3005, merchants that may be able to provide the identified products, services, and/or offerings for the user. For example, the ICST may generate a query based on the GPS coordinates of the user (e.g., obtained from the user's smartphone), the merchant store in which the user currently is present, etc., for merchants in the vicinity of the user who may have products included within the identified products likely desired by the user. In some implementations, the pay network server may also determine offers (e.g., discount offers, Groupon® offers, etc.), e.g., 3006, that the merchant may be able to offer for the users. In some implementations, the ICST may generate a real-time merchant analytics report for the merchant, e.g., 3007. In some implementations, the ICST may generate, e.g., 3008, a real-time geo-sensitive product offer packet for the user, e.g., including such items as (but not limited to): merchant names, location, directions, offers, discounts, interactive online purchase options, instant mobile wallet purchase ability, order hold placing features (e.g., to hold the items for pick up so as to prevent the items going out of stock, e.g., during seasonal shopping times), and/or the like. In some implementations, the ICST may provide the merchant analytics report to the merchant server, and may provide the real-time geo-sensitive product offer packet to the client, e.g., 3009.

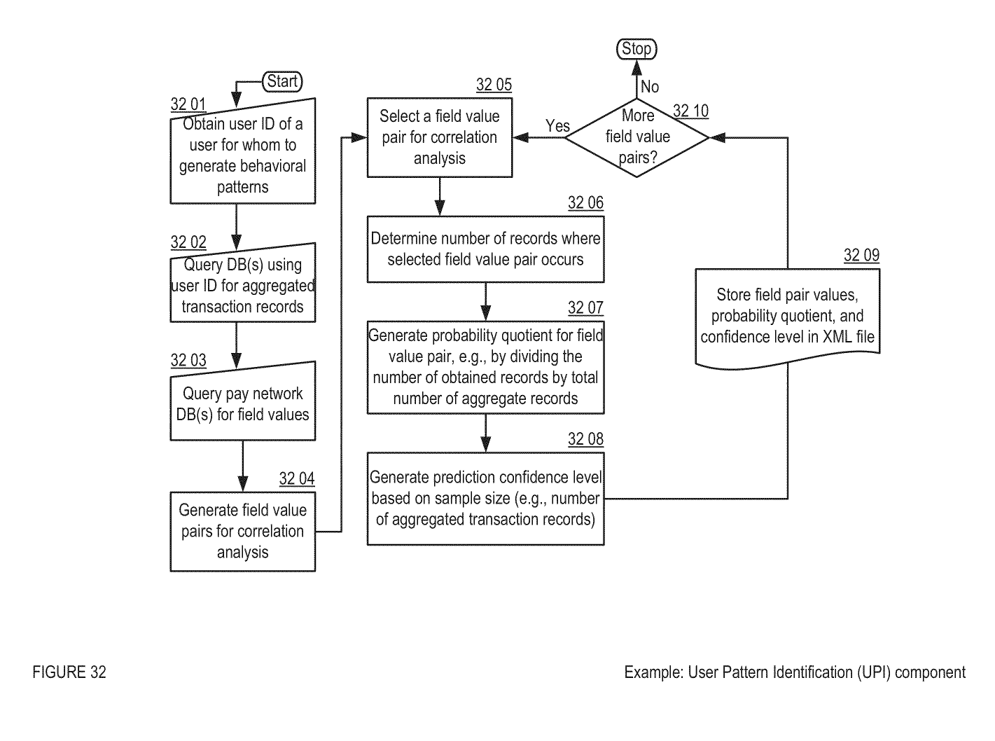

FIG. 31 shows a logic flow diagram illustrating example aspects of generating a user behavior pattern analysis in some embodiments of the ICST, e.g., a User Behavioral Pattern Analytics (“UBPA”) component. In some implementations, the ICST may select, e.g., 3101, a user (e.g., via user ID) for behavioral pattern analysis. The ICST may store, e.g., 3102, card-based transaction data records for each card-based transaction performed by the user, e.g., via a Card-Based Transaction Execution component. The ICST may aggregate such card-based transaction data records of the user, e.g., 3103. For example, the ICST may utilize a Transaction Data Aggregation component such as that described above with reference to FIGS. 14-15. In various implementations, the ICST may aggregate card transaction records of the user according to criteria including, but not limited to: geographical location of card use, time of card use, type of purchase, quantity of purchase, transaction value, merchant type, merchant name, spending category (e.g., such as the North American Industry Classification System (NAICS) codes for spending categories), and/or the like. The ICST may analyze the aggregated card transaction data, e.g., 3104, to determine user behavioral patterns, e.g., via a User Pattern Identification (“UPI”) component such as described below with reference to FIG. 32. In some implementations, the ICST may provide user behavioral patterns obtained from the analysis for use by other ICST components and/or affiliated entities, e.g., 3105.

FIG. 32 shows a logic flow diagram illustrating example aspects of identifying user behavioral patterns from aggregated card-based transaction data in some embodiments of the ICST, e.g., a User Patten Identification (“UPI”) component. In some implementations, a pay network server (“server”) may obtain a user ID of a user for whom the server is required to generate user behavioral patterns, e.g., 3201. The server may query a database, e.g., a pay network database, for aggregated card transaction data records of the user, e.g., 3202. The server may also query, e.g., 3203, the pay network database for all possible field value that can be taken by each of the field values (e.g., AM/PM, zipcode, merchant_ID, merchant_name, transaction cost brackets, etc.). Using the field values of all the fields in the transaction data records, the server may generate field value pairs, for performing a correlation analysis on the field value pairs, e.g., 3204. An example field value pair is: ‘time’ is ‘AM’ and ‘merchant’ is ‘Walmart’. The server may then generate probability estimates for each field value pair occurring in the aggregated transaction data records. For example, the server may select a field value pair, e.g., 3205. The server may determine the number of records within the aggregated transaction data records where the field value pair occurs, e.g., 3206. The server may then calculate a probability quotient for the field value pair by dividing the number determined for the occurrences of the field value pair by the total number of aggregate transaction data records, e.g., 3207. The server may also assign a confidence level for the probability quotient based on the sample size, e.g., total number of records in the aggregated transaction data records, e.g., 3208. The server may generate and store an XML snippet, such as described above with reference to FIGS. 923A-B, including the field value pair, the probability quotient, and the confidence level associated with the probability quotient, e.g., 3209. The server may perform such a computation for each field value pair (see 3210) generated in 3204.

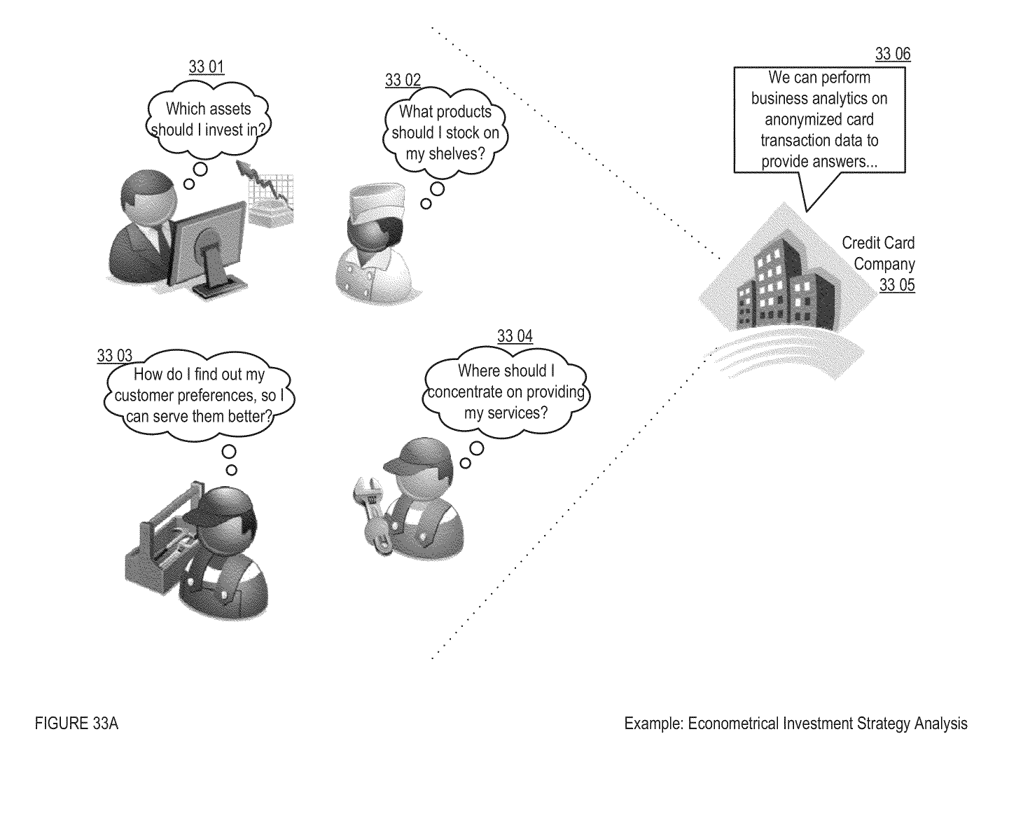

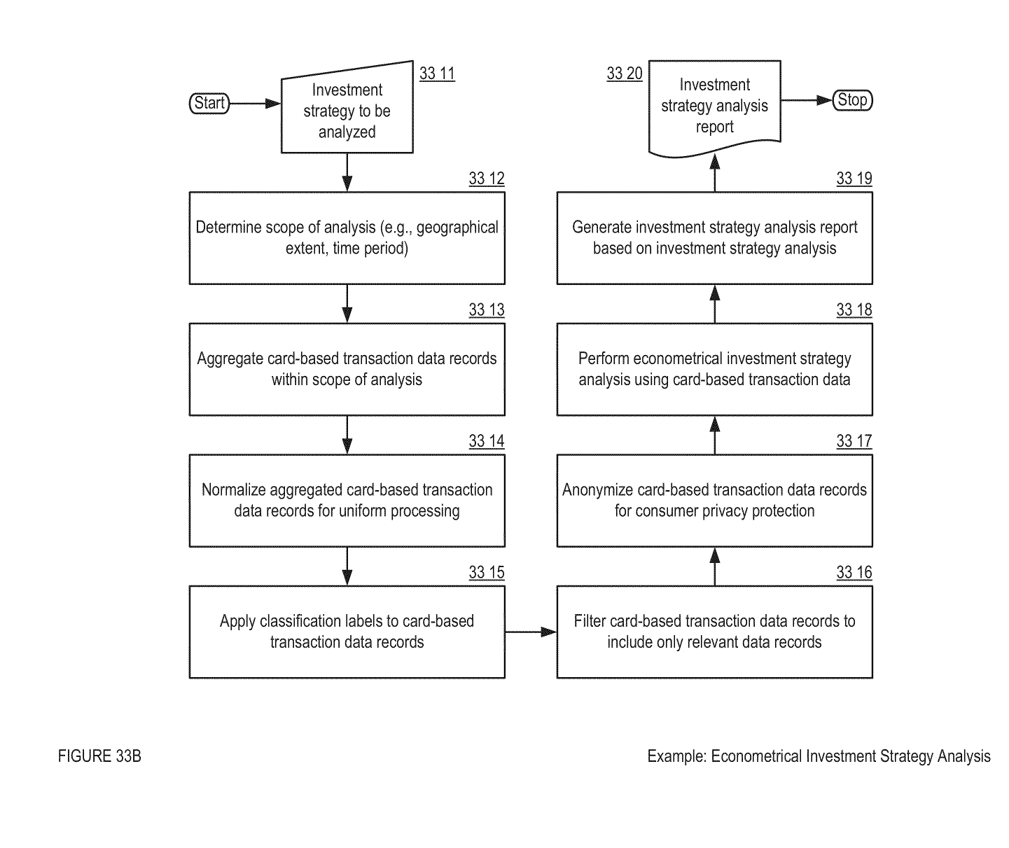

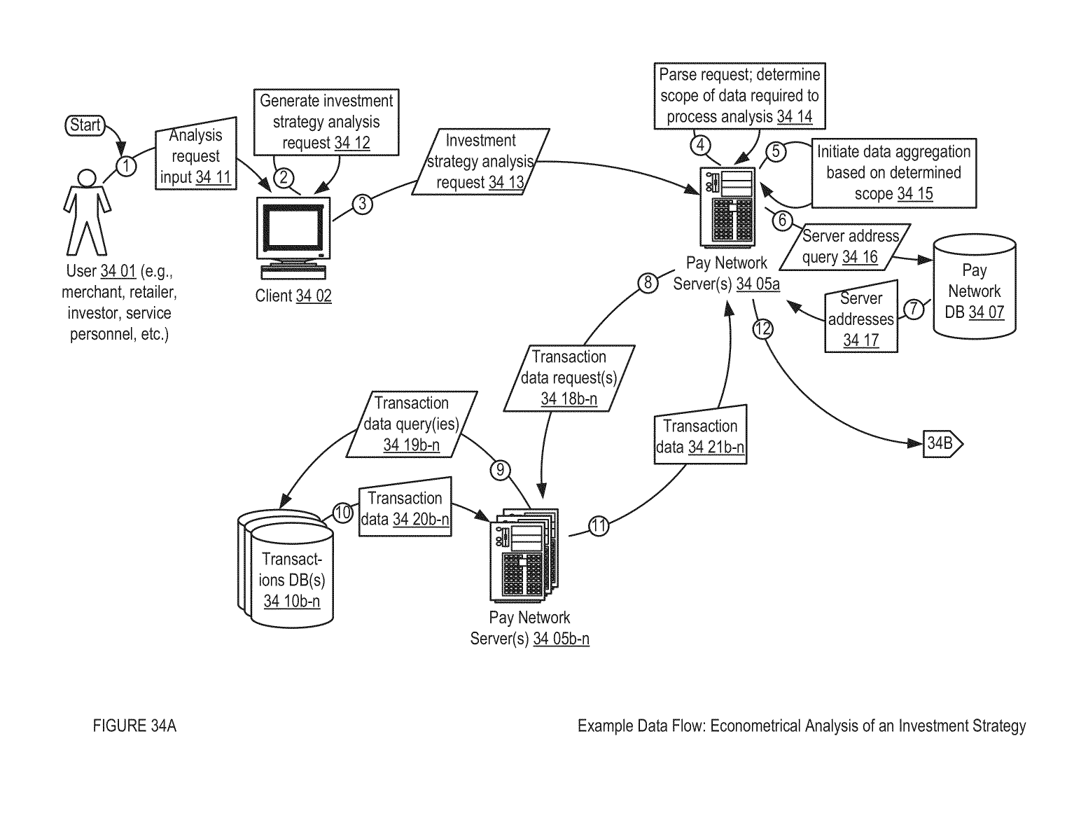

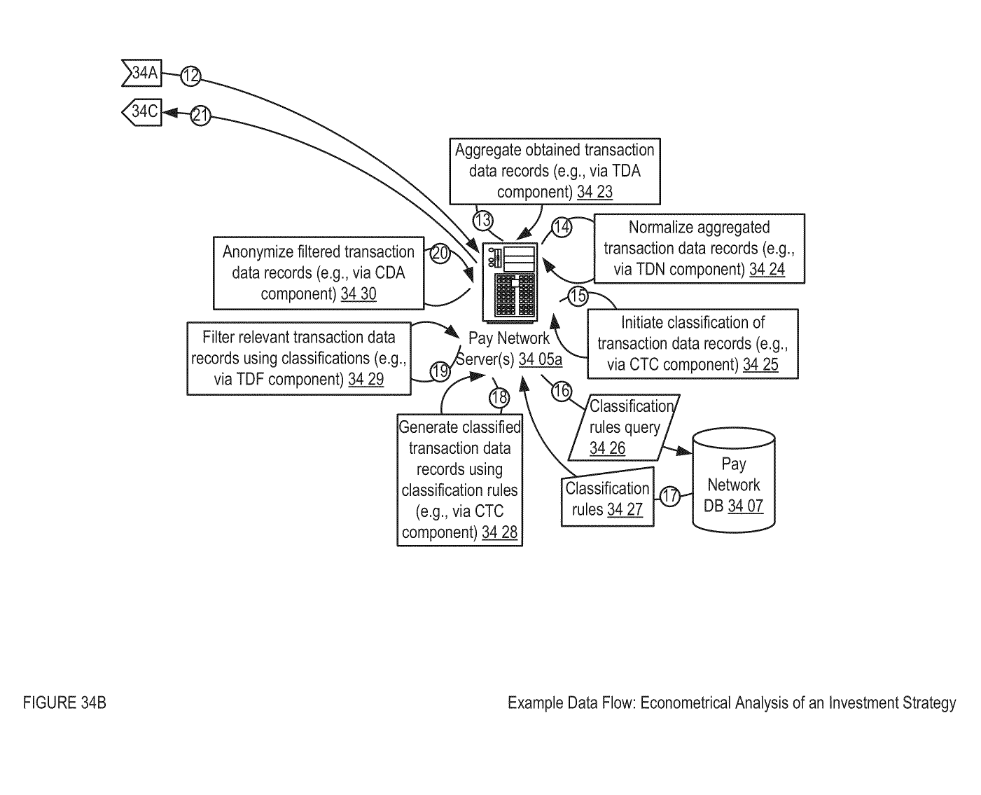

FIGS. 33A-B show block diagrams illustrating example aspects of merchant analytics in a second set of embodiments of the ICST. With reference to FIG. 33A, in some implementations, the ICST may provide merchant analytics reports to various users in order to facilitate their making calculated investment decisions. For example, a stock investor may desire business analytics to determine which stocks the investor should invest in, how the investor should modify the investor's portfolio, and/or the like, e.g., 3301. In another example, a retailer may desire to understand customer behavior better so that the retailer may determine which products to provide for customers to generate maximum retail sales, e.g., 3302. In another example, a serviceperson providing services to customers may desire to understand which services the customer tend to prefer, and/or a paying for in the marketplace, e.g., 3303. In another example, a service provider may desire to understand the geographical areas where business for the serviceperson is likely to be concentrated, e.g., 3304. In some implementations, a credit card company may have access to a large database of card-based transactions. The card-based transaction may have distributed among them information on customer behavior, demand, geographical distribution, industry sector preferences, and/or the like, which may be mined in order to provide investors, retailer, service personnel and/or other users business analytics information based on analyzing the card-based transaction data. In some implementations, the ICST may take specific measures in order to ensure the anonymity of users whose card-based transaction data are analyzed for providing business analytics information for users. For example, the ICST may perform business analytics on anonymized card-based transaction data to provide solutions to questions such as illustrated in 3301-3304.

With reference to FIG. 33B, in some implementations, the ICST may obtain an investment strategy to be analyzed, e.g., 3311, for example, from a user. The ICST may determine, e.g., 3312 the scope of the investment strategy analysis (e.g., geographic scope, amount of data required, industry segments to analyze, type of analysis to be generated, time-resolution of the analysis (e.g., minute, hour, day, month, year, etc.), geographic resolution (e.g., street, block, zipcode, metropolitan area, city, state, country, inter-continental, etc.). The ICST may aggregate card-based transaction data in accordance with the determined scope of analysis, e.g., 3313. The ICST may normalized aggregated card-based transaction data records for uniform processing, e.g., 3314. In some implementations, the ICST may apply classification labels to card-based transaction data records, e.g., 3315, for investment strategy analysis. The ICST may filter the card-based transaction data records to include only those records as relevant to the analysis, e.g., 3316. For example, the ICST may utilize the classification labels corresponding to the transaction data records to determine which records are relevant to the analysis. In some implementations, the ICST may anonymize transaction data records for consumer privacy protection prior to investment strategy analysis, e.g., 3317. The ICST may perform econometrical investment strategy analysis, e.g., 3318, and generate an investment strategy analysis report based on the investment strategy analysis, e.g., 3319. The ICST may provide the investment strategy analysis report for the user requesting the investment strategy analysis.

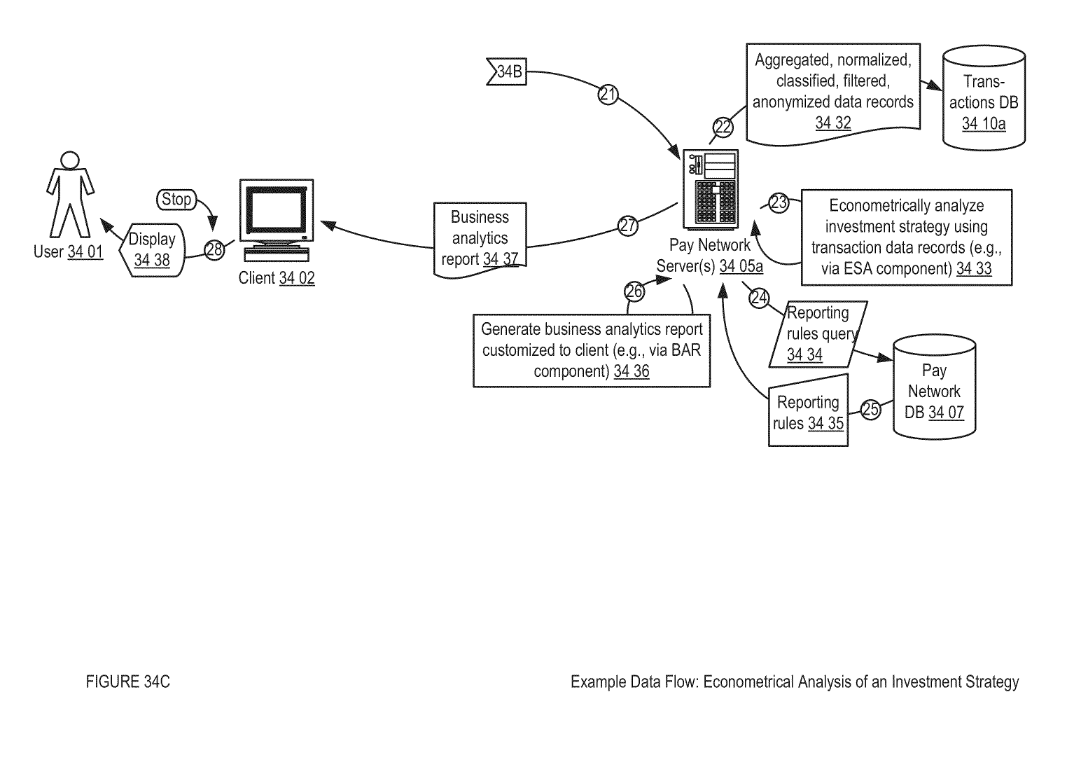

FIGS. 34A-C show data flow diagrams illustrating an example procedure for econometrical analysis of a proposed investment strategy based on card-based transaction data in some embodiments of the ICST. With reference to FIG. 34A, in some implementations, a user, e.g., 3401, may desire to obtain an analysis of an investment strategy. For example, the user may be a merchant, a retailer, an investor, a serviceperson, and/or the like provider or products, services, and/or other offerings. The user may communicate with a pay network server, e.g., 3405a, to obtain an investment strategy analysis. For example, the user may provide user input, e.g., analysis request input 3411, into a client, e.g., 3402, indicating the user's desire to request an investment strategy analysis. In various implementations, the user input may include, but not be limited to: keyboard entry, mouse clicks, depressing buttons on a joystick/game console, voice commands, single/multi-touch gestures on a touch-sensitive interface, touching user interface elements on a touch-sensitive display, and/or the like. In some implementations, the client may generate an investment strategy analysis request, e.g., 3412, and provide, e.g., 3413, the generated investment strategy analysis request to the pay network server. For example, a browser application executing on the client may provide, on behalf of the user, a (Secure) Hypertext Transfer Protocol (“HTTP(S)”) GET message including the investment strategy analysis request in the form of XML-formatted data. Below is an example HTTP(S) GET message including an XML-formatted investment strategy analysis request:

GET /analysisrequest.php HTTP/1.1
Host: www.paynetwork.com
Content-Type: Application/XML
Content-Length: 1306
<?XML version = “1.0” encoding = “UTF-8”?>
<analysis_request>

<request_ID>EJ39FI1F</request_ID>
<timestamp>2011-02-24 09:08:11</timestamp>
<user_ID>investor@paynetwork.com</user_ID>
<password>******</password>
<request_details>

<time_period>year 2011</time_period>
<time_interval>month-to-month</time_interval>
<area_scope>United States</area>
<area_resolution>zipcode</area_resolution>
<spend_sector>retail<sub>home

improvement</sub></spend_sector>

</request_details>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>

</analysis_request>

In some implementations, the pay network server may parse the investment strategy analysis request, and determine the type of investment strategy analysis required, e.g., 3414. In some implementations, the pay network server may determine a scope of data aggregation required to perform the analysis. The pay network server may initiate data aggregation based on the determined scope, for example, via a Transaction Data Aggregation (“TDA”) component such as described above with reference to FIG. 9. The pay network server may query, e.g., 3416, a pay network database, e.g., 3407, for addresses of pay network servers that may have stored transaction data within the determined scope of the data aggregation. For example, the pay network server may utilize PHP/SQL commands similar to the examples provided above. The database may provide, e.g., 3417, a list of server addresses in response to the pay network server's query. Based on the list of server addresses, the pay network server may issue transaction data requests, e.g., 3418b-n, to the other pay network servers, e.g., 3405b-n. The other the pay network servers may query their transaction databases, e.g., 3410b-n, for transaction data falling within the scope of the transaction data requests. In response to the transaction data queries, e.g., 3419b-n, the transaction databases may provide transaction data, e.g., 3420b-n, to the other pay network servers. The other pay network servers may return the transaction data obtained from the transactions databases, e.g., 3421b-n, to the pay network server making the transaction data requests, e.g., 3405a.

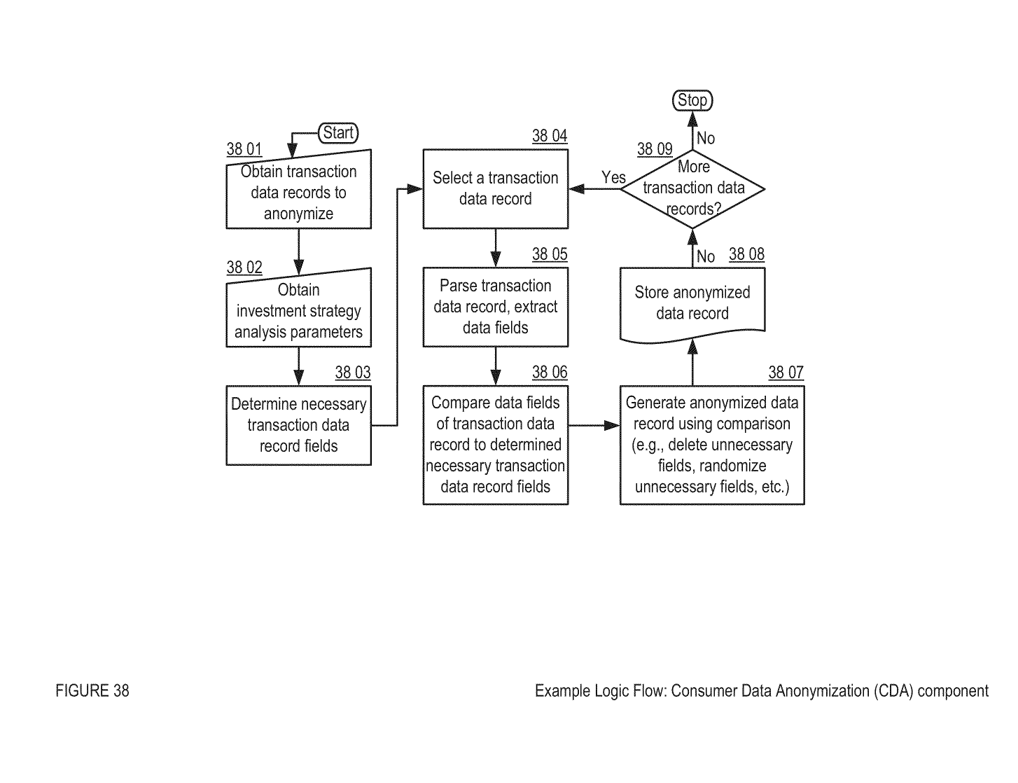

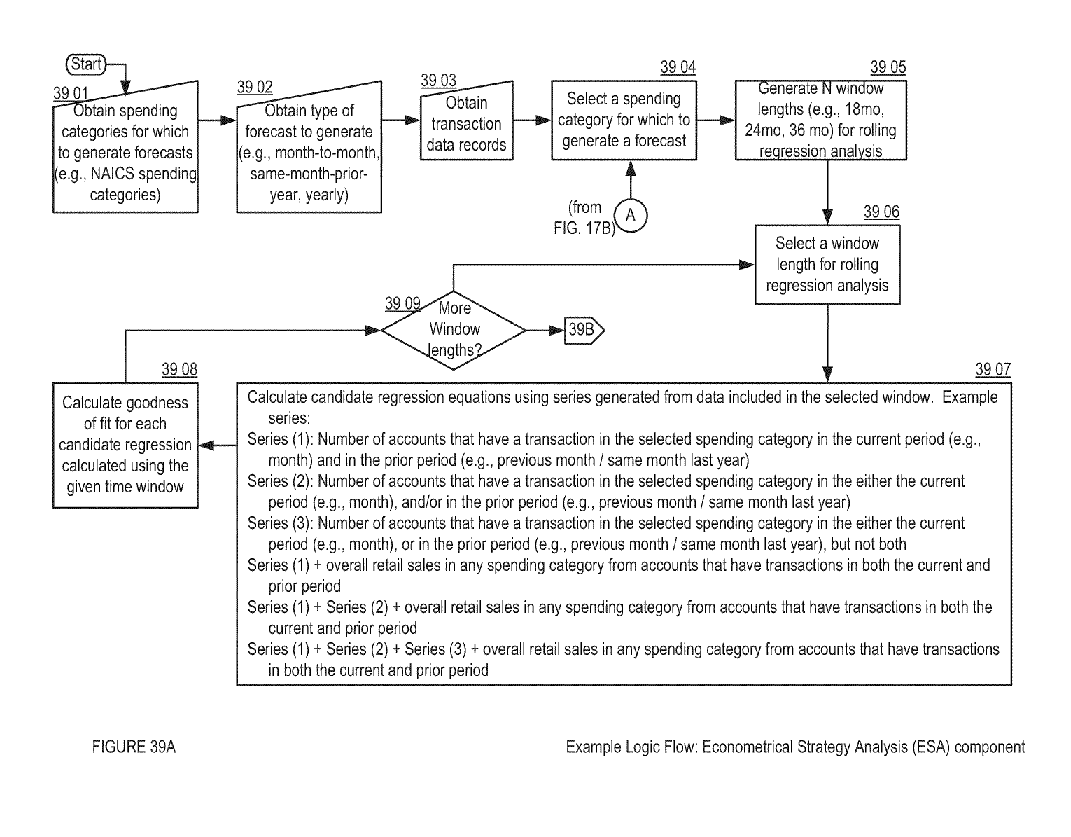

With reference to FIG. 34B, the pay network server 3405a may aggregate, e.g., 3423, the obtained transaction data records, e.g. via the TDA component. The pay network server may normalize, e.g., 3424, the aggregated transaction data so that all the data share a uniform data structure format, e.g., via a Transaction Data Normalization (“TDN”) component such as described below with reference to FIG. 29. The pay network server may generate, e.g., 3425-2828, one or more classification labels for each of the transaction data records, e.g., via a Card-Based Transaction Classification (“CTC”) component such as described below with reference to FIG. 30. The pay network server may query for classification rules, e.g., 3426, a database, e.g., pay network database 3407. Upon obtaining the classification rules, e.g., 3427, the pay network server may generate, e.g., 3428, classified transaction data records using the classification rules, e.g., via the CTC component. The pay network server may filter, e.g., 3429, relevant transaction data records using the classification labels, e.g., via a Transaction Data Filtering (“TDF”) component such as described below with reference to FIG. 31. The pay network server may anonymize, e.g., 3430, the transaction data records, e.g., via a Consumer Data Anonymization (“CDA”) component such as described below with reference to FIG. 38.

With reference to FIG. 34C, the pay network server may, in some implementations, store aggregated, normalized, classified, filtered, and/or anonymized data records, e.g., 3432, in a database, e.g., transactions database 3410a. In some implementations, the pay network server may econometrically analyze, e.g., 3433, aggregated, normalized, classified, filtered, and/or anonymized data records, e.g., via an Econometrical Strategy Analysis (“ESA”) component such as described below with reference to FIG. 33. The pay network server may prepare a report customized to the client used by the user. The pay network server may provide a reporting rules query to a database, e.g., pay network database 3407, for reporting rules to use in preparing the business analytics report. Upon obtaining the reporting rules, e.g., 3435, the pay network server may generate a business analytics report customized to the client, e.g., 3436, for example via a Business Analytics Reporting (“BAR”) such as described below with reference to FIG. 34. The pay network server may provide the business analytics report, e.g., 3437, to the client, e.g., 3402. The client may render and display, e.g., 3438, the business analytics report for the user.

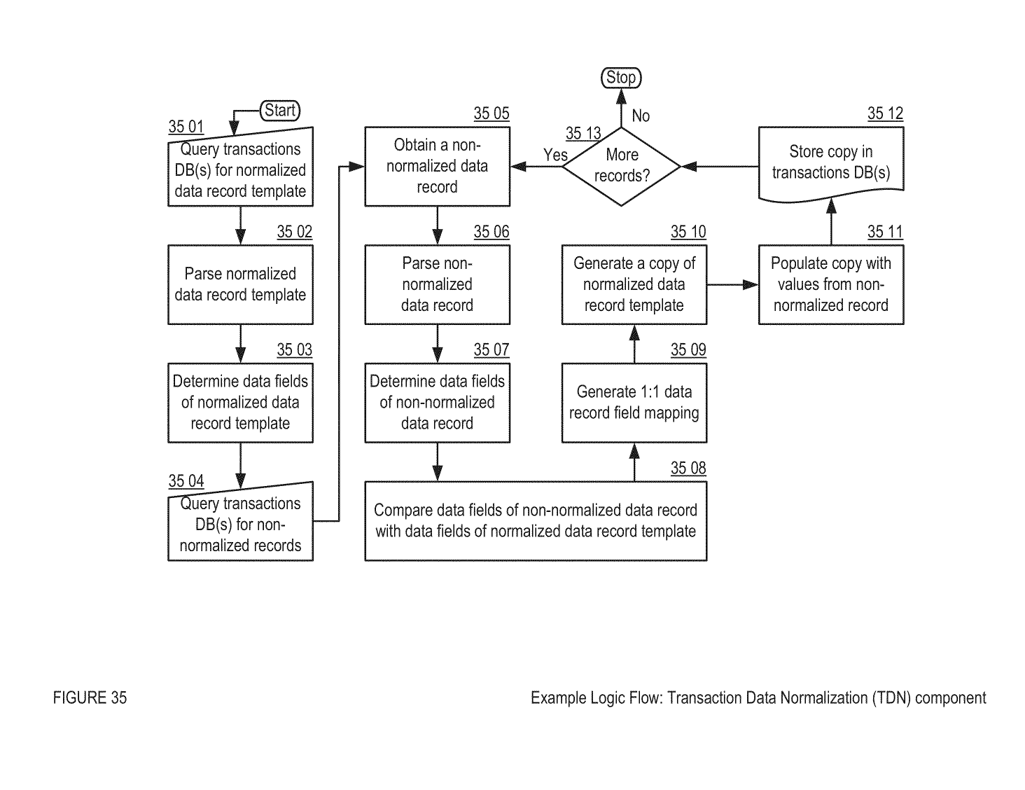

FIG. 35 shows a logic flow diagram illustrating example aspects of normalizing raw card-based transaction data into a standardized data format in some embodiments of the ICST, e.g., a Transaction Data Normalization (“TDN”) component. In some implementations, a pay network server (“server”) may attempt to convert any transaction data records stored in a database it has access to in a normalized data format. For example, the database may have a transaction data record template with predetermined, standard fields that may store data in pre-defined formats (e.g., long integer/double float/4 digits of precision, etc.) in a pre-determined data structure. A sample XML transaction data record template is provided below:

<?XML version = “1.0” encoding = “UTF-8”?>
<transaction_record>

<record_ID>00000000</record_ID>
<norm_flag>false</norm_flag>
<timestamp>yyyy-mm-dd hh:mm:ss</timestamp>
<transaction_cost>$0,000,000,00</transaction_cost>
<merchant_params>

<merchant_id>00000000</merchant_id>
<merchant_name>TBD</merchant_name>
<merch_auth_key>0000000000000000</merch_auth_key>

</merchant_params>
<merchant_products>

<num_products>000</num_products>
<product>

<product_type>TBD</product_type>
<product_name>TBD</product_name>
<class_labels_list>TBD<class_labels_list>
<product_quantity>000</product_quantity>
<unit_value>$0,000,000.00</unit_value>
<sub_total>$0,000,000.00</sub_total>
<comment>normalized transaction data record

template</comment>

</product>

</merchant_products>
<user_account_params>

<account_name>JTBD</account_name>
<account_type>TBD</account_type>
<account_num>0000000000000000</account_num>
<billing_line1>TBD</billing_line1>
<billing_line2>TBD</billing_line2>
<zipcode>TBD</zipcode>
<state>TBD</state>
<country>TBD</country>
<phone>00-00-000-000-0000</phone>
<sign>TBD</sign>

</user_account_params>

</transaction_record>

In some implementations, the server may query a database for a normalized transaction data record template, e.g., 3501. The server may parse the normalized data record template, e.g., 3502. Based on parsing the normalized data record template, the server may determine the data fields included in the normalized data record template, and the format of the data stored in the fields of the data record template, e.g., 3503. The server may obtain transaction data records for normalization. The server may query a database, e.g., 3504, for non-normalized records. For example, the server may issue PHP/SQL commands to retrieve records that do not have the ‘norm_flag’ field from the example template above, or those where the value of the ‘norm_flag’ field is ‘false’. Upon obtaining the non-normalized transaction data records, the server may select one of the non-normalized transaction data records, e.g., 3505. The server may parse the non-normalized transaction data record, e.g., 3506, and determine the fields present in the non-normalized transaction data record, e.g., 3507. The server may compare the fields from the non-normalized transaction data record with the fields extracted from the normalized transaction data record template. For example, the server may determine whether the field identifiers of fields in the non-normalized transaction data record match those of the normalized transaction data record template, (e.g., via a dictionary, thesaurus, etc.), are identical, are synonymous, are related, and/or the like. Based on the comparison, the server may generate a 1:1 mapping between fields of the non-normalized transaction data record match those of the normalized transaction data record template, e.g., 3509. The server may generate a copy of the normalized transaction data record template, e.g., 3510, and populate the fields of the template using values from the non-normalized transaction data record, e.g., 3511. The server may also change the value of the ‘norm_flag’ field to ‘true’ in the example above. The server may store the populated record in a database (for example, replacing the original version), e.g., 3512. The server may repeat the above procedure for each non-normalized transaction data record (see e.g., 3513), until all the non-normalized transaction data records have been normalized.

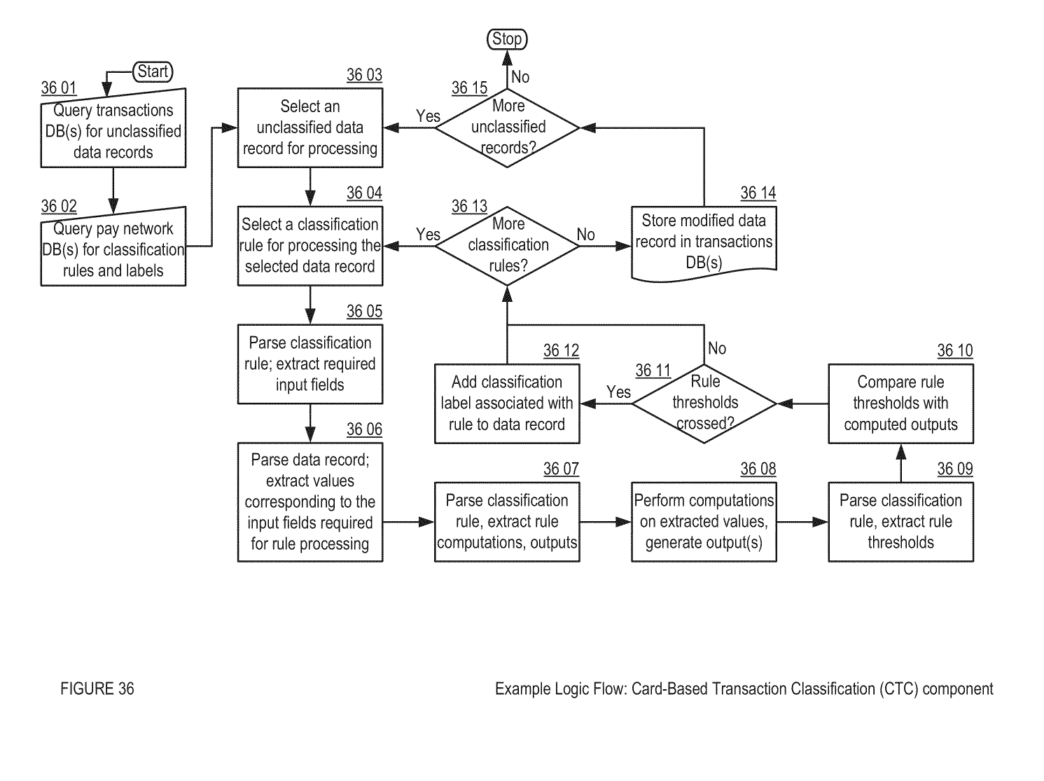

FIG. 36 shows a logic flow diagram illustrating example aspects of generating classification labels for card-based transactions in some embodiments of the ICST, e.g., a Card-Based Transaction Classification (“CTC”) component. In some implementations, a server may apply one or more classification labels to each of the transaction data records. For example, the server may classify the transaction data records, according to criteria such as, but not limited to: geo-political area, luxury level of the product, industry sector, number of items purchased in the transaction, and/or the like. The server may obtain transactions from a database that are unclassified, e.g., 3601, and obtain rules and labels for classifying the records, e.g., 3602. For example, the database may store classification rules, such as the exemplary illustrative XML-encoded classification rule provided below:

<rule>

<id>NAICS44_45</id>
<name>NAICS - Retail Trade</name>
<inputs>merchant_id</inputs>
<operations>

<1>label = ‘null’</1>
<1>cat = NAICS_LOOKUP(merchant_id)</1>
<2>IF (cat == 44 || cat ==45) label = ‘retail

trade’</2>

</operations>
<outputs>label</outputs>

</rule>

The server may select an unclassified data record for processing, e.g., 3603. The server may also select a classification rule for processing the unclassified data record, e.g., 3604. The server may parse the classification rule, and determine the inputs required for the rule, e.g., 3605. Based on parsing the classification rule, the server may parse the normalized data record template, e.g., 3606, and extract the values for the fields required to be provided as inputs to the classification rule. For example, to process the rule in the example above, the server may extract the value of the field ‘merchant_id’ from the transaction data record. The server may parse the classification rule, and extract the operations to be performed on the inputs provided for the rule processing, e.g., 3607. Upon determining the operations to be performed, the server may perform the rule-specified operations on the inputs provided for the classification rule, e.g., 3608. In some implementations, the rule may provide threshold values. For example, the rule may specify that if the number of products in the transaction, total value of the transaction, average luxury rating of the products sold in the transaction, etc. may need to cross a threshold in order for the label(s) associated with the rule to be applied to the transaction data record. The server may parse the classification rule to extract any threshold values required for the rule to apply, e.g., 3609. The server may compare the computed values with the rule thresholds, e.g., 3610. If the rule threshold(s) is crossed, e.g., 3611, option “Yes,” the server may apply one or more labels to the transaction data record as specified by the classification rule, e.g., 3612. For example, the server may apply a classification rule to an individual product within the transaction, and/or to the transaction as a whole. In some implementations, the server may process the transaction data record using each rule (see, e.g., 3613). Once all classification rules have been processed for the transaction record, e.g., 3613, option “No,” the server may store the transaction data record in a database, e.g., 3614. The server may perform such processing for each transaction data record until all transaction data records have been classified (see, e.g., 3615).

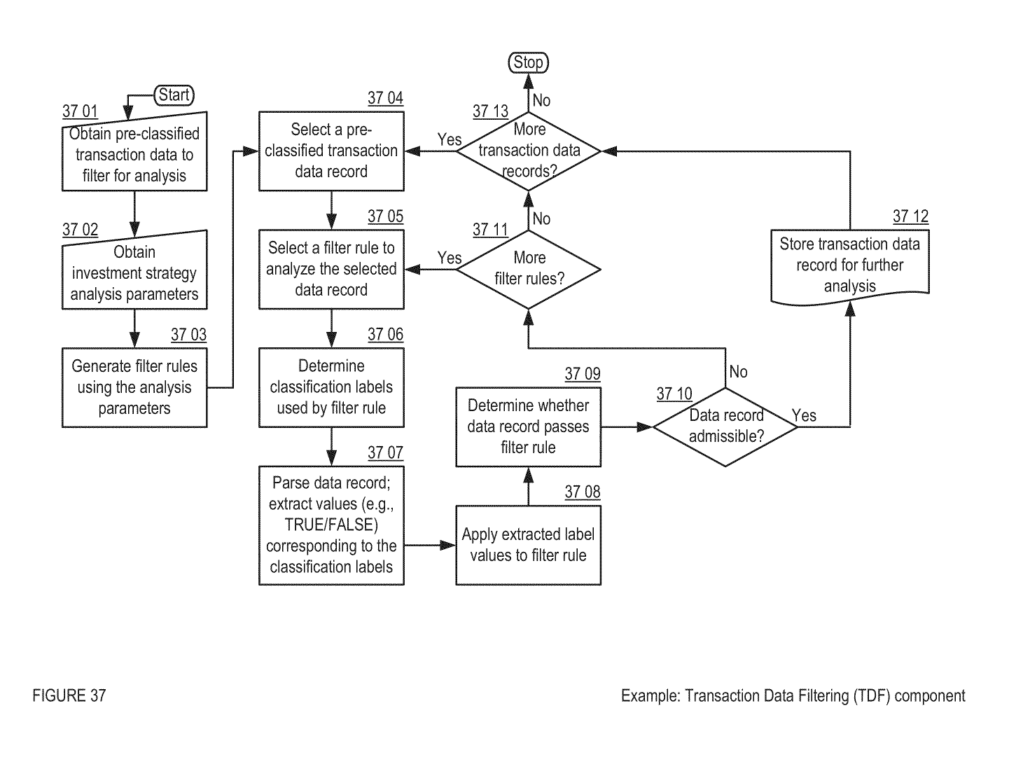

FIG. 37 shows a logic flow diagram illustrating example aspects of filtering card-based transaction data for econometrical investment strategy analysis in some embodiments of the ICST, e.g., a Transaction Data Filtering (“TDF”) component. In some implementations, a server may filter transaction data records prior to econometrical investment strategy analysis based on classification labels applied to the transaction data records. For example, the server may filter the transaction data records, according to criteria such as, but not limited to: geo-political area, luxury level of the product, industry sector, number of items purchased in the transaction, and/or the like. The server may obtain transactions from a database that are classified, e.g., 3701, and investment strategy analysis parameters, e.g., 3702. Based on the analysis parameters, the server may generate filter rules for the transaction data records, e.g., 3703. The server may select a classified data record for processing, e.g., 3704. The server may also select a filter rule for processing the classified data record, e.g., 3705. The server may parse the filter rule, and determine the classification labels required for the rule, e.g., 3706. Based on parsing the classification rule, the server may parse the classified data record, e.g., 3707, and extract values for the classification labels (e.g., true/false) required to process the filter rule. The server may apply the classification labels values to the filter rule, e.g., 3708, and determine whether the transaction data record passes the filter rule, e.g., 3709. If the data record is admissible in view of the filter rule, e.g., 3710, option “Yes,” the server may store the transaction data record for further analysis, e.g., 3712. If the data record is not admissible in view of the filter rule, e.g., 3710, option “No,” the server may select another filter rule to process the transaction data record. In some implementations, the server may process the transaction data record using each rule (see, e.g., 3711) until all rules are exhausted. The server may perform such processing for each transaction data record until all transaction data records have been filtered (see, e.g., 3713).

FIG. 38 shows a logic flow diagram illustrating example aspects of anonymizing consumer data from card-based transactions for econometrical investment strategy analysis in some embodiments of the ICST, e.g., a Consumer Data Anonymization (“CDA”) component. In some implementations, a server may remove personal information relating to the user (e.g., those fields that are not required for econometrical investment strategy analysis) and/or merchant from the transaction data records. For example, the server may truncate the transaction data records, fill randomly generated values in the fields comprising personal information, and/or the like. The server may obtain transactions from a database that are to be anonymized, e.g., 3801, and investment strategy analysis parameters, e.g., 3802. Based on the analysis parameters, the server may determine the fields that are necessary for econometrical investment strategy analysis, e.g., 3803. The server may select a transaction data record for processing, e.g., 3804. The server may parse the transaction data record, e.g., 3805, and extract the data fields in the transactions data records. The server may compare the data fields of the transaction data record with the fields determined to be necessary for the investment strategy analysis, e.g., 3806. Based on the comparison, the server may remove any data fields from the transaction data record, e.g., those that are not necessary for the investment strategy analysis, and generate an anonymized transaction data record, e.g., 3807. The server may store the anonymized transaction data record in a database, e.g., 3808. In some implementations, the server may process each transaction data record (see, e.g., 3809) until all the transaction data records have been anonymized.

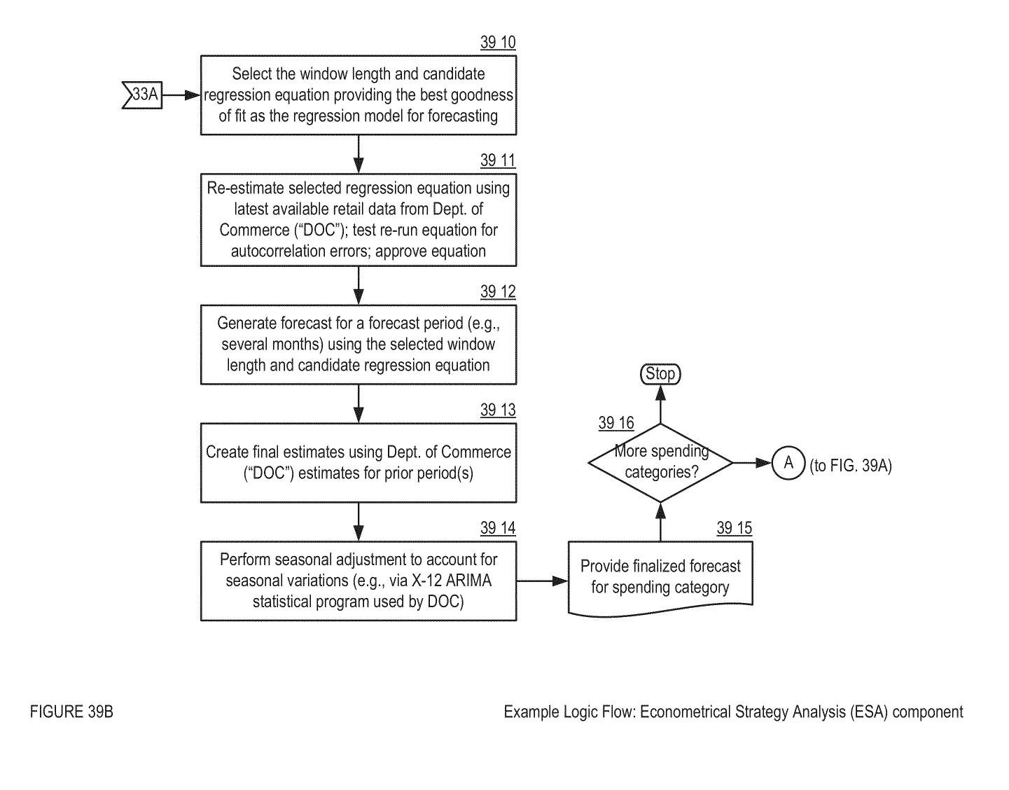

FIGS. 39A-B show logic flow diagrams illustrating example aspects of econometrically analyzing a proposed investment strategy based on card-based transaction data in some embodiments of the ICST, e.g., an Econometrical Strategy Analysis (“ESA”) component. With reference to FIG. 39A, in some implementations, the server may obtain spending categories (e.g., spending categories as specified by the North American Industry Classification System (“NAICS”)) for which to generate estimates, e.g., 3901. The server may also obtain the type of forecast (e.g., month-to-month, same-month-prior-year, yearly, etc.) to be generated from the econometrical investment strategy analysis, e.g., 3902. In some implementations, the server may obtain the transaction data records using which the server may perform econometrical investment strategy analysis, e.g., 3903. For example, the server may select a spending category (e.g., from the obtained list of spending categories) for which to generate the forecast, e.g., 3904. For example, the forecast series may be several aggregate series (described below) and the 12 spending categories in the North American Industry Classification System (NAICS) such as department stores, gasoline, and so on, that may be reported by the Department of Commerce (DOC).

To generate the forecast, the server may utilize a random sample of transaction data (e.g., approximately 6% of all transaction data within the network of pay servers), and regression analysis to generate model equations for calculating the forecast from the sample data. For example, the server may utilize distributed computing algorithms such as Google MapReduce. Four elements may be considered in the estimation and forecast methodologies: (a) rolling regressions; (b) selection of the data sample (“window”) for the regressions; (c) definition of explanatory variables (selection of accounts used to calculate spending growth rates); and (d) inclusion of the explanatory variables in the regression equation (“candidate” regressions) that may be investigated for forecasting accuracy. The dependent variable may be, e.g., the growth rate calculated from DOC revised sales estimates published periodically. Rolling regressions may be used as a stable and reliable forecasting methodology. A rolling regression is a regression equation estimated with a fixed length data sample that is updated with new (e.g., monthly) data as they become available. When a new data observation is added to the sample, the oldest observation is dropped, causing the total number of observations to remain unchanged. The equation may be estimated with the most recent data, and may be re-estimated periodically (e.g., monthly). The equation may then be used to generate a one-month ahead forecast for year-over-year or month over month sales growth.

Thus, in some implementations, the server may generate N window lengths (e.g., 18 mo, 24 mo, 36 mo) for rolling regression analysis, e.g., 3905. For each of the candidate regressions (described below), various window lengths may be tested to determine which would systemically provide the most accurate forecasts. For example, the server may select a window length may be tested for rolling regression analysis, e.g., 3906. The server may generate candidate regression equations using series generated from data included in the selected window, e.g., 3907. For example, the server may generate various series, such as, but not limited to:

Series (1): Number of accounts that have a transaction in the selected spending category in the current period (e.g., month) and in the prior period (e.g., previous month/same month last year);

Series (2): Number of accounts that have a transaction in the selected spending category in the either the current period (e.g., month), and/or in the prior period (e.g., previous month/same month last year);

Series (3): Number of accounts that have a transaction in the selected spending category in the either the current period (e.g., month), or in the prior period (e.g., previous month/same month last year), but not both;

Series (4): Series (1)+overall retail sales in any spending category from accounts that have transactions in both the current and prior period;

Series (5): Series (1)+Series (2)+overall retail sales in any spending category from accounts that have transactions in both the current and prior period; and

Series (6): Series (1)+Series (2)+Series (3)+overall retail sales in any spending category from accounts that have transactions in both the current and prior period.

With reference to FIG. 39B, in some implementations, the server may calculate several (e.g., six) candidate regression equations for each of the series. For example, the server may calculate the coefficients for each of the candidate regression equations. The server may calculate a value of goodness of fit to the data for each candidate regression equations, e.g., 3908. For example, two measures of goodness of fit may be used: (1) out-of-sample (simple) correlation; and (2) minimum absolute deviation of the forecast from revised DOC estimates. In some implementations, various measures of goodness of fit may be combined to create a score. In some implementations, candidate regression equations may be generated using rolling regression analysis with each of the N generated window lengths (see, e.g., 3909). In some implementations, upon generation of all the candidate regression equations and their corresponding goodness of fit scores, the equation (s) with the best score is chosen as the model equation for forecasting, e.g., 3910. In some implementations, the equation (s) with the highest score is then re-estimated using latest retail data available, e.g., from the DOC, e.g., 3911. The rerun equations may be tested for auto correlated errors. If the auto correlation test is statistically significant then the forecasts may include an autoregressive error component, which may be offset based on the autocorrelation test.

In some implementations, the server may generate a forecast for a specified forecast period using the selected window length and the candidate regression equation, e.g., 3912. The server may create final estimates for the forecast using DOC estimates for prior period(s), e.g., 3913. For example, the final estimates (e.g., Fₜ^{Y}—year-over-year growth, Fₜ^{M}—month-over-month growth) may be calculated by averaging month-over-month and year-over-year estimates, as follows:

Dₜ^{Y}=(1+Gₜ^{Y})·Rₜ₋₁₂

Dₜ^{M}=(1+Gₜ^{M})·Aₜ₋₁

Dₜ=Mean(Dₜ^{M},Dₜ^{Y})

Bₜ₋₁^{Y}=(1+Gₜ₋₁^{Y})·Rₜ₋₁₃

Bₜ₋₁^{M}=Aₜ₋₁

Bₜ₋₁=Mean(Bₜ₋₁^{M},Bₜ₋₁^{Y})

Fₜ^{Y}=Dₜ/Dₜ₋₁₂−1

Fₜ^{M}=Dₜ/Bₜ₋₁−1

Here, G represents the growth rates estimated by the regressions for year (superscript Y) or month (superscript M), subscripts refer to the estimate period, t is the current forecasting period); R represents the DOC revised dollar sales estimate; A represents the DOC advance dollar estimate; D is a server-generated dollar estimate, B is a base dollar estimate for the previous period used to calculate the monthly growth forecast.

In some implementations, the server may perform a seasonal adjustment to the final estimates to account for seasonal variations, e.g., 3914. For example, the server may utilize the X-12 ARIMA statistical program used by the DOC for seasonal adjustment. The server may then provide the finalized forecast for the selected spending category, e.g., 3915. Candidate regressions may be similarly run for each spending category of interest (see, e.g., 3916).

FIGS. 39A-B show logic flow diagrams illustrating example aspects of econometrically analyzing a proposed investment strategy based on card-based transaction data in some embodiments of the ICST, e.g., an Econometrical Strategy Analysis (“ESA”) component. With reference to FIG. 39A, in some implementations, the server may obtain spending categories (e.g., spending categories as specified by the North American Industry Classification System (“NAICS”)) for which to generate estimates, e.g., 3901. The server may also obtain the type of forecast (e.g., month-to-month, same-month-prior-year, yearly, etc.) to be generated from the econometrical investment strategy analysis, e.g., 3902. In some implementations, the server may obtain the transaction data records using which the server may perform econometrical investment strategy analysis, e.g., 3903. For example, the server may select a spending category (e.g., from the obtained list of spending categories) for which to generate the forecast, e.g., 3904. For example, the forecast series may be several aggregate series (described below) and the 12 spending categories in the North American Industry Classification System (NAICS) such as department stores, gasoline, and so on, that may be reported by the Department of Commerce (DOC).

To generate the forecast, the server may utilize a random sample of transaction data (e.g., approximately 6% of all transaction data within the network of pay servers), and regression analysis to generate model equations for calculating the forecast from the sample data. For example, the server may utilize distributed computing algorithms such as Google MapReduce. Four elements may be considered in the estimation and forecast methodologies: (a) rolling regressions; (b) selection of the data sample (“window”) for the regressions; (c) definition of explanatory variables (selection of accounts used to calculate spending growth rates); and (d) inclusion of the explanatory variables in the regression equation (“candidate” regressions) that may be investigated for forecasting accuracy. The dependent variable may be, e.g., the growth rate calculated from DOC revised sales estimates published periodically. Rolling regressions may be used as a stable and reliable forecasting methodology. A rolling regression is a regression equation estimated with a fixed length data sample that is updated with new (e.g., monthly) data as they become available. When a new data observation is added to the sample, the oldest observation is dropped, causing the total number of observations to remain unchanged. The equation may be estimated with the most recent data, and may be re-estimated periodically (e.g., monthly). The equation may then be used to generate a one-month ahead forecast for year-over-year or month over month sales growth.

Thus, in some implementations, the server may generate N window lengths (e.g., 18 mo, 24 mo, 36 mo) for rolling regression analysis, e.g., 3905. For each of the candidate regressions (described below), various window lengths may be tested to determine which would systemically provide the most accurate forecasts. For example, the server may select a window length may be tested for rolling regression analysis, e.g., 3906. The server may generate candidate regression equations using series generated from data included in the selected window, e.g., 3907. For example, the server may generate various series, such as, but not limited to:

Series (1): Number of accounts that have a transaction in the selected spending category in the current period (e.g., month) and in the prior period (e.g., previous month/same month last year);

Series (2): Number of accounts that have a transaction in the selected spending category in the either the current period (e.g., month), and/or in the prior period (e.g., previous month/same month last year);

Series (3): Number of accounts that have a transaction in the selected spending category in the either the current period (e.g., month), or in the prior period (e.g., previous month/same month last year), but not both;

Series (4): Series (1)+overall retail sales in any spending category from accounts that have transactions in both the current and prior period;

Series (5): Series (1)+Series (2)+overall retail sales in any spending category from accounts that have transactions in both the current and prior period; and

Series (6): Series (1)+Series (2)+Series (3)+overall retail sales in any spending category from accounts that have transactions in both the current and prior period.

With reference to FIG. 39B, in some implementations, the server may calculate several (e.g., six) candidate regression equations for each of the series. For example, the server may calculate the coefficients for each of the candidate regression equations. The server may calculate a value of goodness of fit to the data for each candidate regression equations, e.g., 3908. For example, two measures of goodness of fit may be used: (i) out-of-sample (simple) correlation; and (2) minimum absolute deviation of the forecast from revised DOC estimates. In some implementations, various measures of goodness of fit may be combined to create a score. In some implementations, candidate regression equations may be generated using rolling regression analysis with each of the N generated window lengths (see, e.g., 3909). In some implementations, upon generation of all the candidate regression equations and their corresponding goodness of fit scores, the equation (s) with the best score is chosen as the model equation for forecasting, e.g., 3910. In some implementations, the equation (s) with the highest score is then re-estimated using latest retail data available, e.g., from the DOC, e.g., 3911. The rerun equations may be tested for auto correlated errors. If the auto correlation test is statistically significant then the forecasts may include an autoregressive error component, which may be offset based on the autocorrelation test.

In some implementations, the server may generate a forecast for a specified forecast period using the selected window length and the candidate regression equation, e.g., 3912. The server may create final estimates for the forecast using DOC estimates for prior period(s), e.g., 3913. For example, the final estimates (e.g., Fₜ^{Y}—year-over-year growth, Fₜ^{M}—month-over-month growth) may be calculated by averaging month-over-month and year-over-year estimates, as follows:

Dₜ^{Y}=(1+Gₜ^{Y})·Rₜ₋₁₂

Dₜ^{M}=(1+Gₜ^{M})·Aₜ₋₁

Dₜ=Mean(Dₜ^{M},Dₜ^{Y})

Bₜ₋₁^{Y}=(1+Gₜ₋₁^{Y})·Rₜ₋₁₃

Bₜ₋₁^{M}=Aₜ₋₁

Bₜ₋₁=Mean(Bₜ₋₁^{M},Bₜ₋₁^{Y})

Fₜ^{Y}=Dₜ/Dₜ₋₁₂−1

Fₜ^{M}=Dₜ/Bₜ₋₁−1

Here, G represents the growth rates estimated by the regressions for year (superscript Y) or month (superscript M), subscripts refer to the estimate period, t is the current forecasting period); R represents the DOC revised dollar sales estimate; A represents the DOC advance dollar estimate; D is a server-generated dollar estimate, B is a base dollar estimate for the previous period used to calculate the monthly growth forecast.

In some implementations, the server may perform a seasonal adjustment to the final estimates to account for seasonal variations, e.g., 3914. For example, the server may utilize the X-12 ARIMA statistical program used by the DOC for seasonal adjustment. The server may then provide the finalized forecast for the selected spending category, e.g., 3915. Candidate regressions may be similarly run for each spending category of interest (see, e.g., 3916).

### Analytical Model Sharing

Thus, as seen from the discussion above, in various embodiments, the ICST facilitates the creation of analytical models using which the data aggregated by the Centralized Personal Information Platform of the ICST may be utilized to provide business or other intelligence to the various users of the ICST. Examples of analytical models include the components discussed above in the discussion with reference to FIGS. 30 and 39A-B. In some implementations, the ICST may facilitate the sharing of such analytical models among various users and/or other entities or components associated with the ICST. For example, a developer of an analytical model such as the real-time offer merchant analytics report-generating component of FIG. 30 may distribute the analytical model to other users of the ICST. Optionally, the model may be described according to an encryptmatics XML format, as discussed in detail further below in this disclosure. In some embodiments, the analytical model may be provide without providing the model data sets based on which the model was developed, so as to protect the privacy of the consumers whose data were included in the model data set. In alternate embodiments, the ICST may utilize a consumer data anonymization component such as that described above with reference to FIG. 38, before sharing the model data set along with the analytical model.

FIG. 41 shows a logic flow diagram illustrating example aspects of sharing an analytical model generated using data acquired using the centralized personal information platform in some embodiments of the ICST, e.g., an Analytical Model Sharing (“AMS”) component. In some embodiments, the ICST may obtain an analytical model provided for sharing with other users, e.g., 4101. The ICST may parse the analytical model, e.g., using one of the parsers described below with reference to FIG. 49. The ICST may, based on the parsing of the model, identify any model data set used to develop the analytical model, that is included in the model provided for sharing, e.g., 4102. The ICST may determine, if such a model dataset is included, whether the model dataset includes private data that may be shared on an open exchange, e.g., personally identifiable information, e.g., 4103. If the data is allowed to be shared, e.g., 4104, option “No,” the ICST may provide the analytical model for sharing, e.g., to a model exchange website, without any further processing, e.g., 4105. If however, the model dataset include data that may not be shared, e.g., 4104, option “Yes,” the ICST may determine whether the model dataset may be excluded from the model, while still allowing the model to be properly used, e.g., 4106. If the model dataset is excludable, e.g., 4107, option “Yes,” the ICST may delete the model dataset from the analytical model, e.g., 4108, and provide the modified analytical model for sharing, e.g., 4105. If however, the model dataset is not excludable, e.g., 4107, option “No,” the ICST may determine whether the dataset can be anonymized while still allowing the analytical model to function properly. If the dataset can be anonymized, e.g., 4109, option “Yes,” the ICST may anonymize the model dataset, e.g., using the CDA component discussed above with reference to FIG. 38, e.g., 4110. Then, the ICST may provide the modified analytical model including the anonymized dataset for sharing, e.g., 4105. If however, the model dataset cannot be anonymized, e.g., 4109, option “No,” the ICST may generate and provide a sharing rejection message to the provider of the analytical model for sharing, e.g., 4111.

### Encryptmatics XML Data Converter

In some embodiments, the ICST may utilize metadata (e.g., easily configurable data) to drive an analytics and rule engine that may convert any structured data obtained via the centralized personal information platform, discussed above in this disclosure, into a standardized XML format (“encryptmatics” XML). See FIG. 14B for additional description. The encryptmatics XML may then be processed by an encryptmatics engine of the ICST that is capable of parsing, transforming and analyzing data to generate decisions based on the results of the analysis. Accordingly, in some embodiments, the ICST may implement a metadata-based interpretation engine that parses structured data, including, but not limited to: web content, graph databases, micro blogs, images or software code, and convert the structured data into commands in the encryptmatics XML file format. The structured data may include, without limitation, software code, images, free text, relational database queries, graph queries, sensory inputs, and/or the like. As an example, the ICST may convert software code written in SAS integrated system of software products provided by SAS Institute, Inc., into a standard encryptmatics XML structure. The example below shows SAS code and encryptmatics XML that serves a similar purpose to the SAS code—defining a module's inputs, outputs, and function calls:

// SAS
filename myFTL “my.378.FTL″;
data MyFile;

length yyddd $5. ;
infile myFTL lrecl=50000;
input @21 yyddd ;

run;
// Encryptmatics XML
<lock name=″F: Transaction Date : yyddd″

inkeyid=″0″ inkeystart=“21″ inkeystop=“25″
outkeyid=″31″ outkeyindex=″1″
function=″INSTANT″
type=″STRING″

/>

In the encryptmatics XML examples herein, a “key” represents a collection of data values. A “tumblar” represents a hash lookup table that may also allow wild card searches. A “lock” represents a definition including one or more input data sources, data types for the input sources, one or more data output storage variables, and functions/modules that may be called to process the input data from the input data sources. A “door” may refer to a collection of locks, and a vault may represent a model package defining the input, output, feature generation rules and analytical models. Thus, the encryptmatics XML may be thought of as a framework for calling functions (e.g., INSTANT—returns the raw value, LAG—return a key from a prior transaction, ADD—add two keys together, OCCURRENCE—returns the number of times a key value occurred in prior transactions, AVG—returns an average of past and current key values, etc.) and data lookups with a shared storage space to process a grouped data stream.

In some embodiments, a metadata based interpretation engine may populate a data/command object (e.g., an encryptmatics XML data structure defining a “vault”) based on a given data record, using configurable metadata. The configurable metadata may define an action for a given glyph or keyword contained within a data record. The ICST may obtain the structured data, and perform a standardization routine using the structured data as input (e.g., including script commands, for illustration). For example, the ICST may remove extra line breaks, spaces, tab spaces, etc. from the structured data. The ICST may determine and load a metadata library, using which the ICST may parse subroutines or functions within the script, based on the metadata. In some embodiments, the ICST may pre-parse conditional statements based on the metadata. The ICST may also parse data to populate a data/command object based on the metadata and prior parsing. Upon finalizing the data/command object, the ICST may export the data/command object as XML in standardized encryptmatics format. For example, the engine may process the object to export its data structure as a collection of encryptmatics vaults in a standard encryptmatics XML file format. The encryptmatics XML file may then be processed to provide various features by an encryptmatics engine.

As an example, using such a metadata based interpretation engine, the ICST can generate the encryptmatics XML code, provided below, from its equivalent SAS code, provided beneath the encryptmatics XML code generated from it:

// SAS function code
myInput = filename(“../data/30x. raw”, “fixed”,
“../metaData/ftl_302.meta”);
data myout;
set myInput;

auth_amt = float(myInput.auth_amt);
auth_amt2 = log(auth_amt);

run;
proc freq data = myout;

tables auth_amt2 ;

run;
// Equivalent encryptmatics XML function code
<init>
loop=mainLoop

<input>

```
  keyname=myinput
  file=../data/30x.raw
  format= fixed
```

meta_data= ../metaData/ftl_302.meta

</input>
<output>

keyname=myout
file=VARRAY
format=VARRAY
meta_data= {‘auth_amt2’: (1, 0, ‘String’), ‘auth_amt’: (0, 0,

‘String’)}

</output>

</init>
<vault>

<door>
<lock>

```
  outkey=myout
  outkeyname=auth_amt
  inkey=myinput
  inkeyname=auth_amt
  function=float
  type=String
```

```
  </lock>
  <lock>
```

```
  outkey=myout
  outkeyname=auth_amt2
  inkey=myout
  inkeyname=auth_amt
  function=log
  type=String
```

</lock>
</door>

</vault>
<init>
summary_level=2
loop=mainLoop

<input>

```
  keyname=myout
  file=VARRAY:myout
  format=array
```

meta_data= {‘auth_amt2’: (1, 0, ‘String’), ‘auth_amt’: (0,

0, ‘String’)}

</input>
<output>

keyname=_output
file=stdout
format=VARRAY
meta_data= {‘_agg1’: (0, 0, ‘object’)}

</output>

</init>
<vault>

<door>
<lock>

```
  outkey=agg1
  outkeyname=auth_amt2
  inkey=myout
  inkeyname=auth_amt2
  function=instant
  type=String
```

```
  </lock>
</door>
<door>
  <lock>
```

```
  outkey=_output
  outkeyname=_agg1
  function=aggfreq
  type=object
  parser=noparse
  groupkeyname=agg1
```

</lock>
</door>

</vault>

As another example, using such a metadata based interpretation engine, the ICST can generate the encryptmatics XML code, provided below, from its equivalent SAS code, provided beneath the encryptmatics XML code generated from it:

```
// SAS function code
myInput = filename(“../data/vnd.test.json”, “JSON”,
“../metaData/enrollment.meta”);
  myTumblar = tumblarname(“../tumblars/enrollment.exp.tumblar”);
  data myOut;
```

set myInput;

customer_ipaddresstmp =

tumble(myInput.customer_ipaddress , customer_ipaddress );

```
  customer_ipaddress = myOut.customer_ipaddresstmp/1000;
  cvv_resulttmp = tumble(myInput.cv_result , cv_result );
  cv_result = myOut.cvv_resulttmp/1000;
```

```
  keep customer_ipaddress cv_result;
  run;
  proc model data = myOut out=Scored;
```

features = customer_ipaddress cv_result ;
weights = 1,1 ;
type = ‘bayes’ ;

```
  run;
  proc print data = Scored;
  run;
// Equivalent encryptmatics XML function code
<init>
loop=mainLoop
```

<input>

```
  keyname=myinput
  file=../data/vnd.test.json
  format=JSON
```

meta_data= ../metaData/ftl_302.meta <br/>
</input>

<output>

keyname=myout
file=VARRAY
format=VARRAY
meta_data= {‘cv_result’: (1, 0, ‘String’),

‘customer_ipaddress’: (0, 0, ‘String’)}

</output>
<constant>

```
  indexname=_constant_1000
  value=1000
  type=float
```

</constant>

</init>
<vault>

<door>
<lock>

```
  outkey=_old_myout
  outkeyname=customer_ipaddresstmp
  inkey=myinput
  inkeyname=customer_ipaddress
  function=INSTANT
  type=String
  tumblar=customer_ipaddress
```

```
  </lock>
  <lock>
```

```
  outkey=_old_myout
  outkeyname=customer_ipaddress
  inkey=_old_myout
  inkeyname=customer_ipaddresstmp
  inkey2=_constants
  inkey2name=_constant_1000
  function=divide
  type=String
```

```
  </lock>
  <lock>
```

```
  outkey=_old_myout
  outkeyname=cvv_resulttmp
  inkey=myinput
  inkeyname=cv_result
  function=INSTANT
  type=String
  tumblar=cv_result
```

```
  </lock>
  <lock>
```

```
  outkey=_old_myout
  outkeyname=cv_result
  inkey=_old_myout
  inkeyname=cvv_resulttmp
  inkey2=_constants
  inkey2name=_constant_1000
  function=divide
  type=String
```

```
  </lock>
  <lock>
```

```
  outkey=myout
  outkeyname=customer_ipaddress
  inkey=_old_myout
  inkeyname=customer_ipaddress
  function=instant
  type=String
```

```
  </lock>
  <lock>
```

```
  outkey=myout
  outkeyname=cv_result
  inkey=_old_myout
  inkeyname=cv_result
  function=instant
  type=String
```

</lock>
</door>

</vault>
<init>
loop=mainLoop

<input>

```
  keyname=myout
  file=VARRAY:myout
  format=array
```

meta_data= {‘cv_result’: (1, 0, ‘String’),

‘customer_ipaddress’: (0, 0, ‘String’)}

</input>
<output>

keyname=scored
file=VARRAY
format=VARRAY
meta_data= {‘_mdl1’: (0, 0, ‘float’)}

</output>

</init>
<vault>

<door>
<lock>

```
  outkey=mdl1
  outkeyname=customer_ipaddress
  inkey=myout
  inkeyname=customer_ipaddress
  function=instant
  type=String
```

```
  </lock>
  <lock>
```

```
  outkey=mdl1
  outkeyname=cv_result
  inkey=myout
  inkeyname=cv_result
  function=instant
  type=String
```

```
  </lock>
</door>
<door>
  <lock>
```

```
  outkey=scored
  outkeyname=_mdl1
  function=_mdl1
  type=float
  fnc-weights=1.0,1.0
  function=SUMPROB
  model=bayes
  parser=noparse
  groupkeyname=mdl1
```

</lock>
</door>

</vault>
<init>
outputall=True
loop=print

<input>

```
  keyname=scored
  file=VARRAY:scored
  format=array
```

meta_data= {‘_mdl1’: (0, 0, ‘float’)}

</input>
<output>

keyname=_output
file=stdout
format=VARRAY
meta_data= {‘_mdl1’: (0, 0, ‘String’)}

</output>

</init>
<vault>

<door>
<lock>

```
  outkey=_output
  outkeyname=_mdl1
  inkey=scored
  inkeyname=_mdl1
  function=instant
  type=String
```

</lock>
</door>

</vault>

FIG. 42 shows a logic flow diagram illustrating example aspects of a metadata based interpretation engine of the ICST that generates standardized encryptmatics XML from structured data obtained from various sources via the centralized personal information platform, e.g., an Encryptmatics XML Converter (“EXC”) component. In some embodiments, the ICST may obtain a structured data object for conversion into encryptmatics XML format, e.g., 4201. The ICST may parse the structured data, e.g., 4202. For example, the ICST may utilize parsers such as the example parsers discussed below with reference to FIG. 74. In some embodiments, the ICST may determine and load a metadata library, using which the ICST may parse subroutines or functions within the script, based on the metadata. In some embodiments, the ICST may pre-parse conditional statements based on the metadata. The ICST may also parse data to populate a data/command object based on the metadata and prior parsing. The ICST may obtain the structured data, and perform a standardization routine using the structured data as input (e.g., including script commands, for illustration). For example, the ICST may optionally eliminate superfluous characters, e.g., extra line breaks, spaces, tabs, etc., to generate a modified structured data object, e.g., 4203. The ICST may extract a glyph or keywords from the modified structured data, e.g., 4204. The ICST may, using the metadata library, lookup a database (e.g., a metadata library) for an encryptmatics XML metadata code snippet corresponding to the extracted glyph or keyword, e.g., 4205, and append the retrieved encryptmatics XML metadata to a metadata object, e.g., 4206. The ICST may perform such a routine until all glyphs or keywords are extracted and processed from the modified structured data, see e.g., 4207. Then, the ICST may, upon finalizing the data/command object, export the data/command object as XML in standardized encryptmatics file format, e.g., 4208. For example, the engine may process the object to export its data structure as a collection of encryptmatics vaults in a standard encryptmatics XML file format. In some embodiments, the ICST may execute an application defined by the exported encryptmatics file, e.g., on other structured data available in the centralized personal information platform, e.g., 4209.

Thus, in some embodiments, the ICST may gradually convert the entire centralized personal information platform from structured data into standardized encryptmatics XML format. The ICST may also generate structured data as an output from the execution of the standardized encryptmatics XML application, and add the structured data to the centralized personal information platform databases, e.g., 4210. In some embodiments, the ICST may recursively provides structured data generated as a result of execution of the encryptmatics XML application as input into the EXC component, e.g. 4211.

FIG. 43 shows a data flow diagram illustrating an example email data aggregation procedure in some embodiments of the ICST. In some implementations, the pay network server may obtain a trigger to extract one or more monitorable user email addressees and generate an email access API query in order to monitor a user's email activity and aggregate the content thereof. For example, the pay network server may periodically perform an update of its aggregated database, e.g., 4310a, with new information available from the user's email account activity operating on the Internet. In one embodiment, the information aggregated is the raw content of email messages, including header information containing the server delivery path through which the message has passed. As another example, a request for email data aggregation update may be obtained as a result of a user wishing to enroll in a service, for which the pay network server may facilitate data entry by providing an automated web form filling system using information about the user obtained from the email data aggregation update. In some implementations, the pay network server may parse the trigger to extract access credentials with which to perform an email data aggregation update. The pay network server may generate a query for application programming interface (API) templates for various email provider services (e.g., Gmail™, Yahoo Mail™, etc.) from which to collect email data for aggregation. In some embodiments, the aggregation templates will be configured to provide access to the user's email account at the email service provider. In other embodiments, the aggregation templates will be configured to provide a mechanism to parse retrieved user email into a more suitable format for processing. In still other embodiments, the templates may indicate that an email transfer protocol (such as POP, IMAP, and/or the like) should be employed. In some instances, the email transfer protocol may be used over a secondary secured connection (such as SSH, PGP, and/or the like).

In one embodiment, the pay network server may query, e.g., 4312, a pay network database, e.g., 4307, for email aggregation API templates for the email provider services. For example, the pay network server may utilize PHP/SQL commands similar to the examples provided above. The database may provide, e.g., 4313, a list of email access API templates in response. Based on the list of API templates, the pay network server may generate email aggregation requests, e.g., 4314. The pay network server may issue the generated email aggregation requests, e.g., 4315a-c, to the email network servers, e.g., 4301a-c. For example, the pay network server may issue PHP commands to request the email provider servers for email data. An example listing of commands to issue email aggregation data requests 4315a-c, substantially in the form of PHP commands, is provided below:

<?php
$aggregated_email = “”;
$mail = imap_open(‘{server.com:110/pop3}’,

$user,
$password);

$headers = imap_headers($mail);
for ($1=1; $i<=count($headers); $i++) {

$structure = imap_fetchstructure($mail, $i);
$structure_parts = $structure−>parts;
$number_parts = count($structure_parts);
for ($j=0; $j<=$number_parts; $j++) {

$text = imap_fetchbody($mail,$i,$j);
$aggregated_email .=
nl2br(htmlspecialchars($text)).“<br>”;

}
}
?>

In some embodiments, the email provider servers may query, e.g., 4317a-c, their databases, e.g., 4310a-c, for email aggregation results falling within the scope of the email aggregation request. In response to the queries, the databases may provide email data, e.g., 4318a-c, to the email provider servers. The email provider servers may return the email data obtained from the databases, e.g., 4319a-c, to the pay network server making the email aggregation requests. An example listing of email data 4319a-c, substantially in the form of JavaScript Object Notation (JSON)-formatted data, is provided below:

[“data”:[

{“headers”: “Delivered-To: MrSmith@gmail.com

Received: by 10.36.81.3 with SMTP1 id e3cs239nzb; Tue, 5 Mar 2020
15:11:47 -0800 (PST)
Return-Path:
Received: from mail.emailprovider.com (mail.emailprovider.com
[111.111.11.111]) by mx.gmail.com with SMTP id
h19si826631rnb.2005.03.29.15.11.46; Tue, 5 Mar 2020 15:11:47 -
0800 (PST)
Message-ID: <20050329231145.62086.mail@mail.emailprovider.com>
Received: from [11.11.111.111] by mail.emailprovider.com via
HTTP; Tue, 5 Mar 2020 15:11:45 PST
Date: Tue, 5 Mar 2020 15:11:45 -0800 (PST)
From: Mr Jones
Subject: Dinner at Patsy's this weekend?
To: Mr Smith”,

```
  “from_addr”: “MrJones@gmail.com”,
  “from_name”: “Mr Jones”,
  “to_addr”: “MrSmith@gmail.com”,
  “subject”: “Dinner at Patsy's this weekend?”
  “date”: “Tue, 5 Mar 2020 15:11:45 -0800 (PST)”,
  “msg_content”: “Hey Frank,\n\nWould you like to meet at
```

Patsy's for dinner on Saturday night? Their chicken parm is as
good as my mom's (and that's pretty good!).\n\nRafael”
},
{
...
}
]]

In some embodiments, the pay network server may store the aggregated email data results, e.g., 4320, in an aggregated database, e.g., 4310a.

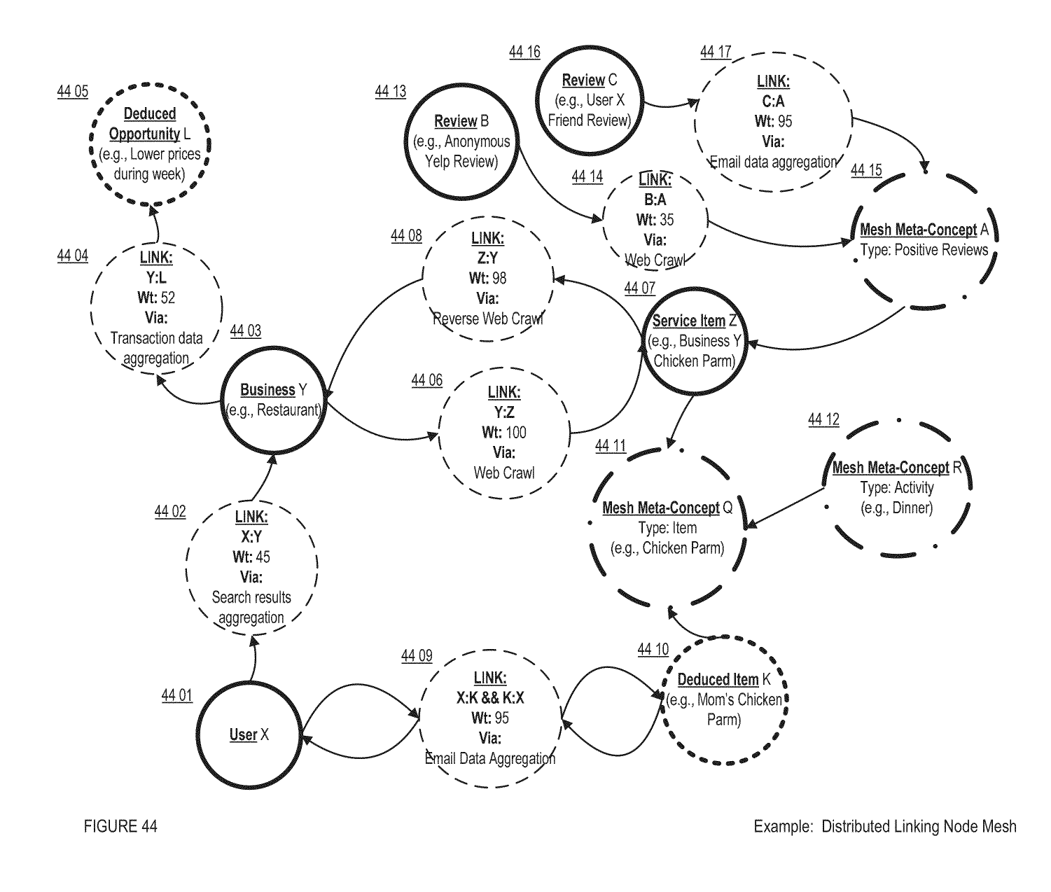

FIG. 44 is a block diagram illustrating an example structure of a distributed linking node mesh, in one embodiment of the ICST. In one embodiment, the linking node mesh may be represented as a modified graph data structure that contains nodes for entities and edges that represent the associations between the nodes. In one embodiment, the nodes are actual observable entities, such as a user 4401, a business 4403, an item 4407, a review on an online web site, e.g., 4413, 4416, and/or the like. The graph mesh may also contain deduced entities that have been inserted by the ICST as a result of the aggregation described herein, such as the aggregation of data from email, search queries, location aggregation, and/or the like. Non-limiting examples of deduced entity nodes that may be inserted into the graph mesh include a deduced item, i.e., 4410 or a deduced opportunity, i.e., 4405. A deduced item may be an item that the mesh determines exists based on scanning emails, e.g., 4409, to determine that a concept that occurs with some frequency in emails is associated with a concept that is not yet linked into the mesh graph. An example deduced item may be a user's mother's chicken parmesan 4410. In one embodiment, there may also be deduced opportunities added to the mesh graph, e.g. 4405. A deduced opportunity may be an opportunity that is determined based on aggregated transaction data, e.g., 4404. For example, through the use of aggregated transaction data it may be determined by the ICST that the price of a given set of items declines at a restaurant, e.g., 4403, during the week, e.g., 4405. This decline in pricing may then allow the ICST to determine that there exists a special weekday menu with lower prices. In so doing, an opportunity for use by the mesh in providing recommendations or information to users may be created, e.g., 4405, in order to facilitate searching the mesh.

In one embodiment, the mesh graph may also contain service items, e.g., 4407, such as a restaurants chicken parmesan or other menu item. The service item and its link to the business 4403, e.g., 4406, 4408, may be determined using a forward web crawl (such as by crawling from a business home page to its menu pages), or by a reverse web crawl, such as by crawling using an Optical Character Recognition scanned menu forwarded through an email exchange and aggregated by an email aggregating component of the ICST.

In one embodiment, the mesh graph may additionally contain meta concepts, e.g., 4410, 4412, 4415. Meta-concepts are conceptual nodes added to the graph by ICST that define not a specific entity (such as a user or a business) nor a specific deduced entity (such as a deduced item or a deduced opportunity), but rather indicate an abstract concept to which many more nodes may relate. For example, through web crawling, e.g., 4414, or email aggregation, e.g., 4417, user reviews may be imported as nodes within the mesh graph, e.g., 4413, 4416. Nodes may be anonymous, e.g., 4413, linked to a specific user's friend (such as to provide specific user recommendations based on a social graph link), e.g., 4416, and/or the like. These reviews may be analyzed for positive concepts or words such as “delightful meal” or “highly recommended” and thereafter be determined by the ICST to be a positive review and linked to a mesh meta-concept of the kind positive review, e.g., 4415. In so doing, the ICST allows disparate aggregated inputs such as email aggregation data, location aggregation data, web crawling or searching aggregated data, and/or the like to be used to roll up concepts into conceptual units.

In one embodiment, these conceptual meta concepts, e.g., 4415, may be further linked to actual items, e.g., 4407. In so doing connections can be formed between real world entities such as actual reviews of items, to meta-concepts such as a positive review or beneficial location, and further linked to actual items as a location. Further meta-concepts may include activities such as dinner, e.g., 4412, a non-entity specific item (e.g., not a restaurant's chicken parmesan and not a mother's chicken parmesan, but chicken parmesan as a concept), e.g., 4411. The connection of actual entity nodes with deduced entity nodes and meta-concept nodes allows the mesh to answer a virtually limitless number of questions regarding a given nodes connections and probable outcomes of a decision.

In one embodiment, nodes within the mesh graph are connected by edges that have no magnitude. In another embodiment, the edges themselves may have metadata associated with them that enable faster or better querying of the mesh. Example meta data that may be stored at a graph edge include a relative magnitude of connection between nodes, path information regarding other nodes available from the edge, and/or the like. In still other embodiments, intermediate or link nodes, e.g., 4404, 4406, 4408, 4414, 4417, 4409, may be inserted by the ICST into the mesh graph. These intermediate nodes may function as the equivalent of an edge, in that they may describe a relationship between two nodes. In one embodiment, the link nodes may contain information about the nodes that they connect to. In so doing, the number of nodes in the graph that need to be searched in order to find a given type, magnitude or value of connection may be reduced logarithmically. Additionally, the link nodes may contain data about how the relationship between the nodes it links was established, such as by indicating the connection was established via search aggregation, email aggregation, and/or the like.

In one embodiment, the distributed linking node mesh may be stored in a modified open source database such as Neo4j, OrientDB, HyperGraphDB, and/or the like. An example structure substantially in the form of XML suitable for storing a distributed linking node mesh is:

<mesh>

<nodes>

<node id=”1” kind=”entity” type=”user”>

<name=”John Doe”>

</node>
<node id=”2” kind=”entity” type=”item”>

<name=”iPhone” />

</node>
<node id=”3” kind=”deduced_entity” type=”business”>

<name=”Apple Computer” />
<attribute type=”keyword” value=”iPhone” />
<deduced_from value=”frequency_keyword” />

</node>
<node>

...

</node>

</nodes>
<link_nodes>

<linknode id=”78” in_node=”1” out_node=”3” value=”55” />
<linknode id=”97” in_node=”1” out_node=”2” value=”124” />
...

</link_nodes>
<edges>

<edge from_node=”1” to node=”78” />
<edge from_node=”78” to node=”3” />
...

</edges>

</mesh>

An example query suitable for querying a distributed linking node mesh is:

START user=node(5,4,1,2,3)
MATCH user-[:affinity]−>”iphone”
WHERE entity.manufacturer =~ ′Apple.*′, link.strength >= 40
RETURN user, user.affinity

In another embodiment, an example query suitable for querying a distributed linking node mesh is:

##MODEL QUERY Language (JSON FORMAT)
{
1: {‘LOWER’: 100, ‘BASETYPE’: [‘MODEL_001_001_00’,
‘MODEL_002_001_00’, ‘MODEL_003_001_00’,
‘MODEL_004_001_00’] ,
‘attribute’: ‘WEIGHT’, ‘rule’: ‘NEAR’, ‘OP’: ‘PROX’, ‘type’:
‘TOKENENTITY’, ‘HIGHER’: 100}
, 2: {‘type’: [‘USER’, ‘MCC’], ‘rule’: ‘FOLLOW’}
, 3: {‘rule’: ‘RESTRICTSUBTYPE’, ‘BASETYPE’:
[‘MODEL_001_001_00’, ‘MODEL_002_001_00’,
‘MODEL_003_001_00’, ‘MODEL_004_001_00’]}}
}

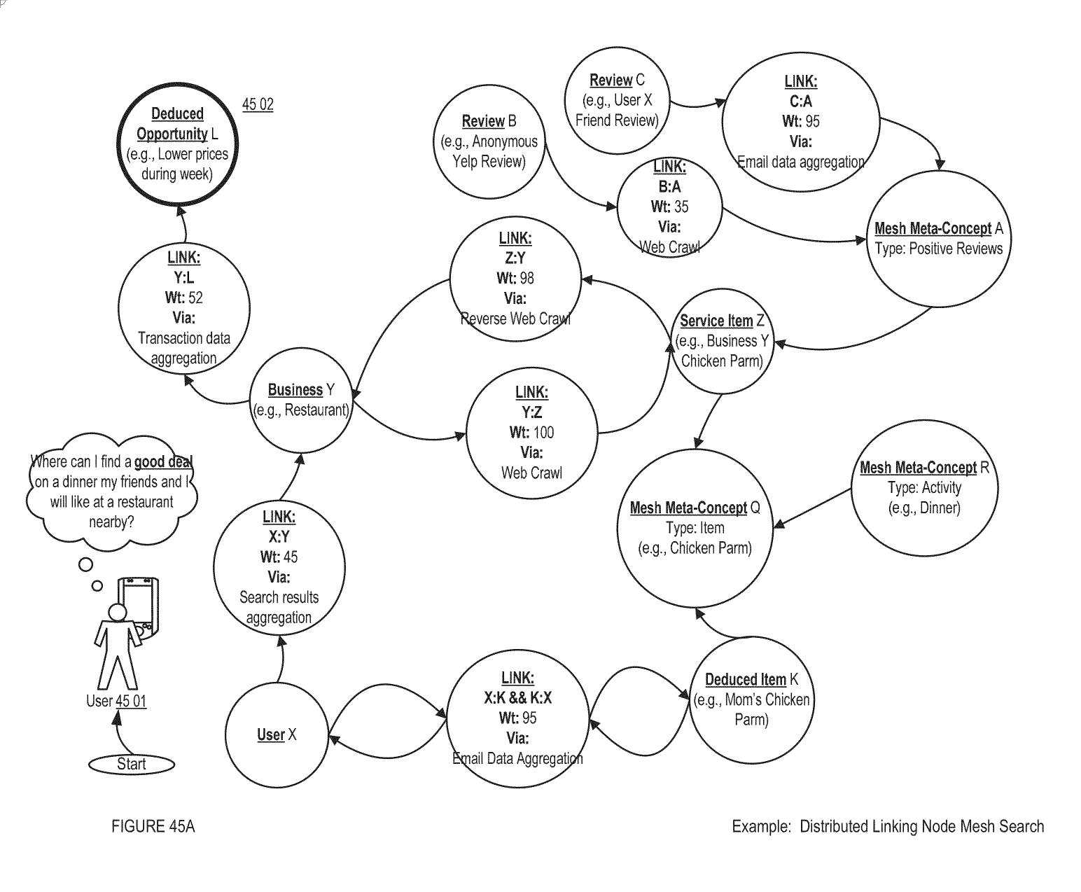

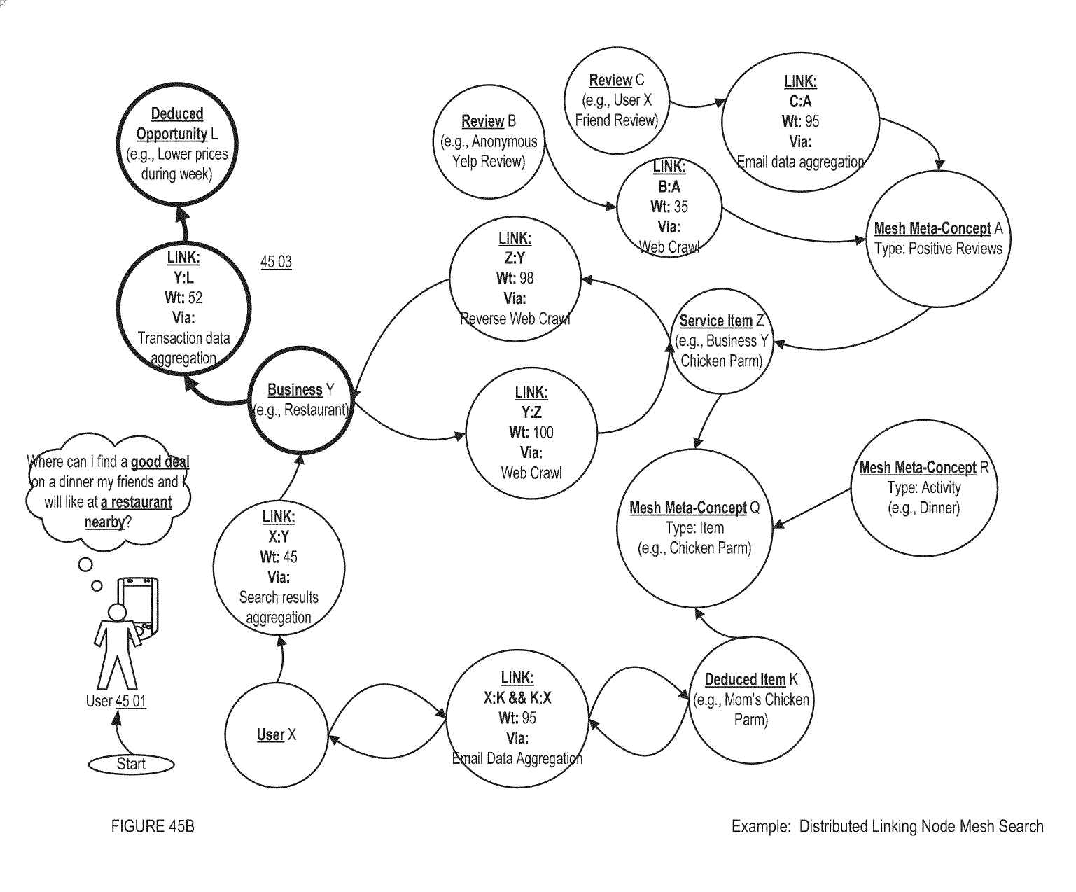

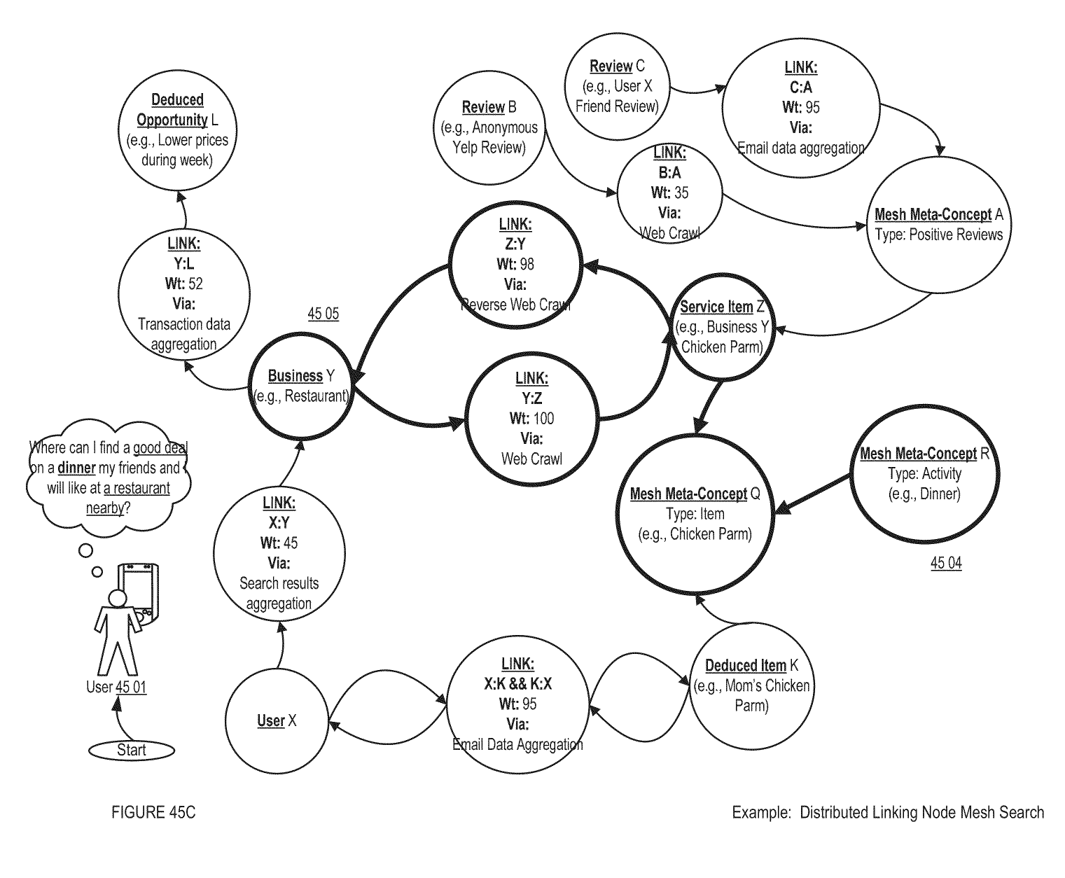

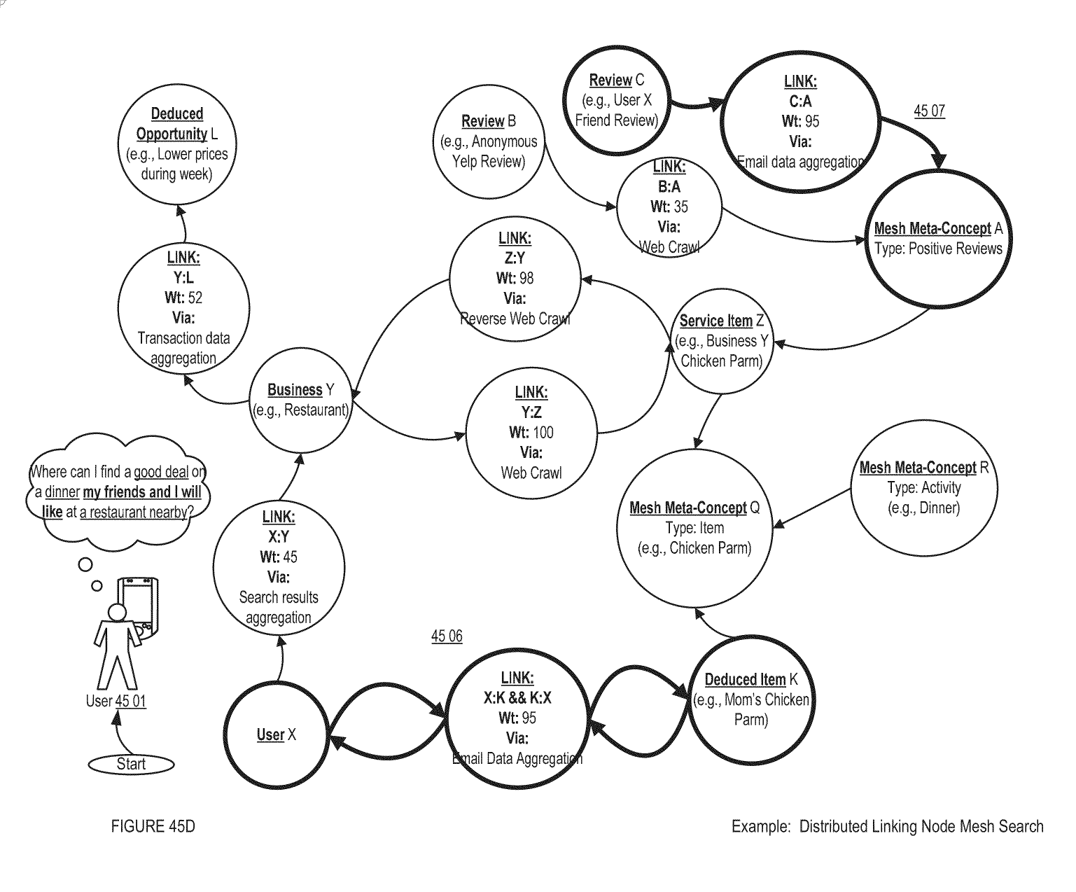

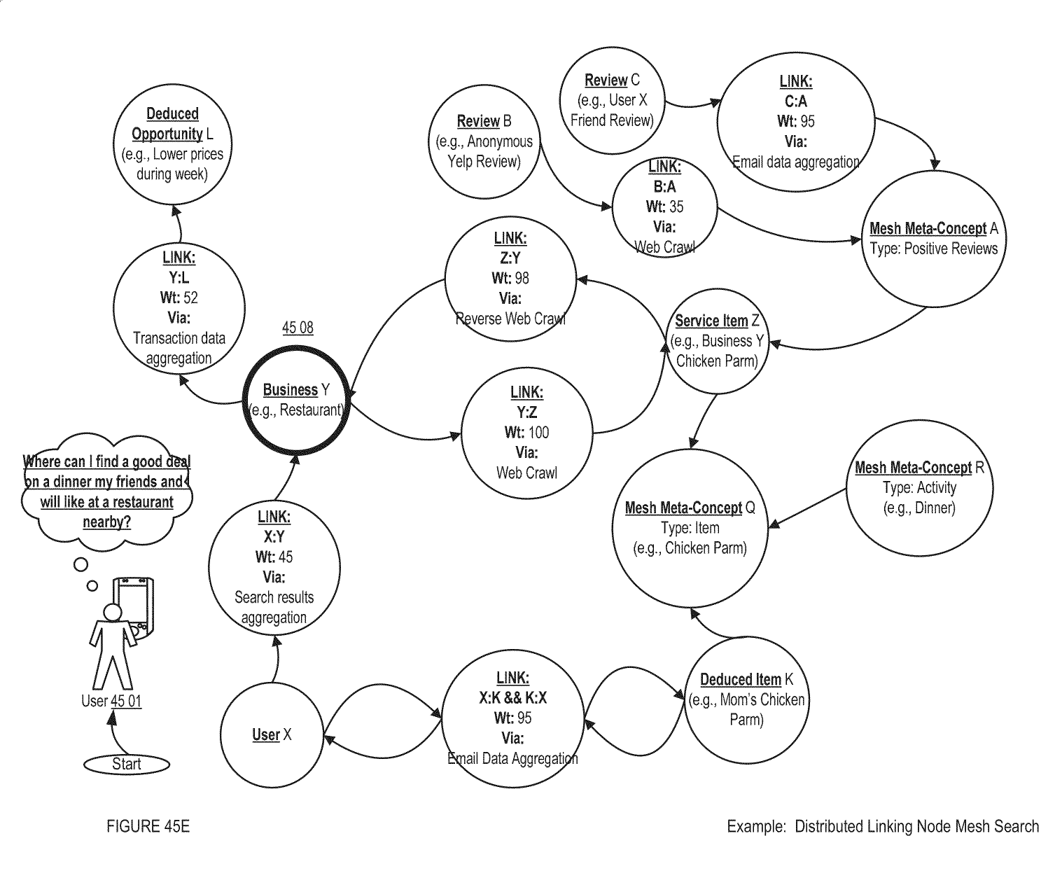

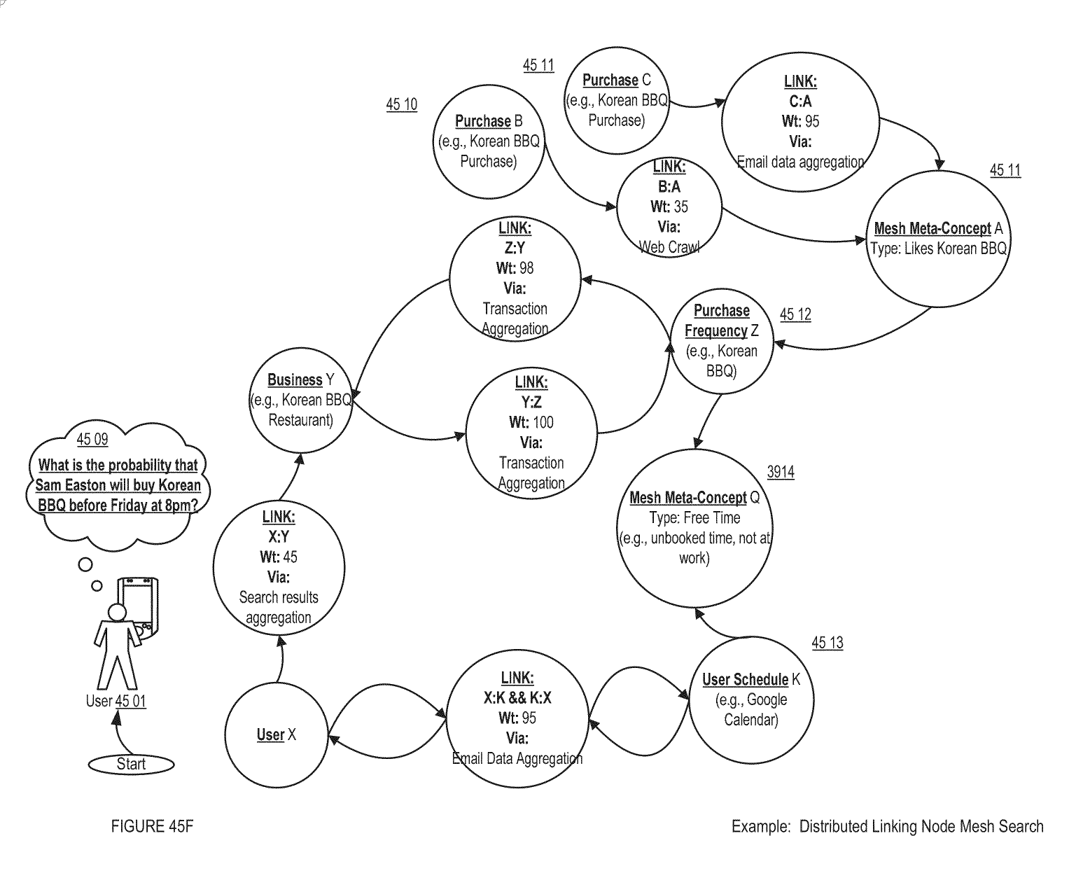

FIGS. 45A-E are an example block diagram illustrating a distributed linking node mesh search, in one embodiment, of the ICST. The graph presented in FIG. 45A-E is similar to the graph presented in FIG. 44 but nodes of different type are represented similarly for ease of understanding. In one embodiment, a user 4501 may desire to find a good deal on dinner with friends at a restaurant nearby. The ICST may be configured with a capability to extract sub-concepts from a natural form query question, such as by natural language processing. Example tools suitable for this type of processing may include OpenNLP, Graph Expression, FreeLing, and/or the like.

In one embodiment, the query portion relating to finding a good deal is performed as a ICST search to arrive arrive at a result of a deduced opportunity for lower prices during weekdays, e.g., 4502. The search may then progress to extract the concept of a good deal merged with a restaurant nearby. Using an integrated location capability of a user's device, the user's current location may additionally be provided to the ICST for use in this portion of the query process, to produce a result containing a deduced opportunity for lower prices (e.g., a “good deal”) at a business nearby wherein the lower prices are linked to the business nearby with a certain degree of weight, e.g., 4503. In one embodiment, the search may progress to find results for the concept of a dinner (e.g., meta-concept dinner 4504), which is itself linked through intermedia nodes to the business found in the previous portion of the search, e.g., 4505. In one embodiment, the search may then progress to find connections that indicate that the user 4501 will like the restaurant, e.g., 4506, and that the user's friends will similarly like the restaurant, e.g., 4507. The intermediate searches performed may be then merged to produce a unitary result, e.g., 4508, for a restaurant meeting the full criteria. In cases where no single entity meets all the criteria, the most important criteria to a user may be first determined using its own ICST search, such as a search that determines that a user 4501 has never traveled to a nearby popular location area for dinner and therefore concluding that location is very important to the user. In one embodiment, multiple results 4508 may be returned and ranked for acceptability to both the user and his/her friends, enabling the user to then choose a preferred location.

FIG. 45F shows an alternative embodiment of a distributed linking node mesh search. Here, mesh user 4501 wants to determine the probability that a user will buy Korean BBQ before a certain time, e.g., 4509. The distributed linking mesh may be queried. For example, the user's previous purchases of Korean BBQ (e.g., 4510, 4511), may be linked to a meta-concept that indicates an affinity for Korean BBQ, e.g., 4511. The affinity may be similarly linked to an entity indicating a purchase frequency for Korean BBQ, e.g., 4512. Similarly, by aggregating data from the user's email correspondence (i.e., calendar updates, and/or the like), the mesh may have an entity representing the user's schedule including free time, e.g., 4513. Both the purchase frequency 4512 and the user schedule 4513 may be linked to a mesh meta-concept of free time, e.g., 4514, which may indicate that the entities are related when the user has free time (e.g., the individual may be more likely to go for Korean BBQ when she is not working). By querying the distributed linking node mesh for interrelations between entities built from aggregation techniques (and deduced or input entities), a profile of the user's future behavior may be similarly built. For example, if the user schedule indicates that the user is free on both Wednesday and Thursday afternoons, and the aggregated purchase history indicates an affinity to purchase Korean BBQ both on those days (based on the purchase transaction entities) and when the user is free (based on the meta-concept of free time), then a mesh search can return a probability based on the respective weights of the constituent entity relationships with respect to the user.

FIGS. 46A-C are an example block diagram illustrating index creation in a distributed linking node mesh, in one embodiment of the ICST. In one embodiment, a non-indexed graph is exploded to form a chain of relationships from a single entity's perspective, e.g., 4601. A furthest node graph traversal is then performed, e.g., 4602, whereby the linking nodes are sequentially removed and replaced with a single edge which has a magnitude of the connection between the two nodes, e.g., 4602a, 4602b. A nearest node graph traversal may then be performed, e.g., 4603, whereby the magnitude of links further from the nearest node is modified by a factor of previous links. Modification proceed from nearest to furthest nodes, e.g., 4603a. In the example illustrated, a modification is made to the second edge encountered to make its value as a relation of magnitude with User X incident on both the relationship of User X to Business Y and of Business Y to Deduced Opportunity L. This procedure may produce a flattened graph from a single entity's perspective, e.g., 4604. The graph may then be further modified to a single perspective indexed graph, e.g., 4605, to reduce the number of hops in the graph from a given entity to any other entity within the indexed graph, so as to advantageously speed searching of the graph from the entity's perspective, e.g., 4605a. In one embodiment, the output of similar indexes performed from other entity perspectives, e.g., 4606b, may be linked 4606c to the generated perspective 4606a. In so doing, the index may form a graph that simultaneously allows easy searching from the perspective of a single entity while maintaining connection between entities of different perspectives.

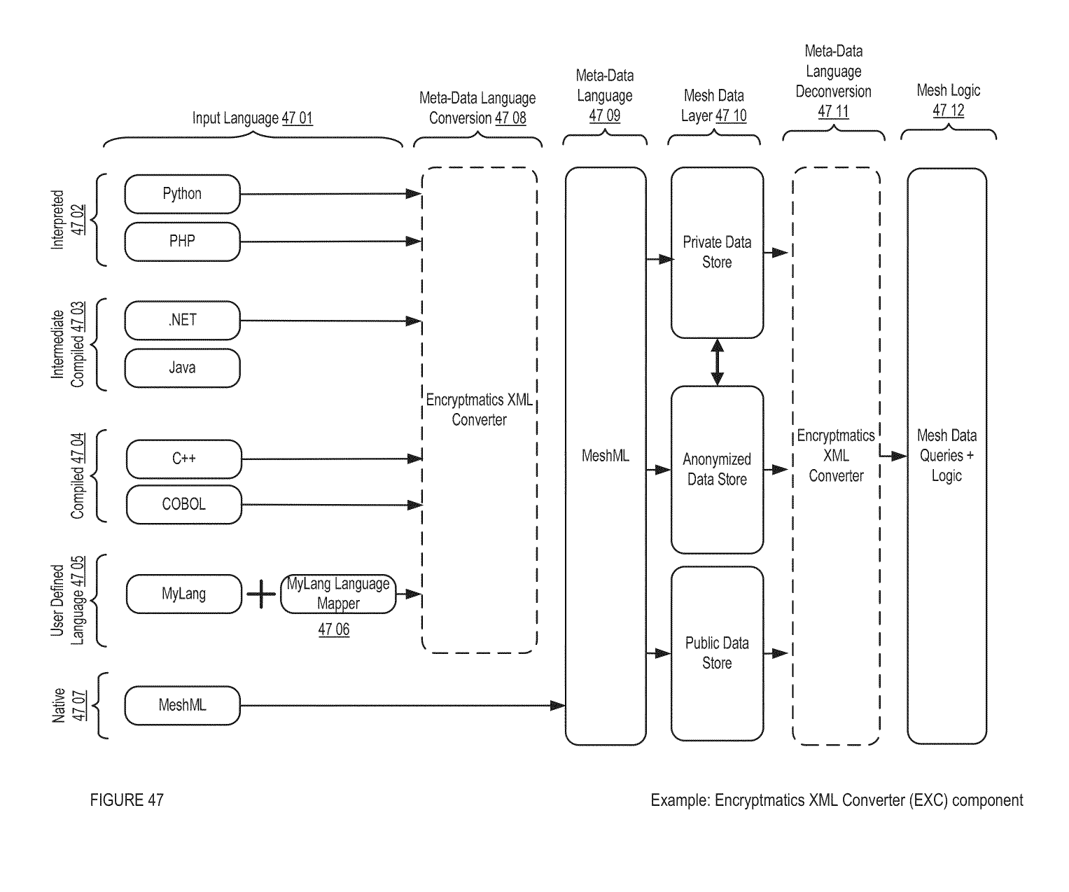

FIG. 47 is an example block diagram illustrating aspects of an Encryptmatics XML converter component. In one embodiment, models may be input in a number of disparate language, e.g., 4701. Languages may include interpreted languages such as Python, PHP, and/or the like, e.g., 4702, intermediate compiled languages such as .Net, Java, and/or the like, e.g., 4703, compiled languages such as C++, COBOL, and/or the like, e.g., 4704. A user defined language may also be input, e.g., 4705. In one embodiment, the user defined language will be input with a language mapper, e.g., 4706 that defines a mapping of the user defined language's functions, methods, supported types, and/or the like to a language known by the ICST. In still other embodiments, a native meta-data language, e.g., 4707, may be input.

In one embodiment, languages other than a native meta-data language are passed to a meta-data language conversion component 4708, such as an Encryptmatics XML converter. The converter may convert the language to a meta-data language 4709. In one embodiment, the meta data language may describe data sources 4710 including a private data store (not available to the provided model), an anonymized data store that is based on the private data store (available to the provided model), and/or a public data store. In one embodiment, the meta-data language may be deconverted 4711 to produce data queries and model logic 4712 that is parseable by the ICST interpreter.

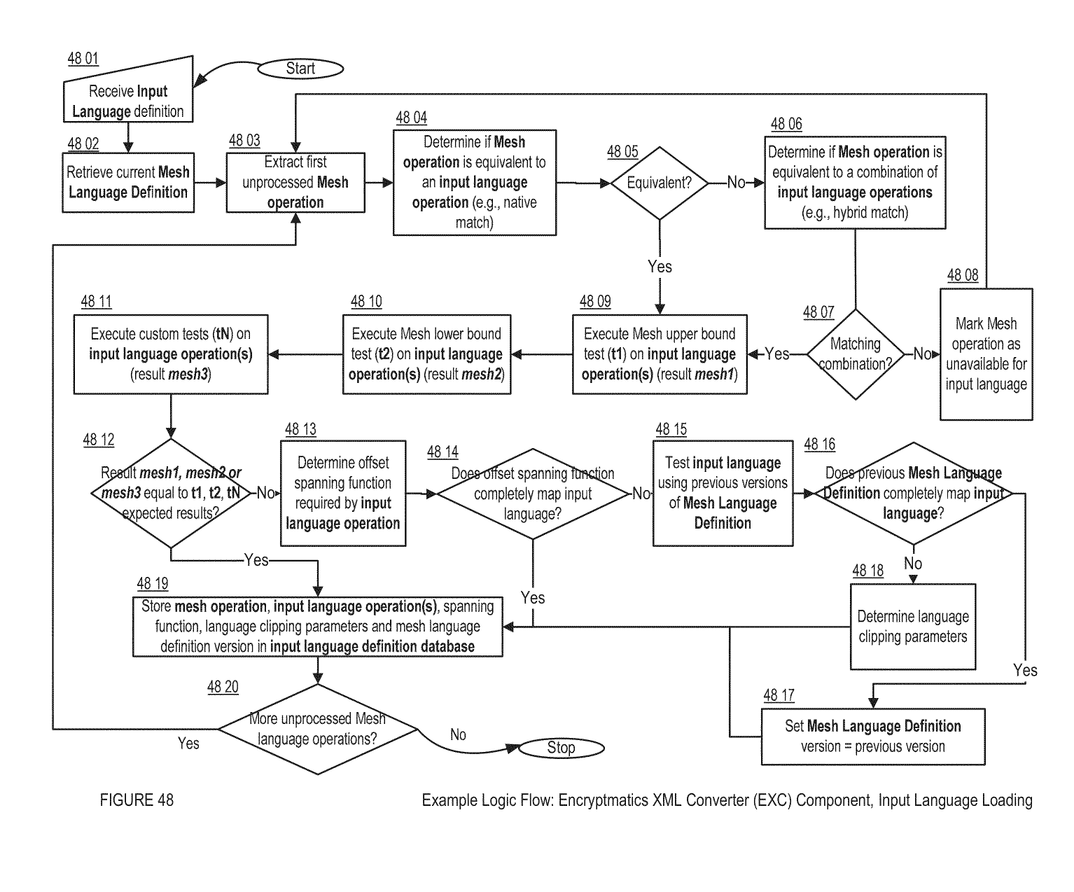

FIG. 48 is an example logic flow illustrating input language loading by an Encryptmatics XML converter component, in one embodiment of a ICST. In one embodiment, an input language definition is received, e.g., 4801. The language definition may be a file containing information about the functions available within the input language. In one embodiment, the language definition is source code for the language to be loaded into the ICST. In still other embodiments, the language definition is an executable binary file suitable for the ICST to issue sample commands and receive output. In one embodiment, the current mesh language definition may be retrieved 4802. The mesh language may be an XML based meta-data language that allows the description of data sources, data source manipulations (both visible and not visible to the input model) and a model to be run against the data sources. A model may be a series of logic commands describing manipulations or conditional logic to apply to input or source data sources in order to reach a result. In one embodiment, language loading may facilitate the user providing the description of data sources, data source manipulations, the model, and/or the like in a language with which the user is already familiar. The ICST may then used a loaded language definition to convert the language to a common meta-data based (e.g., XML based, JSON based, and/or the like) language with which to then parse and execute commands from.

In one embodiment, the first unprocessed mesh language operation is extracted from the mesh language definition. An example operation may be “TRIM”, which may strip whitespace from the beginning and end of an input string. A determination is made if the mesh operation has an equivalent operation in the input language, e.g., 4804. Such a determination may be made by executing a sample command against the input binary and observing the output to determine if an error occurred. In other embodiments, a publically available language definition web site may be crawled to determine which function(s) within an input language likely map to the mesh operation equivalent(s). In some instances, there will be a one-to-one mapping between the input language and the meta-data based mesh language. If there is not a one-to-one equivalence, e.g., 4805, a determination is made (using a procedure similar to that employed above) to determine if a combination of input language functions may equate to a mesh language operation, e.g., 4806. For example, an input language that supports both a left-trim (strip space to left of string) and a right-trim operation (strip space to right of string) may be considered to support a mesh TRIM through a combination applying both the left-trim and right-trim operations, producing a substantially equivalent output result.

In one embodiment, if no matching combination is found, e.g., 4807, the mesh operation may be marked as unavailable for the input language, e.g., 4808 and the next unprocessed mesh operation may then be considered. If a matching combination is found, e.g., 4807, an upper bound test may be employed to test the upper bound behavior of the input language operation and compare that to the upper bound behavior of an equivalent mesh operation, e.g., 4809. For example, some languages may perform floating point rounding to a different degree of precision at upper bounds of input. By testing this case, a determination may be made if the equivalent input language function will produce output equivalent to the mesh operation at upper bounds. In one embodiment, a lower bound test may be employed to test the lower bound behavior of the input language operation and compare that to the lower bound behavior of an equivalent mesh operation, e.g., 4810. For example, some languages may perform floating point rounding to a different degree of precision at lower bounds of input. By testing this case, a determination may be made if the equivalent input language function will produce output equivalent to the mesh operation at upper bounds. In one embodiment, other custom tests may then be performed that may be dependent on the mesh operation or the input language operation(s), e.g., 4811. If the results of the test cases above produce output that is different than the expected output for the equivalent mesh operation, e.g., 4812, an offset spanning function may be generated to span the difference between the languages. For example, in the example above if the rounding function in the input language is determined to produce different behavior than the equivalent mesh operation at a lower bound, a function may be provided in the input or mesh language to modify any output of the given input language operations to create an equivalent mesh language operation output. For example, a given floating point number may be rounded to a given level of significant digits to produce equivalent behavior.

In one embodiment, the offset spanning function may not be capable of completely mapping the input language operation(s) to the mesh language operation, e.g., 4814. In one embodiment, previous versions of the mesh language definition, e.g., 4815, may then be tested using a procedure substantially similar to that described above to determine if they may completely map the input language, e.g., 4816. If the previous version of the mesh language definition completely maps the input language, the mesh language definition version for the input language may be set to the previous version, e.g., 4817. For example, a previous version of the mesh language definition may contain different capabilities or function behaviors that allow it to completely map to an input language. If previous versions of the mesh input language do not completely map to the input language, language clipping parameters may be generated, e.g., 4818. Language clipping parameters are input limitations that are placed on an input language such that any inputs within the input limitations range will produce compliant mesh operation output. Inputs outside that range may generate an error. In one embodiment, language clipping parameters may include limits to the upper bound or lower bound of acceptable input. Such limits may be determined by iteratively testing increasing or decreasing inputs in order to find an input range that maps completely to the mesh operation.

In one embodiment, the current mesh operation, input language operation(s) any spanning functions or language clipping parameters, the mesh language version, and/or the like may be stored in an input language definition database, e.g., 4819. If there are more unprocessed mesh language operations, e.g., 4820, the procedure may repeat.

FIGS. 49A-B show an example logic flow for input model conversion, in one embodiment of an ICST. In one embodiment, a language command file is received, e.g., 4901. The language command file may contain instructions in any language which has been loaded into the ICST (e.g., FIG. 48). The input language command file may contain instructions that may describe a set of manipulations that may be performed on a data set (e.g., a data set that is input as part of the input language command file, a data set that is loaded from an external data source, and/or the like). In one embodiment, input language definitions corresponding to the language of the input language command file is retrieved, e.g., 4902. A mesh language definition, which may specify operations that are available within the mesh language, may also be retrieved, e.g., 4903. Non-conditional logic flow blocks in the input language command file may be determined, e.g., 4904. A non-conditional logic block represents the outermost logic contained within an input language command file. For example, if a file contains no conditional logic (i.e., no if/than/else blocks, and/or the like), then the outermost logic may be the complete set of input language commands themselves. In one embodiment, a run block is created for each outermost non-conditional logic flow block. The metadata run blocks are then populated with logic commands further in the procedure. In one embodiment, any variables that are initialized within the logic block corresponding to the run block are determined, e.g., 4906. A variable initialization template may then be determined, e.g., 4907. In one embodiment, the input language definition is used to determine if an equivalent meta-data based variable type is available in the mesh language definition for each of the variables initialized in the input language command file, e.g., 4908. If all variable types are not available, a model input error may be raised, e.g., 4909.

In one embodiment, the variable initialization template and the input language definition are used to create a constants block based on the variable initialization template, e.g., 4910. Within the constants block, any constants that were included in the input language command file may be stored as structured XML. An example constants block, substantially the form of XML is as follows:

```
<constant>
  indexname=”0”
  value=’row by row’
  Type=”string”
</constant>
```

In one embodiment, there may be multiple constant blocks defined corresponding to multiple constant values in the input language command file. In other embodiments, constants may be collapsed to one block.

In one embodiment, the input datasources may then be determined based on the input language command file, e.g., 4911. For example, an input datasource may be defined directly in the input language command file (such as by declaring a variable as an array to values in the input language command file). In other embodiments, the inputs may be external to the input language command file, such as a third party library or loaded from an external source file (such as a comma delimited file, via a SQL query to an ODBC compliant database, and/or the like). A mesh language input datasource template may then be retrieved, e.g., 4912, to provide a structure to the ICST to use in formatting the inputs as meta-data. The datasources may be scanned to determine if they are available to the model (such as by executing “ls-l” on a POSIX compliant Unix system), e.g., 4913. If the datasources are available to the model, then a meta data language input block may be created using the input datasource template, the language definition, and the input language command file, e.g., 4914. An example input block substantially in the form of XML is:

```
<input>
  keyname=”test_by”
  file=”<ecyptmatics install>/test_by.egd”
  format=”ecdataformat”
  meta_data={‘co18’: (7, 0, ‘string’), ‘_header’: True, ‘col_2’:
(1,0,’int’), ‘col_3’: (2,0,’int’), ‘col_1’: (0,0,’int’), ‘col_6’:
(5,0,’julian’), ‘col_7’: (6,0,’float’), ‘col_4’:
(3,0,’ordinaldate’), ‘col_5’: (4,0,’date’)}
</input>
```

In one embodiment, a mesh language output template is determined, e.g., 4915 and an output block is created using a procedure substantially similar to that described above with respect to the constant and input blocks, e.g., 4916. An example output block, substantially in the form of XML is:

```
    <output>
    keyname=“myout”
    file=“stdout”
    format=“deliminated”
    meta_data={‘col_2’: (2, 0, ‘String’), ‘col_2_l’: (4, 0,
‘String’), ‘test’: (0, 0, ‘String’), ‘col_3’: (3, 0, ‘String’),
‘col_1’: (1, 0, ‘String’), ‘sum_col_7’: (5, 0, ‘String’)}
deliminator= “csv”
</output>
```

In one embodiment, the constant block, input block, and output block are added to a newly created initialization block and the initialization block is added to the current run block, e.g., 4917. An example run block with a complete initialization block included therein, substantially in the form of XML is as follows:

```
<run>
<init>
processor=process
    <input>
      keyname=“test_by”
      file=“<ecryptmatics install>/test/data/test_by.egd”
      format=“ecdataformat”
      deliminator=“csv”
      meta_data={‘col_8’: (7, 0, ‘string’), ‘_header’: True,
‘col_2’: (1, 0, ‘int’), ‘col_3’: (2, 0, ‘int’), ‘col_1’: (0, 0,
‘int’), ‘col_6’: (5, 0, ‘julian’), ‘col_7’: (6, 0, ‘float’),
‘col_4’: (3, 0, ‘ordinaldate’), ‘col_5’: (4, 0, ‘date’)}
    </input>
    <output>
    keyname=“myout”
    file=“stdout”
    format=“deliminated”
    meta_data={‘col_2’: (2, 0, ‘String’), ‘col_2_l’: (4, 0,
‘String’), ‘test’: (0, 0, ‘String’), ‘col_3’: (3, 0, ‘String’),
‘col_1’: (1, 0, ‘String’), ‘sum_col_7’: (5, 0, ‘String’)}
    deliminator= “csv”
    </output>
    <constant>
      indexname=“0”
      value=‘row by row’
      type=“string”
    </constant>
</init>
</run>
```

In one embodiment, a vault block will then be created, e.g., 4918. A logic command block will be extracted from the input logic command file, e.g., 4919. A logic command block is a logic block that is a non-outermost non-conditional logic flow. A door block may then be added to the vault block, e.g., 4920. A logic command, representing a discrete logic operation, may then be extracted from the logic command block, e.g., 4921. The logic command may be a tumbler, e.g., 4922, in which case a tumbler key may be looked up in a tumbler database and the tumbler may be processed, e.g., 4923. Further detail with respect to tumbler processing may be found with respect to FIGS. 44-45. The logic command may then be mapped to a mesh language equivalent by using the language definition file, e.g., 4924. A mesh template logic command template, containing formatting information for a logic command, may be retrieved, e.g., 4925. In one embodiment, a lock block may be created using the mesh language definition, the language definition, and the logic command, e.g., 4926. The created lock block may be added to the current door block, e.g., 4927. In one embodiment, if there are more logic commands, e.g., 4928, the procedure may continue. If there are more logic command blocks, e.g., 4929, the procedure may similarly continue. In one embodiment, if there are more outermost non-conditional logic flow blocks in the input language command file, e.g., 4930, the procedure may continue with respect to FIG. 49A.

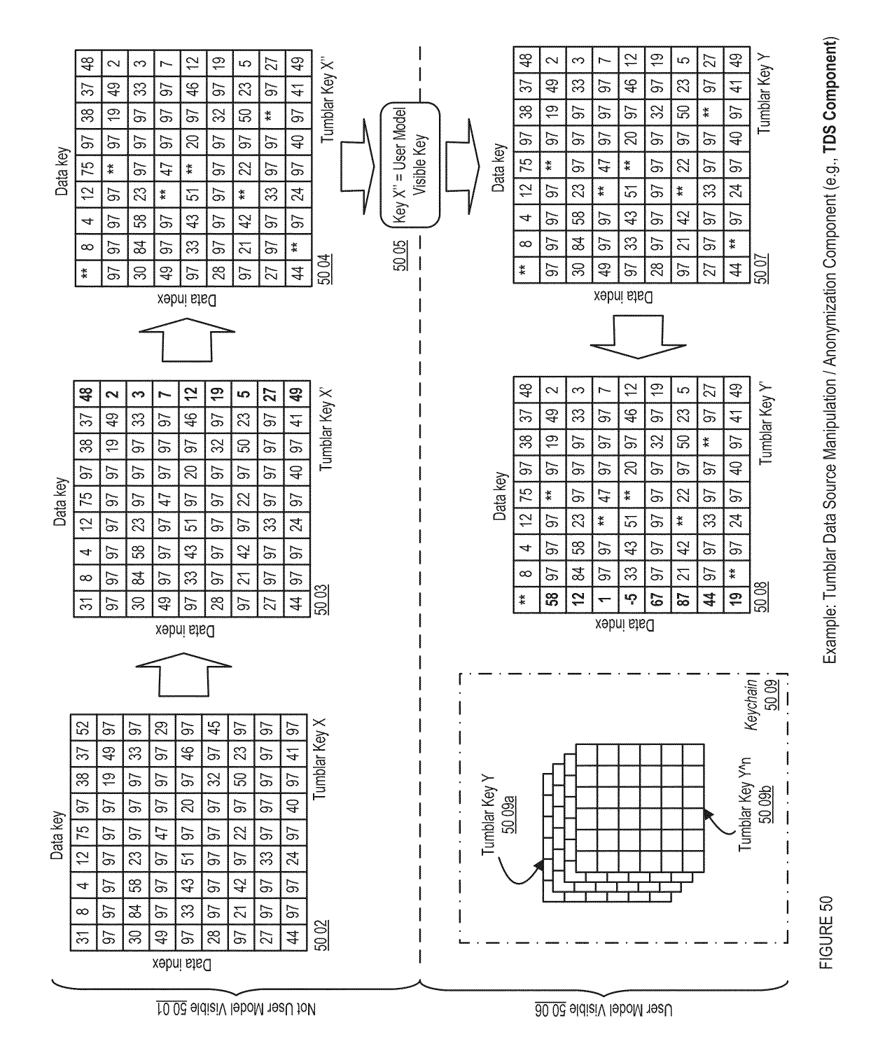

FIG. 50 is an example block diagram illustrating a tumbler data source manipulation and anonymization component, e.g., a TDS Component. In one embodiment, a user model may call a tumbler as part of a logic command block processing (e.g., in order to perform a hash table lookup, to provide third-party data, to import anonymized transaction data, and/or the like). In one embodiment, portions of the data manipulation may not be visible, e.g., 5001, to the user model in order to maintain privacy for the record owners, to preserve business secrets, and/or the like. In one embodiment, the data source to be anonymized is loaded into a key/value table, e.g., 5002. The entire matrix may be considered as a tumblar key. In other embodiments, a single cell within the matrix may be a tumblar key. In still other embodiments, the matrix may take the form of a n×n matrix of arbitrary size (e.g., a 4×4×4×4 matrix, and/or the like) In one embodiment, the keys or values may be pointers to underlying data records. In another embodiment, the keys or values may themselves be the data for manipulation. Commands may be read from the tumblar file (which may, in some embodiments, have a format substantially similar to an input language command file, e.g., 4301). The commands may change some values in the matrix to other values, such as may be done to anonymize user payment card information, e.g., 5003. In other embodiments, data may be removed from the matrix and replaced with other data values, e.g., 5004. When indicated by the tumblar file, when a set number such as 5 anonymization operations have been performed, or when the tumblar key has reached a certain value, the tumblar key may be considered visible to the user model, e.g., 5005. In so doing, the current keychain may be visible to the user model, e.g., 5007. Additional operations may then be performed on the key, extending the keychain, e.g., 5008. A keychain is a representation of current and past values of a key/value store. In one embodiment, the keychain 5009 may be returned. The keychain may contain an n×n sized matrix (i.e., a single 2D matrix, a 3D collection of 2D matrix, a 4D matrix, and/or the like), e.g., 5009a, 5009b.

In one embodiment, a tumblar file may be substantially in the form of XML as follows:

```
<xml>
<run>
<init>
processor=process
tumblar_name=None
tumblar_path=c:\1m\Ecryptmatics\ecryptmatics\test\tumblars\flare
tumblarkey=flare
    <input>
      keyname=“flares”
      file=“<ecryptmatics install>/test/data/flare.data1”
      format=“deliminated”
      deliminator=“ ”
      meta_data={‘evolution’: (4, 0, ‘Evolution’),
‘prev_activity’: (5, 0, ‘Previous 24 hour flare activity code’),
‘area’: (8, 0, ‘Area’), ‘are_largest_spot’: (9, 0, ‘Area of the
largest spot’), ‘histocially_complex’: (6, 0, ‘Historically-
complex’), ‘complex’: (7, 0, “Did region become historically
complex on this pass across the sun's disk”), ‘class_cd’: (0, 0,
‘Code for class (modified Zurich class)’), ‘activity’: (3, 0,
‘Activity’), ‘spot_dict_cd’: (2, 0, ‘Code for spot
distribution’), ‘largets_spot_cd’: (1, 0, ‘Code for largest spot
size’), ‘_header’: False}
    </input>
    <output>
    keyname=“myout”
    file=“stdout”
    format=“deliminated”
    meta_data={‘evolution’: (3, 0, ‘String’), ‘area’: (1, 0,
‘String’), ‘complex’: (2, 0, ‘String’), ‘activity’: (0, 0,
‘String’)}
    deliminator= “csv”
    </output>
</init>
<vault>
    <door>
        <lock>
      outkey=“myout”
      outkeyname=“activity”
      inkey=“flares”
      inkeyname=“activity”
      function=“tumble”
      type=“String”
      tumblar-masks=“*”
      fnc-tumblar-key-table=“flare.activity”
      tumblar-default=“None”
        </lock>
        <lock>
      outkey=“myout”
      outkeyname=“area”
      inkey=“flares”
      inkeyname=“area”
      function=“tumble”
      type=“String”
      tumblar-masks=“*”
      fnc-tumblar-key-table=“flare.area”
      tumblar-default=“None”
        </lock>
        <lock>
      outkey=“myout”
      outkeyname=“complex”
      inkey=“flares”
      inkeyname=“complex”
      function=“tumble”
      type=“String”
      tumblar-masks=“*”
      fnc-tumblar-key-table=“flare.complex”
      tumblar-default=“None”
        </lock>
        <lock>
      outkey=“myout”
      outkeyname=“evolution”
      inkey=“flares”
      inkeyname=“evolution”
      function=“tumble”
      type=“String”
      tumblar-masks=“*”
      fnc-tumblar-key-table=“flare.evolution”
      tumblar-default=“None”
        </lock>
    </door>
</vault>
</run>
</xml>
```

FIG. 51 is an example logic flow showing a tumblar data source anonymization component, e.g., a TDS component, in one embodiment of a ICST. In one embodiment, a user unaccessible data source request and a user generated model containing tumblar data source manipulations may be received, e.g., 5101. In one embodiment, a tumblar key may be extracted, e.g., 5102. A tumblar definition corresponding to the tumblar key may be retrieved from a tumblar database, e.g., 5103. A tumblar definition may contain manipulations (e.g., functions, methods, and/or the like) that may be performed on a given source file before the data is made available for use in a user model. In one embodiment, an input/starting key name may be determined (e.g., by inspecting an init block or by inspecting the input key values in the first lock of the first door of the first vault in the first run block in the tumblar file), e.g., 5105. An unprocessed internal tumblar data operation may be extracted including an input and an output key, e.g., 5106. An internal tumblar operation may be an operation that is performed before a user model has access to the data store, such as data manipulations that anonymize data. Manipulation operations may include bit shifting, replacing or masking certain field values in the data set, swapping data values between records (such as may be done to maintain a total of all values or the average of all values while not revealing to the user model the underlying data). In one embodiment, the current map located at the input key may be duplicated and stored, e.g., 5107. The operation may then be performed on the data copy, e.g., 5108. In so doing, a chain (e.g., a key chain) of values may be created for a single data point. If the current output key is visible to the user model (such as if the output key is > a given value such as 31, the output has undergone a given number of operations, and/or the like), e.g., 5109, then any maps equal to or greater than the current map may be marked as visible to the user model, e.g., 5110. Manipulation operations may continue on the data and an unprocessed external tumblar data operation (e.g., an operation visible to the user model) may be extracted, e.g., 5111. The current map may be duplicated, e.g., 5112, and stored as a new map also visible to the user model, e.g., 5112. In one embodiment, the external tumblar data operation may then be applied to the copied map, e.g., 5113. If there are no more processed external tumblar data operations, e.g., 5114, the user model visible portion of the keychain may be returned, e.g., 5115.

FIG. 52 is an example data flow illustrating mesh aggregation and cluster querying, in one embodiment of a ICST. In one embodiment, a firehose server 5201 provides firehose input, e.g., 5202 to a mesh server 5203. A firehose server may be a server capable of accepting input from one or more data sources (e.g., Twitter or Facebook posts, transaction records, email data, and/or the like) at a high relative flow rate. In one embodiment, the firehose server may perform some manipulations on the received data before it is input to the mesh server 5203. An example firehose input 5202, substantially in the form of XML formatted data is:

```
<firehose_input>
  <input type=”email” id=”1”>
    <dictionary_entry>
        {id: “1h65323765gtyuf#uy76355”,
          type: email,
          category: {cat1: “food”, cat2: “dinner”},
          from_addr: “john.doe@gmail.com”,
          to_addr: “jane.doe@gmail.com”,
          subject: “Korean BBQ this weekend?”,
          dictionary_keywords: “Korean, dinner, nyc”,
          content_hash: “7m865323476feeaniiji”}
    </dictionary_entry>
    <datetime>Jan 20, 2020 15:23:43 UTC</datetime>
    <from_addr>john.doe@gmail.com</from_addr>
    <to_addr>jane.doe@gmail.com</to_addr>
    <subject>Korean BBQ this weekend?</subject>
    <content>
Received: by 10.36.81.3 with SMTP1 id e3cs239nzb; Tue, 5 Mar 2020
15:11:47 -0800 (PST)
Return-Path:
Received: from mail.emailprovider.com (mail.emailprovider.com
[111.111.11.111]) by mx.gmail.com with SMTP id
h19si826631rnb.2005.03.29.15.11.46; Tue, 5 Mar 2020 15:11:47 -
0800 (PST)
Message-ID: <20050329231145.62086.mail@mail.emailprovider.com>
Received: from [11.11.111.111] by mail.emailprovider.com via
HTTP; Tue, 5 Mar 2020 15:11:45 PST
Date: Tue, 5 Mar 2020 15:11:45 -0800 (PST)
From: John Doe <john.doe@gmail.com>
Subject: Korean BBQ this weekend?
To: Jane Doe <jane.doe@gmail.com>
Hi Jane,
Would you like to meet up in New York city this weekend for
Korean BBQ? I know this great place down on Spring Street.
John
    </content>
  </input>
  <input type=”tweet” id=”2”>
    ...
  </input>
  <input type=”purchase_transaction” id=”3”>
    ...
  </input>
  <input type=”web_search” id=”4”>
    ...
  </input>
  <input id=”n”>
    ...
  </input>
</firehost_input>
```

In one embodiment, the mesh structure may then be updated, e.g., 5204. Further detail regarding updating the mesh structure can be found throughout this specification, drawing and claims, and particularly with reference to FIGS. 15-19. In one embodiment, a clustering node 5205 may send a cluster categories request 5206 to the mesh server. A cluster categories request may contain a category or deduced concept that is to be added to the mesh. In one embodiment, the category may have no pre-existing associations in the mesh (e.g., the category to be added may be an orphan category). An example cluster categories request 5206, substantially in the form of an HTTP(S) POST message including XML is:

```
POST /cluster_categories.php HTTP/1.1
Host: www.meshserver.com
Content-Type: Application/XML
Content-Length: 667
<?XML version = “1.0” encoding = “UTF-8”?>
<cluster_categories_request>
  <cluster operation=”add”>
    <concept value=”iphone” />
    <concept_related_concept value=”apple” />
    <concept_keyword value=”64GB” />
    <concept_keyword value=”Steve Jobs” />
  </cluster>
  <cluster>
    ...
  </cluster>
</cluster_categories_request>
```

In an alternative embodiment, an example cluster categories request 5206, substantially in the form of an HTTP(S) POST message including XML is:

```
POST /cluster_categories.php HTTP/1.1
Host: www.meshserver.com
Content-Type: Application/XML
Content-Length: 667
<?XML version = “1.0” encoding = “UTF-8”?>
<cluster_categories_request>
  <cluster operation=”add”>
    <concept value=”portable music player” />
    <manufacturer>Apple Computer</manufacturer>
    <model>iPod Touch 32GB</model>
    <size>32GB</size>
  </cluster>
  <cluster>
    ...
  </cluster>
</cluster_categories_request>
```

In one embodiment, the cluster categories request above may be modified by the ICST as a result of aggregated data. For example, a request to create a cluster for an iPod of a given size may be supplemented with alternative models/sizes. In so doing, the mesh may expand a recommendation, graph entity, and/or the like to emcompass concepts that are connected with the primary concept. In one embodiment, this modified cluster may take the form a the form of XML substantially similar to:

```
<cluster>
  <concept value=”portable music player” />
  <manufacturer>Apple Computer</manufacturer>
  <model>
    <1>iPod Touch 32GB</1>
    <2>iPod Touch 64GB</2>
    <3>iPod Touch 128GB</3>
    <4>iPhone 32GB</4>
    <5>iPhone 64GB</5>
    <6>iPhone 128GB</6>
  </model>
  <size>32GB OR 64GB OR 128GB</size>
</cluster>
```

In one embodiment, the mesh structure may be updated in response to the cluster categories request, e.g., 5204. In one embodiment, a user 5207 may use his/her mobile device to indicate that they wish to purchase an item based on cluster concepts, e.g., a user bid/buy input 5208. For example, a user may query “I want the TV that AV Geeks thinks is best and I'll pay $1,500 for it”. In one embodiment, the query may be substantially in the form of a language input such as the above, which may be parsed using natural language processing packages such as FreeLing, LingPipe, OpenNLP, and/or the like. In other embodiments, the user may be presented with a structured query interface on their mobile device that allows a restricted set of options and values from which to build a bid/buy input 5208. For example, a user may be given a list of categories (such as may be built by querying a categories database as described with respect to FIG. 49) from which to choose when making a bid/buy input. In one embodiment, a clustering server 5209 may receive the user bid/buy input 5208 and generate a consumer cluster based bid request, e.g., 5210 and provide same to a clustering node 5205. An example consumer cluster based bid request 5210, substantially in the form of an HTTP(S) POST message including XML is:

```
POST /consumer_bid_request.php HTTP/1.1
Host: www.meshserver.com
Content-Type: Application/XML
Content-Length: 667
<?XML version = “1.0” encoding = “UTF-8”?>
<consumer_cluster_based_bid_request>
  <datetime>Jan 21, 2020 5:34:09 UTC</datetime>
  <user_id>43246</user_id>
  <request>
    <type>bid</type>
    <item>
      <item_query>LCD Television</item_query>
      <type_desired value=”best” />
      <cluster_source value=”AV Geeks.com” />
      <cluster_min_expertise_level value=”top2prct” />
      <max_price value=”1500.00” currency=”USD” />
      <expire_request value=”30days” />
      <payment type=”credit”>
        <card_type>VISA</card_type>
        <card_num>98765436598766732</card_num>
        <card_exp>0525</card_exp>
      </payment>
      <shipping_address>
        <addr1>100 Main St.</addr1>
        <city>Anytown</city>
        <state>CA</state>
        <zip>90145</zip>
      </shipping_address>
    </item>
  </request>
</consumer_cluster_based_bid_request>
```

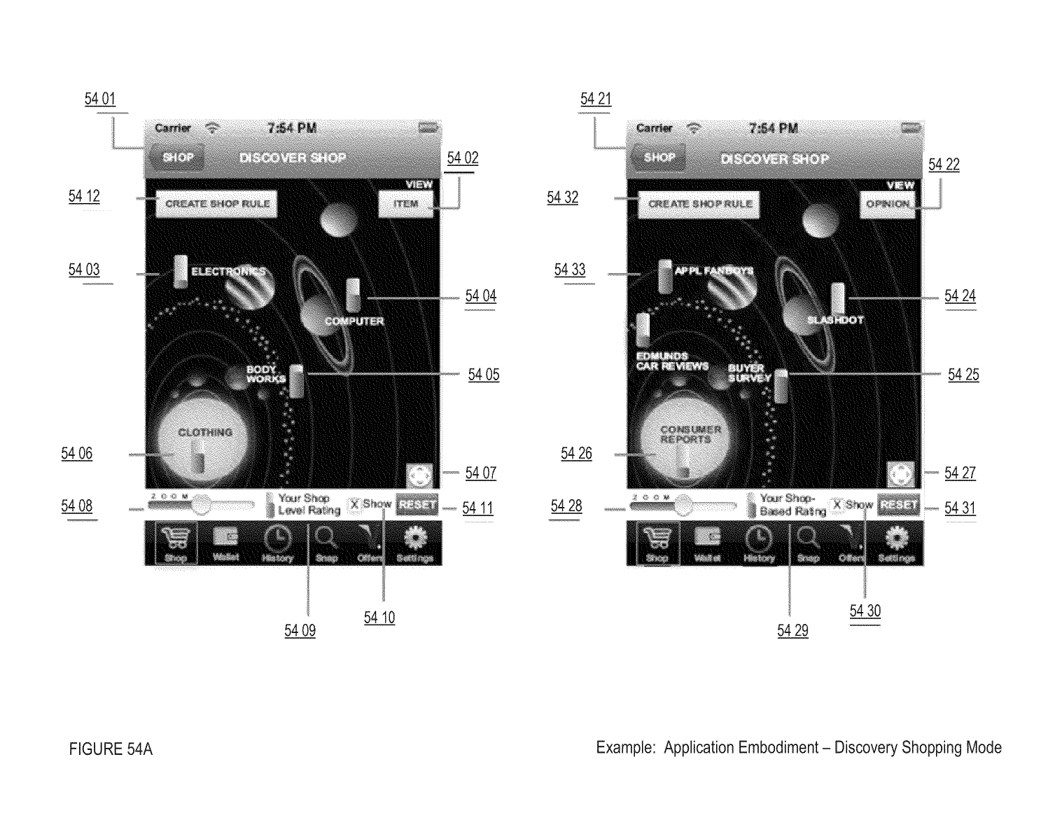

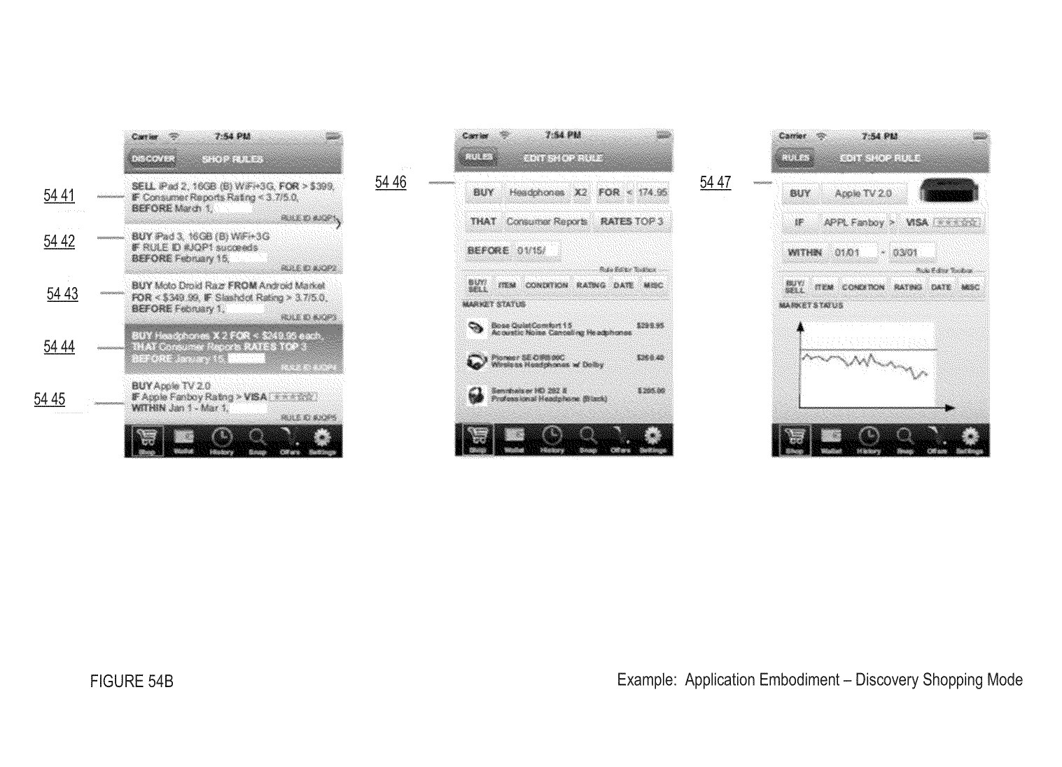

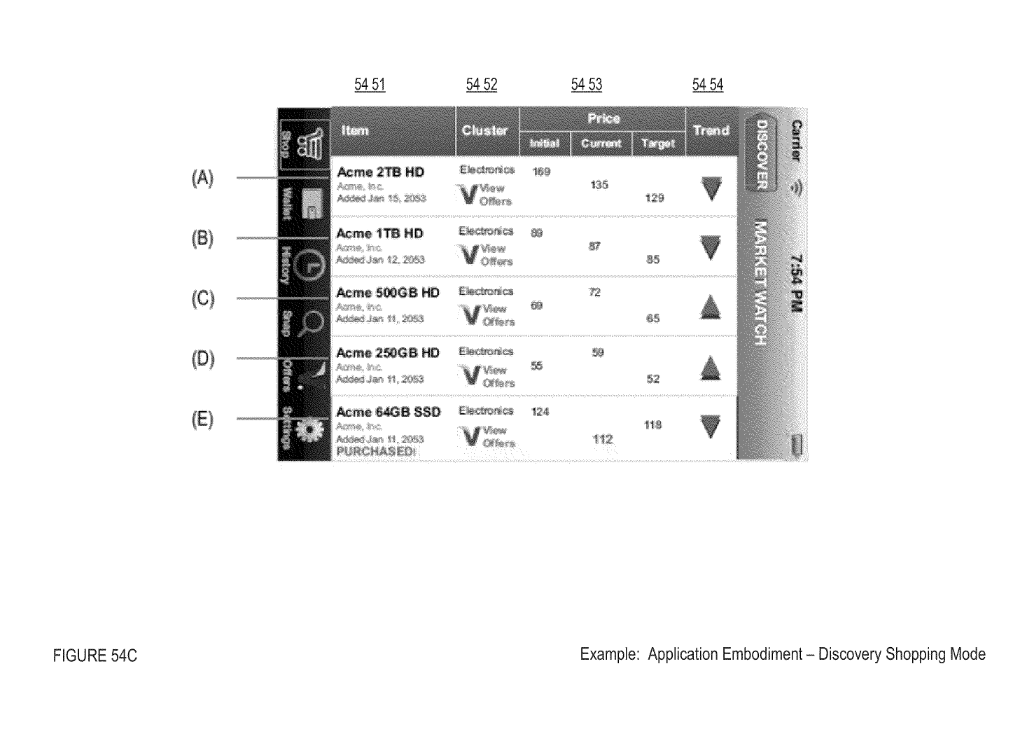

In an alternative embodiment, the consumer cluster based bid request may be generated using the user interface described herein and with respect to FIG. 54A-B. In one embodiment, the consumer cluster based bid request 5210, generated using the interface may be substantially in the form of an HTTP(S) POST message including XML:

```
POST /consumer_bid_request.php HTTP/1.1
Host: www.meshserver.com
Content-Type: Application/XML
Content-Length: 667
<?XML version = “1.0” encoding = “UTF-8”?>
<consumer_cluster_based_bid_request>
  <datetime>Jan 21, 2020 5:34:09 UTC</datetime>
  <user_id>43246</user_id>
  <request>
    <type>bid</type>
    <item>
      <item_query>headphones</item_query>
      <quantity value=”2” />
      <requirement value=”rated_top_3” />
      <cluster_source value=”consumerreports.com” />
      <max_price value=”249.95” currency=”USD” />
      <expire_request value=”January 15, 2020” />
      <payment type=”credit”>
        <card_type>VISA</card_type>
        <card_num>98765436598766732</card_num>
        <card_exp>0525</card_exp>
      </payment>
      <shipping_address>
        <addr1>100 Main St.</addr1>
        <city>Anytown</city>
        <state>CA</state>
        <zip>90145</zip>
      </shipping_address>
    </item>
  </request>
</consumer_cluster_based_bid_request>
```

In one embodiment, in response to the consumer cluster based bid request 5210, the clustering node 5205 may generate a cluster request 5211. A cluster request may be a request to search the mesh in order to find results (e.g., items matching a cluster's buying habits, merchants offering an item, alternative items for purchase, friends that have already purchased items, items the user already owns—based on, for example, past purchase transactions—that may satisfy the request, and/or the like). An example query suitable for querying a distributed linking node mesh is:

```
START user=node(5,4,1,2,3)
MATCH entity-[:affinity]->”consumer_reports”
WHERE entity.recommended >= ‘3’,
    entity.recommendation.item.type ~= “headphones”
RETURN entity.recommendation.item.name,
    entity.recommendation.item.model,
    entity.recommendation.item.averageprice
```

In one embodiment, the mesh server may provide a cluster request response 5212. An example cluster request response 5212 substantially in the form of an HTTP(S) POST message including XML is:

```
POST /cluster_request_response.php HTTP/1.1
Host: www.clusteringnode.com
Content-Type: Application/XML
Content-Length: 667
<?XML version = “1.0” encoding = “UTF-8”?>
<cluster_request_response>
  <requested_item>
    <item_query>LCD Television</item_query>
    <type_desired value=”best” />
    <cluster_source value=”AV Geeks.com” />
    <cluster_min_expertise_level value=”top2prct” />
    <max_price value=”1500.00” currency=”USD” />
  </requested_item>
  <cluster_results>
    <num_users_meeting_cluster value=”2541” />
    <average_user_feedback_ranking value=”94%” />
    <cluster_user_purchases>
      <item rank=”1”>
        <desc>Sony Bravada 50″ LCD 645</desc>
        <model>KDL50EX645</model>
      </item>
      <item rank=”2”>
        <desc>Sony Bravada 50″ LCD 655</desc>
        <model>KDL50EX655</model>
      </item>
      <item>
        ...
      </item>
    </cluster_user_purchases>
  </cluster_results>
</cluster_request_response>
```

In an alternative embodiment, an example cluster request response 5212 substantially in the form of an HTTP(S) POST message including XML is:

```
POST /cluster_request_response.php HTTP/1.1
Host: www.clusteringnode.com
Content-Type: Application/XML
Content-Length: 667
<?XML version = “1.0” encoding = “UTF-8”?>
<cluster_request_response>
  <requested_item>
      <item_query>headphones</item_query>
      <quantity value=”2” />
      <requirement value=”rated_top_3” />
      <cluster_source value=”consumerreports.com” />
      <max_price value=”249.95” currency=”USD” />
      <expire_request value=”January 15, 2020” />
  </requested_item>
  <cluster_results>
    <cluster_consumer_reports_ranking>
      <item consumer_reports_rank=”1”>
        <desc>Panasonic Technics Pro DJ</desc>
        <model>RP-DH1250</model>
        <avg_price>$235.55</avg_price>
      </item>
      <item consumer_reports_rank=”2”>
        <desc>Coby In Ear Headphones</desc>
        <model>CVEM76PNK</model>
        <avg_price>$245.55</avg_price>
      </item>
      <item consumer_reports_rank=”3”>
        <desc>Shure E2c-n Sound Isolating Earphones</desc>
        <model>SHE2CN</model>
        <avg_price>$249.95</avg_price>
      </item>
    </cluster_consumer_reports_ranking>
  </cluster_results>
</cluster_request_response>
```

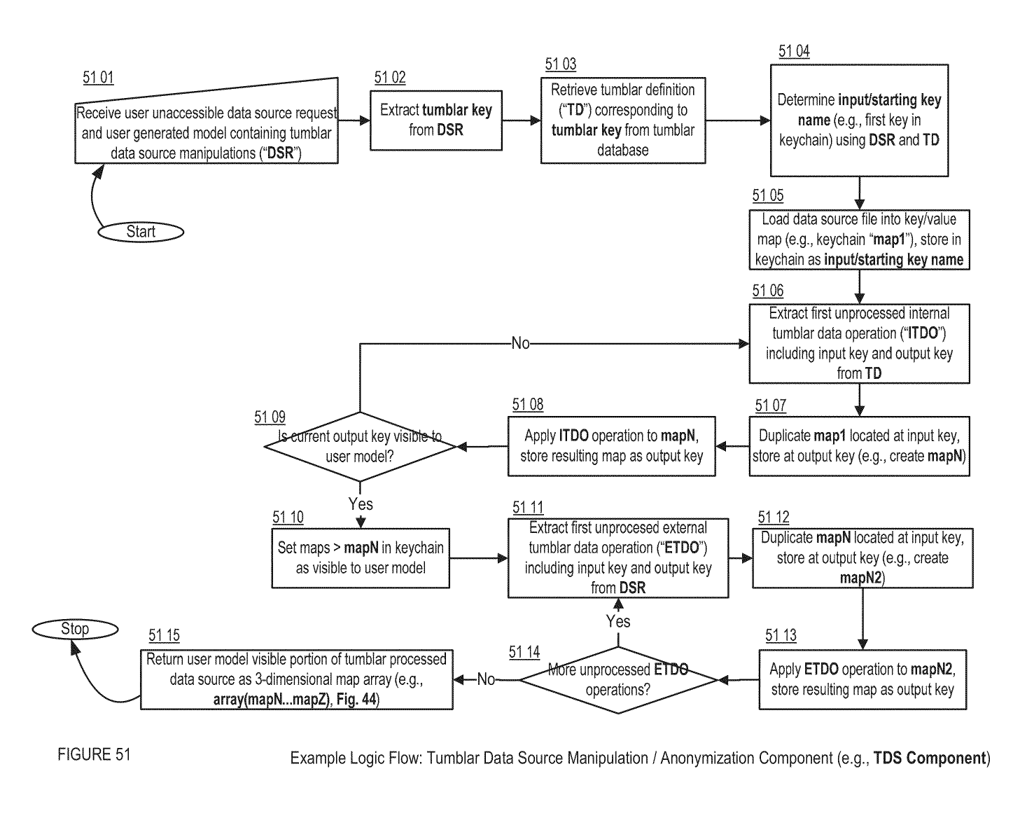

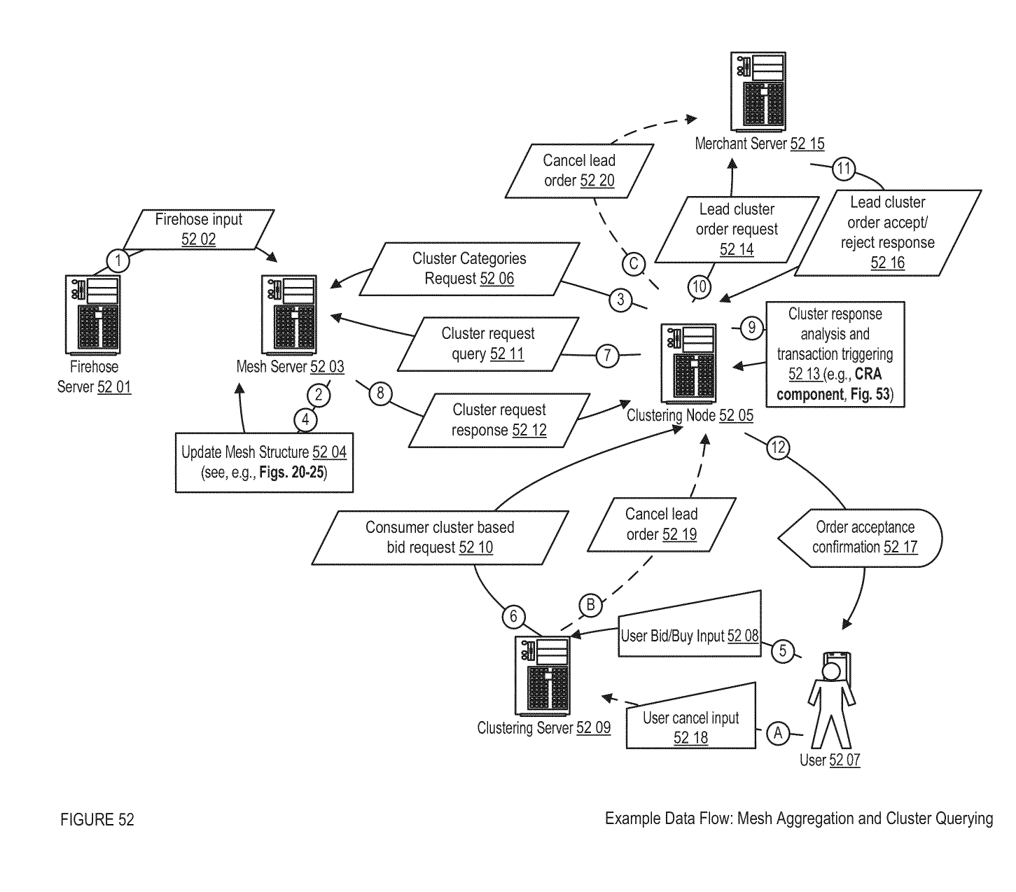

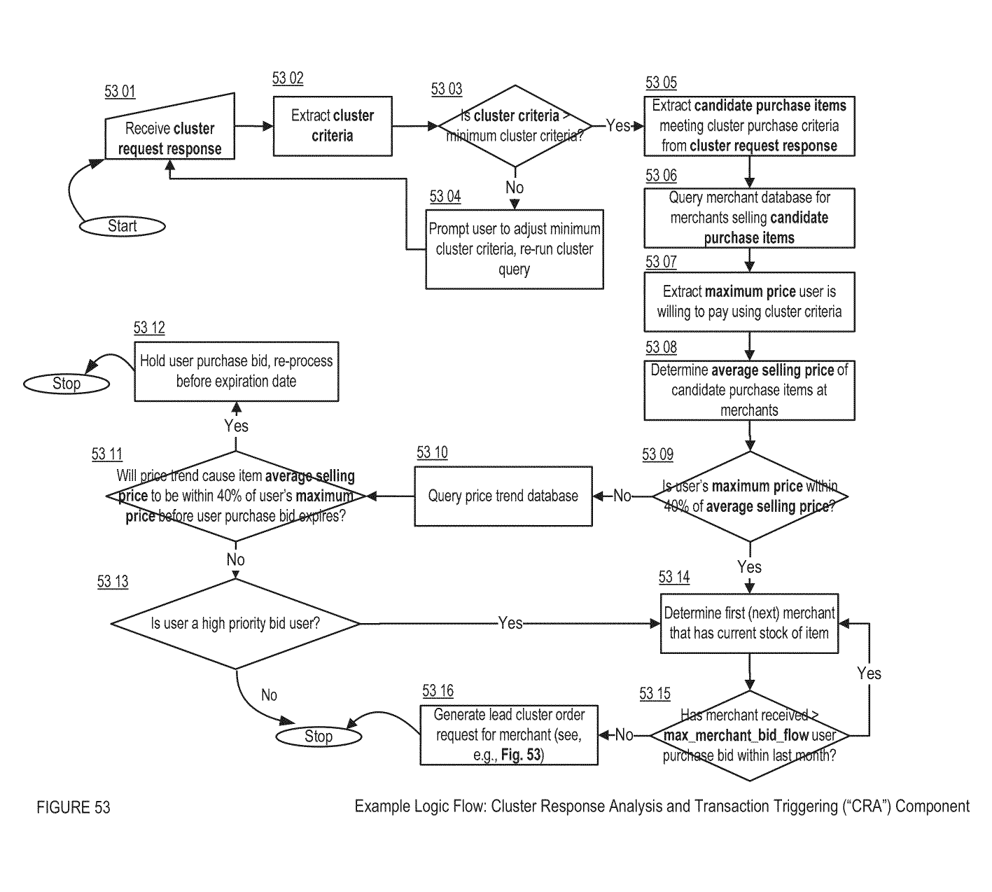

In one embodiment, the clustering node 5205 may then process the cluster response and create transaction triggers. Further details regarding cluster request response 5212 processing may be found throughout the specification, drawings and claims and particularly with reference to FIG. 53, e.g., a CRA Component.

In one embodiment, a lead cluster order request may be generated for merchants that were identified as a result of the cluster response analysis, e.g., 5213. In other embodiments, a default list of merchants may be used. A lead cluster order request may contain information relating to the identified purchase that the user 5207 wishes to engage in. In the example above, for example, the analysis may have determined that based on the aggregated AV Geeks user expert preference information, the user should purchase Sony television model KDL50EX645 or KDL50EX655. The analysis may also have determined that a given merchant sells those models of television (such as by using aggregated sales transaction data as described herein). A request may then be sent to the merchant indicating a purchase item, a user lead that may execute the purchase and a price the user is willing to pay. In one embodiment, the user identity is not provided or is anonymized such that the merchant does not have information sufficient to determine the actual identity of the user but may determine if they wish to execute the sale to the user. An example lead cluster order request 5214, substantially in the form of an HTTP(S) POST message containing XML data:

```
POST /lead_cluster_order_request.php HTTP/1.1
Host: www.merchantserver.com
Content-Type: Application/XML
Content-Length: 667
<?XML version = ″1.0″ encoding = ″UTF-8″?>
<lead_cluster_order_request>
  <lead validFor=”30_days”>
    <type>television</type>
    <items join=”OR”>
      <item model=”KDL50EX645” />
      <item model=”KDL50EX655” />
    </items>
    <user_information>
      <name>John Doe</name>
      <email>john.doe@gmail.com</email>
      <phone>865-765-3465</phone>
    </user_information>
    <payment type=”credit”>
      <card_type>VISA</card_type>
      <card_num>98765436598766732</card_num>
      <card_exp>0525</card_exp>
    </payment>
    <shipping_address>
      <addr1>100 Main St.</addr1>
      <city>Anytown</city>
      <state>CA</state>
      <zip>90145</zip>
      </shipping_address>
  </lead>
  <lead>
    ...
  </lead>
</lead_cluster_order_request>
```

In one embodiment, a merchant may accept the order and generate a lead cluster order accept/reject response. In other embodiments, the merchant may indicate that they wish to hold the lead opportunity open and may accept at a later time if no other merchant has filled the lead cluster order request. In still other embodiments, the merchant response may contain a counteroffer for the user (e.g., $1600), which the user may then accept or decline. In one embodiment, the user receives an order acceptance confirmation 5217 indicating that their order has been fulfilled.

In one embodiment, a user may cancel a cluster based bid request prior to the merchant fulfilling the order. For example, a user may transmit a user cancel input 5218 to clustering server 5209. The clustering server may forward the cancel message to the clustering node 5205, e.g., 5219, which may in turn forward the cancel message to the merchant(s) server 5215, e.g., 5220.

FIG. 53 is an example logic flow illustrating cluster response analysis and transaction triggering, e.g., a CRA component, in one embodiment of a ICST. In one embodiment, a cluster request response is received, e.g., 5301. Cluster criteria (i.e., user requesting cluster, the criteria for the cluster, payment/shipping information for the user purchase bid, and/or the like) may be extracted from the cluster request response, e.g., 5302. In one embodiment, the cluster criteria is examined to determined if it meets the minimum cluster criteria, e.g., 5303. Examples of minimum cluster criteria include minimum feedback ranking of users in cluster, minimum years of expertise of users in cluster, median value of items returned, and/or the like. If the cluster criteria is not greater than the minimum cluster criteria, the user may be prompted to adjust the minimum criteria and a search may be re-run, e.g., 5304. In other embodiments, the criteria may be adjusted automatically by the ICST or a third-party database may be queried to determine new minimum criteria (e.g., a user expertise ranking service, a user review site, and/or the like).

In one embodiment, candidate purchase items may be extracted from the cluster request response, e.g., 5305. A merchant database may be queried to determine merchants selling the candidate purchase items. An example merchant database query, substantially in the form of PHP/SQL commands is provided below:

<?PHP
header(‘Content-Type: text/plain’);
mysql_connect(“localhost”,$DBserver,$password);
mysql_select_db(“merchants.sql”);
$query = “SELECT merchant_id, merchant_name, price,
quantity_on_hand FROM merchants WHERE merchant_item_id LIKE
‘%’ $cluster_returned_model_num”;
$result = mysql_query($query); // perform the search query
mysql_close(“merchants.sql”); // close database access
?>

In one embodiment, a maximum price the user is willing to pay is determined, e.g., 5307. An average selling price of the candidate purchase items may be determine (such as by querying a merchant table containing price history, querying a price history table, performing a live crawl of a merchant's web site, and/or the like). If the user's maximum price is not within a given range of the average merchant item price, e.g., 5309, a price trend database may be queried, e.g., 5310. A price trend database may contain historical information relating to the price of an item over time. If the price trend (i.e., the linear extrapolation of the historical prices, and/or the like) shows that the average price of the item will be within 40% of the user's maximum price before the user purchase bid expires, e.g., 5311, the user purchase bid request may be held, e.g., 5312, so that the cluster response analysis may be re-run again before the bid expires. In another embodiment, even if the user's price will not be within a range of the average price of an item at the queried merchants, the user procedure may continue if the user has been marked as a high priority bid user (e.g., a frequent bidder, a new bidder, and/or the like), e.g., 5313. In one embodiment, the first merchant that has stock of the item may be selected, e.g., 5314. If the merchant has received greater than a set amount of bids in a time period, e.g., 5315, another merchant may be selected. In so doing, one merchant may not be overwhelmed with bids. In one embodiment, a lead cluster order request is created and transmitted to the merchant, e.g., 5316.

FIGS. 54A-C show user interface diagrams illustrating example aspects of a discovery shopping mode of a virtual wallet application in some embodiments of the ICST. In some embodiments, the virtual wallet application may provide a ‘discovery shopping’ mode for the user. For example, the virtual wallet application may obtain information on aggregate purchasing behavior of a sample of a population relevant to the user, and may provide statistical/aggregate information on the purchasing behavior for the user as a guide to facilitate the user's shopping. For example, with reference to FIG. 54A, the discovery shopping mode 5401 may provide a view of aggregate consumer behavior, divided based on product category (see 5402). Thus, the virtual wallet application may provide visualization of the magnitude of consumer expenditure in particular market segment, and generate visual depictions representative of those magnitudes of consumer expenditure (see 5403-5406). In some embodiments, the virtual wallet application may also provide an indicator (see 5409) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 5410). In some embodiments, the virtual wallet application may allow the user to zoom in to and out of the visualization, so that the user may obtain a view with the appropriate amount of granularity as per the user's desire (see 5407-5408). At any time, the user may be able to reset the visualization to a default perspective (see 5411).

Similarly, the discovery shopping mode 5421 may provide a view of aggregate consumer response to opinions of experts, divided based on opinions of experts aggregated form across the web (see 5402). Thus, the virtual wallet application may provide visualizations of how well consumers tend to agree with various expert opinion on various product categories, and whose opinions matter to consumers in the aggregate (see 5423-5426). In some embodiments, the virtual wallet application may also provide an indicator (see 5429) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 5430). In some embodiments, the virtual wallet application may allow the user to zoom in to and out of the visualization, so that the user may obtain a view with the appropriate amount of granularity as per the user's desire (see 5427-5428). At any time, the user may be able to reset the visualization to a default perspective (see 5431).

With reference to FIG. 54B, in some implementations, the virtual wallet application may allow users to create targeted shopping rules for purchasing (see FIG. 54A, 5412, 5422). For example, the user may utilize the consumer aggregate behavior and the expert opinion data to craft rules on when to initiate purchases automatically. As an example, rule 5441 specifies that the virtual wallet should sell the users iPad2 if its consumer reports rating falls below 3.75/50.0, before March 1, provided a sale price of $399 can be obtained. As another example, rule 5442 specifies that the virtual wallet should buy an iPad3 if rule 5441 succeeds before February 15. As another example, rule 5443 specifies that the wallet should buy a Moto Droid Razr from the Android Market for less than $349.99 if its Slashdot rating is greater than 3.75 before February 1. Similarly, numerous rules with a wide variety of variations and dependencies may be generated for targeted shopping in the discovery mode. In some implementations, the virtual wallet user may allow the user to modify a rule. For example, the wallet may provide the user with an interface similar to 5446 or 5447. The user may utilize tools available in the rule editor toolbox to design the rule according to the user's desires. In some implementations, the wallet may also provide a market status for the items that are subject to the targeted shopping rules.

With reference to FIG. 54C, in some implementations, the virtual wallet application may provide a market watch feature, wherein the trends associated with items subject to targeted shopping rules may be tracked and visually represented for the user. For example, the visualization may take, in some implementations, the form of a ticker table, wherein against each item 5451(A)-(E) are listed a product category or cluster of expert opinions to which the product is related 5452, pricing indicators, including, but not limited to: price at the time of rule creation 5452, price at the time of viewing the market watch screen 5453, and a target price for the items (A)-(E). Based on the prices, the market watch screen may provide a trending symbol (e.g., up, down, no change, etc.) for each item that is subject to a targeted shopping rule. Where an item satisfied the targeted rule (see item (E)), the virtual wallet may automatically initiate a purchase transaction for that item once the target price is satisfied.

### Example ICST Terminal: Intellient Shopping Cart

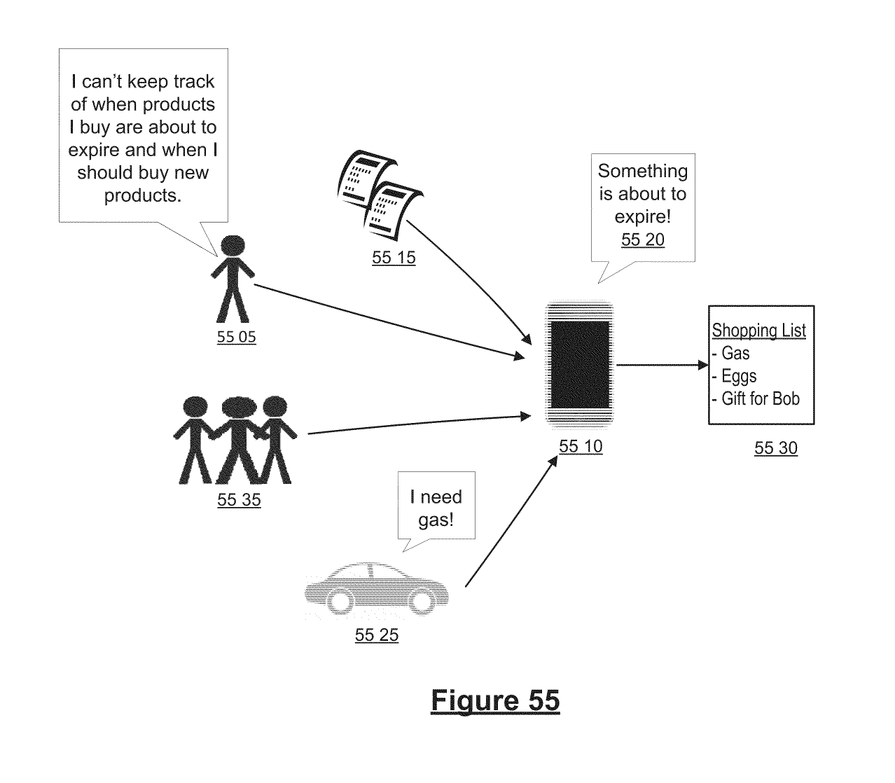

FIG. 55 shows a block diagram illustrating example embodiments of the ICST. In some implementations, a user 5505 may want something that will keep track of expiring products, suggest products to buy the next time the user visits the grocery store, and/or the like. In some implementations, ICST may work with the user's electronic wallet 5510 in order to generate a predictive shopping list 5530 with items that are determined to be expiring 5520, items frequently purchased based on receipt and/or other purchase data 5515, based on smart devices 5525 that can indicate a need to purchase more supplies for the device, via feedback 5535 from people in the user's social network (or from the user directly), and/or the like.

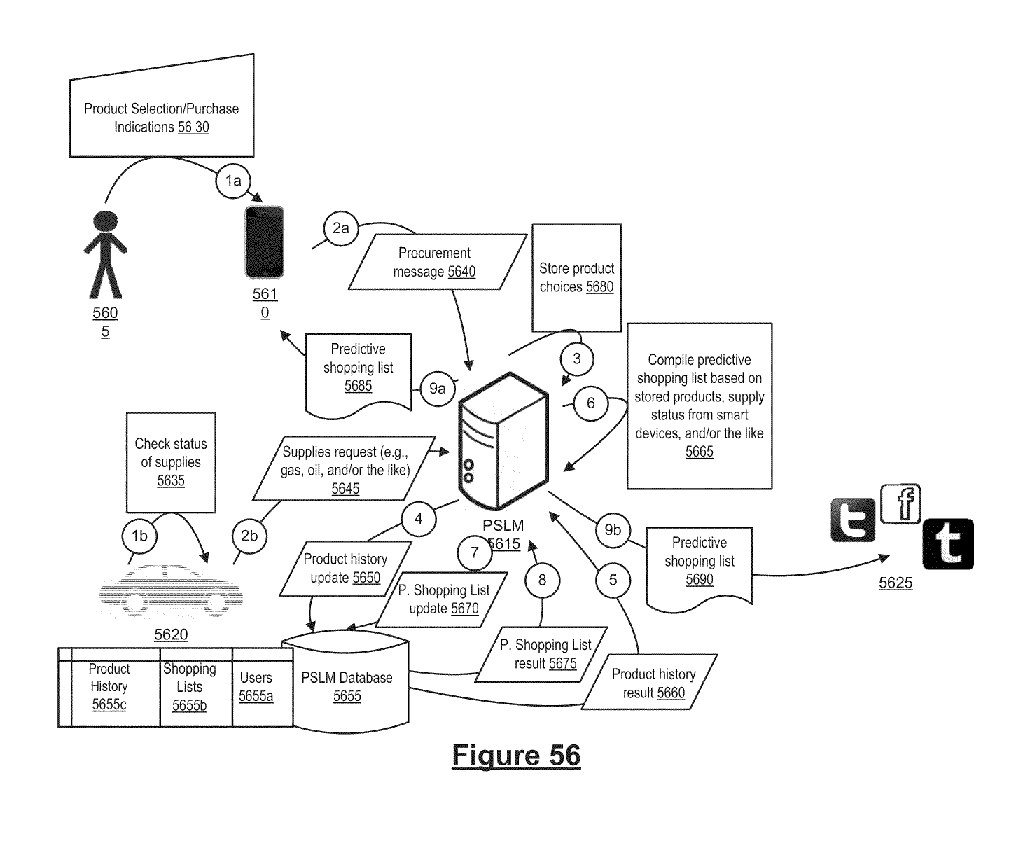

FIG. 56 shows a data flow diagram illustrating collecting information for predictive shopping lists in some embodiments of the ICST. In some implementations, a user 5605 may provide to an electronic device 5610 item purchase selections 5630. In some implementations, the electronic device may be a mobile device such as a mobile phone, laptop, and/or the like, and may connect to an electronic wallet. In some implementations, the item purchase history may include transaction data (e.g. receipts, scanning products for purchase, information for a pending transaction, and/or the like) and/or the like. In some implementations, the electronic device may send a procurement message 5640 to ICST, which may be an XML-encoded message that takes a form similar to the following:

```
POST /procurement_message.php HTTP/1.1
Host: www.ICSTproccess.com
Content-Type: Application/XML
Content-Length: 788
<?XML version = “1.0” encoding = “UTF-8”?>
<procurement_message>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <procurement_params>
        <purchase>
            <product>
                <id>098765432</id>
                <name>Sunshine &#174; Cheez-It &#174; Baked
Snack Crackers</name>
                <weight>170</weight>
                <product_code>2410070582</product_code>
                <lot_ID>9274E8AC</lot_ID>
                <merchant_ID>1155448899</merchant_ID>
                <price>3.99</price>
                <aisle>5</aisle>
                <shelf>2</shelf>
                <expiration_date>2017-02-01
12:30:00</expiration_date>
                ...
            </product>
        </purchase>
        <scan>
            <product>
                    <ID>289786479</ID>
                    <name>Twinings &#174; Chai Ultra Spice
Tea</name>
                    <weight>40</weight>
                    <product_code>7017726772</product_code>
                    <lot_ID>908D0F989A</lot_ID>
                    <merchant_ID>9483738921</merchant_ID>
                    <price>4.99</price>
                    <aisle>7</aisle>
                    <shelf>3</shelf>
                    <expiration_date></expiration_date>
                    <GPS>40.7589905, −73.9790277</GPS>
                    <scan>
                      <qr_object_params>
                      <qr_image>
                      <name> exp_QR </name>
                      <format> JPEG </format>
                      <compression> JPEG compression
</compression>
                      <size> 123456 bytes </size>
                      <x-Resolution> 72.0 </x-Resolution>
                      <y-Resolution> 72.0 </y-Resolution>
                      <date_time> 2014:8:11 16:45:32
</date_time>
                      ...
                      <content> ÿØÿà JFIF H H
                      ÿâ\acute{ }ICC_PROFILE [symbol]
appl mntrRGB XYZ Ü $ acspAPPL öÖÓ-appl
desc P bdscm \acute{ } \check{S}cprt ——————————@ $wtpt
—————————————d rXYZ ————————x gXYZ
————————————— [symbol]  bXYZ ———————— rTRC
—————————————\acute{ } aarg À vcgt ...
                      </content>
                      ...
                      </qr_image>
                      <QR_content>”Expiration Date,
2020:8:11”</QR_content>
                      </qr_object_params>
                    </scan>
                    ...
                </product>
        </scan>
        <smart_device>
            <product>
                <id></id>
                <name>Gasoline/name>
                <weight></weight>
                <product_code></product_code>
                <lot_ID></lot_ID>
                <merchant_ID></merchant_ID>
                <price></price>
                <aisle></aisle>
                <shelf></shelf>
                <note>8 gallons</note>
                <expiration_date>2016-01-05
12:30:00</expiration_date>
                ...
            </product>
        </smart_devices>
        <expiration>
            <product>
                <id></id>
                <name>Silk &#174; Organic Original
                Soymilk</name>
                <weight>4, quart</weight>
                <product_code>7854675684356348</product_code>
                <lot_ID>982183242</lot_ID>
                <merchant_ID>9483738921</merchant_ID>
                <price>3.99</price>
                <aisle>DAIRY</aisle>
                <shelf>2</shelf>
                <note> </note>
                <expiration_date>2016-01-01
12:30:00</expiration_date>
                ...
            </product>
        </expiration>
    </procurement_params>
</procurement_message>
```

In some implementations, ICST may store the product choice information 5680, via querying 5650 a database 5655 and storing the user's product history information in the user's product history record 5655c, which is tied to the user's record in 5655a. In some implementations, ICST may query the database using PHP code similar to the following:

```
<?php
    ...
    foreach ($product_list as $product){
    $new_product = $product;
    $product_result = mysql_query(“INSERT INTO product_history
(ID, name, weight, product_code, lot_ID, merchant_ID, price, aisle,
shelf, note, user_ID, exp_date, scan, scan_GPS) VALUES
    (mysql_real_escape_string($new_product.ID),
    mysql_real_escape_string($new_product.name),
    mysql_real_escape_string($new_product.weight),
    mysql_real_escape_string($new_product.product_code),
    mysql_real_escape_string($new_product.lot_ID),
    mysql_real_escape_string($new_product.merchant_ID),
    mysql_real_escape_string($new_product.price),
    mysql_real_escape_string($new_product.aisle),
    mysql_real_escape_string($new_product.shelf),
    mysql_real_escape_string($new_product.note),
    mysql_real_escape_string($new_product.user_ID),
    mysql_real_escape_string($new_product.exp_date),
    mysql_real_escape_string($new_product.scan),
    mysql_real_escape_string($new_product.scan_GPS),)
    );
    }
>
```

In some implementations, after ICST has received a query result 5660 that indicates that the insert was successfully performed, ICST may use the user's product history to compile a predictive shopping list 5665. In some implementations ICST may also collect data from smart devices 5620 which have capabilities to both check the status of their own supplies 5635 and send messages to ICST 5645 indicating a need to refill a particular supply. In some implementations, the supplies request 5645 may be an XML-encoded message and may take a form similar to the following:

```
POST /supplies_message.php HTTP/1.1
Host: www.ICSTproccess.com
Content-Type: Application/XML
Content-Length: 788
<?XML version = “1.0” encoding = “UTF-8”?>
<supplies_message>
<timestamp>2016-01-01 12:30:00</timestamp>
    <device_params>
        <user_ID>123456789</user_ID>
        <device_ID>********</device_ID>
        <wallet_ID>A2C4E6G8I</wallet_ID>
    </device_params>
    <supplies_params>
        <product_list>
            <product>
                <id></id>
                <name>Gasoline is Low/name>
                <weight></weight>
                <product_code></product_code>
                <lot_ID></lot_ID>
                <merchant_ID></merchant_ID>
                <price></price>
                <aisle></aisle>
                <shelf></shelf>
                <note>8 gallons</note>
                <expiration_date>2016-01-05
12:30:00</expiration_date>
                ...
            </product>
            ...
        </product_list>
    </supplies_params>
</supplies_message>
```

As an example, ICST may collect information from a smart car that is capable of determining how much gasoline it has in the tank, and is capable of sending a message to ICST indicating that it is currently running low. In some implementations, other smart devices may include refrigerators, and/or the like. ICST may also add such supplies to the user's predictive shopping list as they are provided to ICST. In some implementations, ICST may store the generated predictive shopping list in the ICST database via a shopping list query 5670 to the shopping list table 5655b of the ICST database. In some implementations, the PHP-encoded shopping list query may take a form similar to the following:

```
<?php
    ...
    $user_ID = “123456789”;
    $name = “Example Predictive Shopping List”;
    foreach ($product_list as $product){
        $new_product = $new_product . “ ” . $product.ID;
    }
    $product_result = mysql_query(“INSERT INTO shopping_lists
(user_ID, name, products) VALUES (mysql_real_escape_string
($user_ID),
    mysql_real_escape_string($name),
    mysql_real_escape_string($new_product)));
>
```

Once ICST receives a predictive shopping list result 5675 for the query indicating that the insert was successfully performed, ICST may send the user a copy of their predictive shopping list 5685, which the user may keep in the user's wallet-enabled device, and which the user may also forward 5690 to social networking sites 5625 (e.g. Facebook, Twitter, and/or the like) in order to receive feedback on the shopping list from friends, family, and/or the like. In some implementations, an XML-encoded predictive shopping list 5685 may take a form similar to the following:

```
<product_list>
    <user>
        <user_ID>123456789</user_ID>
        <wallet_ID>A2C4E6G8I</wallet_ID>
    </user>
    <list_params>
        <name> Example Predictive Shopping List </name>
        <date_created>2016-01-01 12:30:00</date_created>
    </list_params>
    <replacement_products>
        <expiring>
            <product>
                <id></id>
                <name>Silk &#174; Organic Original
Soymilk</name>
                <weight>4, quart</weight>
    <product_code>7854675684356348</product_code>
                <lot_ID>982183242</lot_ID>
                <merchant_ID>9483738921</merchant_ID>
                <price>3.99</price>
                <aisle>DAIRY</aisle>
                <shelf>2</shelf>
                <note> </note>
                <expiration_date>2016-01-01
12:30:00</expiration_date>
                <confidence_level>1</confidence_level>
                <rating>4.3</rating>
                <replenish_cycle>2,
week</replenish_cycle>
                <alt_products>5874654824885,
4245654356436, 2425458454, ...</alt_products>
                ...
            </product>
        </expiring>
        <smart_device>
            <product>
                <id></id>
                <name>Gasoline is Low/name>
                <weight></weight>
                <product_code></product_code>
                <lot_ID></lot_ID>
                <merchant_ID></merchant_ID>
                <price></price>
                <aisle></aisle>
                <shelf></shelf>
                <note>8 gallons</note>
                <expiration_date>2016-01-05
12:30:00</expiration_date>
                <confidence_level>1</confidence_level>
                <rating>3.3</rating>
                <replenish_cycle>1,
week</replenish_cycle>
                <alt_products></alt_products>
                ...
            </product>
        </smart_device>
        <predicted_replace>
            <product>
                <id>098765432</id>
                <name>Sunshine &#174; Cheez-It &#174; Baked
Snack Crackers</name>
                <weight>170</weight>
                <product_code>2410070582</product_code>
                <lot_ID>9274E8AC</lot_ID>
                <merchant_ID>1155448899</merchant_ID>
                <price>3.99</price>
                <aisle>5</aisle>
                <shelf>2</shelf>
                <expiration_date>2017-02-01
12:30:00</expiration_date>
                <confidence_level>0.7</confidence_level>
                <rating>4.4</rating>
                <replenish_cycle>2,
week</replenish_cycle>
                <alt_products>874684689468,
6347689469846</alt_products>
                ...
            </product>
        <predicted_replace>
    </replacement_products>
    <suggested_products>
        <personal>
            <product>
                <ID>289786479</ID>
                <name>Twinings &#174; Chai Ultra Spice
Tea</name>
                <weight>40, g</weight>
                <product_code>7017726772</product_code>
                <lot_ID>908D0F989A</lot_ID>
                <merchant_ID>9483738921</merchant_ID>
                <price>4.99</price>
                <aisle>7</aisle>
                <shelf>3</shelf>
                <expiration_date></expiration_date>
                <confidence_level>0.8</confidence_level>
                <rating>4.7</rating>
                <replenish_cycle>4,
week</replenish_cycle>
                <alt_products>587456465874,
38749326578</alt_products>
                ...
            </product>
        </personal>
        <social>
            <product>
                <ID>38749326578</ID>
                <name>Lipton &#174; Black Tea</name>
                <weight>40, g</weight>
                <product_code>83487456874</product_code>
                <lot_ID>232D2F436A</lot_ID>
                <merchant_ID>54758487487428</merchant_ID>
                <price>3.99</price>
                <aisle>7</aisle>
                <shelf>3</shelf>
                <expiration_date></expiration_date>
        <confidence_level>0.76</confidence_level>
                <rating>3.7</rating>
                <replenish_cycle>4,
week</replenish_cycle>
                <alt_products>289786479,
97298473974</alt_products>
                ...
            </product>
        </social>
    </suggested_products>
</product_list>
```

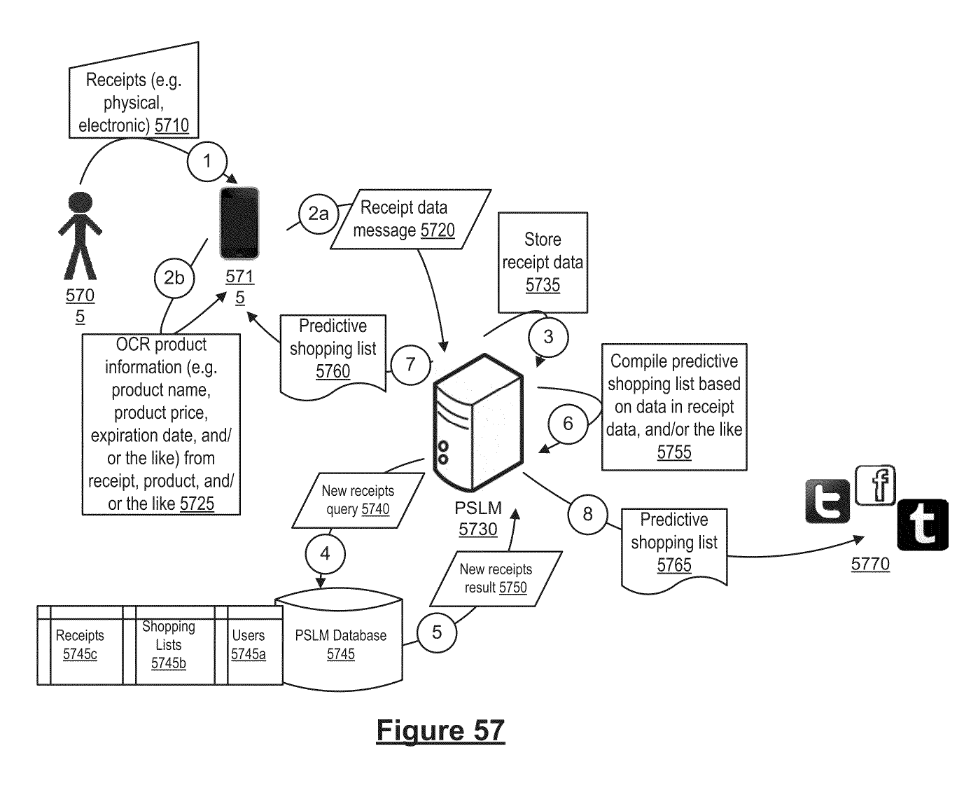

FIG. 57 shows a data flow diagram illustrating collecting receipt information for predictive shopping lists in some embodiments of the ICST. In some implementations, a user 5705 may provide receipts 5710 (physical, electronic, and/or the like) to their wallet-enabled electronic device 5715. In some implementations the electronic device may send the receipt data to ICST330 via a receipt data message 5720. In some implementations, the electronic device may also OCR product information (e.g., the product name, product expiration date, and/or the like) from the user receipts, and may send said information to ICSTwithin the receipt data message. In some implementations, the XML-encoded receipt data message may take a form similar to the following:

```
POST /receipts_message.php HTTP/1.1
Host: www.ICSTproccess.com
Content-Type: Application/XML
Content-Length: 788
<?XML version = “1.0” encoding = “UTF-8”?>
<receipts_message>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <receipts_params>
        <receipts_list>
            <receipt>
                <date_created>2012-01-01
12:30:00</date_created>
                <merchant_ID>82719487194</merchant_ID>
                <transaction_total>24.50</transaction_total>
                <tax>1.50</tax>
                <products>
                    <product>
                        <ID>289786479</ID>
                        <name>Twinings &#174; Chai Ultra Spice
Tea</name>
                        <weight>40, g</weight>
                        <product_code>7017726772
                        </product_code>
                        <lot_ID>908D0F989A</lot_ID>
                        <merchant_ID>9483738921
                        </merchant_ID>
                        <price>4.99</price>
                        <aisle>7</aisle>
                        <shelf>3</shelf>
                        <expiration_date></expiration_date>
                        ...
                    </product>
                    <product>
                        <id>098765432</id>
                        <name>Sunshine &#174; Cheez-It &#174;
Baked Snack Crackers</name>
                        <weight>170</weight>
                        <product_code>2410070582
                        </product_code>
                        <lot_ID>9274E8AC</lot_ID>
                        <merchant_ID>1155448899
                        </merchant_ID>
                        <price>3.99</price>
                        <aisle>5</aisle>
                        <shelf>2</shelf>
                        <expiration_date>2017-02-01
12:30:00</expiration_date>
                        ...
                    </product>
                </products>
            </receipt>
            ...
            <receipt>
                <date_created>2012-01-01
12:30:00</date_created>
                <merchant_ID>82719487194</merchant_ID>
                <products>
                    ...
                </products>
            </receipt>
        </receipt_list>
    </receipts_params>
</receipt_message>
```

In some implementations, the ICSTmay store the receipt data 5735 via generating a new receipts query 5740 to the ICST database 5745, which may create a new receipts record in the receipts table 5745c of the database. In some implementations, the PHP-encoded receipts query 5740 to the database may take a form similar to the following:

```
<?php
...
    $user_ID = “123456789”;
    $merchant_ID = “8486588468498”;
    $date = “2012-01-01 12:30:00”;
    $trans_total = 24.50;
    $tax = 1.50;
    foreach ($product_list as $product){
        $new_product = $new_product . “ ” . $product.ID;
    }
    $product_result = mysql_query(“INSERT INTO receipts (user_ID,
date, merchant_ID, trans_total, tax, products) VALUES
    (mysql_real_escape_string($user_ID),
    mysql_real_escape_string($date),
    mysql_real_escape_string($merchant_ID),
    mysql_real_escape_string($trans_total),
mysql_real_escape_string($tax),
    mysql_real_escape_string($new_product)));
>
```

In some implementations, after receiving a new receipts result 5750 from the query, ICST may compile a predictive shopping list based on data from the receipts, and/or like information 5755. ICST may then send a copy of the predictive shopping list 5760 to the user's wallet, as well as generate a link so that the user may send a copy 5765 of the predictive shopping list to the user's social networks 5770 (e.g. Facebook, Twitter, and/or the like).

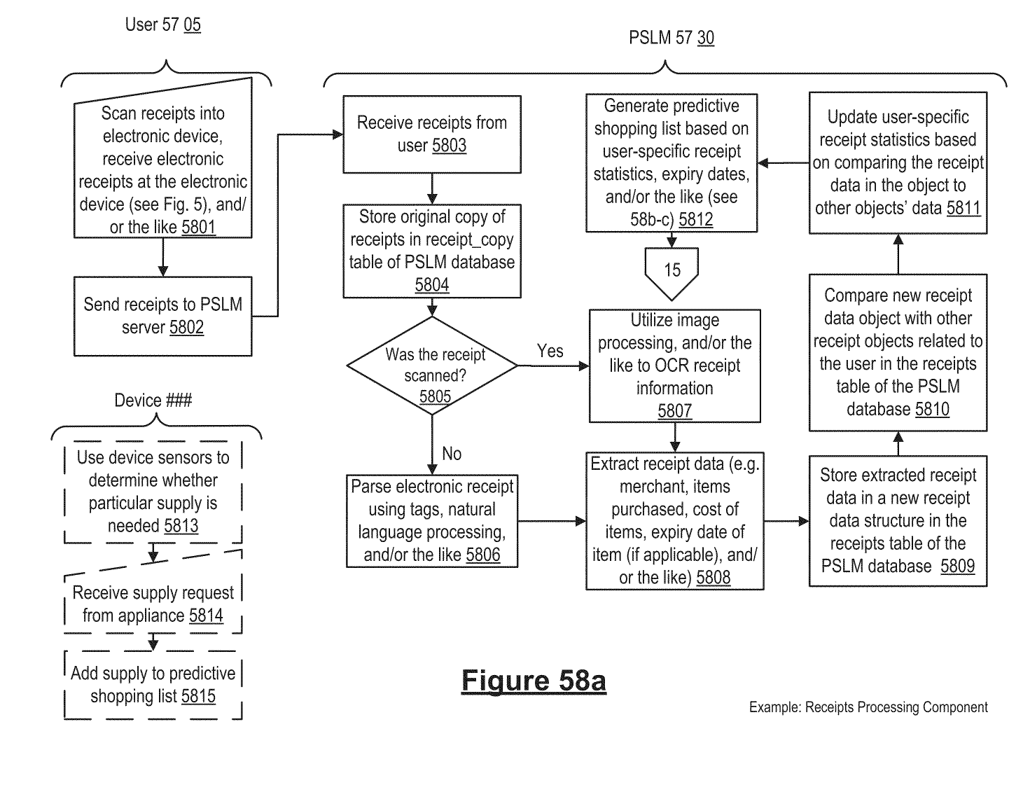

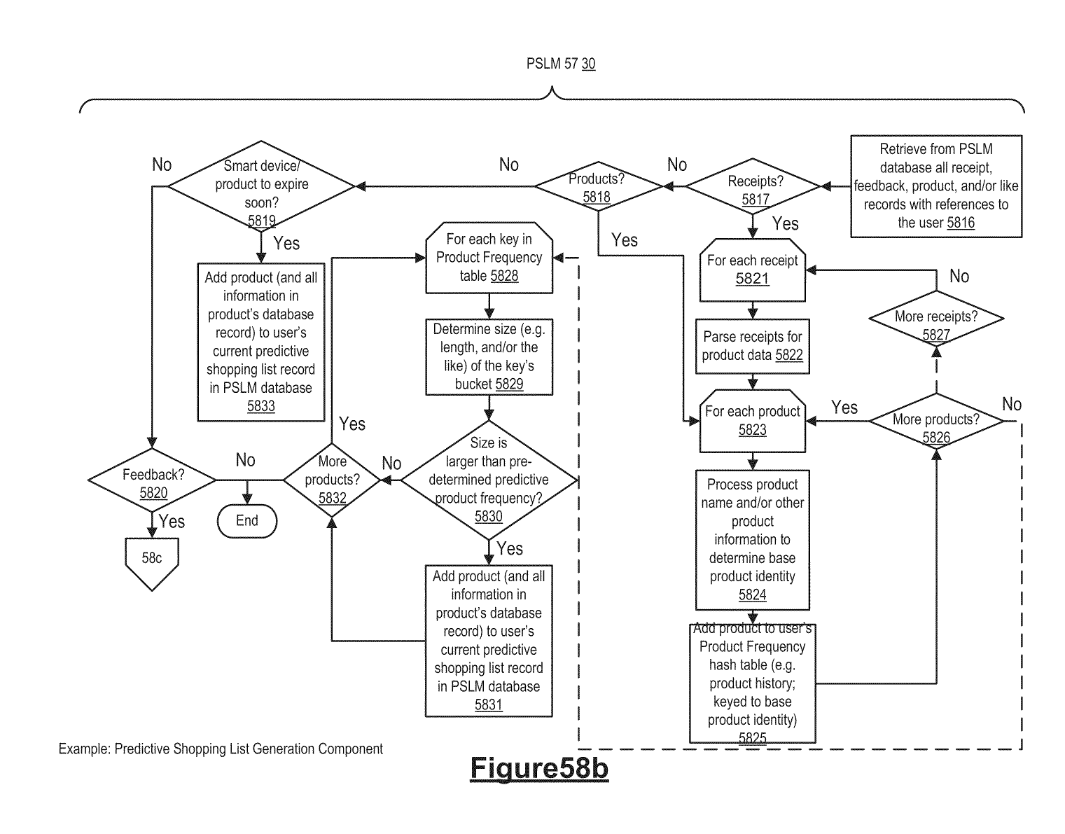

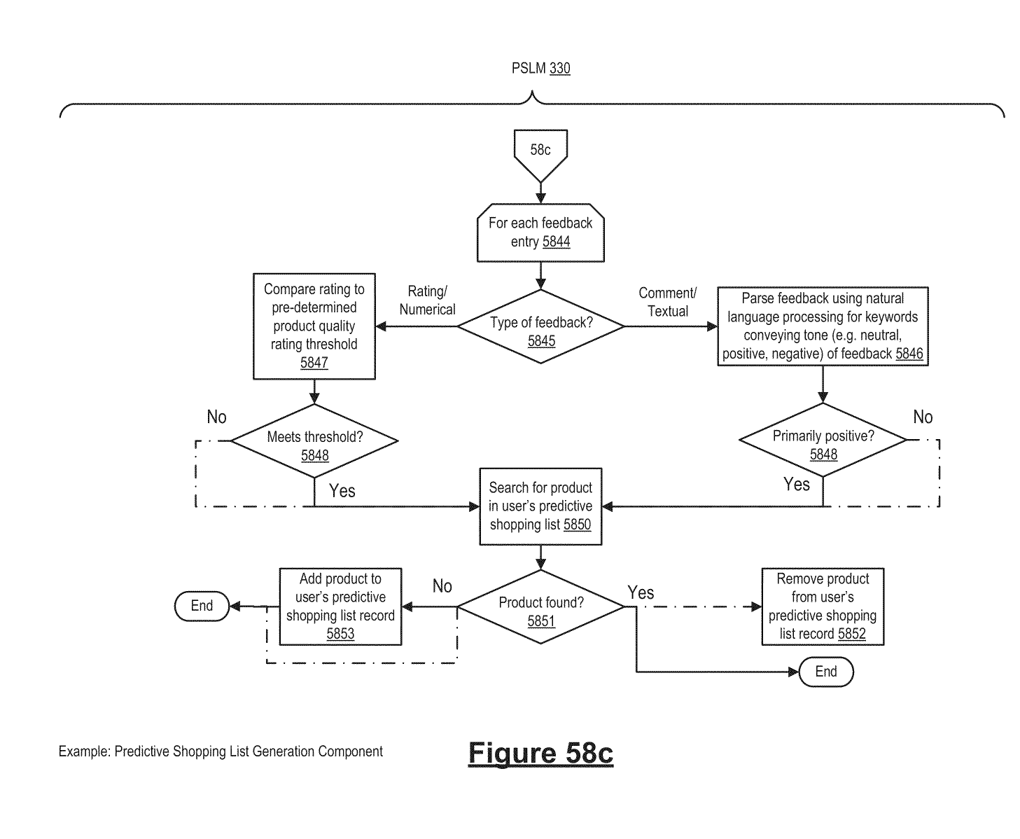

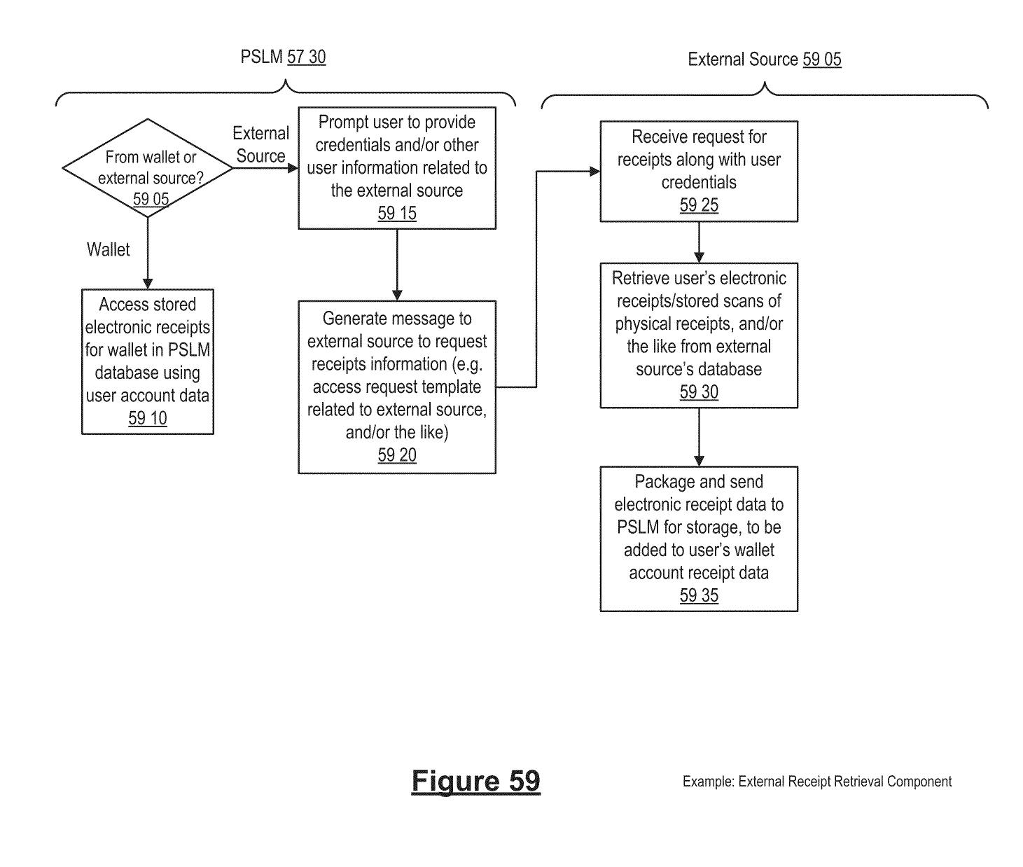

FIGS. 58a-c show logic flow diagrams illustrating parsing receipts and generating predictive shopping lists in some embodiments of the ICST. In some implementations, the user may scan 5801 receipts into his/her electronic device, and/or obtain past receipts via other means (see FIG. 59). In some implementations, the user may then send these receipts to ICST402, which may receive the receipts 5803 and may then store an original copy of the receipts in a table in the ICSTdatabase 5804. ICSTmay then check to determine whether the receipt was scanned or was an electronic receipt 5805. If scanned, ICSTmay use image processing and/or a like component to convert (e.g. via Optical Character Recognition (OCR) and/or a like process) the images into textual receipts 5807. If not scanned, ICSTmay directly parse the electronic receipt 5806 using metadata (e.g. Tags and/or the like) within the electronic receipt, via natural language processing, and/or the like. Once the data on the receipt is readable, ICSTmay then extract 5808 data from the receipt (for example, merchant identification, items purchased, cost of items, expiry date of items if applicable, and/or the like), and may store this extracted information 5809 in a new receipt data structure in the ICSTdatabase. In some implementations, a copy of the receipt from which the data was extracted may also be stored along with the new data structure. In some implementations, ICSTmay compare the new receipt data object with others already created for the user and stored in the database 5810, and may update user receipt statistics 5811 based on these comparisons. For example, ICSTmay keep track of how often a type of eggs from a particular company comes up in all of the user's receipts, and/or the like. From this information, ICSTmay generate a predictive shopping list 5812, wherein products are placed on the predictive shopping list based on frequency of purchase, based on when they were last purchased, based on when products are about to expire, and/or the like.

In some implementations, ICSTmay retrieve all receipt, feedback, product, and/or like data from the ICSTdatabase relating to the user and his or her product history in order to determine a product inclusion index (e.g., a score to assign to the product to determine whether it should be added to the list). In some implementations, if receipts associated with the user are retrieved 5817, ICSTmay, for each receipt 5821, parse the receipts for product data 5822 in order to determine each individual product on the receipt. ICSTmay then, for each product 5823, process the product name, product description, product ID, and/or other information 5824 in order to determine a base product identity. In some implementations, this base product identity may be used to link similar products that may come from different merchants, may have substantially different product names, and/or the like. As an example, a base product identity of “cheese crackers” may apply both to Cheez-It (R) crackers, as well as to Nabisco Cheese Nips (R), and/or the like. In some implementations, ICSTmay add a reference to the product to a user's Product Frequency hash table stored in the ICSTdatabase. In some implementations, the product identity may be used as the product's key in the hash table, and the information saved to the hash table may include the product information and/or the record ID of the product in the ICSTdatabase. In some implementations, if an object has already been hashed to the key, ICSTmay handle the overflow multiple ways. For example, it may compare the product to be added to the Product Frequency table to the product(s) already hashed to the same base product identity key: if the product is also from the same brand, of the same price, and/or shares like factors, ICSTmay not add the product to the table, and may instead update the frequency field of the product already in the table (e.g. increasing the frequency by one). If, however, the product to be added to the table is of a brand, and/or the like from all products similarly keyed to the hash table, ICSTmay add the product to the key bucket via adding it to the end of a link list keyed to the base product identity. If there are more products to potentially add to the Product Frequency hash table 5826, ICSTmay continue to compare products against the Product Frequency table. If there are no other products, ICSTmay check to see if there are more receipts 5827, and may process the rest of the receipts if they exist. Otherwise ICSTmay process the newly-updated Product Frequency table by checking each key in the table 5828 and determining the size of the key's bucket 5829. In some implementations, determining the size of the bucket may include both checking the size of the linked list at the key, and totaling the frequency of each product in the list, and/or some similar process. In some implementations, the total frequency may equate to the product's product inclusion index. In some implementations, if the size of the calculated frequency for a particular base product identity (e.g. sum of frequency of each product) is equal to or greater than a predetermined predictive product frequency 5830, the product may be added to the user's current predictive shopping list. In some implementations, the actual product placed on the list may depend on the frequency of each individual product (e.g., the product with the highest frequency may be added to the list), based on product feedback (e.g. the product with the highest ratings and/or the like may be added to the list), and/or the like. If the base product identity's calculated frequency is not equal to or greater than the predetermined threshold, ICSTmay check if there are more base product identities to check 5832 and may process them accordingly. If there are no more products, ICSTmay complete adding items to the predictive shopping list.

If ICSTobtains product records 5818 from the database, ICSTmay process each item in a manner similar to how they would be processed if the product was extracted from a receipt (see 5823). If ICSTretrieves information from a smart device, or retrieves a product that is soon to expire (e.g. has an expiration date within a specified range of close to expiring) 5819, ICSTmay automatically add the item to the user's predictive shopping list 5833, and may note on the shopping list the device the product came from and/or the expiration date of the item the user last bought. In some implementations, an expiring product and/or a product submitted by a smart device may always be automatically be added to the predictive shopping list because such items may have their product inclusion indices always set to exceed the threshold necessary to add items to the list.

In some implementations, if ICSTretrieves feedback 5820 about any products and/or predictive shopping lists attributed to the user, ICSTmay process the feedback to determine how to handle the products which have received feedback. For example, for each feedback entry 5844, ICSTmay determine the type of feedback obtained on a particular product 5845. If the feedback is textual (e.g. a comment/short answer), ICSTmay parse the feedback 5846 using natural language processing and/or like components in order to identify keywords 5846 that convey a tone of the feedback (e.g. positive words such as “great,” fantastic,” negative words such as “terrible,” “don't buy,” and neutral words such as “okay,” “sufficient”). After determining the general tone of the comment by analyzing such keywords in the comment, if the tone of the comment seems positive 5848, ICSTmay search the user's predictive shopping list for the product 5850, and, if the product is not on the list 5851, may add the product to the predictive shopping list, and/or replace a similar product already on the shopping list. If the product comments seem mostly negative, then ICSTmay, if the product is on the predictive shopping list, remove the product from the predictive shopping list 5852. In some implementations, removal of the product may prompt ICSTto add an alternative to the product in place of the removed item. In some implementations, if the feedback was numerical (e.g. a rating), ICSTmay compare 5847 the numerical value of the rating (or the aggregate of all ratings for the product) to a predetermined product quality threshold (e.g. determined by the user). If the product, based on its ratings, meets the threshold, 5849, ICSTmay check the user's predictive shopping list and may either add the product to the list or replace another similar product with the highly-rated product. If the product does not meet the threshold, ICSTmay remove the item from the list if it is currently on the list, and may also determine a suitable alternative to the removed product.

FIG. 59 shows a logic flow diagram illustrating obtaining electronic receipts in some embodiments of the ICST. In some implementations, ICST may determine 5905 whether the receipts are coming from the user's electronic wallet (e.g. a wallet connected to ICST or a wallet from another entity), or from an external source (e.g. from emails, from scanned images on a computer, and/or the like). In some implementations, if the receipts are coming from an electronic wallet, ICST may access stored receipts within the ICST 5910 by retrieving those which are linked to the user, or may access receipts in electronic wallets not connected to ICST via using the user's account credentials and/or other data to retrieve the receipts from the user's records. If the receipts are from an external source, ICST may prompt 5915 the user to provide his/her credentials and/or other information necessary to access the user's data from the external source. ICST may then generate a message 5920 to the external source using the provided user credentials in order to request receipt information. In some implementations, the message may provide a template for the external source, which it may use to determine what data to retrieve and how to format the data when it sends the data to ICST. In some implementations, the external source may receive the request 5925 and, after authenticating ICST using the user credentials, may retrieve 5930 the user's emails containing electronic receipts, scans of physical receipts, and/or the like from the external source's database. The external source may then package and send 5935 the data to ICST using the provided data template, and ICST, upon receiving the data, may store the receipts data in receipts records in the ICST database, and may link the new receipts records to the user's electronic wallet account.

FIG. 60 shows a data flow diagram illustrating collecting code information for predictive shopping lists in some embodiments of the ICST. In some implementations, a user 6005 may use an electronic wallet-enabled device 6015 to scan 6010 a checkout code in order to check out at a merchant. In some embodiments, the checkout code may be a QR code, an NFC tag, a checkout bar code, and/or the like. In some implementations, the wallet-enabled device may send a checkout message 6025 to ICST 6080. In some implementations, an XML-enabled checkout message 6025 may take a form similar to the following:

```
POST /checkout_message.php HTTP/1.1
Host: www.ICSTproccess.com
Content-Type: Application/XML
Content-Length: 788
<?XML version = “1.0” encoding = “UTF-8”?>
<checkout_message>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <checkout_params>
        <date_performed>2012-01-01 12:30:00</date_performed>
        <merchant_ID>82719487194</merchant_ID>
        <transaction_total></transaction_total>
        <pay_method>wallet</pay_method>
        ...
        <products_list>
            <product>
                ...
            </product>
            ...
            <product>
                ...
            </product>
        </products_list>
        <checkout_QR>
            <qr_object_params>
            <qr_image>
                <name> exp_QR </name>
                <format> JPEG </format>
                <compression> JPEG compression </compression>
                <size> 123456 bytes </size>
                <x-Resolution> 72.0 </x-Resolution>
                <y-Resolution> 72.0 </y-Resolution>
                <date_time> 2014:8:11 16:45:32 </date_time>
                ...
                <content> ÿØÿà JFIF H H ÿâ\acute{ }ICC_PROFILE [symbol]
appl mntrRGB XYZ Ü $ acspAPPL öÖÓ-appl
desc P bdscm \acute{ } \check{S}cprt ——————————@ $wtpt
—————————————d rXYZ ————————x gXYZ
————————————— [symbol]  bXYZ ———————— rTRC
—————————————\acute{ } aarg À vcgt ...
                </content>
                ...
            </qr_image>
            <QR_content>”Products, 893479357985,
98573347932749, ...”</QR_content>
            </qr_object_params>
        </checkout_QR>
        <GPS>40.7589905, −73.9790277</GPS>
    </checkout_params>
</checkout_message>
```

In some implementations ICST may process the information in the scanned code 6035 and may store the specified items in the user's purchase history in the user's record 6050a, and may also store records of the products in the products table 6050c of the ICST database. In some implementations, ICST may then compile a predictive shopping list and/or update the user's existing predictive shopping list 6060 using the items checked out with the checkout code. In some implementations ICST may send a copy of the predictive shopping list 6065 to the user's electronic device, and may allow the user to send another copy of the predictive shopping list 6070 to his/her social network profiles 6075(e.g. Facebook, Twitter, and/or the like).

In some implementations, the user may also scan 6020 an expiration date code (e.g. a QR code, NFC tag, barcode, RFID tag, and/or the like), and/or may scan an expiration date from the product's package. In some implementations, the electronic device may send an expiration message 6030 to ICST containing the expiration data scanned from the code. In some implementations, the XML-enabled expiration message may take a form similar to the following:

```
POST /expiration_message.php HTTP/1.1
Host: www.ICSTproccess.com
Content-Type: Application/XML
Content-Length: 788
<?XML version = “1.0” encoding = “UTF-8”?>
<checkout_message>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <product_exp_params>
        <exp_date>
            <qr_object_params>
            <qr_image>
                <name> exp_QR </name>
                <format> JPEG </format>
                <compression> JPEG compression </compression>
                <size> 123456 bytes </size>
                <x-Resolution> 72.0 </x-Resolution>
                <y-Resolution> 72.0 </y-Resolution>
                <date_time> 2014:8:11 16:45:32 </date_time>
                ...
                <content> ÿØÿà JFIF H H ÿâ\acute{ }ICC_PROFILE [symbol]
appl mntrRGB XYZ Ü $ acspAPPL öÖÓ-appl
desc P bdscm \acute{ } \check{S}cprt ——————————@ $wtpt
—————————————d rXYZ ————————x gXYZ
————————————— [symbol]  bXYZ ———————— rTRC
—————————————\acute{ } aarg À vcgt ...
                </content>
                ...
            </qr_image>
            <QR_content>”Expiration Date,
2014:8:11”</QR_content>
            </qr_object_params>
        </exp_date>
        <product_ID>484873258932</product_ID>
        <GPS>40.7589905, −73.9790277</GPS>
    </product_exp_params>
</expiration_message>
```

In some implementations, ICST may then store 6040 the expiration date information in the products table 6050c of the ICST database via an expiration date query 6045 to the ICST database 6050. In some implementations, a PHP-encoded expiration date query 6045 may take a form similar to the following:

```
<?php
    ...
    $product = “8578388889475”;
    $exp_date = “2014:8:11”;
    $exp_result = mysql_query(“UPDATE products SET
exp_date=’$exp_date’ WHERE id=’$product’”);
>
```

In some implementations, after receiving an expiration date result 6055, ICST may use the expiration date data to update the user's predictive shopping list (e.g. adding items that will expire soon to the shopping list, and/or the like).

FIG. 61 shows a logic flow diagram illustrating collecting code information for predictive shopping lists in some embodiments of the ICST. In some implementations, the user may scan a checkout code and/or the like using the user's electronic device 6105. The electronic device may decode 6110 the data from the checkout code and/or the like, and may extract 6115 product information from the decoded code data and send the decoded information to ICST. In some implementations ICST may receive 6120 a list of the products in the checkout code, and may compare 6125 the list of products to the products stored in the user's purchase history. If any product on the user's checkout list is already in the user's product history 6130, ICST may update 6135 the purchase frequency of the products already in the user's purchase history. If any product on the checkout list is not in the user's purchase history, ICST may add the products 6140 to the user's purchase history, and may update the user's purchase statistics 6145 based on the updated purchase history and purchase frequencies. ICST may then generate and/or update a predictive shopping list for the user 6150 based on the user's purchase statistics and/or the like.

In some implementations, the user may also scan an expiration date code 6155 from the product's packaging, from a shelf label, and/or the like using the user's electronic device, and the electronic device may extract 6160 from the expiration code the expiration date for the product. In some implementations, the electronic may send the expiration data to ICST, which may store 6165 the expiration data in the product record and/or in the user's purchase history data, and which may use the expiration data to update the user's predictive shopping list.

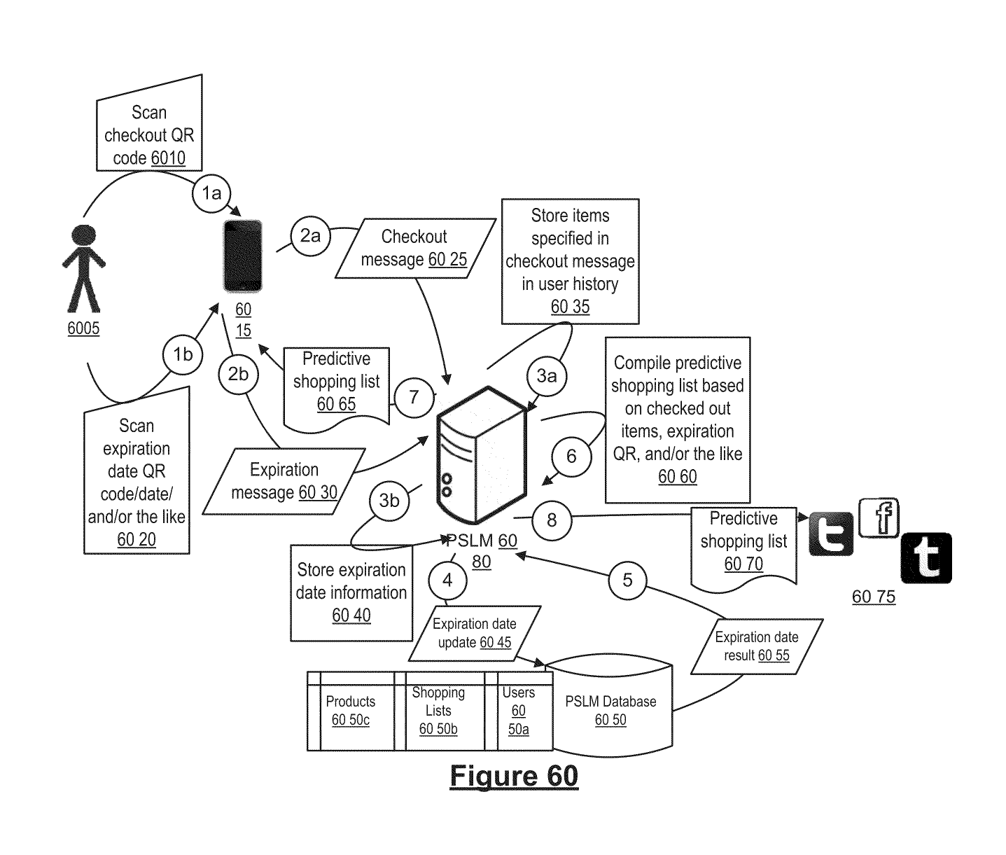

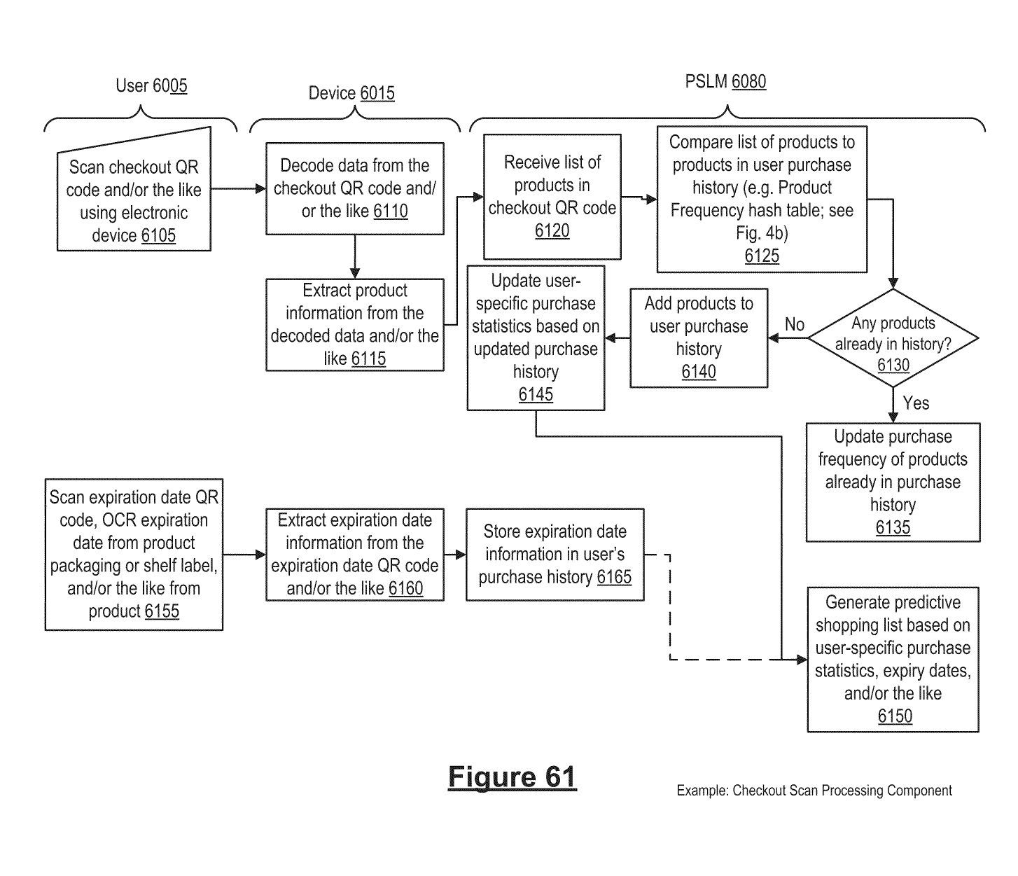

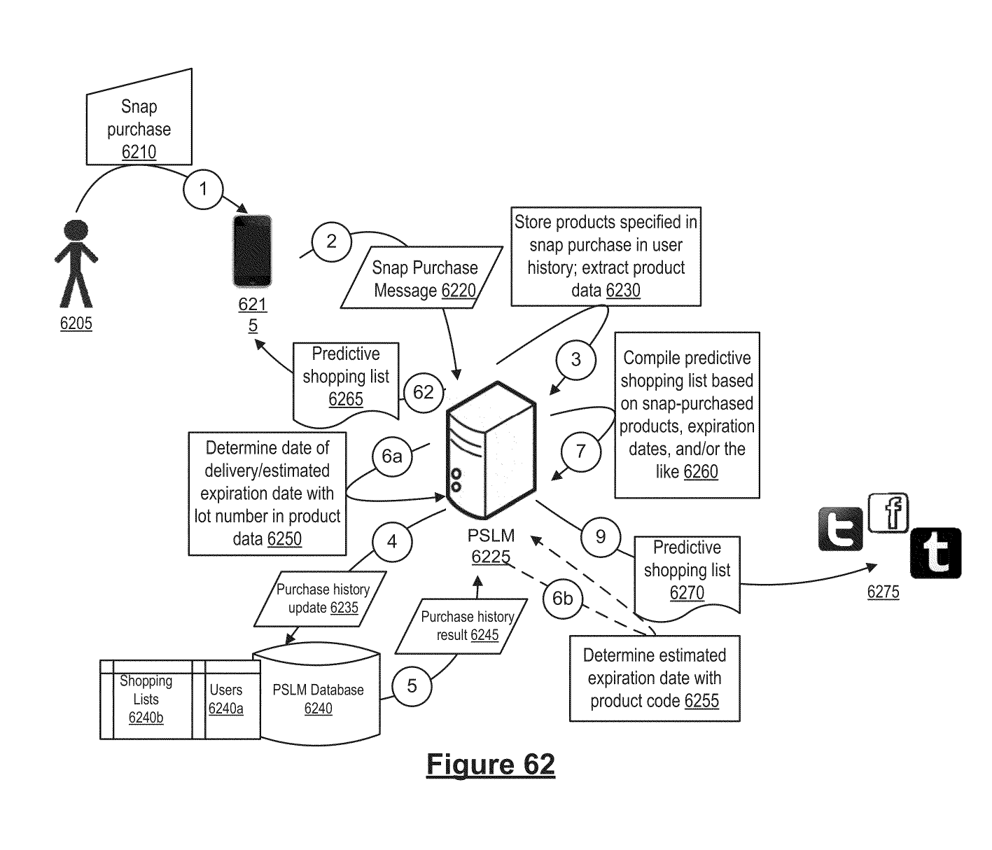

FIG. 62 shows a data flow diagram illustrating collecting snap purchase information for predictive shopping lists in some embodiments of the ICST. In some implementations, a user 6205 may perform a snap purchase 6210 using an electronic device 6215. In some implementations, the electronic device may send a snap purchase message 6220 to ICST 6225, which may be an XML-enabled message that may take a form similar to the following:

```
POST /snap_purchase_message.php HTTP/1.1
Host: www.ICSTproccess.com
Content-Type: Application/XML
Content-Length: 788
<?XML version = “1.0” encoding = “UTF-8”?>
<snap_purchase_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <decoded_tag_params>
          <checkout_params>
                <date>2012-01-01 12:30:00</date >
                <merchant_ID>82719487194</merchant_ID>
                <transaction_total>24.50</transaction_total>
                <tax>1.50</tax>
          </checkout_params>
          <product_params>
                <product>
                      <ID>289786479</ID>
                      <name>Twinings &#174; Chai Ultra Spice Tea</name>
                      <weight>40, g</weight>
                      <product_code>7017726772</product_code>
                      <lot_ID>908D0F989A</lot_ID>
                      <merchant_ID>9483738921</merchant_ID>
                      <price>4.99</price>
                      <aisle>7</aisle>
                      <shelf>3</shelf>
                      <expiration_date></expiration_date>
                      <GPS>40.7589905, −73.9790277</GPS>
                        ...
                </product>
                <product>
                      <id>098765432</id>
                      <name>Sunshine &#174; Cheez-It &#174; Baked Snack
Crackers</name>
                      <weight>170</weight>
                      <product_code>2410070582</product_code>
                      <lot_ID>9274E8AC</lot_ID>
                      <merchant_ID>1155448899</merchant_ID>
                      <price>3.99</price>
                      <aisle>5</aisle>
                      <shelf>2</shelf>
                      <expiration_date>2017-02-01
12:30:00</expiration_date>
                      <GPS>40.7589905, −73.9790277</GPS>
                      ...
                </product>
          </product_params>
    </decoded_tag_params>
    <tag_params>
          <qr_object_params>
                <qr_image>
                      <name> exp_QR </name>
                      <format> JPEG </format>
                      <compression> JPEG compression </compression>
                      <size> 123456 bytes </size>
                      <x-Resolution> 72.0 </x-Resolution>
                      <y-Resolution> 72.0 </y-Resolution>
                      <date_time> 2014:8:11 16:45:32 </date_time>
                      ...
                      <content> ÿØÿà JFIF H H ÿâ\acute{ }ICC_PROFILE [symbol]
appl mntrRGB XYZ Ü $ acspAPPL öÖÓ-appl
desc P bdscm \acute{ } \check{S}cprt ——————————@ $wtpt
—————————————d rXYZ ——————————x gXYZ
————————————— [symbol]   bXYZ —————————— rTRC
—————————————\acute{ } aarg À vcgt ...
                      </content>
                      ...
                </qr_image>
                </qr_object_params>
    </tag_params>
    <dig_signature>897987a87e878232322b22</dig_signature>
</snap_purchase_message>
```

In some implementations, ICST may store 6230 the products specified in the snap purchase within the user history, and may also extract product information from the snap purchase message, or retrieve the information from the ICST database. In some implementations, ICST may query the ICST database 6240 with a purchase history update query 6235 in order to update the user's product history in the user's record 6240a. After receiving a purchase history result 6245, ICST may compile and/or update a predictive shopping list for the user 6260 using the snap purchase information. ICST may also use the extracted product information in order to determine an expiration date for each product. For example, ICST may use the product's lot number 6250 to determine the product's date of delivery to the merchant, and therefore to estimate the expiration date of the product. ICST may also use the product ID or code 6255 to estimate the expiration date, based on information ICST may already have about the type of product (e.g. ICST may estimate the expiration date of a brand of eggs based on aggregate information about egg expiration dates, and/or the like). ICST may use the expiration date information to update the user's predictive shopping list. ICST may then send 6265a copy of the predictive shopping list to the user, and may allow the user to send a copy and/or link of the predictive shopping list 6270 to the user's social networking profiles 6275(e.g. Facebook, Twitter, and/or the like).

FIG. 63 shows a logic flow diagram illustrating collecting snap purchase information for predictive shopping lists in some embodiments of the ICST. In some implementations, the user may snap an item and/or a set of items for purchase 6305, and the snap purchase information may be sent to ICST. In some implementations, ICST may receive 6310 the information about the snap transaction, and may determine 6315 whether any of the products that were snapped for purchase already appear in the user's product history. If any do, ICST may update the purchase frequency of those products 6320; if a product does not appear in the user's product history, ICST may add the product to the user's purchase history 6325. In some implementations, for each product 6330 in the user's product history, ICST may also determine whether or not the product has a lot number 3350r a product ID and/or code by retrieving the product's record from the ICST database. If the product has a lot number, ICST may retrieve the lot ID 6345 and calculate an expiration date for the product based on the product's date of delivery; if the product does not have a lot number and/or ID but does have a product ID and/or code, ICST may instead retrieve the product ID and/or code, determine the type of product based on the ID and/or code, and estimate an expiration date for the product based on the product type, and based on data ICST already has for the type of product. ICST may then generate 6350 a predictive shopping list based on the user's purchase statistics and/or any other information obtained from the snap purchase.

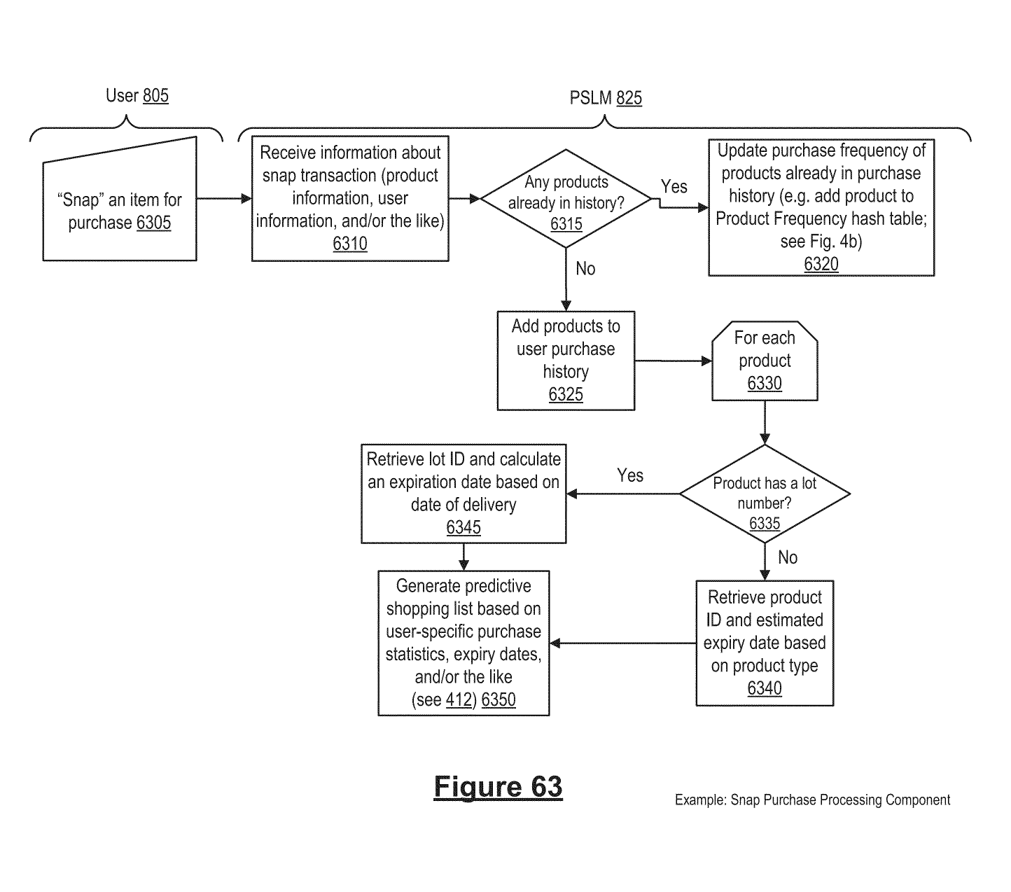

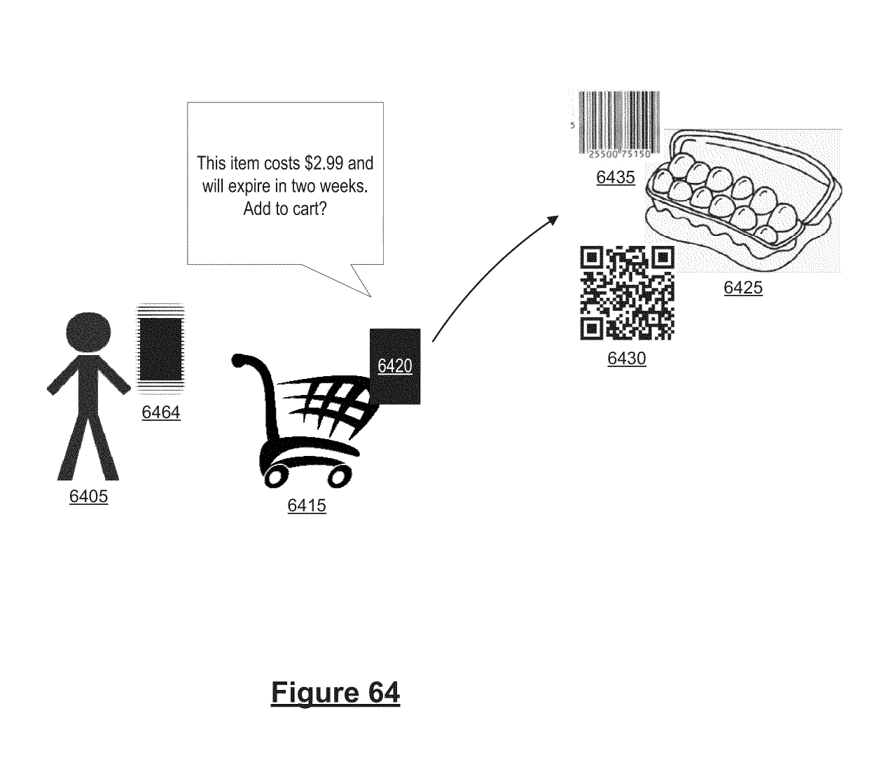

FIG. 64 shows a block diagram illustrating using predictive shopping lists with a smart shopping cart in some embodiments of the ICST. In some implementations, a user 6405 may want to use their electronic device 6410 connected to their electronic wallet, in conjunction with a smart cart 6415 with a code reader 6420, to automatically read product 6425 information from QR codes 6430, barcodes 6435, and/or like codes in order to keep track of products being purchased while at a merchant.

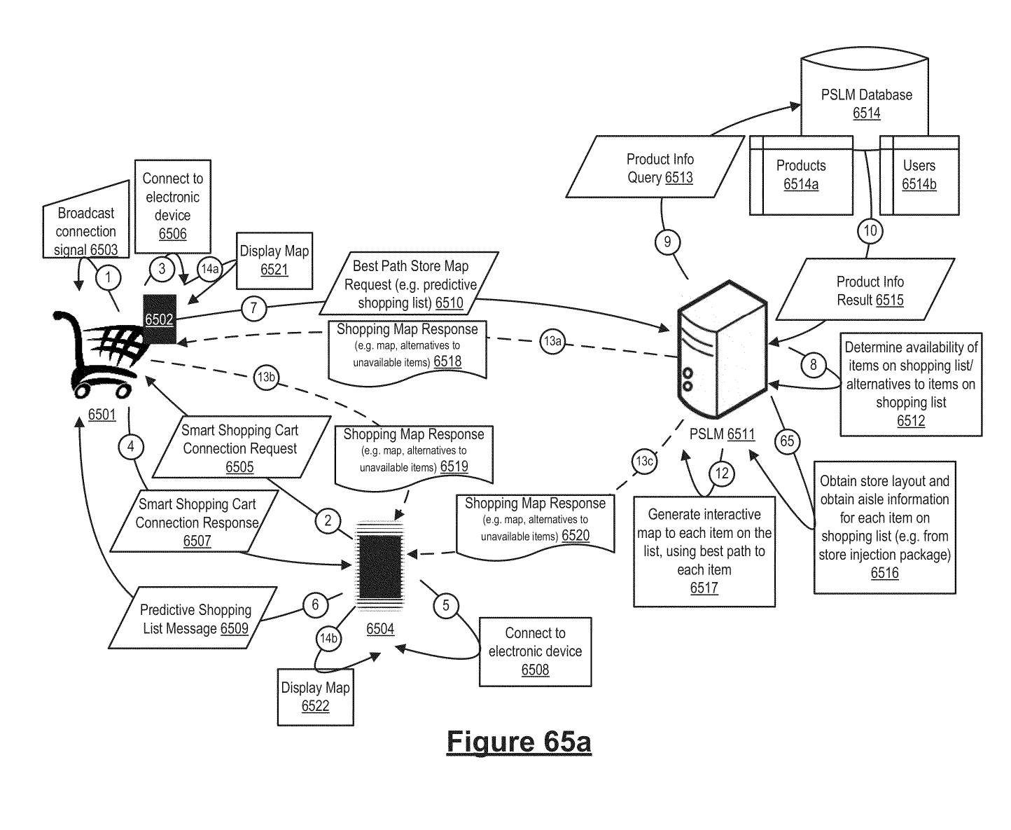

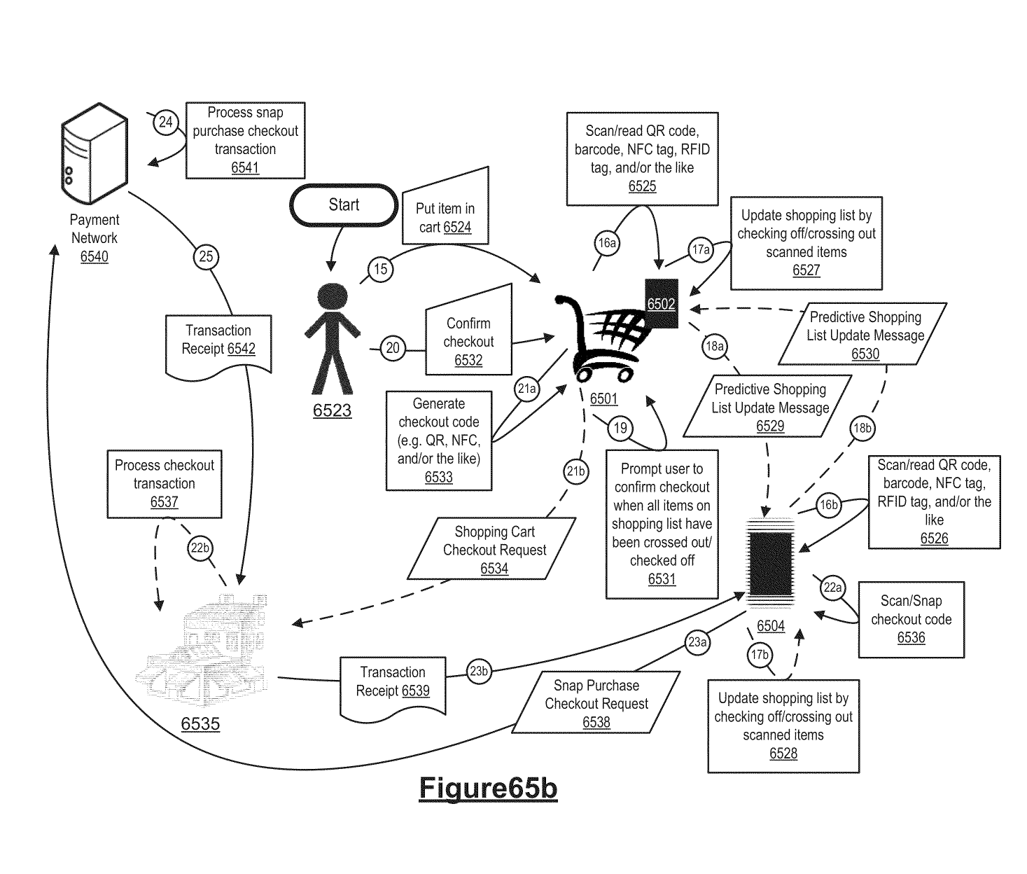

FIGS. 65a-b show data flow diagrams illustrating using predictive shopping lists with a smart shopping cart in some embodiments of the ICST. In some implementations, a merchant may have smart shopping carts 6501 fitted with a code scanner 6502, which may be able to read QR codes, barcodes, NFC tags, RFID tags, and/or the like. A smart shopping cart may broadcast 6503 a connection signal so that users may connect devices to the smart shopping cart. In some implementations, a user's wallet-enabled electronic device 6504 may be able to pick up the broadcasted signal, and may send a smart shopping cart connection request 6505 to the shopping cart. In some implementations, an exemplary XML-encoded shopping cart connection request 6505 may take a form similar to the following:

```
POST /connect_message.php HTTP/1.1
Host: www.ICSTproccess.com
Content-Type: Application/XML
Content-Length: 788
<?XML version = “1.0” encoding = “UTF-8”?>
<connect_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <device_params>
          <device_ID>875464684658</device_ID>
          <device_name>Example Device</device_name>
          <device_pin>1234</device_pin>
          <device_connect>bluetooth,wifi</user_connect>
    </device_params>
</connect_message>
```

In some implementations, the shopping cart may attempt to connect 6506 to the electronic device and, if successful, may send a smart shopping cart connection response 6507, which may contain a notification that the shopping cart is successfully able to see and communicate with the electronic device, or a notification of a failed connection attempt, allowing the user to try to connect to the shopping cart again through his/her device. In some implementations the notification may also contain information about the cart which may help facilitate a connection between the two devices, e.g. a passcode and/or the like. In some implementations, the electronic device may then connect 6508 to the smart shopping cart, and may send a copy 6509 of the user's predictive shopping list to the cart. The shopping cart may then send a best path store map request 6510 to ICST, which may contain the predictive shopping list so that ICST may determine the fastest route through the store to get to the items on the list. In some implementations, the store map request 6510 may take a form similar to the following:

```
POST /map_message.php HTTP/1.1
Host: www.ICSTproccess.com
Content-Type: Application/XML
Content-Length: 788
<?XML version = “1.0” encoding = “UTF-8”?>
<map_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <shopping_list_params>
          <list_params>
                <name> Example Predictive Shopping List </name>
                <date_created>2016-01-01 12:30:00</date_created>
          </list_params>
          <product_list>
                ...
          </product_list>
    </shopping_list_params>
    <path_params>
          <start>closest_to_user</start>
          <end>closest_to_checkout</end>
          <alts>true</alts>
    </path_params>
</map_message>
```

In some implementations, ICST may determine the availability 6512 of the items on the user's predictive shopping list, and/or the availability of alternative items (e.g. if items in the shopping list are not available and/or the like) via sending a product information query 6513 to the ICST database 654. A PHP-encoded product info query may take a form similar to the following:

```
<?php
        ...
          $merchant = “54435435562436”;
          $exp_result = mysql_query(“FROM products WHERE
merchant_ID=’$merchant’ SELECT *);
>
```

In some implementations, the query may access the products table 6515a and retrieve a store injection package stored on ICST for the purpose of determining the merchant's most recently-provided inventory. In some implementations, ICST may, instead of retrieving said package from the ICST database, may contact a store injection database or a merchant directly to retrieve a recent store injection package for the merchant. In some implementations, the ICST database may return a product information result 6515, which may contain a store injection package for the merchant specified, so that ICST may parse the package for the merchant's available inventory. In some implementations, items on the user's predictive shopping list not available at the merchant at the time of purchase may be swapped for alternative items (e.g. stored in the predictive shopping list, proposed by the merchant and/or social network contacts, and/or the like), and ICST may parse the package for information regarding these alternative items. In some implementations, ICST may also obtain the store layout 6516 and aisle information for all the items on the user's predictive shopping list and/or alternatives added to the list, e.g. via parsing the store injection package for such information. In some implementations, ICST may use the store layout, aisle and shelf information for each product, and/or the like to determine the best path to each item in the store, and to generate an interactive map 6517 to each item on the predictive shopping list. In some implementations, the path from item to item may be drawn via mapping Cartesian coordinates to the floor map/bird's eye view image of the store, and plotting the path based on these coordinates. In some implementations, ICST may then send the shopping map via a shopping map response 6518 to the smart shopping cart. In some implementations, a XML-enabled shopping map 6518 may take a form similar to the following:

```
<graphic_shopping_map>
          <order>
                <product>
                      <id>573687474878</id>
                      <x>20</x>
                      <y>40</y>
                </product>
                <product>
                      <id>87676876879</id>
                      <x>20</x>
                      <y>70</y>
                </product>
                ...
          </order>
                <map_base>
                      <format> JPEG </format>
                      <compression> JPEG compression </compression>
                      <size> 123456 bytes </size>
                      <x-Resolution> 72.0 </x-Resolution>
                      <y-Resolution> 72.0 </y-Resolution>
                      <x-width>200</x-width>
                      <y-height>320</y-height>
                      <date_time> 2014:8:11 16:45:32 </date_time>
                      <color>greyscale</color>
                      ...
                      <content> ÿØÿà JFIF H H ÿâ\acute{ } ICC_PROFILE [symbol]   appl
mntrRGB XYZ Ü $ acspAPPL öÖÓ-appl
desc P bdscm \acute{ } \check{S}cprt ——————————@ $wtpt
—————————————d rXYZ ——————————x gXYZ
—————————— [symbol]  bXYZ —————————— rTRC
——————————\acute{ } aarg À vcgt ...
                      </content>
                </map_base>
                <overlay_color>red</overlay_color>
</graphic_shopping_map>
```

In some implementations, the shopping cart may forward 6519 the shopping map to the user's electronic device. In some implementations, ICST may send the shopping map 6520 directly to the user's electronic device. In some implementations, the cart may display 6521 the map on a display mounted on the cart, and/or the user's electronic device may display 6522 the map on its screen.

After receiving the map, the user 6523 may add items to his/her cart 6524, which may involve allowing the smart cart to scan and/or read 6525 a code (e.g. a QR code, barcode, NFC tag, RFID tag, and/or the like) from the product packaging. The smart cart may then update the shopping list 6527 on the cart by marking the item scanned as being obtained via checking off the item, crossing off the item, and/or a like action on the list. In some implementations, the cart may also send a predictive shopping list update message 6529 to the user's electronic device, which may used the sent scanned product information to update a copy of the shopping list being maintained on the electronic device 6528. In some implementations, an exemplary XML-encoded shopping list update message 6529 may take a form similar to the following:

```
POST /scanned_item_message.php HTTP/1.1
Host: www.ICSTproccess.com
Content-Type: Application/XML
Content-Length: 788
<?XML version = “1.0” encoding = “UTF-8”?>
<scanned_item_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <scanned_item_params>
          <product >
                ...
          </product >
          <on_list>true</on_list>
          <action>check_off</action>
    </scanned_item_params>
</scanned_item_message>
```

In other implementations, the user may instead scan and/or read a code from a product using the user's electronic device 6526, and may send a predictive shopping list update message 6530 to the user's smart cart, which may provide scanned product information to the cart that may allow it to cross off and/or otherwise mark items on its copy of the shopping list. In some implementations, the shopping list update message 6530 may take a form similar to update message 6529. In some implementations, the user may be able to dynamically change his/her predictive shopping list while shopping for products on the list. For example, the user may be able to manually add new items for the list, or manually remove items on the list. In other implementations, scanning items not on the list may add them automatically to the user's predictive shopping list, and re-scanning items already scanned and placed in the cart may remove them from the list and/or uncheck them on the list.

In some implementations, the cart may ask the user to confirm checkout 6531 of the items collected in the cart once all of the items on the predictive shopping list have been marked as being scanned. In some implementations, the user's electronic device may also prompt the user to checkout once all of the items on the user's predictive shopping list have been marked as being scanned. In some implementations the user may confirm 6532 checkout of the items added to the cart. In some implementations, the shopping cart may generate 6533 a checkout code that the user may use in order to initiate a snap purchase 6536 via the user's electronic device. The user's device may then send a snap purchase checkout request 6538 to a payment network 6540. In some implementations, a XML-encoded snap purchase checkout request 6538 may take a form similar to snap purchase message 820.

In some implementations, the payment network may talk to the appropriate parties (e.g. merchant's acquirer, user's issuer, and/or the like) in order to process 6541 the snap purchase checkout transaction. In some implementations the payment network may then send a transaction receipt 6542 to the merchant 6535 so that the merchant may create a record for the transaction, and be able to verify that the user purchased the items without needing the user to complete any part of the transaction with the merchant. In some implementations the payment network may send a notification and/or transaction receipt to the user as well.

In some implementations, the shopping cart may, instead of generating a checkout code, generate and send a shopping cart checkout request 6534 directly to the merchant. In some implementations, the checkout request 6534 may take a form similar to the following:

```
POST /checkout_message.php HTTP/1.1
Host: www.ICSTproccess.com
Content-Type: Application/XML
Content-Length: 788
<?XML version = “1.0” encoding = “UTF-8”?>
<checkout_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <checkout_params>
          <date>2012-01-01 12:30:00</date >
          <merchant_ID>82719487194</merchant_ID>
          <transaction_total>24.50</transaction_total>
          <tax>1.50</tax>
    </checkout_params>
    <product_params>
          <product>
                  <ID>289786479</ID>
                  <name>Twinings &#174; Chai Ultra Spice
                  Tea</name>
                  <weight>40, g</weight>
                  <product_code>7017726772</product_code>
                  <lot_ID>908D0F989A</lot_ID>
                  <merchant_ID>9483738921</merchant_ID>
                  <price>4.99</price>
                  <aisle>7</aisle>
                  <shelf>3</shelf>
                  <expiration_date></expiration_date>
                  ...
          </product>
          <product>
                <id>098765432</id>
                <name>Sunshine &#174; Cheez-It &#174; Baked Snack
Crackers</name>
                <weight>170</weight>
                <product_code>2410070582</product_code>
                <lot_ID>9274E8AC</lot_ID>
                <merchant_ID>1155448899</merchant_ID>
                <price>3.99</price>
                <aisle>5</aisle>
                <shelf>2</shelf>
                <expiration_date>2017-02-01
                12:30:00</expiration_date>
                ...
                </product>
    </product_params>
</checkout_message>
```

In some implementations the merchant may then process 6537 the checkout transaction using the information in the checkout request, and may send a transaction receipt 6539 to the user once the checkout has been processed.

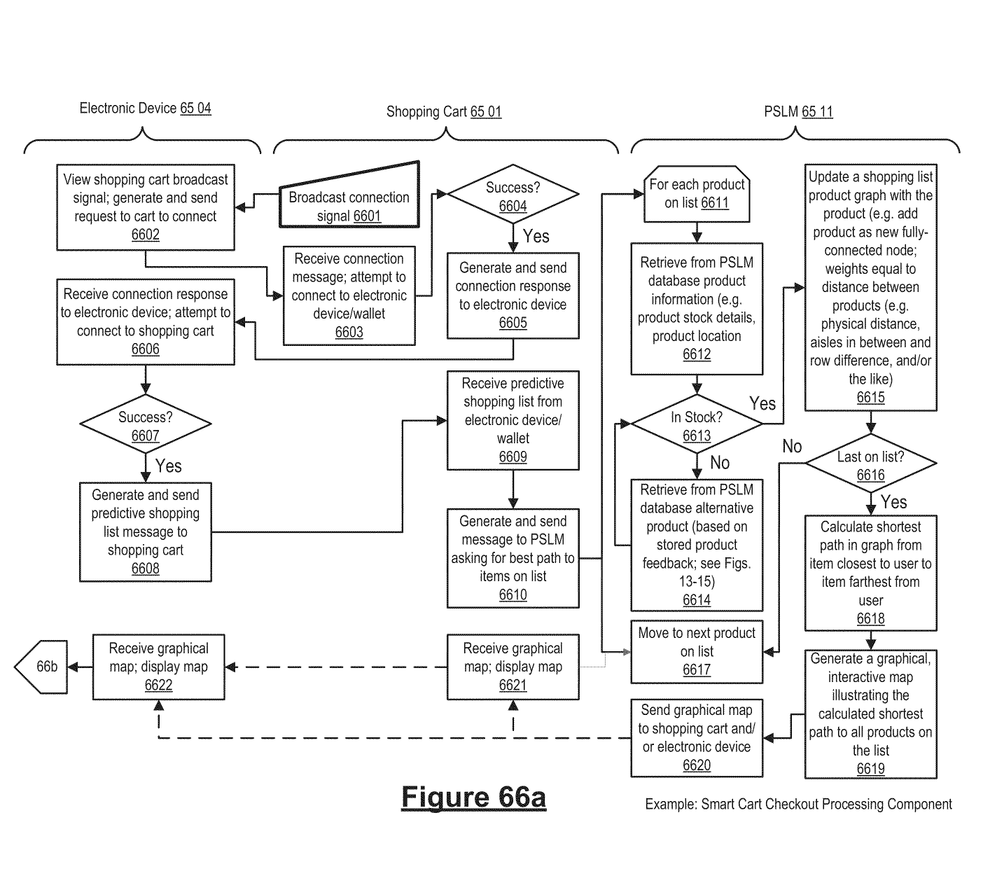

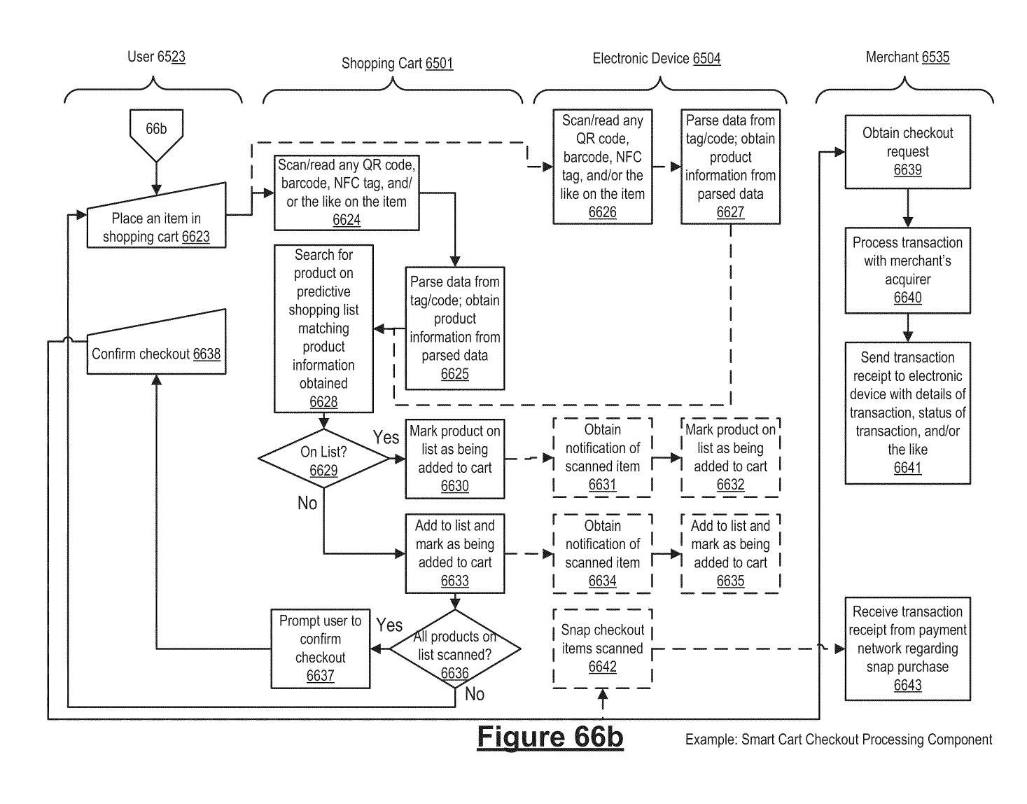

FIGS. 66a-b show logic flow diagrams illustrating using predictive shopping lusts with a smart shopping cart in some embodiments of the ICST. In some implementations, the shopping cart may broadcast a connection signal 6601, which may be picked up by the user's electronic device. In some implementations the user may view the shopping cart's broadcast signal 6602, and may send a request to the cart in order to connect to the shopping cart. In some implementations, the shopping cart may receive 6603 the connection message and may attempt to connect to the electronic device. If the connection attempt is a success 6604, then the shopping cart may send a connection response 6605 to the electronic device, which may provide information to aid the electronic device in connecting to the shopping cart. In some implementations, the electronic device may receive the connection response 6606 and may use the response information to attempt to connect to the shopping cart. If the electronic device successfully connects to the shopping cart 6607, then the electronic device may send 6608 a predictive shopping list message to the shopping cart, containing the user's predictive shopping list. The shopping cart may receive the shopping list 6609 from the electronic device, and may send a message 6610 to ICST containing the predictive shopping list and asking ICST to determine the best path to all items on the list. ICST may, for each product 6611, retrieve from the ICST database 6612 product information, such as the product location, the product availability, and/or the like. If the item is not in stock 6613, ICST may retrieve alternative products in stock 6614 from the ICST database, which may be chosen based on stored product feedback, alternative items already in the user's predictive shopping list, and/or the like. In some implementations, if the item on the list is in stock, ICST may add the product to a shopping list product graph 6615, which may include adding the product as a node to the graph, which is fully-connected to all other nodes (i.e. products) in the graph, and in which each weight is equal to the distance between the product and the other node it is attached to. In some implementations, distance may be determined by the physical distance between items, may be determined by the number of aisles in between the products (with an added weight given to products whose aisles are in different rows), and/or a like metric. In some implementations, if the item added to the graph is not the last on the list 6616, ICST may then check the next item on the list 6617. Otherwise, ICST may use the generated graph to calculate 6618 the shortest path on the graph from the item closest to the user, to the item furthest from the user, to the item closest to the checkout section of the store, to and from items chosen by the user, and/or the like. ICST may use the calculated path to generate a graphical and optionally interactive map that may illustrate the calculated shortest path to all products on the list. In some implementations, the graphical map may be a drawn map of the store, with a colored path overlay signifying how to navigate the store, and containing markers which indicate products to purchase. In other implementations, the user may view a bird's-eye image view of the store with the path overlayed on the image, along with markers indicating products on the user's list. In some implementations, ICST may send 6620 this graphical map to the shopping cart, which may display 6621 the map for the user. The user may also receive the graphical map on his/her electronic device 6622, which may also display the map for the user's convenience.

In some implementations, the user may place 6623 items in the shopping cart, and may scan and/or read codes from the product via the shopping cart 6624, or scan and/or read codes from the product via the user's electronic device 6626. In some implementations the code scanned may be a QR code, RFID tag, bar code, NFC tag, and/or a like code. In some implementations, after either the shopping cart 66250r the electronic device 6627 parses the data from the scanned code and obtains information from the parsed data (and, if applicable, after the electronic device has send a notification of a scan to the shopping cart), the shopping cart may search 6628 for the scanned product on the predictive shopping list using the product information in the code that was scanned. In some implementations, if the item is on the list 6629, the shopping cart may mark 6630 the product as being added to the cart on the shopping cart's predictive shopping list, and may additionally send a notification to the user's electronic device 6631, which may provide an indication that the item was checked off the shopping cart's list, so that the electronic device may also mark 6632 the product as being added to the cart. In some implementations, if the electronic device scans the item as it is put in the cart, the electronic device may cross the item off its own list, and may send a notification to the cart indicating the scanned item is on the list.

If the item is not on the list, the shopping cart may add the item to the list 6633 and then mark the item as being added to the cart, and may send a notification 6634 to the electronic device indicating that an item should be added to the list on the electronic device 6632 and that the item should also be marked as added to the cart. In some implementations, if the electronic device is used to scan the item, the electronic device may instead add the item to its copy of the list, mark the item as being added to the cart, and may send a message to the shopping cart indicating that an item has been added to the list and to the shopping cart. In some implementations, re-scanning an item marked off may unmark the item and/or may remove the item from the list. In some implementations, once all items on the list have been scanned 6636, the shopping cart may prompt the user to confirm checkout 6637. If the user confirms 6638 the checkout, a checkout request 6639 may be sent to the merchant, who may process the transaction 6640 and may send a transaction receipt 6641 to the user's electronic device detailing the transaction status, and/or other transaction details (e.g. total cost, items purchased in transaction, and/or the like). In some implementations, rather than sending a checkout message to the merchant, the electronic device may snap 6642 a checkout code and/or perform a like task to snap checkout the items scanned by the device and/or the shopping cart, which may involve sending a message to a payment network to process the transaction. In some implementations, the merchant may receive a transaction receipt from the payment network 6643 once the transaction has been processed in order to verify that the user has successfully purchased the items. In other implementations, the smart shopping cart may instead generate a checkout code (e.g. QR code, barcode, and/or the like) for the merchant to scan at its checkout counter via a point-of-sales (PoS) device, may generate a store injection checkout message to send to the user's electronic device so that the user may initiate a store injection transaction, and/or the like.

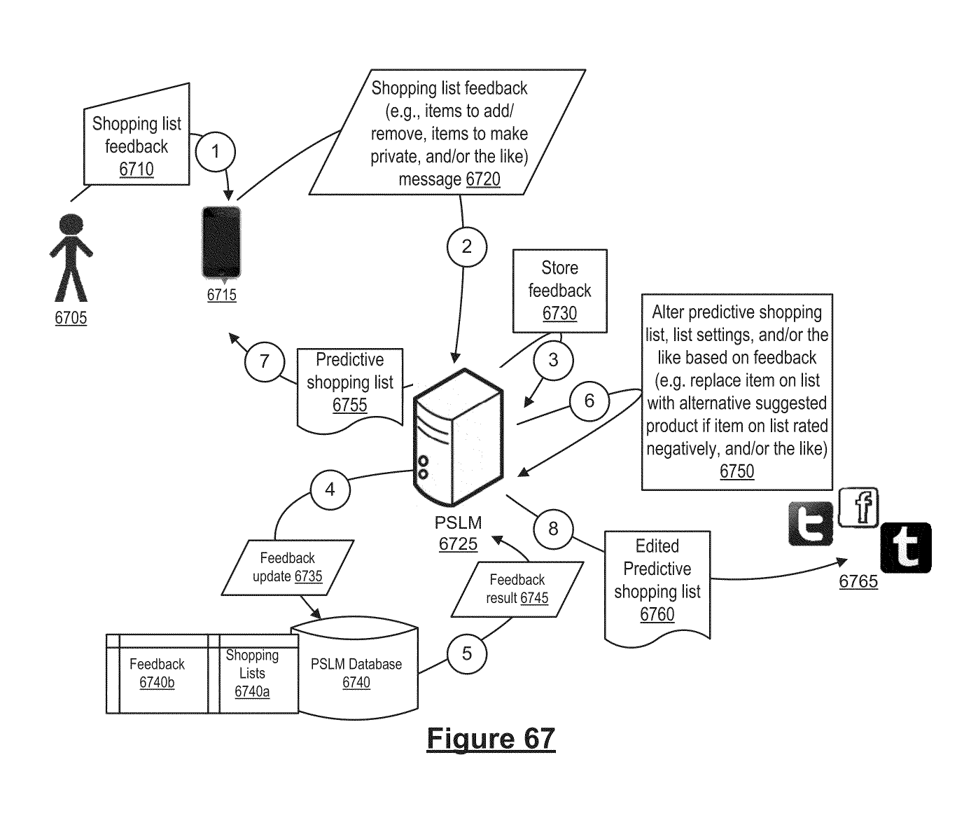

FIG. 67 shows a data flow diagram illustrating providing predictive shopping list feedback in some embodiments of the ICST. In some implementations, the user 6705 may provide feedback 6710 on items on his/her predictive shopping list by entering said feedback into his/her electronic device 6715, which may be connected to the user's electronic wallet account. In some implementations, feedback may comprise textual feedback such as comments and/or the like, numerical feedback such as ratings/scores and/or the like, and/or a like type of feedback. In some implementations, feedback may also comprise indicating new items to add, items to delete from the shopping list, items to make public/private, and/or like information. In some implementations, the electronic device may then send the feedback via a shopping list feedback message 6720 to ICST 6725. In some implementations, an XML-encoded shopping list feedback message may take a form similar to the following:

```
POST /feedback_message.php HTTP/1.1
Host: www.ICSTproccess.com
Content-Type: Application/XML
Content-Length: 788
<?XML version = “1.0” encoding = “UTF-8”?>
<feedback_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <feedback_params>
          <feedback>
                <product_ID>38749326578</product_ID>
                <from_user>567463546548</from_user>
                <rating>5</rating>
                <comment></comment>
                <visible>false</visible>
                <action>update</action>
                <GPS>40.7589905, −73.9790277</GPS>
          </feedback>
          ...
          <feedback>
                <product_ID>5637563959</product_ID>
                <from_user>567463546548</from_user>
                <rating></rating>
                <comment>Terrible taste; do not buy.</comment>
                <visible>true</visible>
                <action>remove</action>
                <GPS>40.7589905, −73.9790277</GPS>
          </feedback>
          <feedback>
                <product_ID>289786479</product_ID>
                <from_user>567463546548</from_user>
                <rating>5</rating>
                <comment>Really good tea.</comment>
                <visible>true</visible>
                <action>add</action>
                <GPS>40.7589905, −73.9790277</GPS>
          </feedback>
</feedback_params>
</feedback_message>
```

In some implementations, ICST may store 6730 the feedback information from the feedback message by sending a feedback update query 6735to the ICST database 6740 and storing the information in a new feedback record within the feedback table 6740b. After receiving a feedback result 6745 from the ICST database, ICST may update 6750 the user's predictive shopping list in the predictive shopping list table 6740a of the ICST database, based on the feedback received. For example, ICST may replace and/or add items to the predictive shopping list, may swap items on the list with alternative items suggested by ICST when the original item has negative aggregate and/or user feedback and/or when an alternate item has more positive aggregate and/or user feedback, and/or the like. ICST may then send the predictive shopping list 6755 to the user, and may allow the user to send a copy of and/or link to the list 6760 to various social networking profiles 6765 (e.g. Facebook, Twitter, and/or the like). In some implementations, the XML-encoded list may take a form similar to the following:

```
<product_list>
          <user>
                <user_ID>123456789</user_ID>
                <wallet_ID>A2C4E6G8I</wallet_ID>
          </user>
          <list_params>
                <name> Example Predictive Shopping List </name>
                <date_created>2016-01-01 12:30:00</date_created>
          </list_params>
          <replacement_products>
                <expiring>
                      ...
                </expiring>
                <smart_device>
                      ...
                </smart_device>
                <predicted_replace>
                      ...
                <predicted_replace>
          </replacement_products>
          <suggested_products>
                <personal>
                      <product>
                            ID>289786479</ID>
                            <name>Twinings &#174; Chai Ultra Spice
Tea</name>
                            <weight>40, g</weight>
                            <product_code>7017726772</product_code>
                            <lot_ID>908D0F989A</lot_ID>
                            <merchant_ID>9483738921</merchant_ID>
                            <price>4.99</price>
                            <aisle>7</aisle>
                            <shelf>3</shelf>
                            <expiration_date></expiration_date>
                            <confidence_level>0.8</confidence_level>
                            <agg_ICST_rating>4.7</agg_ICST_rating>
        <agg_external_rating>4.5</agg_external_rating>
        <feedback_IDs>87487487485,5587468786,67464687868,
...</feedback_IDs>
                            <visible>true</visible>
                            <GPS>40.7589905, −73.9790277</GPS>
                            <replenish_cycle>4, week</replenish_cycle>
                            <alt_products>587456465874,
38749326578</alt_products>
                            ...
                      </product>
                </personal>
                <social>
                      <product>
                            <ID>38749326578</ID>
                            <name>Lipton &#174; Black Tea</name>
                            <weight>40, g</weight>
                            <product_code>83487456874</product_code>
                            <lot_ID>232D2F436A</lot_ID>
                            <merchant_ID>54758487487428</merchant_ID>
                            <price>3.99</price>
                            <aisle>7</aisle>
                            <shelf>3</shelf>
                            <expiration_date></expiration_date>
                            <confidence_level>0.76</confidence_level>
                            <agg_ICST_rating>4.0</agg_ICST_rating>
                            <agg_external_rating>3.7
</agg_external_rating>
          <feedback_IDs>87487487485,5587468786,67464687868,
...</feedback_IDs>
                            <GPS>40.7589905, −73.9790277</GPS>
                            <replenish_cycle>4, week</replenish_cycle>
                            <alt_products>289786479,
97298473974</alt_products>
                            ...
                      </product>
                </social>
          </suggested_products>
</product_list>
```

FIG. 68 shows a data flow diagram illustrating receiving predictive shopping list feedback from other users in some embodiments of the ICST. In some implementations, friends, family, and/or like entities 6805 may provide their own receipts, shopping lists, and/or the like 6815 to ICST 6825. In some implementations, friends, family, and/or like entities on social networking websites 6810 where the user 6865 has provided his/her predictive shopping list may also provide feedback 6820 on the user's predictive shopping list. In some implementations, ICST may store 6830 the social network feedback, as well as the receipt and shopping list data from friends, family, and/or the like, by sending the feedback and/or the like to the ICST database 6840 via a social network feedback update query 6835. ICST may store the social network feedback in the feedback table 6840b of the ICST database, and may store the user's friends, family, and/or the like in the shopping list table 6840a of the ICST database. ICST database may send a social network feedback result 6845 back to the ICST. ICST may then alter 6850 the predictive shopping lists of the user and/or the friends, family, and/or other entities that have provided their own predictive shopping lists, based on the aggregate feedback received and based on other users' predictive shopping lists. For example, ICST may alter the user's predictive shopping list via removing a product from the list if the aggregate feedback is negative for the particular item, suggesting alternative products for the removed products based on alternative items that friends, family, and/or the like have positively rated, adding products frequently purchased by friends, family, and/or the like (and/or offering such products as alternatives to products already on the user's predictive shopping list), and/or the like. ICST may, after altering the user's predictive shopping list, may send an updated copy of the predictive shopping list 6855 to the user via the user's electronic device 6860.

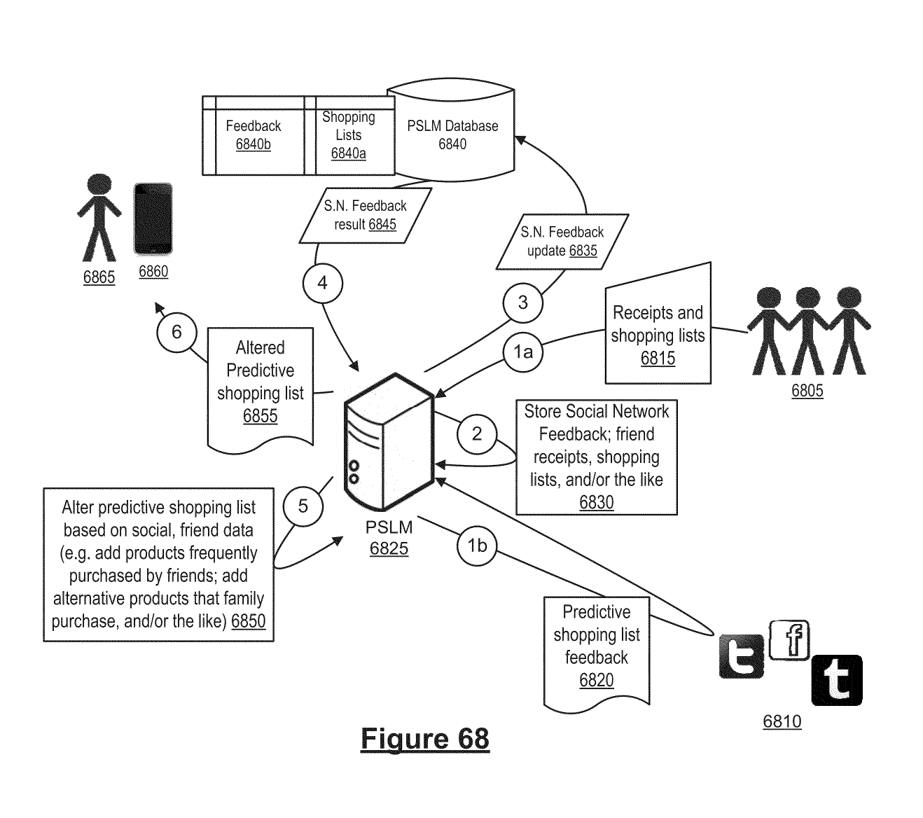

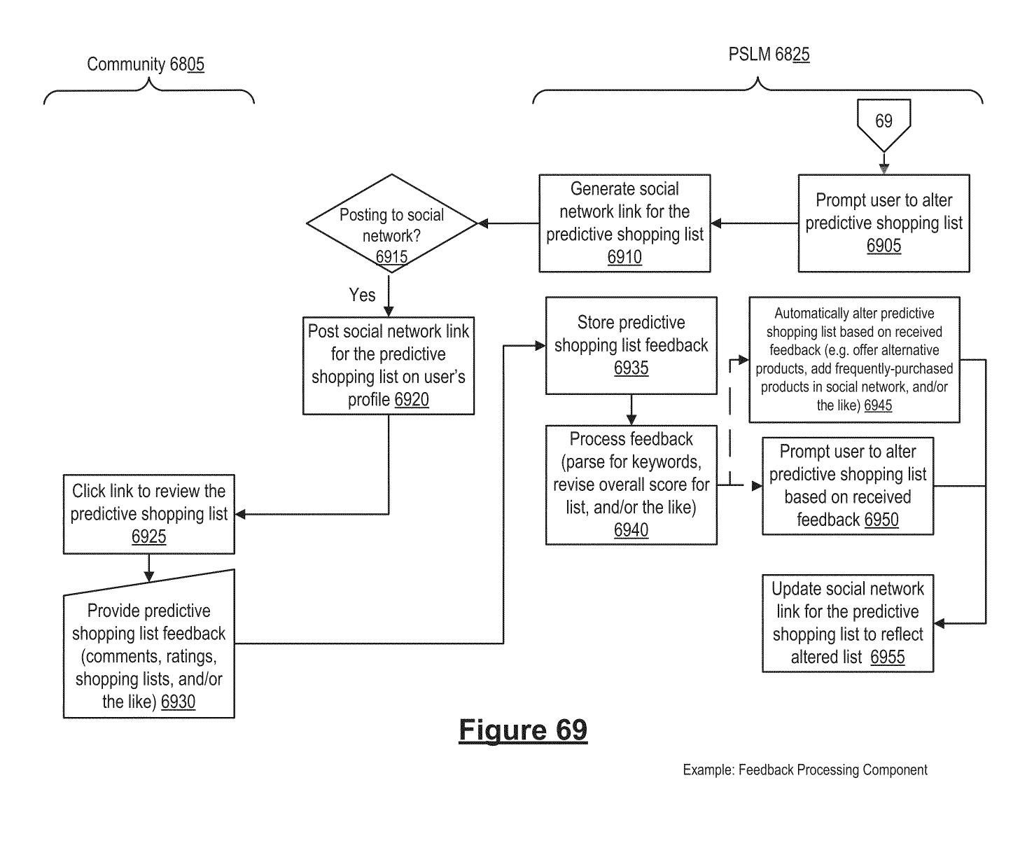

FIG. 69 shows a logic flow diagram illustrating receiving feedback for predictive shopping list in some embodiments of the ICST. In some implementations, the user may be prompted by ICST to provide feedback 6905 to their predictive shopping list, if applicable, including but not limited to commenting and/or rating the shopping list, adding/removing items on the list, swapping items on the list with items offered as alternatives to those already on the list, and/or the like. In some implementations, ICST may generate a social network link 6910 that the user may use to post the predictive shopping list on a social networking website (e.g. on Facebook, Twitter, and/or the like). In some implementations, if the user agrees to post the list to a social network 6915, the user may be provided with a number of methods of doing so, e.g., via marking a “share” setting in the predictive shopping list that may automatically add the predictive shopping list to social networking profiles specified by the user and may automatically update the shopping list if it changes, via the user manually posting the link to the predictive shopping list on a social networking website 6920, and/or the like. In some implementations, the user's social networking may then be able to interact with the link provided by ICST to review 6925 the user's predictive shopping list, and to provide feedback on the predictive shopping list 6930, including providing comments, ratings, their own receipts and/or shopping lists, and/or like input. In some implementations such feedback may be communicated to ICST, which may store 6935 the predictive shopping list feedback in the feedback table of the ICST database. ICST may also process 6940 the feedback provided (such as updating the aggregated score and/or rating of the item, parsing the comments provided for keywords to indicate the tone of the comments, parsing the community's receipts and/or shopping lists for alternative items, and/or the like). ICST may automatically 6945 alter the user's predictive shopping list based on the feedback processed, and/or may prompt the user 6950 to alter his/her predictive shopping list based on the feedback received from the community. In some implementations, altering the shopping list may be performed via adding and/or removing items from the list, reviewing alternative items and replacing items on the list based on which items received mostly negative feedback and which receive mostly positive feedback, and/or the like. In some implementations, the user may also set a threshold for how much negative feedback an item may receive before ICST automatically removes it from the user's list (e.g., the user may be able to specify that only items ranked at least 4 out of 5 starts may be kept on the list, and that any items ranked lower may be removed from the list and replaced with alternative items ranked at least 4 out of 5, and/or the like). In some implementations, ICST may then update 6955 the social network link to reflect the altered list.

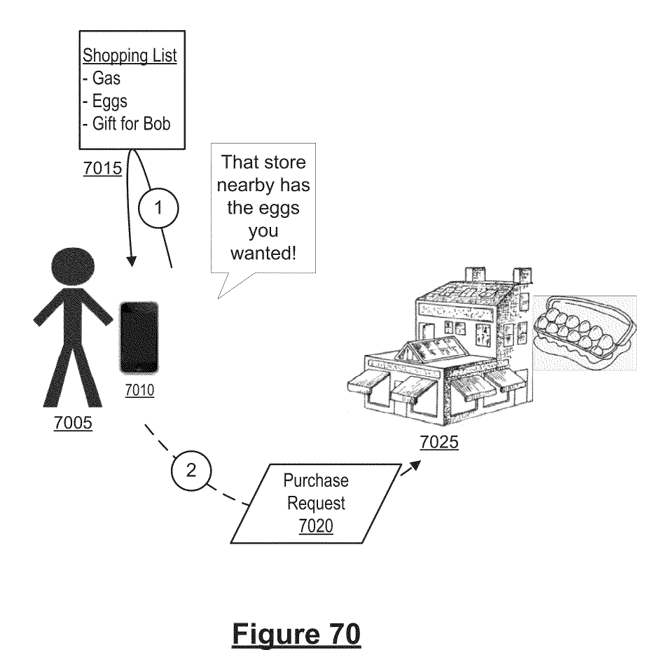

FIG. 70 shows a block diagram illustrating notifying users of nearby merchants with items on predictive shopping list in some embodiments of the ICST. In some implementations, a user 7005 may walk around in the real world, and may be notified via his/her electronic wallet-enabled device 7010 that a nearby merchant 7025 has an item on the user's predictive shopping list 7015 in stock. The user may be able to enter the store and purchase the item 7020, or may be able to purchase the item from the user's electronic device, and pick the item up once the user arrives at the merchant.

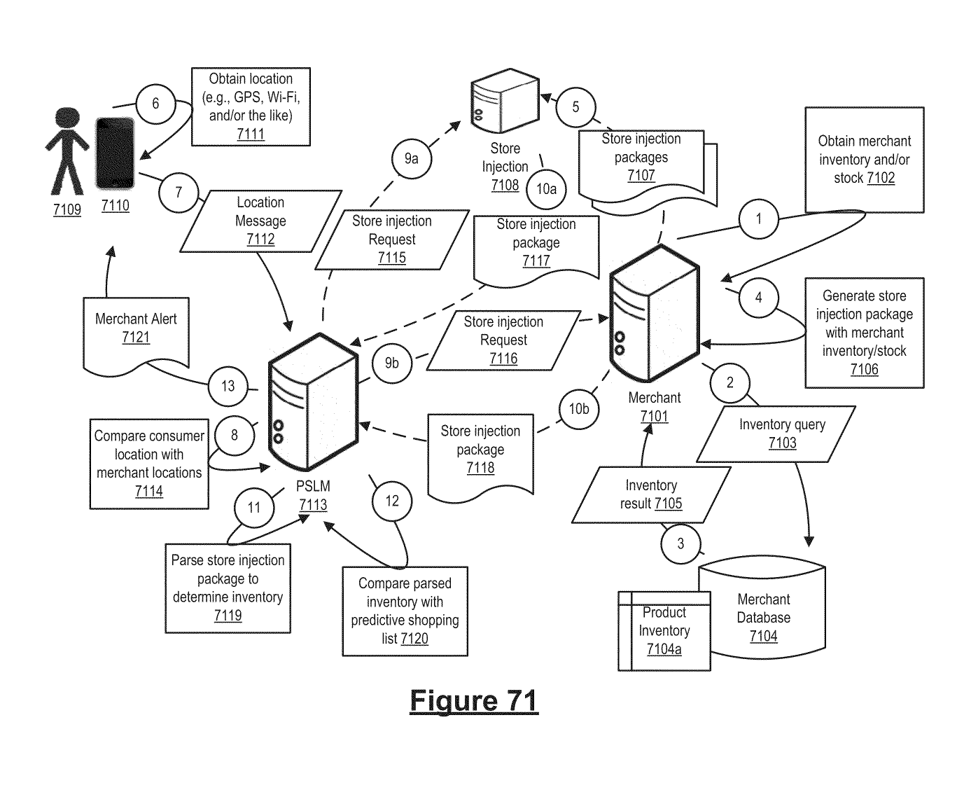

FIG. 71 shows a data flow diagram illustrating notifying users of nearby merchants with items on predictive shopping list in some embodiments of the ICST. In some implementations, a merchant 7101 may wish to generate store injection packages, and may do so via obtaining its inventory and/or stock 7102 via sending an inventory query 7103 to the merchant's database 7104. In some implementations a PHP-encoded database query 7103 may take a form similar to the following:

```
<?php
        ...
          $product_result = mysql_query(“FROM products
          SELECT * ;”);
>
```

In some implementations the database may send an inventory result 7105 containing a list of all products and their attributes, including availability of items and/or the like. The merchant may generate 7106 a store injection package containing information about the merchant's store, the merchant's inventory and/or stock, and or like information about the merchant. The merchant may then send 7107 the store injection package to a store injection server 7108 configured to pass store injection packages to entities requesting the merchant's inventory information.

In some implementations, a user 7109 may also walk around his/her real-life environment with his/her wallet-enabled electronic device 7110, which may periodically (e.g. every 20 seconds, every 5 minutes, every 20 minutes, based on a user-specified cycle period, and/or the like) obtain the location of the user (e.g. via GPS coordinates, Wi-Fi triangulation, and/or the like) 7111 and send the location information via a location message 7112 to the ICST. In some implementations a XML-encoded location message 7112 may take a form similar to the following:

```
POST /location_message.php HTTP/1.1
Host: www.ICSTproccess.com
Content-Type: Application/XML
Content-Length: 788
<?XML version = “1.0” encoding = “UTF-8”?>
<location_message>
<timestamp>2016-01-01 12:30:00</timestamp>
    <user_params>
        <user_ID>123456789</user_ID>
        <user_password>********</user_password>
        <wallet_ID>A2C4E6G8I</wallet_ID>
    </user_params>
    <location_params>
        <GPS>40.7589905, −73.9790277</GPS>
        <wifi_IPs> 50.59.105.10, 50.59.102.10, 50.59.104.3</
        wifi_IPs>
    </location_params>
</location_message>
```

In some implementations, ICST may compare the user's location with the location of merchants in the ICST database. In some implementations, the user may also be able to indicate where (s)he is going, and ICST may, rather than determining merchants near the user, may determine merchants on the user's way to his/her destination. ICST may send a store injection request 7115 to the store injection server, requesting a store injection package of the specified merchant. In some implementations a XML-encoded store injection request 7115 may take a form similar to the following:

```
POST /injection_package_message.php HTTP/1.1
Host: www.ICSTproccess.com
Content-Type: Application/XML
Content-Length: 788
<?XML version = “1.0” encoding = “UTF-8”?>
<injection_package_message>
<timestamp>2016-01-01 12:30:00</timestamp>
    <merchant_params>
        <merchant_ID>27462548458</merchant_ID>
        <merchant_name>********</merchant_name>
        <data_requested>inventory_package</data_requested>
    </merchant_params>
</injection_package_message>
```

In some implementations the store injection server may send ICST a store injection package 7117 containing the most recent inventory and/or like information the merchant has provided. In other implementations, ICST may send a similar store injection request 7116 directly to the merchant in order to receive the store inventory. The merchant may in turn directly send its store injection package 7118 to ICST. ICST may then parse 7119 the store injection package to determine the merchant's inventory, and then may compare 7120 the parsed inventory information with the products on the user's predictive shopping list. If a product on the list matches a product in the merchant's inventory, ICST may send an alert 7121 to the user indicating that a nearby merchant (and/or a merchant on the way to a pre-entered destination) has a product on the user's list.

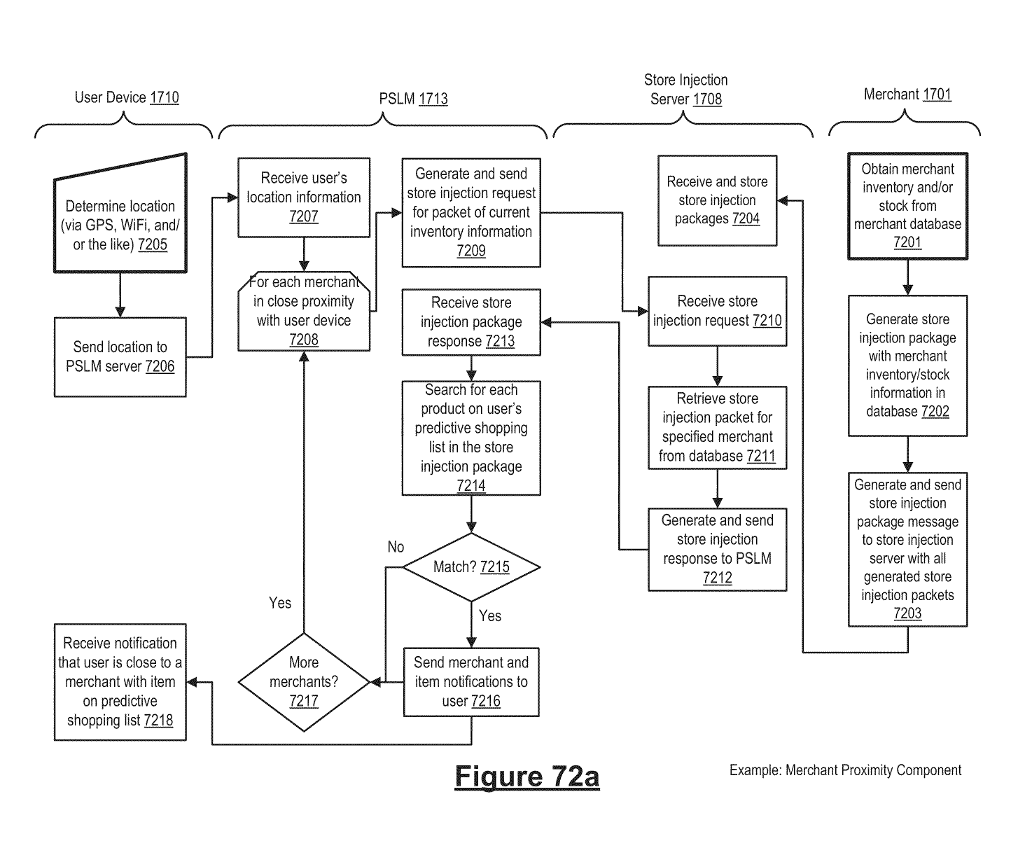

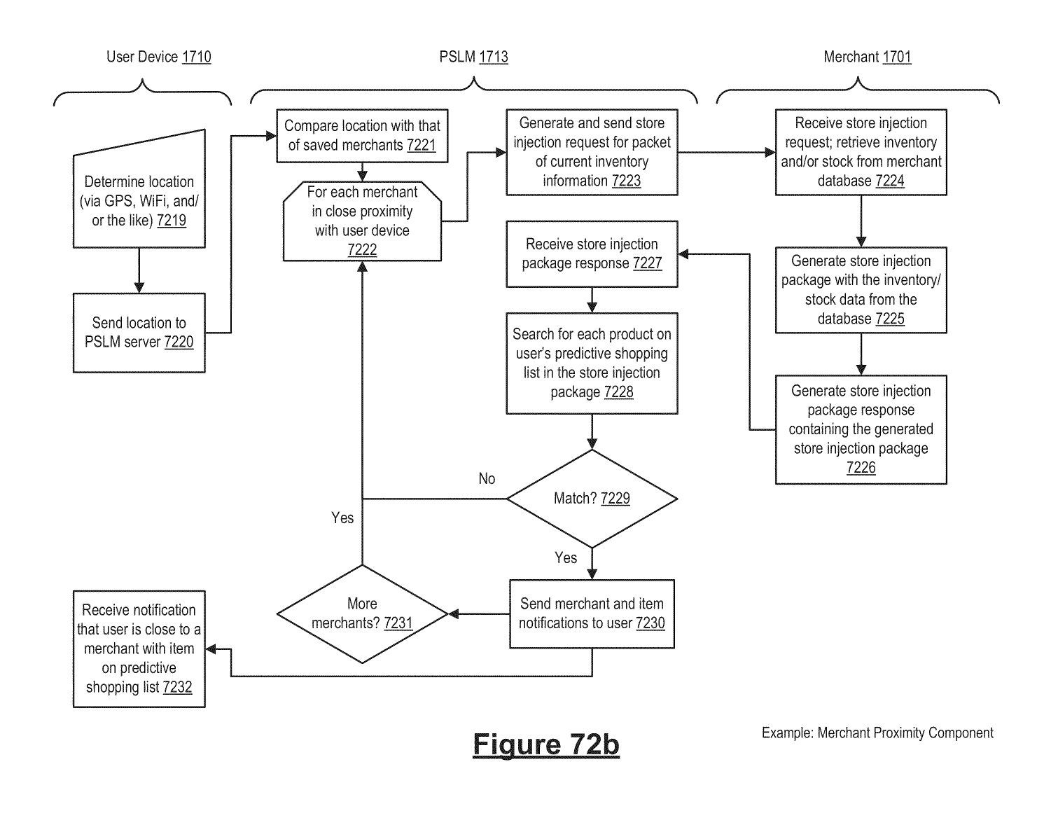

FIGS. 72a-b show logic flow diagrams illustrating notifying users of nearby merchants with items on predictive shopping list in some embodiments of the ICST. In some implementations, a merchant may obtain its inventory and/or stock 7201 from its database, and may generate 7202 a store injection package using all of the inventory information retrieved from the database. The merchant may then generate and send 7203 a store injection package message to a store injection server, which may store 7204 and keep track of all generated store injection packets, and which may also request updated packets at regular intervals which may be specified by the merchant and/or another entity.

In some implementations, the user device may also determine its location 7205 via GPS, Wi-Fi, and or a like method and/or type of data. The user's device may send 7206 the device's location to the ICST, which may, after receiving 7207 the user's location information, may, for each merchant in proximity to the user 7208, generate and send a store injection request 7209 to the store injection server asking for current inventory information. In some implementations, proximity may be gauged by physical distance to the user's current location, distance from a user-entered destination or from the path the user is taking to the destination, and/or the like. in some implementations, the store injection server may receive 7210 the request for the merchant's store injection package and may retrieve the package for the specified merchant from its database 7211. In some implementations, the store injection server may then send a store injection response 7212 to ICST containing the pertinent store injection package. ICST may receive the package response 7213 and may search the package 7214 for each product on the user's predictive shopping list. If at least one product is found 7215, ICST may send the user a merchant and item notification 7216 which, when received by the user 7218, may indicate to the user that a merchant has been found close to the user that has at least one item on the user's predictive shopping list. In some implementations, if the merchant does not have any of the user's items in its inventory and/or stock, ICST may try another merchant 7217 in close proximity to the user and/or the user's destination, and may request a store injection for the other merchant in a similar manner as described above.

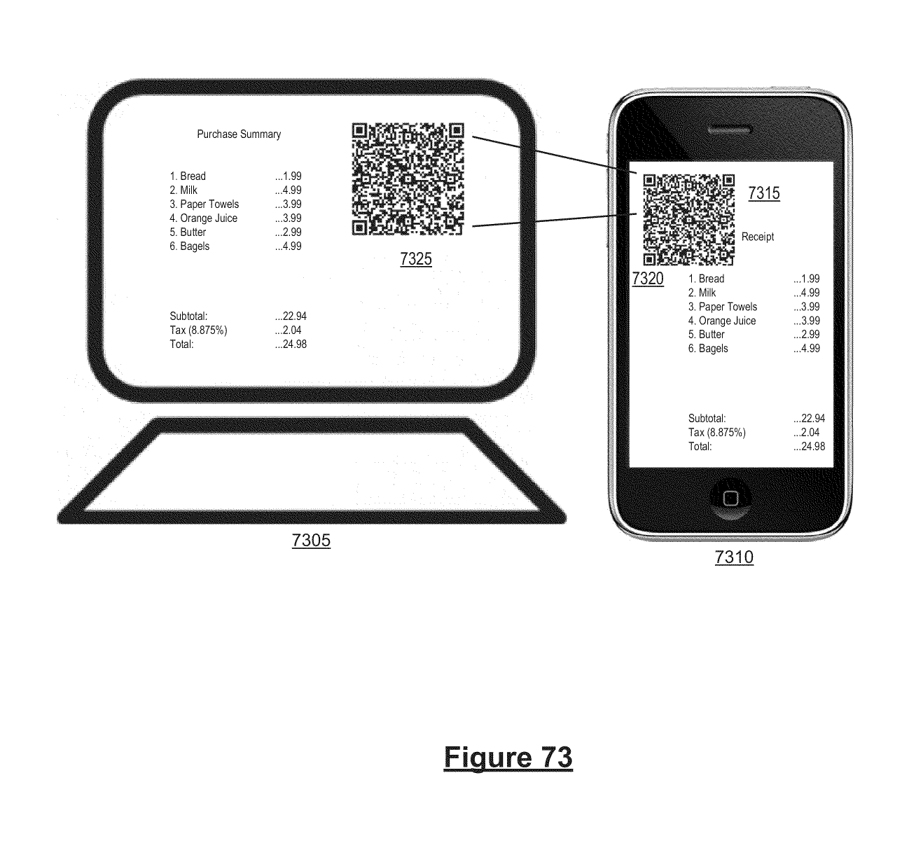

FIG. 73 shows a block diagram illustrating a PoS checkout code in some embodiments of the ICST. In some implementations, a user, after scanning all items on his/her predictive shopping list, may view on his/her electronic wallet-enabled device 7310, a receipt 7315 containing all of the items checked out, as well as a QR and/or like code 7320 that may be scanned by PoS device 7305. By scanning QR code 7320, the PoS device may be able to obtain all the information about the user's checkout 7325, including product information for all items the user plans to purchase. The PoS may then use this information for the user to check out. Alternatively, the user may checkout automatically through the electronic wallet, and the PoS may be able to scan the QR and/or like code in order to verify that the user has successfully checked out through his/her electronic wallet, and does not need to check out via the merchant's PoS.

### ICST Controller

FIG. 74 shows a block diagram illustrating example aspects of a ICST controller 7401. In this embodiment, the ICST controller 7401 may serve to aggregate, process, store, search, serve, identify, instruct, generate, match, and/or facilitate interactions with a computer through various technologies, and/or other related data.

Users, e.g., 7433a, which may be people and/or other systems, may engage information technology systems (e.g., computers) to facilitate information processing. In turn, computers employ processors to process information; such processors 7403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 7429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ICST controller 1401 may be connected to and/or communicate with entities such as, but not limited to: one or more users from user input devices 7411; peripheral devices 7412; an optional cryptographic processor device 7428; and/or a communications network 7413. For example, the ICST controller 7401 may be connected to and/or communicate with users, e.g., 7433a, operating client device(s), e.g., 7433b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ICST controller 7401 may be based on computer systems that may comprise, but are not limited to, components such as: a computer systemization 7402 connected to memory 7429.

### Computer Systemization

A computer systemization 7402 may comprise a clock 7430, central processing unit (“CPU(s)” and/or “processor(s)” (these terms are used interchangeably throughout the disclosure unless noted to the contrary)) 7403, a memory 7429 (e.g., a read only memory (ROM) 7406, a random access memory (RAM) 7405, etc.), and/or an interface bus 7407, and most frequently, although not necessarily, are all interconnected and/or communicating through a system bus 7404 on one or more (mother)board(s) 7402 having conductive and/or otherwise transportive circuit pathways through which instructions (e.g., binary encoded signals) may travel to effectuate communications, operations, storage, etc. The computer systemization may be connected to a power source 7486; e.g., optionally the power source may be internal. Optionally, a cryptographic processor 7426 and/or transceivers (e.g., ICs) 7474 may be connected to the system bus. In another embodiment, the cryptographic processor and/or transceivers may be connected as either internal and/or external peripheral devices 7412 via the interface bus I/O. In turn, the transceivers may be connected to antenna(s) 7475, thereby effectuating wireless transmission and reception of various communication and/or sensor protocols; for example the antenna(s) may connect to: a Texas Instruments WiLink WL1283 transceiver chip (e.g., providing 802.1 in, Bluetooth 3.0, FM, global positioning system (GPS) (thereby allowing ICST controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM47501UB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 7429 beyond the processor itself; internal memory may include, but is not limited to: fast registers, various levels of cache memory (e.g., level 7, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core 2 (2/Duo/i3/i5/i7), Itanium, Pentium, Xeon, and/or XScale, and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the ICST controller and beyond through various interfaces. Should processing requirements dictate a greater amount speed and/or capacity, distributed processors (e.g., Distributed ICST), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the ICST may be achieved by implementing a microcontroller such as CAST's R8051XC2 microcontroller; Intel's MCS 51 (i.e., 8051 microcontroller); and/or the like. Also, to implement certain features of the ICST, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ICST component collection (distributed or otherwise) and/or features may be implemented via the microprocessor and/or via embedded components; e.g., via ASIC, coprocessor, DSP, FPGA, and/or the like. Alternately, some implementations of the ICST may be implemented with embedded components that are configured and used to achieve a variety of features or signal processing.

Depending on the particular implementation, the embedded components may include software solutions, hardware solutions, and/or some combination of both hardware/software solutions. For example, ICST features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ICST features. A hierarchy of programmable interconnects allow logic blocks to be interconnected as needed by the ICST system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the ICST may be developed on regular FPGAs and then migrated into a fixed version that more resembles ASIC implementations. Alternate or coordinating implementations may migrate ICST controller features to a final ASIC instead of or in addition to FPGAs. Depending on the implementation all of the aforementioned embedded components and microprocessors may be considered the “CPU” and/or “processor” for the ICST.

### Power Source

The power source 7486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 7486 is connected to at least one of the interconnected subsequent components of the ICST thereby providing an electric current to all the interconnected components. In one example, the power source 7486 is connected to the system bus component 7404. In an alternative embodiment, an outside power source 7486 is provided through a connection across the I/O 7408 interface. For example, a USB and/or IEEE 7394 connection carries both data and power across the connection and is therefore a suitable source of power.

### Interface Adapters

Interface bus(ses) 7407 may accept, connect, and/or communicate to a number of interface adapters, frequently, although not necessarily in the form of adapter cards, such as but not limited to: input output interfaces (I/O) 7408, storage interfaces 7409, network interfaces 7410, and/or the like. Optionally, cryptographic processor interfaces 7427 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 7409 may accept, communicate, and/or connect to a number of storage devices such as, but not limited to: storage devices 7414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 7394, Ethernet, fiber channel, Small Computer Systems Interface (SCSI), Thunderbolt, Universal Serial Bus (USB), and/or the like.

Network interfaces 7410 may accept, communicate, and/or connect to a communications network 7413. Through a communications network 7413, the ICST controller is accessible through remote clients 7433b (e.g., computers with web browsers) by users 7433a. Network interfaces may employ connection protocols such as, but not limited to: direct connect, Ethernet (thick, thin, twisted pair 70/100/1000 Base T, and/or the like), Token Ring, wireless connection such as IEEE 802.11a-x, and/or the like. Should processing requirements dictate a greater amount speed and/or capacity, distributed network controllers (e.g., Distributed ICST), architectures may similarly be employed to pool, load balance, and/or otherwise increase the communicative bandwidth required by the ICST controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 7410 may be used to engage with various communications network types 7413. For example, multiple network interfaces may be employed to allow for the communication over broadcast, multicast, and/or unicast networks.

Input Output interfaces (I/O) 7408 may accept, communicate, and/or connect to user input devices 7411, peripheral devices 7412, cryptographic processor devices 7428, and/or the like. I/O may employ connection protocols such as, but not limited to: audio: analog, digital, monaural, RCA, stereo, and/or the like; data: Apple Desktop Bus (ADB), Bluetooth, IEEE 7394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x, Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 7411 often are a type of peripheral device 7412 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 7412 may be connected and/or communicate to I/O and/or other facilities of the like such as network interfaces, storage interfaces, directly to the interface bus, system bus, the CPU, and/or the like. Peripheral devices may be external, internal and/or part of the ICST controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 7428), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the ICST controller may be embodied as an embedded, dedicated, and/or monitor-less (i.e., headless) device, wherein access would be provided over a network interface connection.

Cryptographic units such as, but not limited to, microcontrollers, processors 7426, interfaces 7427, and/or devices 7428 may be attached, and/or communicate with the ICST controller. A MC68HC16 microcontroller, manufactured by Motorola Inc., may be used for and/or within cryptographic units. The MC68HC16 microcontroller utilizes a 76-bit multiply-and-accumulate instruction in the 76 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 784; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 7429. However, memory is a fungible technology and resource, thus, any number of memory embodiments may be employed in lieu of or in concert with one another. It is to be understood that the ICST controller and/or a computer systemization may employ various forms of memory 7429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 7429 may include ROM 7406, RAM 7405, and a storage device 7414. A storage device 7414 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 7429 may contain a collection of program and/or database components and/or data such as, but not limited to: operating system component(s) 7415(operating system); information server component(s) 7416 (information server); user interface component(s) 7417 (user interface); Web browser component(s) 7418 (Web browser); database(s) 7419; mail server component(s) 7421; mail client component(s) 7422; cryptographic server component(s) 7420 (cryptographic server); the ICST component(s) 7435; and/or the like (i.e., collectively a component collection). These components may be stored and accessed from the storage devices and/or from storage devices accessible through an interface bus. Although non-conventional program components such as those in the component collection may be stored in a local storage device 7414, they may also be loaded and/or stored in memory such as: peripheral devices, RAM, remote storage facilities through a communications network, ROM, various forms of memory, and/or the like.

### Operating System

The operating system component 7415 is an executable program component facilitating the operation of the ICST controller. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ICST controller to communicate with other entities through a communications network 7413. Various communication protocols may be used by the ICST controller as a subcarrier transport mechanism for interaction, such as, but not limited to: multicast, TCP/IP, UDP, unicast, and/or the like.

### Information Server

An information server component 7416 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols 24 (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ICST controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ICST database 7419, operating systems, other program components, user interfaces, Web browsers, and/or the like.

Access to the ICST database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ICST. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ICST as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/18 Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 7417 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 7418 is a stored program component that is executed by a CPU. The Web browser may be a hypertext viewing application such as Goofle's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 728 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the ICST equipped nodes. The combined application may be nugatory on systems employing standard Web browsers.

### Mail Server

A mail server component 7421 is a stored program component that is executed by a CPU 7403. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ICST.

Access to the ICST mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 7422 is a stored program component that is executed by a CPU 7403. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 7420 is a stored program component that is executed by a CPU 7403, cryptographic processor 7426, cryptographic processor interface 7427, cryptographic processor device 7428, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5(MD5, which is a one way hash operation), passwords, Rivest Cipher (RC5), Rijndael, RSA (which is an Internet encryption and authentication system that uses an algorithm developed in 7977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ICST may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the ICST component to engage in secure transactions if so desired. The cryptographic component facilitates the secure accessing of resources on the ICST and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ICST Database

The ICST database component 7419 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ICST database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ICST database is implemented as a data-structure, the use of the ICST database 7419 may be integrated into another component such as the ICST component 7435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 7419 includes several tables 7419a-o. A Users table 7419a may include fields such as, but not limited to: user_id, ssn, dob, first_name, last_name, age, state, address_firstline, address_secondline, zipcode, devices_list, contact_info, hardware_id, contact_type, alt_contact_info, alt_contact_type, UserPricacySetting, and/or the like. The Users table may support and/or track multiple entity accounts on an EISA. An Accounts table 7419b may include fields such as, but not limited to: user_id, account_firstname, account_lastname, username, user_password, password_question, question_answer, site_key, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Robots table 7419c may include fields such as, but not limited to: user_id, robot_id, robot_ip, robot_MAC, robot_type, robot_model, operating_system, os_version, app_installed_flag, application_id, application_version, application_vendor, application_trademark, and/or the like. A Transactions table 7419d may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_liner, billingaddress_line2, billing_zipcode, billing_state, shipping_preferences, shippingaddress_line1, shippingaddress_line2, shipping_zipcode, shipping_state, agent_id, agent_name, agent_auth_key, and/or the like. An Issuers table 7419e may include fields such as, but not limited to: issuer_id, issuer_name, issuer_address, ip_address, mac_address, auth_key, port_num, security_settings_list, and/or the like. A Batch Data table 7419f may include fields such as, but not limited to: batch_id, transaction_id_list, timestamp_list, cleared_flag_list, clearance_trigger_settings, and/or the like. A Payment Ledger table 7419g may include fields such as, but not limited to: request_id, timestamp, deposit_amount, batch_id, transaction_id, clear_flag, deposit_account, transaction_summary, payor_name, payor_account, and/or the like. An Analysis Requests table 7419h may include fields such as, but not limited to: user_id, password, request_id, timestamp, request_details_list, time_period, time_interval, area_scope, area_resolution, spend_sector_list, client_id, client_ip, client_model, operating_system, os_version, app_installed_flag, and/or the like. A Normalized Templates table 7419i may include fields such as, but not limited to: transaction_record_list, norm_flag, timestamp, transaction_cost, biller_params_list, agent_id, agent_name, agent_auth_key, agent_products_list, num_products, product_list, product_type, product_name, class_labels_list, product_quantity, unit_value, subtotal, comment, user_account_params, account_name, account_type, account_num, billing_line1, billing_line2, zipcode, state, country, phone, sign, and/or the like. A Classification Rules table 7419j may include fields such as, but not limited to: rule_id, rule_name, inputs_list, operations_list, outputs_list, thresholds_list, and/or the like. A Strategy Parameters table 7419k may include fields such as, but not limited to: strategy_id, strategy_params_list, regression_models_list, regression_equations_list, regression_coefficients_list, fit_goodness_list, lsm_values_list, and/or the like. A merchant table 7419l includes fields such as, but not limited to: MerchantID, MerchantName, MerchantType, MerchantTerminalID, MerchantAddress, MerchantGPS, MerchantURL, MerchantTransactionID, MerchantReferralMax, and/or the like. A Message table 7419m includes fields such as, but not limited to: MessageID, MessageType, MessageUserID, MessageFormat, MessageOriginatorID, MessageDestinationID, MessageHeader, MessageFieldNo, MessageFieldValue, MessageChannel, and/or the like. A Solution table 7419n includes fields such as, but not limited to: SolutionID, User_ID, Request_ID, SolutionConsumerID, SolutionFeedsID, SolutionMerchantID, TriggreType, SolutionTime, SolutionContent, SolutionCategory, SolutionPublishing, and/or the like. A Service Request table 7419o includes fields such as, but not limited to: UserID, UserName, TimeStamp, request_content, request, request_robot_id, request_server_id, request_app_id, request_app_version, and/or the like.

In further implementations, the data base component 7419 may further comprise data tables 7499a-w related to a centralized personal information management platform. For example, In one embodiment, the database component 7419 includes several tables 7499a-w. A Users table 7499a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a ICST. A Devices table 7499b may include fields such as, but not limited to: device_id, user_id, client_ip, client_type, client_model, operating_system, os_version, app_installed_flag, and/or the like. An Apps table 7499c may include fields such as, but not limited to: app_id, app_name, app_type, OS_compatibilities_list, version, timestamp, developer_id, and/or the like. An Accounts table 7499d may include fields such as, but not limited to: account_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Merchants table 7499e may include fields such as, but not limited to: merchant_id, merchant_name, provi merchant_address, ip_address, mac_address, auth_key, port_num, security_settings_list, and/or the like. An Issuers table 7499f may include fields such as, but not limited to: issuer_id, issuer_name, issuer_address, ip_address, mac_address, auth_key, port_num, security_settings_list, and/or the like. An Acquirers table 7499g may include fields such as, but not limited to: acquirer_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Gateways table 7499h may include fields such as, but not limited to: gateway_id, gateway_name, merchant_id, issuer_id, acquirer_id, user_id, and/or the like. A Transactions table 7499i may include fields such as, but not limited to: transaction_id, order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 7499j may include fields such as, but not limited to: batch_id, parent_batch_id, transaction_id, account_id, user_id, app_id, batch_rules, and/or the like. A Ledgers table 7499k may include fields such as, but not limited to: ledger_id, transaction_id, user_id, merchant_id, issuer_id, acquirer_id, aggregation_id, ledger_name, ledger_value, and/or the like. A Products table 7499l may include fields such as, but not limited to: product_id, product_name, sku, price, inventory_level, stores_carrying, unit_of_measure, and/or the like. A Offers table 7499m may include fields such as, but not limited to: offer_id, merchant_id, offered_to_user_id, offer_type, offer_description, start_date, end_date, num_times_redeemed, and/or the like. A Behavior table 7499n may include fields such as, but not limited to: behavior_id, user_id, behavior_description, behavior_type, behavior_value, date_time_behavior, and/or the like. An Analytics table 7499o may include fields such as, but not limited to: analytics_id, batch_id, user_id, transaction_id, generated_graph, generated_results_set, generated_results_set_json, input_data_set, date_time_generated, and/or the like. A Market Data table 7499p may include fields such as, but not limited to: market data_id, index_name, index_value, last_updated_index_datetime, and/or the like. An Input Languages table 7499q may include fields such as, but not limited to: input language_id, function_name, function_definition, parent_input_language_id, mesh_language_id, user_id, tumbler_id, aggregation_id, and/or the like. A Mesh Language table 7499r may include fields such as, but not limited to: mesh_language_id, operation_name, operation_min_test_case, operation_max_test_case, operation_custom_test_case, mesh_language_version, mesh_language_updated_date, and/or the like. A Tumblars table 7499s may include fields such as, but not limited to: tumbler_id, user_visible_model_commands, non_user_visible_model_commands, input_key, output_key, and/or the like. An Aggregation table 7499t may include fields such as, but not limited to: aggregation_id, aggregation data source, key, value, parent aggregation_id, and/or the like. A Category table 7499u may include fields such as, but not limited to: category_id, mesh_id, user_id, category_name, category_type, entity_name, is_present_in_mesh, and/or the like. A Mesh table 7499v may include fields such as, but not limited to: mesh_id, mesh_node, mesh_node_value, mesh_edge, mesh_edge_value, mesh_link, mesh_link_value, attributes, tags, keywords, and/or the like. A Price Trends table 7499w may include fields such as, but not limited to: price_trends_id, merchant_id, date_price_observed, number_observations, observed_price, next check date, inventory quantity, and/or the like.

In one embodiment, the ICST database may interact with other database systems. For example, employing a distributed database system, queries and data access by search ICST component may treat the combination of the ICST database, an integrated data security layer database as a single database entity.

In one embodiment, user programs may contain various user interface primitives, which may serve to update the ICST. Also, various accounts may require custom database tables depending upon the environments and the types of clients the ICST may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 7419a-o. The ICST may be configured to keep track of various settings, inputs, and parameters via database controllers.

The ICST database may communicate to and/or with other components in a component collection, including itself, and/or facilities of the like. Most frequently, the ICST database communicates with the ICST component, other program components, and/or the like. The database may contain, retain, and provide information regarding other nodes and data.

### The ICSTs

The ICST component 7435 is a stored program component that is executed by a CPU. In one embodiment, the ICST component incorporates any and/or all combinations of the aspects of the ICST discussed in the previous figures. As such, the ICST affects accessing, obtaining and the provision of information, services, transactions, and/or the like across various communications networks. The features and embodiments of the ICST discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the ICST's features and facilities, and in many cases reduce the costs, energy consumption/requirements, and extend the life of ICST's underlying infrastructure; this has the added benefit of making the ICST more reliable. Similarly, many of the features and mechanisms are designed to be easier for users to use and access, thereby broadening the audience that may enjoy/employ and exploit the feature sets of the ICST; such ease of use also helps to increase the reliability of the ICST. In addition, the feature sets include heightened security as noted via the Cryptographic components 7420, 7426, 7428 and throughout, making access to the features and data more reliable and secure.

The ICST component may transform user service request inputs (e.g., 206a in FIG. 2A) via ICST components such as, but not limited to request processing 7442 (e.g., 315 in FIG. 3A), solution query 7444 (e.g., FIG. 3B), data cloud management 7445 and or the like into service solution (e.g., 226b in FIG. 2A), and/or like use of the ICST. In another implementation, The ICST component may transform data aggregated from various computer resources via ICST components into updated entity profiles and/or social graphs, and/or the like and use of the ICST. In one embodiment, the ICST component 7435 takes inputs such as aggregated data from various computer resources, and transforms the inputs via various components (e.g., SRA 7441, CTE 7442, TDA 7443 SDA 7444, VASE 7445, DFR 7446, ETC 7447, CEC 7448, EAA 7449, EPGU 7450, STG 7451, MA 7452, UBPA 7453, UPI 7454, TDN 7455, CTC 7456, TDF 7457, CDA 7458, ESA 7459, BAR 7460, AMS 7461, ADRN 7462, EXC 7463, CRA 7464, and/or the like), into outputs such as updated entity profiles and social graphs within the ICST.

The ICST component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ICST server employs a cryptographic server to encrypt and decrypt communications. The ICST component may communicate to and/or with other components in a component collection, including itself, and/or facilities of the like. Most frequently, the ICST component communicates with the ICST database, operating systems, other program components, and/or the like. The ICST may contain, communicate, generate, obtain, and/or provide program component, system, user, and/or data communications, requests, and/or responses.

### Distributed ICSTs

The structure and/or operation of any of the ICST node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ICST controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ICST controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 7024 byte blocks until end of
message
do {
          $input = “”;
          $input = socket_read($client, 7024);
          $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference herein.

Additional embodiments of the ICST may include:

1. An encryptmatics extensible markup language data conversion processor-implemented system for increased efficiency in contextless user model sharing through the use of intermediary meta-language processing, comprising:
means to receive an input model containing non-meta-data based language commands;
means to retrieve input language definition records corresponding to the input model language commands;
means to retrieve meta-data based language definition records; and
means to generate a meta-data based language command file using the input language definition records and the meta-based language definition records.

2. The system of embodiment 1, additionally comprising:
means to determine at least one non-conditional logic flow block in the input model language commands; and
means to generate a meta-data based language execution block for the at least one non-conditional logic flow block.

3. The system of embodiment 1, additionally comprising:
means to determine a meta-data based language variable initialization template; and
means to create a meta-data based language content block based on the variable initialization template and non-variable definitions contained within the input language model commands.

4. The system of embodiment 1, additionally comprising:
means to determine that the input model language commands contain instructions to manipulate an external data source; and
means to determine that the external data source contains data that may not be used by the input model.

5. The system of embodiment 4, additionally comprising:
means to execute iterative sequential anonymization commands on the external data source;
means to determine that the external data source is available for use by the input model; and
means to provide the anonymized external data source to the input model commands for model execution on the anonymized data.

6. The system of embodiment 5, wherein determining that the external data source is available for use by the input model includes an indication that a minimum count of iterative sequential anonymization commands have been executed on the external data source.

7. The system of embodiment 1, additionally comprising:
means to provide the meta-data based language command file to a user model sharing service if it is determined that the model does not contain commands to manipulate an external data source that contains data requiring anonymization.

8. The system of embodiment 1, wherein the input language definition records contain executable logic commands.

9. The system of embodiment 8, wherein the executable logic commands are in a different language than the input model.

10. The system of embodiment 1, additionally comprising:
means to determine a mapping between the retrieved input language definition record contents and the retrieved meta-data based language definition record contents.

11. The system of embodiment 1, additionally comprising:
means to determine an offset spanning function required by an input language operation.

12. The system of embodiment 11, wherein the offset spanning function includes a plurality of input language commands.

13. The system of embodiment 11, wherein determining an offset spanning function additionally comprises:
means to execute an upper bound input language operation test.

14. The system of embodiment 11, wherein determining an offset spanning function additionally comprises:
means to execute a lower bound input language operation test.

15. The system of embodiment 11, wherein determining an offset spanning function additionally comprises:
means to execute a user defined input language operation test.

16. The system of embodiment 1, wherein the meta-data based language command file is extensible markup language.

17. The system of embodiment 1, wherein the meta-data based language command file is JSON.

18. The system of embodiment 1, wherein the input model is created using a non-compiled interpreted language.

Additional embodiments of the ICST may include:

1. An encryptmatics extensible markup language data conversion processor-implemented apparatus for increased efficiency in contextless user model sharing through the use of intermediary meta-language processing, comprising:

a memory;

a processor disposed in communication with said memory, and configured to issue a plurality of processing instructions stored in the memory, wherein the processor issues instructions to:
receive an input model containing non-meta-data based language commands;
retrieve input language definition records corresponding to the input model language commands;
retrieve meta-data based language definition records; and
generate a meta-data based language command file using the input language definition records and the meta-based language definition records.

2. The apparatus of embodiment 1, additionally comprising instructions to:
determine at least one non-conditional logic flow block in the input model language commands; and
generate a meta-data based language execution block for the at least one non-conditional logic flow block.

3. The apparatus of embodiment 1, additionally comprising instructions to:
determine a meta-data based language variable initialization template; and
create a meta-data based language content block based on the variable initialization template and non-variable definitions contained within the input language model commands.

4. The apparatus of embodiment 1, additionally comprising instructions to:
determine that the input model language commands contain instructions to manipulate an external data source; and
determine that the external data source contains data that may not be used by the input model.

5. The apparatus of embodiment 4, additionally comprising instructions to:
execute iterative sequential anonymization commands on the external data source;
determine that the external data source is available for use by the input model; and
provide the anonymized external data source to the input model commands for model execution on the anonymized data.

6. The apparatus of embodiment 5, wherein determining that the external data source is available for use by the input model includes an indication that a minimum count of iterative sequential anonymization commands have been executed on the external data source.

7. The apparatus of embodiment 1, additionally comprising instructions to:
provide the meta-data based language command file to a user model sharing service if it is determined that the model does not contain commands to manipulate an external data source that contains data requiring anonymization.

8. The apparatus of embodiment 1, wherein the input language definition records contain executable logic commands.

9. The apparatus of embodiment 8, wherein the executable logic commands are in a different language than the input model.

10. The apparatus of embodiment 1, additionally comprising instructions to:
determine a mapping between the retrieved input language definition record contents and the retrieved meta-data based language definition record contents.

11. The apparatus of embodiment 1, additionally comprising instructions to:
determine an offset spanning function required by an input language operation.

12. The apparatus of embodiment 11, wherein the offset spanning function includes a plurality of input language commands.

13. The apparatus of embodiment 11, wherein determining an offset spanning function additionally comprises instructions to:
execute an upper bound input language operation test.

14. The apparatus of embodiment 11, wherein determining an offset spanning function additionally comprises instructions to:
execute a lower bound input language operation test.

15. The apparatus of embodiment 11, wherein determining an offset spanning function additionally comprises instructions to:
execute a user defined input language operation test.

16. The apparatus of embodiment 1, wherein the meta-data based language command file is extensible markup language.

17. The apparatus of embodiment 1, wherein the meta-data based language command file is JSON.

18. The apparatus of embodiment 1, wherein the input model is created using a non-compiled interpreted language.

Additional embodiments of the ICST may include:

1. A non-transitory medium storing processor-issuable instructions for encryptmatics extensible markup language data conversion to:
receive an input model containing non-meta-data based language commands;
retrieve input language definition records corresponding to the input model language commands;
retrieve meta-data based language definition records; and
generate a meta-data based language command file using the input language definition records and the meta-based language definition records.

2. The medium of embodiment 1, additionally comprising instructions to:
determine at least one non-conditional logic flow block in the input model language commands; and
generate a meta-data based language execution block for the at least one non-conditional logic flow block.

3. The medium of embodiment 1, additionally comprising instructions to:
determine a meta-data based language variable initialization template; and
create a meta-data based language content block based on the variable initialization template and non-variable definitions contained within the input language model commands.

4. The medium of embodiment 1, additionally comprising instructions to:
determine that the input model language commands contain instructions to manipulate an external data source; and
determine that the external data source contains data that may not be used by the input model.

5. The medium of embodiment 4, additionally comprising instructions to:
execute iterative sequential anonymization commands on the external data source;
determine that the external data source is available for use by the input model; and
provide the anonymized external data source to the input model commands for model execution on the anonymized data.

6. The medium of embodiment 5, wherein determining that the external data source is available for use by the input model includes an indication that a minimum count of iterative sequential anonymization commands have been executed on the external data source.

7. The medium of embodiment 1, additionally comprising instructions to:
provide the meta-data based language command file to a user model sharing service if it is determined that the model does not contain commands to manipulate an external data source that contains data requiring anonymization.

8. The medium of embodiment 1, wherein the input language definition records contain executable logic commands.

9. The medium of embodiment 8, wherein the executable logic commands are in a different language than the input model.

10. The medium of embodiment 1, additionally comprising instructions to:
determine a mapping between the retrieved input language definition record contents and the retrieved meta-data based language definition record contents.

11. The medium of embodiment 1, additionally comprising instructions to:
determine an offset spanning function required by an input language operation.

12. The medium of embodiment 11, wherein the offset spanning function includes a plurality of input language commands.

13. The medium of embodiment 11, wherein determining an offset spanning function additionally comprises instructions to:
execute an upper bound input language operation test.

14. The medium of embodiment 11, wherein determining an offset spanning function additionally comprises instructions to:
execute a lower bound input language operation test.

15. The medium of embodiment 11, wherein determining an offset spanning function additionally comprises instructions to:
execute a user defined input language operation test.

16. The medium of embodiment 1, wherein the meta-data based language command file is extensible markup language.

17. The medium of embodiment 1, wherein the meta-data based language command file is JSON.

18. The medium of embodiment 1, wherein the input model is created using a non-compiled interpreted language.

Additional embodiments of the ICST may include:

1. A centralized personal information platform processor-implemented method for enhancing transaction speed through the reduction of user input data transfer requirements, comprising:
aggregating data records including search results, purchase transaction data, service usage data, service enrollment data, email data and social data;
identifying data field types within the data records and their associated data values;
identifying an entity from the data field types and their associated data values;
generating, via a processor, correlations of the entity to other entities identifiable from the data field types and their associated data values;
associating, via the processor, attributes to the entity by drawing inferences related to the entity from the data field types and their associated data values;
generating an updated profile and social graph of the entity using the generated correlations and associated attributes; and
providing the updated profile and social graph for an automated web form filling request.

2. The method of embodiment 1, further comprising:
generating a search query using the updated profile; and
providing the generated search query for further data aggregation.

3. The method of embodiment 2, wherein the search query is a web search query.

4. The method of embodiment 2, wherein the search query is a social search query.

5. The method of embodiment 2, wherein the search query is an email data aggregation query.

6. The method of embodiment 4, wherein the updated profile includes a social login credential; and wherein the social search query utilizes the social login credential.

7. The method of embodiment 1, further comprising:
generating a search query using the updated social graph; and
providing the generated search query for further data aggregation.

8. The method of embodiment 6, wherein the search query is a web search query.

9. The method of embodiment 6, wherein the search query is a social search query.

10. The method of embodiment 8, wherein the updated profile includes a social login credential; and wherein the social search query utilizes the social login credential.

11. The method of embodiment 1, wherein the entity is one of: an Internet Protocol address; an individual; a pair of associated individuals; and a household; an office space; and an organization.

12. A merchant analytics platform processor-implemented method for reduced transaction wait processing requirements through the use of customized transaction parameters based on a distributed linking node mesh, comprising:
obtaining a request for a merchant analytics report including a user identification;
aggregating user data of the user in a centralized personal information database;
retrieving the aggregated user data in response to obtaining the request for the merchant analytics report;
generating a user behavior profile using an analytical model, based on the aggregated user data retrieved from the centralized personal information database;
providing the user behavior profile as part of the merchant analytics report.

13. The method of embodiment 12, further comprising:
retrieving aggregated user data for a plurality of users from the centralized personal information database;
generating a statistical user behavior profile using an analytical model, based on the aggregated user data for the plurality of users retrieved from the centralized personal information database; and
providing the statistical user behavior profile as part of the merchant analytics report for the merchant.

14. The method of embodiment 12, wherein the retrieved aggregated user data includes personally identifiable data associated with the user identification.

15. The method of embodiment 14, further comprising:
anonymizing the retrieved aggregated user data by removing the personally identifiable data from the retrieved aggregated user data.

16. The method of embodiment 12, wherein the aggregated user data includes social data obtained from a social networking website.

17. The method of embodiment 16, wherein the user behavior profile is generated using the social data obtained from the social networking website.

18. The method of embodiment 18, wherein the social data includes user social posts to the social networking website.

19. The method of embodiment 12, further comprising:
determining a product or service having maximum likelihood of being purchased by the user; and
providing an identification of the product or service as part of the merchant analytics report.

20. The method of embodiment 13, wherein the statistical user behavior profile is generated using aggregated social data obtained from social networking websites for the plurality of users, and retrieved from the centralized personal information database.

21. The method of embodiment 12, further comprising:
triggering an investment action based on the merchant analytics report.

22. An analytical model sharing processor-implemented method for privacy enhanced analytical model sharing through the use of contextual privacy dataset modifications, comprising:
obtaining a request to publish an analytical model operating on user data retrieved from a centralized personal information database;
determining whether the analytical model includes a model dataset;
upon determining that the analytical model includes a model dataset, determining whether the model dataset includes personally identifiable information; and
generating a determination of whether to accept the request to publish the analytical model based on whether the model dataset includes personally identifiable information.

23. The method of embodiment 22, further comprising:
determining that model dataset does not include personally identifiable information;
generating a notification of acceptance of the request to publish the analytical model;
providing the analytical model for publication; and
providing the notification of acceptance of the request to publish the analytical model.

24. The method of embodiment 22, further comprising:
determining that model dataset includes personally identifiable information;
upon determining that the model dataset includes personally identifiable information, determining whether the analytical model can be run in the absence of the personally identifiable information; and
generating a determination of whether to accept the request to publish the analytical model based on whether the analytical model can be run in the absence of the personally identifiable information.

25. The method of embodiment 24, further comprising:
determining that analytical model can be run in the absence of the personally identifiable information;
extracting the personally identifiable information from the model dataset;
providing the analytical model for publication excluding the personally identifiable information from the model dataset; and
providing the notification of acceptance of the request to publish the analytical model.

26. The method of embodiment 24, further comprising:
determining that the analytical model cannot be run in the absence of the personally identifiable information;
upon determining that the analytical model cannot be run in the absence of the personally identifiable information, determining whether the analytical model can be run after anonymization of the personally identifiable information; and
generating a determination of whether to accept the request to publish the analytical model based on whether the analytical model can be run after anonymization of the personally identifiable information.

27. The method of embodiment 26, further comprising:
determining that the analytical model can be run after anonymization of the personally identifiable information;
anonymizing the personally identifiable information in the model dataset;
providing the analytical model for publication including the anonymized personally identifiable information in the model dataset; and
providing the notification of acceptance of the request to publish the analytical model.

28. The method of embodiment 26, further comprising:
determining that the analytical model cannot be run after anonymization of the personally identifiable information; and
providing a notification of rejection of the request to publish the analytical model.

29. The method of embodiment 22, wherein the user data retrieved from a centralized personal information database is that of a single user.

30. The method of embodiment 22, wherein the user data retrieved from a centralized personal information database is aggregated user data.

31. The method of embodiment 22, wherein the analytical model is published to a publicly-accessible model sharing website.

32. An encryptmatics extensible markup language data conversion processor-implemented method for increased efficiency in contextless user model sharing through the use of intermediary meta-language processing, comprising:
receiving an input model containing non-meta-data based language commands;
retrieving input language definition records corresponding to the input model language commands;
retrieving meta-data based language definition records; and
generating a meta-data based language command file using the input language definition records and the meta-based language definition records.

33. The method of embodiment 32, additionally comprising:
determining at least one non-conditional logic flow block in the input model language commands; and
generating a meta-data based language execution block for the at least one non-conditional logic flow block.

34. The method of embodiment 32, additionally comprising:
determining a meta-data based language variable initialization template; and
creating a meta-data based language content block based on the variable initialization template and non-variable definitions contained within the input language model commands.

35. The method of embodiment 32, additionally comprising:
determining that the input model language commands contain instructions to manipulate an external data source;
determining that the external data source contains data that may not be used by the input model;
executing iterative sequential anonymization commands on the external data source; determining that the external data source is available for use by the input model; and
providing the anonymized external data source to the input model commands for model execution on the anonymized data.

36. The method of embodiment 35, wherein determining that the external data source is available for use by the input model includes an indication that a minimum count of iterative sequential anonymization commands have been executed on the external data source.

37. The method of embodiment 32, additionally comprising:
providing the meta-data based language command file to a user model sharing service if it is determined that the model does not contain commands to manipulate an external data source that contains data requiring anonymization.

38. An processor-implemented method, comprising:
aggregating, from a plurality of entities, raw mesh entries comprising any of: emails, engagement transactions, financial transactions, social media entries, into memory;
determining an mesh entry type for each raw mesh entry;
placing contents of each raw mesh entry into an unprocessed mesh entry structure;
setting the mesh entry type for the unprocessed mesh entry from the determined mesh entry type;
generating a dictionary hash entry from the raw mesh entry and saving it into the unprocessed mesh entry structure;
updating a mesh entry dictionary with the unprocessed mesh entry structure;
replicating the mesh entry dictionary to another location without the raw mesh entry in the mesh entry structure, wherein the replicated mesh entry dictionary is actionable for analysis without the raw mesh entry and with the dictionary has entry and set mesh entry type;
storing the unprocessed mesh entry structure into a multi-directionally linked multimedia data mesh (MLMD mesh);
determining correlations within the unprocessed mesh entry structure with other stored mesh entry structures in the MLMD mesh;
creating links to the determined correlated stored mesh entry structures and storing them in the stored unprocessed mesh entry structure;
marking the unprocessed mesh entry structure as a processed mesh entry structure.

39. The method of embodiment 38, wherein processed mesh entry structures are updated with category, interest group, product type, price, and location information.

40. The method of embodiment 39, further, comprising:

obtaining a purchase request for a specified interest group, a specified interest group qualifier, an unspecified merchant, an unspecified product for a specified amount.

41. The method of embodiment 40, further, comprising:

wherein the unspecified product is determined by a consumer specified interest group qualifier of the specified interest group.

42. The method of embodiment 41, wherein the consumer specified interest group qualifier is any of best, most popular, most expensive, most exclusive, best deal.

43. The method of embodiment 42, further, comprising:

quering the MLMD mesh with the purchase request for a specified amount;

obtaining MLMD mesh query results for the purchase request;

querying merchants with the MLMD mesh query results for purchase items satisfying the purchase request;

placing an order for purchase items satisfying the purchase request.

44. The method of embodiment 43, further, comprising:

wherein if no purchase items satisfy the purchase request, the purchase request is maintained until cancelled.

45. The method of embodiment 44, further, comprising:

wherein the maintained purchase request may result in a purchase when merchant items satisfy the purchase request as such items parameters change with time.

46. A centralized personal information platform processor-implemented system for enhancing transaction speed through the reduction of user input data transfer requirements, comprising:
means to aggregate data records including search results, purchase transaction data, service usage data, service enrollment data, email data and social data;
means to identify data field types within the data records and their associated data values;
means to identify an entity from the data field types and their associated data values;
means to generate, via a processor, correlations of the entity to other entities identifiable from the data field types and their associated data values;
means to associate, via the processor, attributes to the entity by drawing inferences related to the entity from the data field types and their associated data values;
means to generate an updated profile and social graph of the entity using the generated correlations and associated attributes; and
means to provide the updated profile and social graph for an automated web form filling request.

47. The system of embodiment 46, further comprising:
means to generate a search query using the updated profile; and
means to provide the generated search query for further data aggregation.

48. The system of embodiment 47, wherein the search query is a web search query.

49. The system of embodiment 47, wherein the search query is a social search query.

50. The system of embodiment 47, wherein the search query is an email data aggregation query.

51. The system of embodiment 49, wherein the updated profile includes a social login credential; and wherein the social search query utilizes the social login credential.

52. The system of embodiment 46, further comprising:
means to generate a search query using the updated social graph; and
means to provide the generated search query for further data aggregation.

53. The system of embodiment 51, wherein the search query is a web search query.

54. The system of embodiment 51, wherein the search query is a social search query.

55. The system of embodiment 53, wherein the updated profile includes a social login credential; and wherein the social search query utilizes the social login credential.

56. The system of embodiment 46, wherein the entity is one of: an Internet Protocol address; an individual; a pair of associated individuals; and a household; an office space; and an organization.

57. A merchant analytics platform processor-implemented system for reduced transaction wait processing requirements through the use of customized transaction parameters based on a distributed linking node mesh, comprising:
means to obtain a request for a merchant analytics report including a user identification;
means to aggregate user data of the user in a centralized personal information database;
means to retrieve the aggregated user data in response to obtaining the request for the merchant analytics report;
means to generate a user behavior profile using an analytical model, based on the aggregated user data retrieved from the centralized personal information database;
means to provide the user behavior profile as part of the merchant analytics report.

58. The system of embodiment 57, further comprising:
means to retrieve aggregated user data for a plurality of users from the centralized personal information database;
means to generate a statistical user behavior profile using an analytical model, based on the aggregated user data for the plurality of users retrieved from the centralized personal information database; and
means to provide the statistical user behavior profile as part of the merchant analytics report for the merchant.

59. The system of embodiment 57, wherein the retrieved aggregated user data includes personally identifiable data associated with the user identification.

60. The system of embodiment 59, further comprising:
means to anonymize the retrieved aggregated user data by removing the personally identifiable data from the retrieved aggregated user data.

61. The system of embodiment 57, wherein the aggregated user data includes social data obtained from a social networking website.

62. The system of embodiment 61, wherein the user behavior profile is generated using the social data obtained from the social networking website.

63. The system of embodiment 63, wherein the social data includes user social posts to the social networking website.

64. The system of embodiment 57, further comprising:
means to determine a product or service having maximum likelihood of being purchased by the user; and
means to provide an identification of the product or service as part of the merchant analytics report.

65. The system of embodiment 58, wherein the statistical user behavior profile is generated using aggregated social data obtained from social networking websites for the plurality of users, and retrieved from the centralized personal information database.

66. The system of embodiment 57, further comprising:
means to trigger an investment action based on the merchant analytics report.

67. An analytical model sharing processor-implemented system for privacy enhanced analytical model sharing through the use of contextual privacy dataset modifications, comprising:
means to obtain a request to publish an analytical model operating on user data retrieved from a centralized personal information database;
means to determine whether the analytical model includes a model dataset;
means to upon determining that the analytical model includes a model dataset, determining whether the model dataset includes personally identifiable information; and
means to generate a determination of whether to accept the request to publish the analytical model based on whether the model dataset includes personally identifiable information.

68. The system of embodiment 67, further comprising:
means to determine that model dataset does not include personally identifiable information;
means to generate a notification of acceptance of the request to publish the analytical model;
means to provide the analytical model for publication; and
means to provide the notification of acceptance of the request to publish the analytical model.

69. The system of embodiment 67, further comprising:
means to determine that model dataset includes personally identifiable information;
means to upon determining that the model dataset includes personally identifiable information, determining whether the analytical model can be run in the absence of the personally identifiable information; and
means to generate a determination of whether to accept the request to publish the analytical model based on whether the analytical model can be run in the absence of the personally identifiable information.

70. The system of embodiment 69, further comprising:
means to determine that analytical model can be run in the absence of the personally identifiable information;
means to extract the personally identifiable information from the model dataset;
means to provide the analytical model for publication excluding the personally identifiable information from the model dataset; and
means to provide the notification of acceptance of the request to publish the analytical model.

71. The system of embodiment 69, further comprising:
means to determine that the analytical model cannot be run in the absence of the personally identifiable information;
means to upon determining that the analytical model cannot be run in the absence of the personally identifiable information, determining whether the analytical model can be run after anonymization of the personally identifiable information; and
means to generate a determination of whether to accept the request to publish the analytical model based on whether the analytical model can be run after anonymization of the personally identifiable information.

72. The system of embodiment 71, further comprising:
means to determine that the analytical model can be run after anonymization of the personally identifiable information;
means to anonymize the personally identifiable information in the model dataset;
means to provide the analytical model for publication including the anonymized personally identifiable information in the model dataset; and
means to provide the notification of acceptance of the request to publish the analytical model.

73. The system of embodiment 71, further comprising:
means to determine that the analytical model cannot be run after anonymization of the personally identifiable information; and
means to provide a notification of rejection of the request to publish the analytical model.

74. The system of embodiment 67, wherein the user data retrieved from a centralized personal information database is that of a single user.

75. The system of embodiment 67, wherein the user data retrieved from a centralized personal information database is aggregated user data.

76. The system of embodiment 67, wherein the analytical model is published to a publicly-accessible model sharing website.

77. An encryptmatics extensible markup language data conversion processor-implemented system for increased efficiency in contextless user model sharing through the use of intermediary meta-language processing, comprising:
means to receive an input model containing non-meta-data based language commands;
means to retrieve input language definition records corresponding to the input model language commands;
means to retrieve meta-data based language definition records; and
means to generate a meta-data based language command file using the input language definition records and the meta-based language definition records.

78. The system of embodiment 77, additionally comprising:
means to determine at least one non-conditional logic flow block in the input model language commands; and
means to generate a meta-data based language execution block for the at least one non-conditional logic flow block.

79. The system of embodiment 77, additionally comprising:
means to determine a meta-data based language variable initialization template; and
means to create a meta-data based language content block based on the variable initialization template and non-variable definitions contained within the input language model commands.

80. The system of embodiment 77, additionally comprising:
means to determine that the input model language commands contain instructions to manipulate an external data source;
means to determine that the external data source contains data that may not be used by the input model;
means to execute iterative sequential anonymization commands on the external data source; determining that the external data source is available for use by the input model; and
means to provide the anonymized external data source to the input model commands for model execution on the anonymized data.

81. The system of embodiment 80, wherein determining that the external data source is available for use by the input model includes an indication that a minimum count of iterative sequential anonymization commands have been executed on the external data source.

82. The system of embodiment 77, additionally comprising:
means to provide the meta-data based language command file to a user model sharing service if it is determined that the model does not contain commands to manipulate an external data source that contains data requiring anonymization.

83. An processor-implemented system, comprising:

means to aggregate, from a plurality of entities, raw mesh entries comprising any of: emails, engagement transactions, financial transactions, social media entries, into memory;

means to determine an mesh entry type for each raw mesh entry;

means to place contents of each raw mesh entry into an unprocessed mesh entry structure;

means to set the mesh entry type for the unprocessed mesh entry from the determined mesh entry type;

means to generate a dictionary hash entry from the raw mesh entry and saving it into the unprocessed mesh entry structure;

means to update a mesh entry dictionary with the unprocessed mesh entry structure;

means to replicate the mesh entry dictionary to another location without the raw mesh entry in the mesh entry structure, wherein the replicated mesh entry dictionary is actionable for analysis without the raw mesh entry and with the dictionary has entry and set mesh entry type;

means to store the unprocessed mesh entry structure into a multi-directionally linked multimedia data mesh (MLMD mesh);

means to determine correlations within the unprocessed mesh entry structure with other stored mesh entry structures in the MLMD mesh;

means to create links to the determined correlated stored mesh entry structures and storing them in the stored unprocessed mesh entry structure;

means to mark the unprocessed mesh entry structure as a processed mesh entry structure.

84. The system of embodiment 83, wherein processed mesh entry structures are updated with category, interest group, product type, price, and location information.

85. The system of embodiment 84, further, comprising:

means to obtain a purchase request for a specified interest group, a specified interest group qualifier, an unspecified merchant, an unspecified product for a specified amount.

86. The system of embodiment 85, further, comprising:

wherein the unspecified product is determined by a consumer specified interest group qualifier of the specified interest group.

87. The system of embodiment 86, wherein the consumer specified interest group qualifier is any of best, most popular, most expensive, most exclusive, best deal.

88. The system of embodiment 87, further, comprising:

means to query the MLMD mesh with the purchase request for a specified amount;

means to obtainin MLMD mesh query results for the purchase request;

means to query merchants with the MLMD mesh query results for purchase items satisfying the purchase request;

means to place an order for purchase items satisfying the purchase request.

89. The system of embodiment 88, further, comprising:

wherein if no purchase items satisfy the purchase request, the purchase request is maintained until cancelled.

90. The system of embodiment 89, further, comprising:

wherein the maintained purchase request may result in a purchase when merchant items satisfy the purchase request as such items parameters change with time.

91. A centralized personal information platform processor-implemented apparatus for enhancing transaction speed through the reduction of user input data transfer requirements, comprising:

a memory;

a processor disposed in communication with said memory, and configured to issue a plurality of processing instructions stored in the memory, wherein the processor issues instructions to:
aggregate data records including search results, purchase transaction data, service usage data, service enrollment data, email data and social data;
identify data field types within the data records and their associated data values;
identify an entity from the data field types and their associated data values;
generate, via a processor, correlations of the entity to other entities identifiable from the data field types and their associated data values;
associate, via the processor, attributes to the entity by drawing inferences related to the entity from the data field types and their associated data values;
generate an updated profile and social graph of the entity using the generated correlations and associated attributes; and
provide the updated profile and social graph for an automated web form filling request.

92. The apparatus of embodiment 91, further comprising instructions to:
generate a search query using the updated profile; and
provide the generated search query for further data aggregation.

93. The apparatus of embodiment 92, wherein the search query is a web search query.

94. The apparatus of embodiment 92, wherein the search query is a social search query.

95. The apparatus of embodiment 92, wherein the search query is an email data aggregation query.

96. The apparatus of embodiment 94, wherein the updated profile includes a social login credential; and wherein the social search query utilizes the social login credential.

97. The apparatus of embodiment 91, further comprising instructions to:
generate a search query using the updated social graph; and
provide the generated search query for further data aggregation.

98. The apparatus of embodiment 96, wherein the search query is a web search query.

99. The apparatus of embodiment 96, wherein the search query is a social search query.

100. The apparatus of embodiment 98, wherein the updated profile includes a social login credential; and wherein the social search query utilizes the social login credential.

101. The apparatus of embodiment 91, wherein the entity is one of: an Internet Protocol address; an individual; a pair of associated individuals; and a household; an office space; and an organization.

102. A merchant analytics platform processor-implemented apparatus for reduced transaction wait processing requirements through the use of customized transaction parameters based on a distributed linking node mesh, comprising:

a memory;

a processor disposed in communication with said memory, and configured to issue a plurality of processing instructions stored in the memory, wherein the processor issues instructions to:
obtainin a request for a merchant analytics report including a user identification;
aggregate user data of the user in a centralized personal information database;
retrieve the aggregated user data in response to obtaining the request for the merchant analytics report;
generate a user behavior profile using an analytical model, based on the aggregated user data retrieved from the centralized personal information database;
provide the user behavior profile as part of the merchant analytics report.

103. The apparatus of embodiment 102, further comprising instructions to:
retrieve aggregated user data for a plurality of users from the centralized personal information database;
generate a statistical user behavior profile using an analytical model, based on the aggregated user data for the plurality of users retrieved from the centralized personal information database; and
provide the statistical user behavior profile as part of the merchant analytics report for the merchant.

104. The apparatus of embodiment 102, wherein the retrieved aggregated user data includes personally identifiable data associated with the user identification.

105. The apparatus of embodiment 104, further comprising instructions to:
anonymize the retrieved aggregated user data by removing the personally identifiable data from the retrieved aggregated user data.

106. The apparatus of embodiment 102, wherein the aggregated user data includes social data obtained from a social networking website.

107. The apparatus of embodiment 106, wherein the user behavior profile is generated using the social data obtained from the social networking website.

108. The apparatus of embodiment 108, wherein the social data includes user social posts to the social networking website.

109. The apparatus of embodiment 102, further comprising instructions to:
determine a product or service having maximum likelihood of being purchased by the user; and
provide an identification of the product or service as part of the merchant analytics report.

110. The apparatus of embodiment 103, wherein the statistical user behavior profile is generated using aggregated social data obtained from social networking websites for the plurality of users, and retrieved from the centralized personal information database.

111. The apparatus of embodiment 102, further comprising instructions to:
trigger an investment action based on the merchant analytics report.

112. An analytical model sharing processor-implemented apparatus for privacy enhanced analytical model sharing through the use of contextual privacy dataset modifications, comprising:

a memory;

a processor disposed in communication with said memory, and configured to issue a plurality of processing instructions stored in the memory, wherein the processor issues instructions to:
obtain a request to publish an analytical model operating on user data retrieved from a centralized personal information database;
determine whether the analytical model includes a model dataset;
upon determining that the analytical model includes a model dataset, determining whether the model dataset includes personally identifiable information; and
generate a determination of whether to accept the request to publish the analytical model based on whether the model dataset includes personally identifiable information.

113. The apparatus of embodiment 112, further comprising instructions to:
determine that model dataset does not include personally identifiable information;
generate a notification of acceptance of the request to publish the analytical model;
provide the analytical model for publication; and
provide the notification of acceptance of the request to publish the analytical model.

114. The apparatus of embodiment 112, further comprising instructions to:
determine that model dataset includes personally identifiable information;
upon determining that the model dataset includes personally identifiable information, determining whether the analytical model can be run in the absence of the personally identifiable information; and
generate a determination of whether to accept the request to publish the analytical model based on whether the analytical model can be run in the absence of the personally identifiable information.

115. The apparatus of embodiment 114, further comprising instructions to:
determine that analytical model can be run in the absence of the personally identifiable information;
extract the personally identifiable information from the model dataset;
provide the analytical model for publication excluding the personally identifiable information from the model dataset; and
provide the notification of acceptance of the request to publish the analytical model.

116. The apparatus of embodiment 114, further comprising instructions to:
determine that the analytical model cannot be run in the absence of the personally identifiable information;
upon determining that the analytical model cannot be run in the absence of the personally identifiable information, determining whether the analytical model can be run after anonymization of the personally identifiable information; and
generate a determination of whether to accept the request to publish the analytical model based on whether the analytical model can be run after anonymization of the personally identifiable information.

117. The apparatus of embodiment 116, further comprising instructions to:
determine that the analytical model can be run after anonymization of the personally identifiable information;
anonymize the personally identifiable information in the model dataset;
provide the analytical model for publication including the anonymized personally identifiable information in the model dataset; and
provide the notification of acceptance of the request to publish the analytical model.

118. The apparatus of embodiment 116, further comprising instructions to:
determine that the analytical model cannot be run after anonymization of the personally identifiable information; and
provide a notification of rejection of the request to publish the analytical model.

119. The apparatus of embodiment 112, wherein the user data retrieved from a centralized personal information database is that of a single user.

120. The apparatus of embodiment 112, wherein the user data retrieved from a centralized personal information database is aggregated user data.

121. The apparatus of embodiment 112, wherein the analytical model is published to a publicly-accessible model sharing website.

122. An encryptmatics extensible markup language data conversion processor-implemented apparatus for increased efficiency in contextless user model sharing through the use of intermediary meta-language processing, comprising:

a memory;

a processor disposed in communication with said memory, and configured to issue a plurality of processing instructions stored in the memory, wherein the processor issues instructions to:
receive an input model containing non-meta-data based language commands;
retrieve input language definition records corresponding to the input model language commands;
retrieve meta-data based language definition records; and
generate a meta-data based language command file using the input language definition records and the meta-based language definition records.

123. The apparatus of embodiment 122, additionally comprising instructions to:
determine at least one non-conditional logic flow block in the input model language commands; and
generate a meta-data based language execution block for the at least one non-conditional logic flow block.

124. The apparatus of embodiment 122, additionally comprising instructions to:
determine a meta-data based language variable initialization template; and
create a meta-data based language content block based on the variable initialization template and non-variable definitions contained within the input language model commands.

125. The apparatus of embodiment 122, additionally comprising instructions to:
determine that the input model language commands contain instructions to manipulate an external data source;
determine that the external data source contains data that may not be used by the input model;
execute iterative sequential anonymization commands on the external data source; determining that the external data source is available for use by the input model; and
provide the anonymized external data source to the input model commands for model execution on the anonymized data.

126. The apparatus of embodiment 125, wherein determining that the external data source is available for use by the input model includes an indication that a minimum count of iterative sequential anonymization commands have been executed on the external data source.

127. The apparatus of embodiment 122, additionally comprising instructions to:
provide the meta-data based language command file to a user model sharing service if it is determined that the model does not contain commands to manipulate an external data source that contains data requiring anonymization.

128. An processor-implemented apparatus, comprising:

a memory;

a processor disposed in communication with said memory, and configured to issue a plurality of processing instructions stored in the memory, wherein the processor issues instructions to:
aggregate, from a plurality of entities, raw mesh entries comprising any of: emails, engagement transactions, financial transactions, social media entries, into memory;
determine an mesh entry type for each raw mesh entry;
place contents of each raw mesh entry into an unprocessed mesh entry structure;
set the mesh entry type for the unprocessed mesh entry from the determined mesh entry type;
generate a dictionary hash entry from the raw mesh entry and saving it into the unprocessed mesh entry structure;
update a mesh entry dictionary with the unprocessed mesh entry structure;
replicate the mesh entry dictionary to another location without the raw mesh entry in the mesh entry structure, wherein the replicated mesh entry dictionary is actionable for analysis without the raw mesh entry and with the dictionary has entry and set mesh entry type;
store the unprocessed mesh entry structure into a multi-directionally linked multimedia data mesh (MLMD mesh);
determine correlations within the unprocessed mesh entry structure with other stored mesh entry structures in the MLMD mesh;
create links to the determined correlated stored mesh entry structures and storing them in the stored unprocessed mesh entry structure;
mark the unprocessed mesh entry structure as a processed mesh entry structure.

129. The apparatus of embodiment 128, wherein processed mesh entry structures are updated with category, interest group, product type, price, and location information.

130. The apparatus of embodiment 129, further, comprising instructions to:

obtain a purchase request for a specified interest group, a specified interest group qualifier, an unspecified merchant, an unspecified product for a specified amount.

131. The apparatus of embodiment 130, further, comprising instructions to:

wherein the unspecified product is determined by a consumer specified interest group qualifier of the specified interest group.

132. The apparatus of embodiment 131, wherein the consumer specified interest group qualifier is any of best, most popular, most expensive, most exclusive, best deal.

133. The apparatus of embodiment 132, further, comprising instructions to:

query the MLMD mesh with the purchase request for a specified amount;

obtain MLMD mesh query results for the purchase request;

query merchants with the MLMD mesh query results for purchase items satisfying the purchase request;

place an order for purchase items satisfying the purchase request.

134. The apparatus of embodiment 133, further, comprising instructions to:

wherein if no purchase items satisfy the purchase request, the purchase request is maintained until cancelled.

135. The apparatus of embodiment 134, further, comprising instructions to:

wherein the maintained purchase request may result in a purchase when merchant items satisfy the purchase request as such items parameters change with time.

136. A non-transitory medium storing processor-issuable instructions for a centralized personal information platform processor-implemented to:
aggregate data records including search results, purchase transaction data, service usage data, service enrollment data, email data and social data;
identify data field types within the data records and their associated data values;
identify an entity from the data field types and their associated data values;
generate, via a processor, correlations of the entity to other entities identifiable from the data field types and their associated data values;
associate, via the processor, attributes to the entity by drawing inferences related to the entity from the data field types and their associated data values;
generate an updated profile and social graph of the entity using the generated correlations and associated attributes; and
provide the updated profile and social graph for an automated web form filling request.

137. The medium of embodiment 136, further comprising instructions to:
generate a search query using the updated profile; and
provide the generated search query for further data aggregation.

138. The medium of embodiment 137, wherein the search query is a web search query.

139. The medium of embodiment 137, wherein the search query is a social search query.

140. The medium of embodiment 137, wherein the search query is an email data aggregation query.

141. The medium of embodiment 139, wherein the updated profile includes a social login credential; and wherein the social search query utilizes the social login credential.

142. The medium of embodiment 136, further comprising instructions to:
generate a search query using the updated social graph; and
provide the generated search query for further data aggregation.

143. The medium of embodiment 141, wherein the search query is a web search query.

144. The medium of embodiment 141, wherein the search query is a social search query.

145. The medium of embodiment 143, wherein the updated profile includes a social login credential; and wherein the social search query utilizes the social login credential.

146. The medium of embodiment 136, wherein the entity is one of: an Internet Protocol address; an individual; a pair of associated individuals; and a household; an office space; and an organization.

147. A merchant analytics platform processor-implemented medium storing instructions for reduced transaction wait processing requirements through the use of customized transaction parameters based on a distributed linking node mesh to:
obtain a request for a merchant analytics report including a user identification;
aggregate user data of the user in a centralized personal information database;
retrieve the aggregated user data in response to obtaining the request for the merchant analytics report;
generate a user behavior profile using an analytical model, based on the aggregated user data retrieved from the centralized personal information database;
provide the user behavior profile as part of the merchant analytics report.

148. The medium of embodiment 147, further comprising instructions to:
retrieve aggregated user data for a plurality of users from the centralized personal information database;
generate a statistical user behavior profile using an analytical model, based on the aggregated user data for the plurality of users retrieved from the centralized personal information database; and
provide the statistical user behavior profile as part of the merchant analytics report for the merchant.

149. The medium of embodiment 147, wherein the retrieved aggregated user data includes personally identifiable data associated with the user identification.

150. The medium of embodiment 149, further comprising instructions to:
anonymize the retrieved aggregated user data by removing the personally identifiable data from the retrieved aggregated user data.

151. The medium of embodiment 147, wherein the aggregated user data includes social data obtained from a social networking website.

152. The medium of embodiment 151, wherein the user behavior profile is generated using the social data obtained from the social networking website.

153. The medium of embodiment 153, wherein the social data includes user social posts to the social networking website.

154. The medium of embodiment 147, further comprising instructions to:
determine a product or service having maximum likelihood of being purchased by the user; and
provide an identification of the product or service as part of the merchant analytics report.

155. The medium of embodiment 148, wherein the statistical user behavior profile is generated using aggregated social data obtained from social networking websites for the plurality of users, and retrieved from the centralized personal information database.

156. The medium of embodiment 147, further comprising instructions to:
trigger an investment action based on the merchant analytics report.

157. An analytical model sharing processor-implemented medium for privacy enhanced analytical model sharing through the use of contextual privacy dataset modifications, comprising instructions to:
obtain a request to publish an analytical model operating on user data retrieved from a centralized personal information database;
determine whether the analytical model includes a model dataset;
upon determining that the analytical model includes a model dataset, determining whether the model dataset includes personally identifiable information; and
generate a determination of whether to accept the request to publish the analytical model based on whether the model dataset includes personally identifiable information.

158. The medium of embodiment 157, further comprising instructions to:
determine that model dataset does not include personally identifiable information;
generate a notification of acceptance of the request to publish the analytical model;
provide the analytical model for publication; and
provide the notification of acceptance of the request to publish the analytical model.

159. The medium of embodiment 157, further comprising instructions to:
determine that model dataset includes personally identifiable information;
upon determining that the model dataset includes personally identifiable information, determining whether the analytical model can be run in the absence of the personally identifiable information; and
generate a determination of whether to accept the request to publish the analytical model based on whether the analytical model can be run in the absence of the personally identifiable information.

160. The medium of embodiment 159, further comprising instructions to:
determine that analytical model can be run in the absence of the personally identifiable information;
extract the personally identifiable information from the model dataset;
provide the analytical model for publication excluding the personally identifiable information from the model dataset; and
provide the notification of acceptance of the request to publish the analytical model.

161. The medium of embodiment 159, further comprising instructions ti:
determine that the analytical model cannot be run in the absence of the personally identifiable information;
upon determining that the analytical model cannot be run in the absence of the personally identifiable information, determining whether the analytical model can be run after anonymization of the personally identifiable information; and
generate a determination of whether to accept the request to publish the analytical model based on whether the analytical model can be run after anonymization of the personally identifiable information.

162. The medium of embodiment 161, further comprising instructions to:
determine that the analytical model can be run after anonymization of the personally identifiable information;
anonymize the personally identifiable information in the model dataset;
provide the analytical model for publication including the anonymized personally identifiable information in the model dataset; and
provide the notification of acceptance of the request to publish the analytical model.

163. The medium of embodiment 161, further comprising instructions to:
determine that the analytical model cannot be run after anonymization of the personally identifiable information; and
provide a notification of rejection of the request to publish the analytical model.

164. The medium of embodiment 157, wherein the user data retrieved from a centralized personal information database is that of a single user.

165. The medium of embodiment 157, wherein the user data retrieved from a centralized personal information database is aggregated user data.

166. The medium of embodiment 157, wherein the analytical model is published to a publicly-accessible model sharing website.

167. An encryptmatics extensible markup language data conversion processor-implemented medium storing instructions for increased efficiency in contextless user model sharing through the use of intermediary meta-language processing to:
receive an input model containing non-meta-data based language commands;
retrieve input language definition records corresponding to the input model language commands;
retrieve meta-data based language definition records; and
generate a meta-data based language command file using the input language definition records and the meta-based language definition records.

168. The medium of embodiment 167, additionally comprising instructions to:
determine at least one non-conditional logic flow block in the input model language commands; and
generate a meta-data based language execution block for the at least one non-conditional logic flow block.

169. The medium of embodiment 167, additionally comprising instructions to:
determine a meta-data based language variable initialization template; and
create a meta-data based language content block based on the variable initialization template and non-variable definitions contained within the input language model commands.

170. The medium of embodiment 167, additionally comprising instructions to:
determine that the input model language commands contain instructions to manipulate an external data source;
determine that the external data source contains data that may not be used by the input model;
execute iterative sequential anonymization commands on the external data source; determine that the external data source is available for use by the input model; and
provide the anonymized external data source to the input model commands for model execution on the anonymized data.

171. The medium of embodiment 170, wherein determining that the external data source is available for use by the input model includes an indication that a minimum count of iterative sequential anonymization commands have been executed on the external data source.

172. The medium of embodiment 167, additionally comprising instructions to:
provide the meta-data based language command file to a user model sharing service if it is determined that the model does not contain commands to manipulate an external data source that contains data requiring anonymization.

173. An processor-implemented medium containing instructions to:

aggregate, from a plurality of entities, raw mesh entries comprising any of: emails, engagement transactions, financial transactions, social media entries, into memory;

determine an mesh entry type for each raw mesh entry;

place contents of each raw mesh entry into an unprocessed mesh entry structure;

set the mesh entry type for the unprocessed mesh entry from the determined mesh entry type;

generate a dictionary hash entry from the raw mesh entry and saving it into the unprocessed mesh entry structure;

update a mesh entry dictionary with the unprocessed mesh entry structure;

replicate the mesh entry dictionary to another location without the raw mesh entry in the mesh entry structure, wherein the replicated mesh entry dictionary is actionable for analysis without the raw mesh entry and with the dictionary has entry and set mesh entry type;

store the unprocessed mesh entry structure into a multi-directionally linked multimedia data mesh (MLMD mesh);

determine correlations within the unprocessed mesh entry structure with other stored mesh entry structures in the MLMD mesh;

create links to the determined correlated stored mesh entry structures and storing them in the stored unprocessed mesh entry structure;

mark the unprocessed mesh entry structure as a processed mesh entry structure.

174. The medium of embodiment 173, wherein processed mesh entry structures are updated with category, interest group, product type, price, and location information.

175. The medium of embodiment 174, further, comprising instructions to: obtain a purchase request for a specified interest group, a specified interest group qualifier, an unspecified merchant, an unspecified product for a specified amount.

176. The medium of embodiment 175, further, comprising instructions to:

wherein the unspecified product is determined by a consumer specified interest group qualifier of the specified interest group.

177. The medium of embodiment 176, wherein the consumer specified interest group qualifier is any of best, most popular, most expensive, most exclusive, best deal.

178. The medium of embodiment 177, further, comprising instructions to:

query the MLMD mesh with the purchase request for a specified amount;

obtain MLMD mesh query results for the purchase request;

query merchants with the MLMD mesh query results for purchase items satisfying the purchase request;

place an order for purchase items satisfying the purchase request.

179. The medium of embodiment 178, further, comprising instructions to:

wherein if no purchase items satisfy the purchase request, the purchase request is maintained until cancelled.

180. The medium of embodiment 179, further, comprising instructions to:
wherein the maintained purchase request may result in a purchase when merchant items satisfy the purchase request as such items parameters change with time.

Additional embodiments of the ICST terminals, e.g., in the form of an intelligent shopping cart, may further comprise:

1. A processor-implemented method embodiment for generating a predictive consumer shopping list, comprising:

receiving from a user aggregate product interest and procurement indicia;

determining a product inclusion index for each product identified via the aggregate product interest and procurement indicia; and

generating via a processor a predictive consumer shopping list based on the product inclusion index of each item.

2. The method of embodiment 1, further comprising:

receiving location information from the user;

retrieving a store injection package from at least one merchant in close proximity to the user;

comparing the contents of the store injection package to the predictive consumer shopping list; and

sending a merchant proximity notification to the user if at least one product on the predictive consumer shopping list matches the contents of the store injection package.

3. The method of embodiment 1, further comprising:

receiving a social predictive consumer shopping list feedback message containing at least one social predictive consumer shopping list feedback submission for at least one product on the predictive consumer shopping list;

storing the at least one social predictive consumer shopping list feedback; and

updating the user's predictive consumer shopping list based on the at least one social predictive consumer shopping list feedback submission.

4. The method of embodiment 1, wherein each product is added to the predictive consumer shopping list if the product inclusion index exceeds a specified inclusion index threshold.

5. The method of embodiment 4, wherein the product interest and procurement indicia are from product expiration data; and

wherein the product inclusion index for each product is automatically set to exceed the specified inclusion index threshold.

6. The method of embodiment 1, wherein the product interest and procurement indicia are from at least one of receipts data and checkout data; and

wherein the product inclusion index for each product is equal to the frequency of purchase for said items.

7. The method of embodiment 3, wherein the social predictive consumer shopping list feedback submission is a numerical rating.

8. The method of embodiment 3, wherein the social predictive consumer shopping list feedback submission is a textual comment.

9. The method of embodiment 3, wherein the social predictive consumer shopping list feedback submission is obtained from at least one social networking website.

10. A processor-implemented method embodiment for shopping with a predictive consumer shopping list, comprising:

receiving at a code-scanning smart shopping cart a user's electronic, wallet-enabled device's request to connect;

connecting to the wallet-enabled device;

receiving from the wallet-enabled device a predictive consumer shopping list;

sending the predictive consumer shopping list to a predictive shopping list managing server;

receiving from the predictive shopping list managing server a best product path map;

obtaining a scan of a product and the extracted product code data from the scan; and

altering via a processor the predictive consumer shopping list to reflect the scanning of the product code.

11. The method of embodiment 10, further comprising:

automatically via a processor generating a checkout snap purchase code once the predictive consumer shopping list has been altered to a pre-determined shopping list standard.

12. The method of embodiment 10, wherein the best product path map depicts the best path for purchasing the products on the user's predictive consumer shopping list.

13. The method of embodiment 12, wherein the best product path map includes alternatives to items on the predictive consumer shopping list.

14. The method of embodiment 10, wherein altering the consumer shopping list further comprises:

marking scanned products as added to the cart on the predictive consumer shopping list.

15. The method of embodiment 14, wherein the pre-determined shopping list standard has been met if all items on the predictive consumer shopping list have been marked as added to the cart.

16. The method of embodiment 15, wherein altering the consumer shopping list further comprises:

adding scanned products to the predictive consumer shopping list if they are not already on the predictive shopping list.

17. The method of embodiment 10, wherein the scan is obtained via a smart shopping cart code reader device.

18. The method of embodiment 10, wherein the scan is obtained from the user's wallet-enabled electronic device.

19. The method of embodiment 17 further comprising:

sending a predictive consumer shopping list update message to the user's electronic consumer shopping cart indicating that a scanned item has been added to the smart shopping cart.

20. The method of embodiment 10, further comprising:

automatically via a processor obtaining a purchase authorization from the user; and

generating a checkout purchase message for a merchant point-of-sales device once the predictive consumer shopping list has been altered to a pre-determined shopping list standard.

21. The method of embodiment 20, wherein the checkout purchase message is wirelessly communicated to the merchant.

22. The method of embodiment 20, wherein the checkout purchase message is a checkout purchase code generated for the merchant point-of-sales device to scan and automatically process.

23. The method of embodiment 15, further comprising:

automatically via a processor generating a purchase authorization, wherein the predictive shopping list has been altered within a user's electronic wallet having a store-injected transaction component.

24. A predictive consumer shopping list-generating apparatus, comprising:

a processor; and

a memory disposed in communication with the processor and storing processor-executable instructions to:
receive from a user aggregate product interest and procurement indicia;
determine a product inclusion index for each product identified via the aggregate product interest and procurement indicia; and
generate via a processor a predictive consumer shopping list based on the product inclusion index of each item.

25. The apparatus of embodiment 24, further comprising instructions to:

Receive location information from the user;

retrieve a store injection package from at least one merchant in close proximity to the user;

compare the contents of the store injection package to the predictive consumer shopping list; and

send a merchant proximity notification to the user if at least one product on the predictive consumer shopping list matches the contents of the store injection package.

26. The apparatus of embodiment 24, further comprising instructions to:

receive a social predictive consumer shopping list feedback message containing at least one social predictive consumer shopping list feedback submission for at least one product on the predictive consumer shopping list;

store the at least one social predictive consumer shopping list feedback; and

update the user's predictive consumer shopping list based on the at least one social predictive consumer shopping list feedback submission. 27. The apparatus of embodiment 24 wherein each product is added to the predictive consumer shopping list if the product inclusion index exceeds a specified inclusion index threshold.

28. The apparatus of embodiment 27, wherein the product interest and procurement indicia are from product expiration data; and

wherein the product inclusion index for each product is automatically set to exceed the specified inclusion index threshold.

29. The apparatus of embodiment 24, wherein the product interest and procurement indicia are from at least one of receipts data and checkout data; and

wherein the product inclusion index for each product is equal to the frequency of purchase for said items.

30. The apparatus of embodiment 26, wherein the social predictive consumer shopping list feedback submission is a numerical rating.

31. The apparatus of embodiment 26, wherein the social predictive consumer shopping list feedback submission is a textual comment.

32. The apparatus of embodiment 26, wherein the social predictive consumer shopping list feedback submission is obtained from at least one social networking website.

33. A smart shopping cart apparatus, comprising:

a shopping cart fitted with an electronic scanning device comprising:
a processor; and
a memory disposed in communication with the processor and storing processor-executable instructions to:
   receive at a code-scanning smart shopping cart a user's electronic, wallet-enabled device's request to connect;
   connect to the wallet-enabled device;
   receive from the wallet-enabled device a predictive consumer shopping list;
   send the predictive consumer shopping list to a predictive shopping list managing server;
   receive from the predictive shopping list managing server a best product path map;
   obtain a scan of a product and the extracted product code data from the scan; and
   alter the predictive consumer shopping list to reflect the scanning of the product code.

34. The apparatus of embodiment 33, further comprising instructions to:

automatically generate a checkout snap purchase code once the predictive consumer shopping list has been altered to a pre-determined shopping list standard.

35. The apparatus of embodiment 33, wherein the best product path map depicts the best path for purchasing the products on the user's predictive consumer shopping list.

36. The apparatus of embodiment 35, wherein the best product path map includes alternatives to items on the predictive consumer shopping list.

37. The apparatus of embodiment 33, wherein the instructions to alter the consumer shopping list further comprise instructions to:

mark scanned products as added to the cart on the predictive consumer shopping list.

38. The apparatus of embodiment 34, wherein the pre-determined shopping list standard has been met if all items on the predictive consumer shopping list have been marked as added to the cart.

39. The apparatus of embodiment 37, wherein the instructions to alter the consumer shopping list further comprise instructions to:

add scanned products to the predictive consumer shopping list if they are not already on the predictive shopping list.

40. The apparatus of embodiment 33, wherein the scan is obtained via a smart shopping cart code reader device.

41. The apparatus of embodiment 33, wherein the scan is obtained from the user's wallet-enabled electronic device.

42. The apparatus of embodiment 40 further comprising:

send a predictive consumer shopping list update message to the user's electronic consumer shopping cart indicating that a scanned item has been added to the smart shopping cart.

43. The apparatus of embodiment 33, further comprising instructions to:

automatically obtain a purchase authorization from the user; and

generate a checkout purchase message for a merchant point-of-sales device once the predictive consumer shopping list has been altered to a pre-determined shopping list standard.

44. The apparatus of embodiment 43, wherein the checkout purchase message is wirelessly communicated to the merchant.

45. The apparatus of embodiment 43, wherein the checkout purchase message is a checkout purchase code generated for the merchant point-of-sales device to scan and automatically process.

46. The apparatus of embodiment 38, further comprising instructions to:

automatically generate a purchase authorization, wherein the predictive shopping list has been altered within a user's electronic wallet having a store-injected transaction component.

47. A predictive consumer shopping list-generating system, comprising:

means for receiving from a user aggregate product interest and procurement indicia;

means for determining a product inclusion index for each product identified via the aggregate product interest and procurement indicia; and

means for generating via a processor a predictive consumer shopping list based on the product inclusion index of each item.

48. The system of embodiment 47, further comprising:

means for receiving location information from the user;

means for retrieving a store injection package from at least one merchant in close proximity to the user;

means for comparing the contents of the store injection package to the predictive consumer shopping list; and

means for sending a merchant proximity notification to the user if at least one product on the predictive consumer shopping list matches the contents of the store injection package.

49. The system of embodiment 47, further comprising:

means for receiving a social predictive consumer shopping list feedback message containing at least one social predictive consumer shopping list feedback submission for at least one product on the predictive consumer shopping list;

means for storing the at least one social predictive consumer shopping list feedback; and

means for updating the user's predictive consumer shopping list based on the at least one social predictive consumer shopping list feedback submission.

50. The system of embodiment 47, wherein each product is added to the predictive consumer shopping list if the product inclusion index exceeds a specified inclusion index threshold.

51. The system of embodiment 4, wherein the product interest and procurement indicia are from product expiration data; and

wherein the product inclusion index for each product is automatically set to exceed the specified inclusion index threshold.

52. The system of embodiment 47, wherein the product interest and procurement indicia are from at least one of receipts data and checkout data; and

wherein the product inclusion index for each product is equal to the frequency of purchase for said items.

53. The system of embodiment 49, wherein the social predictive consumer shopping list feedback submission is a numerical rating.

54. The system of embodiment 49, wherein the social predictive consumer shopping list feedback submission is a textual comment.

55. The system of embodiment 49, wherein the social predictive consumer shopping list feedback submission is obtained from at least one social networking website.

56. A smart shopping cart system, comprising:

means for receiving at a code-scanning smart shopping cart a user's electronic, wallet-enabled device's request to connect;

means for connecting to the wallet-enabled device;

means for receiving from the wallet-enabled device a predictive consumer shopping list;

means for sending the predictive consumer shopping list to a predictive shopping list managing server;

means for receiving from the predictive shopping list managing server a best product path map;

means for obtaining a scan of a product and the extracted product code data from the scan; and

means for altering via a processor the predictive consumer shopping list to reflect the scanning of the product code.

57. The system of embodiment 56, further comprising:

means for automatically via a processor generating a checkout snap purchase code once the predictive consumer shopping list has been altered to a pre-determined shopping list standard.

58. The system of embodiment 56, wherein the best product path map depicts the best path for purchasing the products on the user's predictive consumer shopping list.

59. The system of embodiment 58, wherein the best product path map includes alternatives to items on the predictive consumer shopping list.

60. The system of embodiment 56, wherein altering the consumer shopping list further comprises:

means for marking scanned products as added to the cart on the predictive consumer shopping list.

61. The system of embodiment 60, wherein the pre-determined shopping list standard has been met if all items on the predictive consumer shopping list have been marked as added to the cart.

62. The system of embodiment 61, wherein altering the consumer shopping list further comprises:

means for adding scanned products to the predictive consumer shopping list if they are not already on the predictive shopping list.

63. The system of embodiment 56, wherein the scan is obtained via a smart shopping cart code reader device.

64. The system of embodiment 56, wherein the scan is obtained from the user's wallet-enabled electronic device.

65. The system of embodiment 63 further comprising:

means for sending a predictive consumer shopping list update message to the user's electronic consumer shopping cart indicating that a scanned item has been added to the smart shopping cart.

66. The system of embodiment 56, further comprising:

means for automatically via a processor obtaining a purchase authorization from the user; and

means for generating a checkout purchase message for a merchant point-of-sales device once the predictive consumer shopping list has been altered to a pre-determined shopping list standard.

67. The system of embodiment 66, wherein the checkout purchase message is wirelessly communicated to the merchant.

68. The system of embodiment 66, wherein the checkout purchase message is a checkout purchase code generated for the merchant point-of-sales device to scan and automatically process.

69. The system of embodiment 63, further comprising:

means for automatically via a processor generating a purchase authorization, wherein the predictive shopping list has been altered within a user's electronic wallet having a store-injected transaction component.

70. A predictive consumer shopping list-generating non-transitory computer-readable medium storing processor-executable instructions, said instructions executable by a processor to:

receive from a user aggregate product interest and procurement indicia;

determine a product inclusion index for each product identified via the aggregate product interest and procurement indicia; and

generate via a processor a predictive consumer shopping list based on the product inclusion index of each item.

71. The medium of embodiment 70, further comprising instructions to:

receive location information from the user;

retrieve a store injection package from at least one merchant in close proximity to the user;

compare the contents of the store injection package to the predictive consumer shopping list; and

send a merchant proximity notification to the user if at least one product on the predictive consumer shopping list matches the contents of the store injection package.

72. The medium of embodiment 70, further comprising instructions to:

receive a social predictive consumer shopping list feedback message containing at least one social predictive consumer shopping list feedback submission for at least one product on the predictive consumer shopping list;

store the at least one social predictive consumer shopping list feedback; and

update the user's predictive consumer shopping list based on the at least one social predictive consumer shopping list feedback submission.

73. The medium of embodiment 70 wherein each product is added to the predictive consumer shopping list if the product inclusion index exceeds a specified inclusion index threshold.

74. The medium of embodiment 73, wherein the product interest and procurement indicia are from product expiration data; and

wherein the product inclusion index for each product is automatically set to exceed the specified inclusion index threshold.

75. The medium of embodiment 70, wherein the product interest and procurement indicia are from at least one of receipts data and checkout data; and

wherein the product inclusion index for each product is equal to the frequency of purchase for said items.

76. The medium of embodiment 72, wherein the social predictive consumer shopping list feedback submission is a numerical rating.

77. The medium of embodiment 72, wherein the social predictive consumer shopping list feedback submission is a textual comment.

78. The medium of embodiment 72, wherein the social predictive consumer shopping list feedback submission is obtained from at least one social networking website.

79. A smart shopping cart non-transitory computer-readable medium storing processor-executable instructions, said instructions executable by a processor to:
receive at a code-scanning smart shopping cart a user's electronic, wallet-enabled device's request to connect;
connect to the wallet-enabled device;
receive from the wallet-enabled device a predictive consumer shopping list;
send the predictive consumer shopping list to a predictive shopping list managing server;
receive from the predictive shopping list managing server a best product path map;
obtain a scan of a product and the extracted product code data from the scan; and
alter the predictive consumer shopping list to reflect the scanning of the product code.

80. The medium of embodiment 79, further comprising instructions to:

automatically generate a checkout snap purchase code once the predictive consumer shopping list has been altered to a pre-determined shopping list standard.

81. The medium of embodiment 79, wherein the best product path map depicts the best path for purchasing the products on the user's predictive consumer shopping list.

82. The medium of embodiment 81, wherein the best product path map includes alternatives to items on the predictive consumer shopping list.

83. The medium of embodiment 79, wherein the instructions to alter the consumer shopping list further comprise instructions to:

mark scanned products as added to the cart on the predictive consumer shopping list.

84. The medium of embodiment 80, wherein the pre-determined shopping list standard has been met if all items on the predictive consumer shopping list have been marked as added to the cart.

85. The medium of embodiment 83, wherein the instructions to alter the consumer shopping list further comprise instructions to:

add scanned products to the predictive consumer shopping list if they are not already on the predictive shopping list.

86. The medium of embodiment 79, wherein the scan is obtained via a smart shopping cart code reader device.

87. The medium of embodiment 79, wherein the scan is obtained from the user's wallet-enabled electronic device.

88. The medium of embodiment 86 further comprising:

send a predictive consumer shopping list update message to the user's electronic consumer shopping cart indicating that a scanned item has been added to the smart shopping cart.

89. The medium of embodiment 79, further comprising instructions to:

automatically obtain a purchase authorization from the user; and

generate a checkout purchase message for a merchant point-of-sales device once the predictive consumer shopping list has been altered to a pre-determined shopping list standard.

90. The medium of embodiment 89, wherein the checkout purchase message is wirelessly communicated to the merchant.

91. The medium of embodiment 89, wherein the checkout purchase message is a checkout purchase code generated for the merchant point-of-sales device to scan and automatically process.

92. The medium of embodiment 84, further comprising instructions to:

automatically generate a purchase authorization, wherein the predictive shopping list has been altered within a user's electronic wallet having a store-injected transaction component.

Additional embodiments of the ICST platform further comprise:

1. An intelligent consumer service solution apparatus, comprising:

a memory;

a processor disposed in communication with said memory, and configured to issue a plurality of processing instructions stored in the memory, wherein the processor issues instructions to:
receiving, at a service solution cloud, status data updates relating to a service solution deployed at one or more remote robotic terminals from the one or more remote robotic terminals,
   wherein the one or more remote robotic terminals are configured to provide similar services;
aggregating and storing the status data updates relating to the service solution in an encryptomatic data format at the service solution cloud in a bandwidth efficient manner by maintaining data updates at a centralized data platform to reduce data message passing and data storage space,
   wherein the service solution cloud is configured to periodically update based on the status data updates;
receive, at the periodically updated service solution cloud, a service solution request inquiry from a remote robotic terminal;
parse the service request inquiry to obtain service identifying information including an application ID;
obtain, from the received service request, a supplied data package indicating a currently deployed service solution at the remote robotic terminal;
query in the solution cloud based on the obtained service identifying information and the supplied data package;
aggregate queried results from the solution cloud related to the supplied data package;
determine an enhanced service solution based on the aggregated queried results in response to the service request inquiry;
generate a downloadable instruction package including the generated solution based on source information of the remote terminal;
provide the downloadable instruction package to the remote robotic terminal; and
updating, at the service solution cloud, data records related to the service solution based on the generated enhanced service solution.

2. An intelligent consumer service solution apparatus, comprising:

a memory;

a processor disposed in communication with said memory, and configured to issue a plurality of processing instructions stored in the memory, wherein the processor issues instructions to:
receive, at a server, a service request inquiry from a remote terminal;
parse the service request inquiry to obtain service identifying information;
obtain, from the received service request, a supplied data package indicating a currently deployed service solution at the remote robotic terminal;
query in the solution cloud based on the obtained service identifying information and the supplied data package;
aggregate queried results from the solution cloud related to the supplied data package;
determine an enhanced service solution based on the aggregated queried results in response to the service request inquiry;
generate a downloadable instruction package including the generated solution based on source information of the remote terminal; and
provide the downloadable instruction package to the remote terminal.

3. The apparatus of embodiment 1, wherein the remote terminal comprises an intelligent robot.

4. The apparatus of embodiment 3, wherein the intelligent robot comprises any of:

a robot cleaner;

a police car detector;

a traffic detector;

electronic jewelry; and

a quadrocopter.

5. The apparatus of embodiment 1, wherein the service request is received at a remote server.

6. The apparatus of embodiment 1, wherein the service request includes any of:

GPS information;

device information of the remote terminal; and

key words describing the service request.

7. The apparatus of embodiment 1, wherein the remote terminal comprises a user interface to receive the service request from a user.

8. The apparatus of embodiment 1, wherein the remote terminal determines whether there is a locally existing solution prior to sending the service request to the server.

9. The apparatus of embodiment 1, wherein the processor further issues instructions for:

determining whether a queried solution from the solution cloud is compatible with the remote terminal.

10. The apparatus of embodiment 1, wherein the processor further issues instructions for:

identifying an application identifier associated with the service request; and

forming a query based on the application identifier in the solution cloud.

11. The apparatus of embodiment 1, wherein the processor further issues instructions for:

determining whether there are linked remote terminals of a same type of the remote terminal; and

retrieving a list of linked remote terminal profiles;

retrieving service request history of the linked remote terminals based on the list of linked remote terminal profiles; and

forming a query on the retrieved service request history of the linked remote terminals based on the service request.

12. The apparatus of embodiment 11, wherein the processor further issues instructions for:

expanding the list of linked remote terminal profiles to a second degree linked remote terminals; and

forming a query within the expanded list of linked remote terminal profiles for a solution based on the service request.

13. The apparatus of embodiment 1, wherein the processor further issues instructions for:

retrieving a list of unprocessed service solution history from the solution cloud; and

determining feedback associated with each service request query from the list of unprocessed service solution history.

14. The apparatus of embodiment 13, wherein the processor further issues instructions for:

determining a type of the feedback associated with each service request query.

15. The apparatus of embodiment 14, wherein the type of the feedback comprises any of: a user rating of a provided service solution; a further inquiry for a service solution.

16. The apparatus of embodiment 14, wherein the processor further issues instructions for:

adjusting a solution record based on the feedback; and re-querying based on the service request on the adjusted solution record.

17. The apparatus of embodiment 1, wherein the processor further issues instructions for:

forming a social network of remote terminals based on a type of the remote terminals.

18. The apparatus of embodiment 17, wherein the processor further issues instructions for:

sharing the downloadable instruction package with other remote terminals within the social network.

19. The apparatus of embodiment 1, wherein the aggregating queried results are based on feedback from the remote terminal related to the service request inquiry.

20. The apparatus of embodiment 1, wherein the enhanced service solution is determined based on an encryptmatic data format converter.

21. An intelligent consumer service solution system, comprising:
means to receive, at a server, a service request inquiry from a remote terminal;
means to parse the service request inquiry to obtain service identifying information;
means to obtain, from the received service request, a supplied data package indicating a currently deployed service solution at the remote robotic terminal;
means to query in the solution cloud based on the obtained service identifying information and the supplied data package;
means to aggregate queried results from the solution cloud related to the supplied data package;
means to determine an enhanced service solution based on the aggregated queried results in response to the service request inquiry;
means to generate a downloadable instruction package including the generated solution based on source information of the remote terminal; and
means to provide the downloadable instruction package to the remote terminal.

22. The system of embodiment 21, wherein the remote terminal comprises an intelligent robot.

23. The system of embodiment 22, wherein the intelligent robot comprises any of:

a robot cleaner;

a police car detector;

a traffic detector;

electronic jewelry; and

a quadrocopter.

24. The system of embodiment 21, wherein the service request is received at a remote server.

25. The system of embodiment 21, wherein the service request includes any of:

GPS information;

device information of the remote terminal; and

key words describing the service request.

26. The system of embodiment 21, wherein the remote terminal comprises a user interface to receive the service request from a user.

27. The system of embodiment 21, wherein the remote terminal determines whether there is a locally existing solution prior to sending the service request to the server.

28. The system of embodiment 21, further comprising:

means for determining whether a queried solution from the solution cloud is compatible with the remote terminal.

29. The system of embodiment 21, further comprising:

means for identifying an application identifier associated with the service request; and

means for forming a query based on the application identifier in the solution cloud.

30. The system of embodiment 21, further comprising:

means for determining whether there are linked remote terminals of a same type of the remote terminal; and

means for retrieving a list of linked remote terminal profiles.

31. The system of embodiment 30, further comprising:

means for retrieving service request history of the linked remote terminals based on the list of linked remote terminal profiles; and

means for forming a query on the retrieved service request history of the linked remote terminals based on the service request.

32. The system of embodiment 30, further comprising:

means for expanding the list of linked remote terminal profiles to a second degree linked remote terminals; and

means for forming a query within the expanded list of linked remote terminal profiles for a solution based on the service request.

33. The system of embodiment 21, further comprising:

means for retrieving a list of unprocessed service solution history from the solution cloud; and

means for determining feedback associated with each service request query from the list of unprocessed service solution history.

34. The system of embodiment 33, further comprising:

means for determining a type of the feedback associated with each service request query.

35. The system of embodiment 34, wherein the type of the feedback comprises a user rating of a provided service solution.

36. The system of embodiment 34, wherein the type of the feedback comprises a further inquiry.

37. The system of embodiment 34, further comprising:

means for adjusting a solution record based on the feedback; and

means for re-querying based on the service request on the adjusted solution record.

38. The system of embodiment 21, further comprising:

means for forming a social network of remote terminals.

39. The system of embodiment 38, wherein the social network of remote terminals is based on a type of the remote terminals.

40. The system of embodiment 38, further comprising:

means for sharing the downloadable instruction package with other remote terminals within the social network.

41. An intelligent consumer service solution processor-readable non-transitory medium storing processor-executable instructions executable by a processor to:

receive, at a server, a service request inquiry from a remote terminal;

parse the service request inquiry to obtain service identifying information;

obtain, from the received service request, a supplied data package indicating a currently deployed service solution at the remote robotic terminal;

query in the solution cloud based on the obtained service identifying information and the supplied data package;

aggregate queried results from the solution cloud related to the supplied data package;

determine an enhanced service solution based on the aggregated queried results in response to the service request inquiry;

generate a downloadable instruction package including the generated solution based on source information of the remote terminal; and

provide the downloadable instruction package to the remote terminal.

42. The medium of embodiment 41, wherein the remote terminal comprises an intelligent robot.

43. The medium of embodiment 42, wherein the intelligent robot comprises any of:

a robot cleaner;

a police car detector;

a traffic detector;

electronic jewelry; and

a quadrocopter.

44. The medium of embodiment 41, wherein the service request is received at a remote server.

45. The medium of embodiment 41, wherein the service request includes any of:

GPS information;

device information of the remote terminal; and

key words describing the service request.

46. The medium of embodiment 41, wherein the remote terminal comprises a user interface to receive the service request from a user.

47. The medium of embodiment 41, wherein the remote terminal determines whether there is a locally existing solution prior to sending the service request to the server.

48. The medium of embodiment 41, further storing processor-executable instructions to:

determine whether a queried solution from the solution cloud is compatible with the remote terminal.

49. The medium of embodiment 41, further storing processor-executable instructions to:

identify an application identifier associated with the service request; and

form a query based on the application identifier in the solution cloud.

50. The medium of embodiment 41, further storing processor-executable instructions to:

determine whether there are linked remote terminals of a same type of the remote terminal; and

retrieve a list of linked remote terminal profiles.

51. The medium of embodiment 50, further storing processor-executable instructions to:

retrieve service request history of the linked remote terminals based on the list of linked remote terminal profiles; and

form a query on the retrieved service request history of the linked remote terminals based on the service request.

52. The medium of embodiment 50, further storing processor-executable instructions to:

expand the list of linked remote terminal profiles to a second degree linked remote terminals; and

form a query within the expanded list of linked remote terminal profiles for a solution based on the service request.

53. The medium of embodiment 41, further storing processor-executable instructions to:

retrieve a list of unprocessed service solution history from the solution cloud; and

determine feedback associated with each service request query from the list of unprocessed service solution history.

54. The medium of embodiment 53, further storing processor-executable instructions to:

determine a type of the feedback associated with each service request query.

55. The medium of embodiment 54, wherein the type of the feedback comprises a user rating of a provided service solution.

56. The medium of embodiment 54, wherein the type of the feedback comprises a further inquiry.

57. The medium of embodiment 54, further storing processor-executable instructions to:

adjust a solution record based on the feedback; and

re-query based on the service request on the adjusted solution record.

58. The medium of embodiment 41, further storing processor-executable instructions to:

form a social network of remote terminals.

59. The medium of embodiment 58, wherein the social network of remote terminals is based on a type of the remote terminals.

60. The medium of embodiment 58, further storing processor-executable instructions to:

share the downloadable instruction package with other remote terminals within the social network.

61. An intelligent consumer service solution processor-implemented method, comprising:
receiving, at a server, a service request inquiry from a remote terminal;
parsing the service request inquiry to obtain service identifying information;
obtaining, from the received service request, a supplied data package indicating a currently deployed service solution at the remote robotic terminal;
querying in the solution cloud based on the obtained service identifying information and the supplied data package;
aggregating queried results from the solution cloud related to the supplied data package;
determining an enhanced service solution based on the aggregated queried results in response to the service request inquiry;
generating a downloadable instruction package including the generated solution based on source information of the remote terminal; and
providing the downloadable instruction package to the remote terminal.

62. The method of embodiment 61, wherein the remote terminal comprises an intelligent robot.

63. The method of embodiment 62, wherein the intelligent robot comprises any of:

a robot cleaner;

a police car detector;

a traffic detector;

electronic jewelry; and

a quadrocopter.

64. The method of embodiment 61, wherein the service request is received at a remote server.

65. The method of embodiment 61, wherein the service request includes any of:

GPS information;

device information of the remote terminal; and

key words describing the service request.

66. The method of embodiment 61, wherein the remote terminal comprises a user interface to receive the service request from a user.

67. The method of embodiment 61, wherein the remote terminal determines whether there is a locally existing solution prior to sending the service request to the server.

68. The method of embodiment 61, further comprising:

determining whether a queried solution from the solution cloud is compatible with the remote terminal.

69. The method of embodiment 61, further comprising:

identifying an application identifier associated with the service request; and

forming a query based on the application identifier in the solution cloud.

70. The method of embodiment 61, further comprising:

determining whether there are linked remote terminals of a same type of the remote terminal; and

retrieving a list of linked remote terminal profiles.

71. The method of embodiment 70, further comprising:

retrieving service request history of the linked remote terminals based on the list of linked remote terminal profiles; and

forming a query on the retrieved service request history of the linked remote terminals based on the service request.

72. The method of embodiment 70, further comprising:

expanding the list of linked remote terminal profiles to a second degree linked remote terminals; and

forming a query within the expanded list of linked remote terminal profiles for a solution based on the service request.

73. The method of embodiment 61, further comprising:

retrieving a list of unprocessed service solution history from the solution cloud; and

determining feedback associated with each service request query from the list of unprocessed service solution history.

74. The method of embodiment 73, further comprising:

determining a type of the feedback associated with each service request query.

75. The method of embodiment 74, wherein the type of the feedback comprises a user rating of a provided service solution.

76. The method of embodiment 74, wherein the type of the feedback comprises a further inquiry.

77. The method of embodiment 74, further comprising:

adjusting a solution record based on the feedback; and

re-querying based on the service request on the adjusted solution record.

78. The method of embodiment 61, further comprising:

forming a social network of remote terminals.

79. The method of embodiment 78, wherein the social network of remote terminals is based on a type of the remote terminals.

80. The method of embodiment 78, further comprising:

sharing the downloadable instruction package with other remote terminals within the social network.

81. An intelligent consumer service solution apparatus, comprising:

a memory;

a processor disposed in communication with said memory, and configured to issue a plurality of processing instructions stored in the memory, wherein the processor issues instructions to:
receive a service request inquiry at a remote terminal;
determine whether a solution to the service request inquiry is available from solutions instantiated on the remote terminal;
generate a cloud service request including terminal device information to a solution cloud;
obtain a downloadable instruction package from the solution cloud;
install and instantiate the instruction package at the remote terminal; and
generate solution data to the service request inquiry and submitting the generated solution data to the solution cloud for social sharing.

82. The apparatus of embodiment 81, wherein the remote terminal comprises an intelligent robot.

83. The apparatus of embodiment 82, wherein the intelligent robot comprises any of:

a robot cleaner;

a police car detector;

a traffic detector;

electronic jewelry; and

a quadrocopter.

84. The apparatus of embodiment 81, wherein the service request inquiry is sent to a remote server from the remote terminal.

85. The apparatus of embodiment 81, wherein the cloud service request includes any of:

GPS information;

device information of the remote terminal; and

key words describing the service request.

86. The apparatus of embodiment 81, wherein the remote terminal comprises a user interface to receive the service request inquiry from a user.

87. The apparatus of embodiment 81, wherein the remote terminal determines whether there is a locally existing solution prior to sending the service request to the server.

88. The apparatus of embodiment 81, wherein the processor further issues instructions to:

determine whether the downloadable instruction package from the solution cloud is compatible with the remote terminal.

89. The apparatus of embodiment 81, wherein the solution cloud further identifies an application identifier associated with the cloud service request; and forms a query based on the application identifier in the solution cloud.

90. The apparatus of embodiment 81, wherein the remote terminal is linked to other remote terminals of a same type of the remote terminal.

91. The apparatus of embodiment 90, wherein the solution cloud further retrieves service request history of the linked remote terminals based on a list of linked remote terminal profiles; and forms a query on the retrieved service request history of the linked remote terminals based on the service request.

92. The apparatus of embodiment 91, wherein the solution cloud further expands the list of linked remote terminal profiles to a second degree linked remote terminals; and

forms a query within the expanded list of linked remote terminal profiles for a solution based on the service request.

93. The apparatus of embodiment 81, wherein the solution data to the service request inquiry comprises feedback associated with each cloud service request query.

94. The apparatus of embodiment 81, wherein the solution data comprises a user rating of a provided service solution.

95. The apparatus of embodiment 81, wherein the type of the feedback comprises a further inquiry related to the service request inquiry.

96. The apparatus of embodiment 81, wherein the type of the feedback comprises a status of instruction package instantiated on the remote terminal.

97. The apparatus of embodiment 81, wherein the solution data further comprises human behavioral data collected by the remote terminal.

98. The apparatus of embodiment 81, wherein the remote terminal is connected to a social network of remote terminals.

99. The apparatus of embodiment 98, wherein the social network of remote terminals is based on a type of the remote terminals.

100. The apparatus of embodiment 98, wherein the processor further issues instructions to:

share the downloadable instruction package with other remote terminals within the social network.

101. An intelligent consumer service solution system, comprising:
means for receiving a service request inquiry at a remote terminal;
means for determining whether a solution to the service request inquiry is available from solutions instantiated on the remote terminal;
means for generating a cloud service request including terminal device information to a solution cloud;
means for obtaining a downloadable instruction package from the solution cloud;
means for installing and instantiating the instruction package at the remote terminal; and
means for generating solution data to the service request inquiry and submitting the generated solution data to the solution cloud for social sharing.

102. The system of embodiment 101, wherein the remote terminal comprises an intelligent robot.

103. The system of embodiment 102, wherein the intelligent robot comprises any of:

a robot cleaner;

a police car detector;

a traffic detector;

electronic jewelry; and

a quadrocopter.

104. The system of embodiment 101, wherein the service request inquiry is sent to a remote server from the remote terminal.

105. The system of embodiment 101, wherein the cloud service request includes any of:

GPS information;

device information of the remote terminal; and

key words describing the service request.

106. The system of embodiment 101, wherein the remote terminal comprises a user interface to receive the service request inquiry from a user.

107. The system of embodiment 101, wherein the remote terminal determines whether there is a locally existing solution prior to sending the service request to the server.

108. The system of embodiment 101, further comprising:

means for determining whether the downloadable instruction package from the solution cloud is compatible with the remote terminal.

109. The system of embodiment 101, wherein the solution cloud further identifies an application identifier associated with the cloud service request; and forms a query based on the application identifier in the solution cloud.

110. The system of embodiment 101, wherein the remote terminal is linked to other remote terminals of a same type of the remote terminal.

111. The system of embodiment 90, wherein the solution cloud further retrieves service request history of the linked remote terminals based on a list of linked remote terminal profiles; and forms a query on the retrieved service request history of the linked remote terminals based on the service request.

112. The system of embodiment 91, wherein the solution cloud further expands the list of linked remote terminal profiles to a second degree linked remote terminals; and

forms a query within the expanded list of linked remote terminal profiles for a solution based on the service request.

113. The system of embodiment 81, wherein the solution data to the service request inquiry comprises feedback associated with each cloud service request query.

114. The system of embodiment 81, wherein the solution data comprises a user rating of a provided service solution.

115. The system of embodiment 81, wherein the type of the feedback comprises a further inquiry related to the service request inquiry.

116. The system of embodiment 81, wherein the type of the feedback comprises a status of instruction package instantiated on the remote terminal.

117. The system of embodiment 81, wherein the solution data further comprises human behavioral data collected by the remote terminal.

118. The system of embodiment 81, wherein the remote terminal is connected to a social network of remote terminals.

119. The system of embodiment 118, wherein the social network of remote terminals is based on a type of the remote terminals.

120. The system of embodiment 118, further comprising:

means for sharing the downloadable instruction package with other remote terminals within the social network.

121. An intelligent consumer service solution processor-readable non-transitory medium storing processor-executable instructions executable by a processor to:

receive a service request inquiry at a remote terminal;

determine whether a solution to the service request inquiry is available from solutions instantiated on the remote terminal;

generate a cloud service request including terminal device information to a solution cloud;

obtain a downloadable instruction package from the solution cloud;

install and instantiate the instruction package at the remote terminal; and

generate solution data to the service request inquiry and submitting the generated solution data to the solution cloud for social sharing.

122. The medium of embodiment 121, wherein the remote terminal comprises an intelligent robot.

123. The medium of embodiment 122, wherein the intelligent robot comprises any of:

a robot cleaner;

a police car detector;

a traffic detector;

electronic jewelry; and

a quadrocopter.

124. The medium of embodiment 121, wherein the service request inquiry is sent to a remote server from the remote terminal.

125. The medium of embodiment 121, wherein the cloud service request includes any of:

GPS information;

device information of the remote terminal; and

key words describing the service request.

126. The medium of embodiment 121, wherein the remote terminal comprises a user interface to receive the service request inquiry from a user.

127. The medium of embodiment 121, wherein the remote terminal determines whether there is a locally existing solution prior to sending the service request to the server.

128. The medium of embodiment 121, wherein the processor further issues instructions to:

determine whether the downloadable instruction package from the solution cloud is compatible with the remote terminal.

129. The medium of embodiment 121, wherein the solution cloud further identifies an application identifier associated with the cloud service request; and forms a query based on the application identifier in the solution cloud.

130. The medium of embodiment 121, wherein the remote terminal is linked to other remote terminals of a same type of the remote terminal.

131. The medium of embodiment 130, wherein the solution cloud further retrieves service request history of the linked remote terminals based on a list of linked remote terminal profiles; and forms a query on the retrieved service request history of the linked remote terminals based on the service request.

132. The medium of embodiment 131, wherein the solution cloud further expands the list of linked remote terminal profiles to a second degree linked remote terminals; and

forms a query within the expanded list of linked remote terminal profiles for a solution based on the service request.

133. The medium of embodiment 121, wherein the solution data to the service request inquiry comprises feedback associated with each cloud service request query.

134. The medium of embodiment 121, wherein the solution data comprises a user rating of a provided service solution.

135. The medium of embodiment 121, wherein the type of the feedback comprises a further inquiry related to the service request inquiry.

136. The medium of embodiment 121, wherein the type of the feedback comprises a status of instruction package instantiated on the remote terminal.

137. The medium of embodiment 121, wherein the solution data further comprises human behavioral data collected by the remote terminal.

138. The medium of embodiment 121, wherein the remote terminal is connected to a social network of remote terminals.

139. The medium of embodiment 138, wherein the social network of remote terminals is based on a type of the remote terminals.

140. The medium of embodiment 138, wherein the processor further issues instructions to:

share the downloadable instruction package with other remote terminals within the social network.

141. An intelligent consumer service solution processor-implemented method, comprising:
receiving a service request inquiry at a remote terminal;
determining whether a solution to the service request inquiry is available from solutions instantiated on the remote terminal;
generating a cloud service request including terminal device information to a solution cloud;
obtaining a downloadable instruction package from the solution cloud;
installing and instantiating the instruction package at the remote terminal; and
generating solution data to the service request inquiry and submitting the generated solution data to the solution cloud for social sharing.

142. The method of embodiment 141, wherein the remote terminal comprises an intelligent robot.

143. The method of embodiment 142, wherein the intelligent robot comprises any of:

a robot cleaner;

a police car detector;

a traffic detector;

electronic jewelry; and

a quadrocopter.

144. The method of embodiment 141, wherein the service request inquiry is sent to a remote server from the remote terminal.

145. The method of embodiment 141, wherein the cloud service request includes any of:

GPS information;

device information of the remote terminal; and

key words describing the service request.

146. The method of embodiment 141, wherein the remote terminal comprises a user interface to receive the service request inquiry from a user.

147. The method of embodiment 141, wherein the remote terminal determines whether there is a locally existing solution prior to sending the service request to the server.

148. The method of embodiment 141, further comprising:

determining whether the downloadable instruction package from the solution cloud is compatible with the remote terminal.

149. The method of embodiment 141, wherein the solution cloud further identifies an application identifier associated with the cloud service request; and forms a query based on the application identifier in the solution cloud.

150. The method of embodiment 141, wherein the remote terminal is linked to other remote terminals of a same type of the remote terminal.

151. The method of embodiment 150, wherein the solution cloud further retrieves service request history of the linked remote terminals based on a list of linked remote terminal profiles; and forms a query on the retrieved service request history of the linked remote terminals based on the service request.

152. The method of embodiment 151, wherein the solution cloud further expands the list of linked remote terminal profiles to a second degree linked remote terminals; and

forms a query within the expanded list of linked remote terminal profiles for a solution based on the service request.

153. The method of embodiment 141, wherein the solution data to the service request inquiry comprises feedback associated with each cloud service request query.

154. The method of embodiment 141, wherein the solution data comprises a user rating of a provided service solution.

155. The method of embodiment 141, wherein the type of the feedback comprises a further inquiry related to the service request inquiry.

156. The method of embodiment 141, wherein the type of the feedback comprises a status of instruction package instantiated on the remote terminal.

157. The method of embodiment 141, wherein the solution data further comprises human behavioral data collected by the remote terminal.

158. The method of embodiment 141, wherein the remote terminal is connected to a social network of remote terminals.

159. The method of embodiment 158, wherein the social network of remote terminals is based on a type of the remote terminals.

160. The method of embodiment 158, further comprising:

sharing the downloadable instruction package with other remote terminals within the social network.

161. An intelligent consumer assistance apparatus having one or more removable and replaceable layer elements, comprising:

a first layer element containing one or more cameras configured to capture visual content of surroundings;

a second layer element containing one or more wireless antenna configured to communicatively receive and transmit data via a wireless communication network;

a third layer element containing a power supply element configured to provide power to the camera and the one or more wireless antenna;

a fourth layer element containing a processor and a data storage element configured to process and store captured visual content of surroundings;

one or more connectors positioned to interconnect the first layer element, the second layer element and the third layer element,
wherein any of the first layer element, the second layer element and the third layer element is configured to be removed by disconnecting the one or more connectors;
wherein the visual content of surroundings captured by the first layer element is uploaded to a centralized personal information platform.

162. The apparatus of embodiment 161, wherein the intelligent consumer assistance apparatus comprises different shapes and sizes.

163. The apparatus of embodiment 161, wherein the intelligent consumer assistance apparatus comprises a form of any of:

electronic jewelry;

robot cleaner;

traffic detector; and

a quadrocopter.

164. The apparatus of embodiment 161, wherein the one or more wireless antenna comprises any of:

infrared;

WiFi;

radio; and

Bluetooth.

165. The apparatus of embodiment 161, wherein the second layer element further comprises a GPS component.

166. The apparatus of embodiment 161, wherein the one or more removable and replaceable layer elements are in the shape of round disks stacked on top of each other.

167. The apparatus of embodiment 161, wherein the one or more removable and replaceable layer elements are in the shape of rectangular bars interconnected by wires.

168. The apparatus of embodiment 161, wherein the one or more connectors comprises metallic wires fixed by clasps attached at a back side of the layer elements.

169. The apparatus of embodiment 161, wherein the one or more connectors comprises magnetic connectors installed on a top and a bottom surface of the layer elements.

170. The apparatus of embodiment 161, wherein the power supply element comprises any of:

a button battery;

a solar cell; and

a mechanic winder.

171. The apparatus of embodiment 161, further comprising:

a fifth layer element containing a decorative element, said decorative element comprising any of: a crystal, a diamond, and a gem stone.

172. The apparatus of embodiment 171, wherein the decorative element has a unique identifiable pattern used to identify an identity of the wearer.

173. The apparatus of embodiment 161, further comprising:

a fifth layer element containing a GPS component.

174. The apparatus of embodiment 161, further comprising:

a fifth layer element containing rollers for the apparatus to move on a floor.

175. The apparatus of embodiment 161, further comprising:

a set of wings to carry the apparatus to fly in the air.

176. The apparatus of embodiment 161, further comprising:

a fifth layer element containing any of a temperature meter, a humidiy meter, and a air pollution meter.

In order to address various issues and advance the art, the entirety of this application for INTELLIGENT CONSUMER SERVICE TERMINAL APPARATUSES, METHODS AND SYSTEMS APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ICST individual and/or enterprise user, database configuration and/or relational model, data type, data transmission and/or network framework, syntax structure, and/or the like, various embodiments of the ICST may be implemented that allow a great deal of flexibility and customization. For example, aspects of the ICST may be adapted for remote payment terminal monitoring. While various embodiments and discussions of the ICST have been directed to intelligent consumer terminal solutions, however, it is to be understood that the embodiments described herein may be readily configured and/or customized for a wide variety of other applications and/or implementations.

What is claimed is:

1. An intelligent consumer service solution apparatus, comprising:
a memory;
a processor disposed in communication with said memory, and configured to issue a plurality of processing instructions stored in the memory, wherein the processor issues instructions to:
receiving, at a service solution cloud, status data updates relating to a service solution deployed at one or more remote robotic terminals from the one or more remote robotic terminals,
wherein the one or more remote robotic terminals are configured to provide similar services;
aggregating and storing the status data updates relating to the service solution in an encryptomatic data format at the service solution cloud in a bandwidth efficient manner by maintaining data updates at a centralized data platform to reduce data message passing and data storage space,
wherein the service solution cloud is configured to periodically update based on the status data updates;
receive, at the periodically updated service solution cloud, a service solution request inquiry from a remote robotic terminal;
parse the service request inquiry to obtain service identifying information including an application ID;
obtain, from the received service request, a supplied data package indicating a currently deployed service solution at the remote robotic terminal;
query in the solution cloud based on the obtained service identifying information and the supplied data package;
aggregate queried results from the solution cloud related to the supplied data package;
determine an enhanced service solution based on the aggregated queried results in response to the service request inquiry;
generate a downloadable instruction package including the generated solution based on source information of the remote terminal,
provide the downloadable instruction package to the remote robotic terminal, and
updating, at the service solution cloud, data records related to the service solution based on the generated enhanced service solution.

2. An intelligent consumer service solution apparatus, comprising:
a memory;
a processor disposed in communication with said memory, and configured to issue a plurality of processing instructions stored in the memory, wherein the processor issues instructions to:
receive, at a server, a service request inquiry from a remote terminal,
parse the service request inquiry to obtain service identifying information;
obtain, from the received service request, a supplied data package indicating a currently deployed service solution at the remote robotic terminal,
query in the solution cloud based on the obtained service identifying information and the supplied data package;
aggregate queried results from the solution cloud related to the supplied data package;
determine an enhanced service solution based on the aggregated queried results in response to the service request inquiry;
generate a downloadable instruction package including the generated solution based on source information of the remote terminal, and
provide the downloadable instruction package to the remote terminal.

3. The apparatus of claim 1, wherein the remote terminal comprises an intelligent robot.

4. The apparatus of claim 3, wherein the intelligent robot comprises any of:
a robot cleaner;
a police car detector;
a traffic detector;
electronic jewelry; and
a quadrocopter.

5. The apparatus of claim 1, wherein the service request is received at a remote server.

6. The apparatus of claim 1, wherein the service request includes any of:
GPS information;
device information of the remote terminal; and
key words describing the service request.

7. The apparatus of claim 1, wherein the remote terminal comprises a user interface to receive the service request from a user.

8. The apparatus of claim 1, wherein the remote terminal determines whether there is a locally existing solution prior to sending the service request to the server.

9. The apparatus of claim 1, wherein the processor further issues instructions for:
determining whether a queried solution from the solution cloud is compatible with the remote terminal.

10. The apparatus of claim 1, wherein the processor further issues instructions for:
identifying an application identifier associated with the service request; and
forming a query based on the application identifier in the solution cloud.

11. The apparatus of claim 1, wherein the processor further issues instructions for:
determining whether there are linked remote terminals of a same type of the remote terminal; and
retrieving a list of linked remote terminal profiles;
retrieving service request history of the linked remote terminals based on the list of linked remote terminal profiles; and
forming a query on the retrieved service request history of the linked remote terminals based on the service request.

12. The apparatus of claim 11, wherein the processor further issues instructions for:
expanding the list of linked remote terminal profiles to a second degree linked remote terminals; and
forming a query within the expanded list of linked remote terminal profiles for a solution based on the service request.

13. The apparatus of claim 1, wherein the processor further issues instructions for:
retrieving a list of unprocessed service solution history from the solution cloud; and
determining feedback associated with each service request query from the list of unprocessed service solution history.

14. The apparatus of claim 13, wherein the processor further issues instructions for:
determining a type of the feedback associated with each service request query.

15. The apparatus of claim 1, wherein the processor further issues instructions for:
forming a social network of remote terminals based on a type of the remote terminals.

16. The apparatus of claim 17, wherein the processor further issues instructions for:
sharing the downloadable instruction package with other remote terminals within the social network.

17. The apparatus of claim 1, wherein the aggregating queried results are based on feedback from the remote terminal related to the service request inquiry.

18. The apparatus of claim 1, wherein the enhanced service solution is determined based on an encryptmatic data format converter.

19. An intelligent consumer service solution processor-readable non-transitory medium storing processor-executable instructions executable by a processor to:
receive, at a server, a service request inquiry from a remote terminal;
parse the service request inquiry to obtain service identifying information;
obtain, from the received service request, a supplied data package indicating a currently deployed service solution at the remote robotic terminal;
query in the solution cloud based on the obtained service identifying information and the supplied data package;
aggregate queried results from the solution cloud related to the supplied data package;
determine an enhanced service solution based on the aggregated queried results in response to the service request inquiry;
generate a downloadable instruction package including the generated solution based on source information of the remote terminal; and
provide the downloadable instruction package to the remote terminal.

20. An intelligent consumer service solution processor-implemented method, comprising:
receiving, at a server, a service request inquiry from a remote terminal;
parsing the service request inquiry to obtain service identifying information;
obtaining, from the received service request, a supplied data package indicating a currently deployed service solution at the remote robotic terminal;
querying in the solution cloud based on the obtained service identifying information and the supplied data package;
aggregating queried results from the solution cloud related to the supplied data package;
determining an enhanced service solution based on the aggregated queried results in response to the service request inquiry;
generating a downloadable instruction package including the generated solution based on source information of the remote terminal; and
providing the downloadable instruction package to the remote terminal.
